(19) United States
(12) Patent Application Publication
(10) Pub. No.: US 2018/0262388 A1
(43) Pub. Date: Sep. 13, 2018

(54) REMOTE DEVICE DEPLOYMENT

(71) Applicant: Weaved, Inc., Palo Alto, CA (US)

(72) Inventors: Michael W. Johnson, Petaluma, CA (US); Ryo Koyama, Palo Alto, CA (US); Michael John Sebastian, Palo Alto, CA (US)

(21) Appl. No.: 15/663,110

(22) Filed: Jul. 28, 2017

Related U.S. Application Data
(63) Continuation-in-part of application No. 15/613,281, filed on Jun. 5, 2017.
Application No. 15/613,281 is a continuation-in-part of application No. 15/202,489, filed on Jul. 5, 2016, now abandoned.
Application No. 15/202,489 is a continuation-in-part of application No. 13/918,773, filed on Jun. 14, 2013, now abandoned.
Application No. 13/918,773 is a continuation-in-part of application No. 14/493,278, filed on Sep. 22, 2014, now abandoned.
Application No. 14/493,278 is a continuation-in-part of application No. 14/499,362, filed on Sep. 29, 2014, now abandoned.
Application No. 14/499,362 is a continuation-in-part of application No. 14/517,843, filed on Oct. 18, 2014, now abandoned.
Application No. 14/517,843 is a continuation-in-part of application No. 14/520,389, filed on Oct. 22, 2014, now abandoned.
Application No. 14/520,389 is a continuation-in-part of application No. 13/865,910, filed on Apr. 18, 2013, now Pat. No. 9,253,031.
Application No. 13/865,910 is a continuation of application No. 11/860,876, filed on Sep. 25, 2007, now Pat. No. 8,447,843.
Application No. 11/860,876 is a continuation-in-part of application No. 14/534,155, filed on Nov. 5, 2014, now abandoned.
Application No. 14/534,155 is a continuation-in-part of application No. 13/865,910, filed on Apr. 18, 2013, now Pat. No. 9,253,031.
Application No. 13/865,910 is a continuation of application No. 11/860,876, filed on Sep. 25, 2007, now Pat. No. 8,447,843.
Application No. 11/860,876 is a continuation-in-part of application No. 14/956,386, filed on Dec. 1, 2015, now Pat. No. 9,712,486.
Application No. 14/956,386 is a continuation-in-part of application No. 14/589,951, filed on Jan. 5, 2015, now Pat. No. 9,231,904.
Application No. 14/589,951 is a continuation-in-part of application No. 14/534,155, filed on Nov. 5, 2014, now abandoned.
Application No. 14/534,155 is a continuation-in-part of application No. 13/865,910, filed on Apr. 18, 2013, now Pat. No. 9,253,031.
Application No. 13/865,910 is a continuation of application No. 11/860,876, filed on Sep. 25, 2007, now Pat. No. 8,447,843.
(60) Provisional application No. 62/537,819, filed on Jul. 27, 2017.
(60) Provisional application No. 61/660,619, filed on Jun. 15, 2012.
(60) Provisional application No. 60/883,637, filed on Jan. 5, 2007.
(60) Provisional application No. 60/826,887, filed on Sep. 25, 2006.
(60) Provisional application No. 60/883,637, filed on Jan. 5, 2007.
(60) Provisional application No. 60/826,887, filed on Sep. 25, 2006.
(60) Provisional application No. 60/883,637, filed on Jan. 5, 2007.
(60) Provisional application No. 60/826,887, filed on Sep. 25, 2006.

(51) Int. Cl. H04L 29/06; H04L 12/24; H04L 29/08; G06Q 10/10; G06F 9/448; H04L 29/12; H01L 29/12

(52) U.S. Cl. CPC H04L 41/0803; H04L 67/34; H04L 67/125; H04L 63/105; H04L 67/025; G06F 9/448; H04L 29/12; H01L 29/12; G06Q 10/103

(57) ABSTRACT

Methods, systems, and computer program products for configuring internet of things (IoT) devices. In use, a connection between a user device and at least one of a plurality of remote devices is established without allowing any incoming connections to the at least one of the plurality of remote devices. Additionally, a script is executed on the at least one of the plurality of remote devices, and results of executing the script on the at least one of the plurality of remote devices are gathered. Further, at least a portion of the results are sent to the user device.

### RELATED APPLICATIONS

The present application claims the benefit of priority from U.S. Provisional Patent Application No. 62/537,819 filed Jul. 27, 2017, entitled “REMOTE DEVICE DEPLOYMENT,” and is a continuation-in-part of co-pending U.S. patent application Ser. No. 15/613,281 filed Jun. 5, 2017, entitled “MANAGING NETWORK CONNECTED DEVICES”, which is a continuation-in-part of co-pending U.S. patent application Ser. No. 15/202,489 filed Jul. 5, 2016, entitled “NETWORKING SYSTEMS”, which is a continuation-in-part of, and claims the benefit to U.S. patent application Ser. No. 13/918,773, filed Jun. 14, 2013, entitled “NETWORKING SYSTEMS” (now abandoned), which in turn claims priority to U.S. Provisional Patent Application No. 61/660,619, filed Jun. 15, 2012, entitled “NETWORKING SYSTEMS”. The foregoing applications and/or patents are herein incorporated by reference in their entirety for all purposes.

Additionally, this application is a continuation-in-part of, and claims the benefit to U.S. patent application Ser. No. 14/493,278, filed Sep. 22, 2014, entitled “MULTI-SERVER FRACTIONAL SUBDOMAIN DNS PROTOCOL” (now abandoned). The foregoing application and/or patent is herein incorporated by reference in their entirety for all purposes.

Additionally, this application is a continuation-in-part of, and claims the benefit to U.S. patent application Ser. No. 14/499,362, filed Sep. 29, 2014, entitled “DIRECT MAP PROXY SYSTEM AND PROTOCOL” (now abandoned). The foregoing application and/or patent is herein incorporated by reference in their entirety for all purposes.

Additionally, this application is a continuation-in-part of, and claims the benefit to U.S. patent application Ser. No. 14/517,843, filed Oct. 18, 2014, entitled “INSTALLATION AND CONFIGURATION OF CONNECTED DEVICES” (now abandoned) The foregoing application and/or patent is herein incorporated by reference in their entirety for all purposes.

Additionally, this application is a continuation-in-part of, and claims the benefit to U.S. patent application Ser. No. 14/520,389, filed Oct. 22, 2014, entitled “METHOD AND PROTOCOL FOR SECURE DEVICE DEPLOYMENT USING A PARTIALLY-ENCRYPTED PROVISIONING FILE” (now abandoned), which in turn is a continuation-in-part of U.S. patent application Ser. No. 13/865,910, now U.S. Pat. No. 9,253,031, filed Apr. 18, 2013, entitled “SYSTEM, METHOD AND COMPUTER PROGRAM PRODUCT FOR IDENTIFYING, CONFIGURING AND ACCESSING A DEVICE ON A NETWORK,” which in turn is a continuation of U.S. patent application Ser. No. 11/860,876, now U.S. Pat. No. 8,447,843, filed Sep. 25, 2007, entitled “SYSTEM, METHOD AND COMPUTER PROGRAM PRODUCT FOR IDENTIFYING, CONFIGURING AND ACCESSING A DEVICE ON A NETWORK,” which claims the benefit of priority from U.S. Provisional Patent Application No. 60/883,637, filed Jan. 5, 2007, entitled “SYSTEM, METHOD AND COMPUTER PROGRAM PRODUCT FOR ACCESSING A DEVICE ON A NETWORK UTILIZING A UNIVERSAL DEVICE LOCATOR” and U.S. Provisional Patent Application No. 60/826,887, filed Sep. 25, 2006, entitled “SYSTEM, METHOD AND COMPUTER PROGRAM PRODUCT FOR AUTOMATICALLY IDENTIFYING AND CONFIGURING A DEVICE.” The foregoing applications and/or patents are herein incorporated by reference in their entirety for all purposes.

Additionally, this application is a continuation-in-part of, and claims the benefit to U.S. patent application Ser. No. 14/534,155, filed Nov. 5, 2014, entitled “LOAD BALANCED INTER-DEVICE MESSAGING” (now abandoned), which in turn is a continuation-in-part of U.S. patent application Ser. No. 13/865,910, now U.S. Pat. No. 9,253,031, filed Apr. 18, 2013, entitled “SYSTEM, METHOD AND COMPUTER PROGRAM PRODUCT FOR IDENTIFYING, CONFIGURING AND ACCESSING A DEVICE ON A NETWORK,” which in turn is a continuation of U.S. patent application Ser. No. 11/860,876, now U.S. Pat. No. 8,447,843, filed Sep. 25, 2007, entitled “SYSTEM, METHOD AND COMPUTER PROGRAM PRODUCT FOR IDENTIFYING, CONFIGURING AND ACCESSING A DEVICE ON A NETWORK,” which claims the benefit of U.S. Provisional Patent Application No. 60/883,637, filed Jan. 5, 2007, entitled “SYSTEM, METHOD AND COMPUTER PROGRAM PRODUCT FOR ACCESSING A DEVICE ON A NETWORK UTILIZING A UNIVERSAL DEVICE LOCATOR” and U.S. Provisional Patent Application No. 60/826,887, filed Sep. 25, 2006, entitled “SYSTEM, METHOD AND COMPUTER PROGRAM PRODUCT FOR AUTOMATICALLY IDENTIFYING AND CONFIGURING A DEVICE.” The foregoing applications and/or patents are herein incorporated by reference in their entirety for all purposes.

Additionally, this application is a continuation-in-part of, and claims the benefit to co-pending U.S. patent application Ser. No. 14/956,386, filed Dec. 1, 2015, entitled “TECHNIQUES FOR THE DEPLOYMENT AND MANAGEMENT OF NETWORK CONNECTED DEVICES,” which in turn is a continuation-in-part of U.S. patent application Ser. No. 14/589,951, now U.S. Pat. No. 9,231,904, filed Jan. 5, 2015, entitled “DEPLOYING AND MANAGING NETWORKED DEVICES,” which in turn is a continuation-in-part of U.S. patent application Ser. No. 14/534,155, filed Nov. 5, 2014, entitled “LOAD BALANCED INTER-DEVICE MESSAGING,” which in turn is a continuation-in-part of U.S. patent application Ser. No. 13/865,910, filed Apr. 18, 2013, now U.S. Pat. No. 9,253,031, entitled “SYSTEM, METHOD AND COMPUTER PROGRAM PRODUCT FOR IDENTIFYING, CONFIGURING AND ACCESSING A DEVICE ON A NETWORK,” which in turn is a continuation of U.S. patent application Ser. No. 11/860,876, now U.S. Pat. No. 8,447,843, filed Sep. 25, 2007, entitled “SYSTEM, METHOD AND COMPUTER PROGRAM PRODUCT FOR IDENTIFYING, CONFIGURING AND ACCESSING A DEVICE ON A NETWORK,” which claims the benefit of U.S. Provisional Patent Application No. 60/883,637, filed Jan. 5, 2007, entitled “SYSTEM, METHOD AND COMPUTER PROGRAM PRODUCT FOR ACCESSING A DEVICE ON A NETWORK UTILIZING A UNIVERSAL DEVICE LOCATOR” and U.S. Provisional Patent Application No. 60/826,887, filed Sep. 25, 2006, entitled “SYSTEM, METHOD AND COMPUTER PROGRAM PRODUCT FOR AUTOMATICALLY IDENTIFYING AND CONFIGURING A DEVICE.” The foregoing applications and/or patents are herein incorporated by reference in their entirety for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

This disclosure relates to the field of internet of things and more particularly to techniques for auto-configuration of remote devices upon deployment.

### BACKGROUND

Internet-connected devices are everywhere. With the ever-increasing deployment of Internet-of-Things (IOT) devices, has come an increasing need for easy configuration of deployed IoT devices. Legacy techniques have failed to address the complexity of deployment.

Unfortunately, legacy techniques have failed to address the need for so called “zero-touch” remote device deployment. Techniques are needed to address the problem of massive deployments of remote devices.

None of the aforementioned legacy approaches achieve the capabilities of the herein-disclosed techniques for auto-configuration of remote devices upon deployment. Therefore, there is a need for improvements.

### SUMMARY

The present disclosure provides an improved method, system, and computer program product suited to address the aforementioned issues with legacy approaches. More specifically, the present disclosure provides a detailed description of techniques used in methods, systems, and computer program products for auto-configuration of remote devices upon deployment. The claimed embodiments address the problem of massive deployments of remote devices. More specifically, some claims are directed to approaches for systems and protocols for auto-configuration of remote devices upon deployment, which claims advance the technical fields for addressing the problem of massive deployments of remote devices, as well as advancing peripheral technical fields. Some claims improve the functioning of multiple systems within the disclosed environments.

Further details of aspects, objectives, and advantages of the disclosure are described below and in the detailed description, drawings, and claims. Both the foregoing general description of the background and the following detailed description are exemplary and explanatory, and are not intended to be limiting as to the scope of the claims.

### BRIEF DESCRIPTION OF THE DRAWINGS

So that the features of various embodiments of the present disclosure can be understood, a more detailed description, briefly summarized above, may be had by reference to various embodiments, some of which are illustrated in the accompanying drawings. It is to be noted, however, that the accompanying drawings illustrate only embodiments and are therefore not to be considered limiting of the scope of the various embodiments of the disclosure, for the embodiment(s) may admit to other effective embodiments. The following detailed description makes reference to the accompanying drawings that are now briefly described.

The drawings described below are for illustration purposes only. The drawings are not intended to limit the scope of the present disclosure. This patent or application file contains at least one drawing executed in color. Copies of this patent or patent application publication with color drawings will be provided by the U.S. Patent and Trademark Office upon request and payment of the necessary fee.

One or more of the various embodiments of the disclosure are susceptible to various modifications, combinations, and alternative forms, various embodiments thereof are shown by way of example in the drawings and will herein be described in detail. It should be understood, however, that the accompanying drawings and detailed description are not intended to limit the embodiment(s) to the particular form disclosed, but on the contrary, the intention is to cover all modifications, combinations, equivalents and alternatives falling within the spirit and scope of the various embodiments of the present disclosure as defined by the relevant claims.

FIG. Y5-1A depicts an Internet-connected system that carries out a protocol for auto-configuration of remote devices upon deployment, according to an embodiment.

FIG. Y5-1B depicts a sample set of configuration protocol communications to carry communications between Internet-connected system components for auto-configuration of remote devices upon deployment, according to an embodiment.

FIG. Y5-1C depicts a sample set of terms used in describing configuration protocol communications to carry communications between Internet-connected system components for auto-configuration of remote devices upon deployment, according to an embodiment.

FIG. Y5-2A through FIG. Y5-2N depict a sample set of configuration protocol communications to carry communications between Internet-connected system components for auto-configuration of remote devices upon deployment, according to an embodiment.

FIG. Y5-3A through FIG. Y5-3G depict a packet trace for a proxy connection as used in auto-configuration of remote devices upon deployment, according to an embodiment.

FIG. Y5-4 is a CHAT protocol packet structure, according to an embodiment. This exemplary embodiment may implement additional features.

FIG. Y5-5 is the packet structure of a TLV (type-length-value) element used for (device to) server communications, according to an embodiment. This exemplary embodiment may implement additional features.

FIG. Y5-6 is an example server communications packet format with a sequence of two TLV elements, according to an embodiment and as used in any of the embodiments described herein. This exemplary embodiment may implement additional features.

FIG. Y5-7 is an example server communications packet format encapsulated in UDP and showing a server communications packet type that includes two data types and thus a sequence of two TLV elements, according to an embodiment.

FIG. Y5-8 depicts an example server communications protocol using a packet format encapsulated in UDP and showing a server communications packet type that includes two data types and thus a sequence of two TLV elements, according to an embodiment.

FIG. Y5-9 is an example remot3.it server communications packet format, according to an embodiment, showing extra CHAT protocol header fields used for encryption.

FIG. Y5-10 is an example remot3.it P2P communications packet diagram, according to an embodiment.

FIG. Y5-11 is a packet format of an ssh2 packet type 20 SSH_MSG_KEXINIT, according to an embodiment.

FIG. Y5-12 is a chart for comparing SSH key exchange techniques, according to an embodiment.

FIG. Y5-13 depicts a user interface for a proxy connection as used in for managing remote devices, according to an embodiment.

FIG. Y5-14A depicts a block diagram of an instance of a computer system suitable for implementing embodiments of the present disclosure.

FIG. Y5-14B is a diagram illustrating a mobile terminal, according to an embodiment.

FIG. Y5-14C depicts an interconnection of components to form a mobile terminal, according to an embodiment.

FIG. Y5-14D depicts a deployable device architecture, according to an embodiment.

FIG. Y5-15 depicts a deployment scheme, according to an embodiment.

### DETAILED DESCRIPTION

### Glossary

In this description, a device refers to a mobile device, electronic system, machine, and/or any type of apparatus, system, that may be mobile, fixed, wearable, portable, worn, carried, integrated, cloud-based, distributed and/or any combination of these and which may be formed, manufactured, operated, etc. in any fashion, or manner in any location(s). It should be understood, however, that one or more of the embodiments described herein and/or in one or more specifications incorporated by reference may be applied to any device(s) or similar object(s) e.g., consumer devices, phones, phone systems, cell phones, cellular phones, mobile phone, smart phone, internet phones, wireless phones, personal digital assistants (PDAs), remote communication devices, wireless devices, music players, video players, media players, multimedia players, video recorders, VCRs, DVRs, book readers, voice recorders, voice controlled systems, voice controllers, cameras, social interaction devices, radios, TVs, watches, personal communication devices, electronic wallets, electronic currency, smart cards, smart credit cards, electronic money, electronic coins, electronic tokens, smart jewelry, electronic passports, electronic identification systems, biometric sensors, biometric systems, biometric devices, smart pens, smart rings, personal computers, tablets, laptop computers, scanners, printers, computers, web servers, media servers, multimedia servers, file servers, datacenter servers, database servers, database appliances, cloud servers, cloud devices, cloud appliances, embedded systems, embedded devices, electronic glasses, electronic goggles, electronic screens, displays, wearable displays, projectors, picture frames, touch screens, computer appliances, kitchen appliances, home appliances, home theater systems, audio systems, home control appliances, home control systems, irrigation systems, sprinkler systems, garage door systems, garage door controls, remote controls, remote control systems, thermostats, heating systems, air conditioning systems, ventilation systems, climate control systems, climate monitoring systems, industrial control systems, transportation systems and controls, industrial process and control systems, industrial controller systems, machine-to-machine systems, aviation systems, locomotive systems, power control systems, power controllers, lighting control, lights, lighting systems, solar system controllers, solar panels, vehicle and other engines, engine controllers, motors, motor controllers, navigation controls, navigation systems, navigation displays, sensors, sensor systems, transducers, transducer systems, computer input devices, device controllers, touchpads, mouse, pointer, joystick, keyboards, game controllers, haptic devices, game consoles, game boxes, network devices, routers, switches, TiVO, AppleTV, GoogleTV, internet TV boxes, internet systems, internet devices, set-top boxes, cable boxes, modems, cable modems, PCs, tablets, media boxes, streaming devices, entertainment centers, entertainment systems, aircraft entertainment systems, hotel entertainment systems, car and vehicle entertainment systems, GPS devices, GPS systems, automobile and other motor vehicle systems, truck systems, vehicle control systems, vehicle sensors, aircraft systems, automation systems, home automation systems, industrial automation systems, reservation systems, check-in terminals, ticket collection systems, admission systems, payment devices, payment systems, banking machines, cash points, ATMs, vending machines, vending systems, point of sale devices, coin-operated devices, token operated devices, gas (petrol) pumps, ticket machines, toll systems, barcode scanners, credit card scanners, travel token systems, travel card systems, RFID devices, electronic labels, electronic tags, tracking systems, electronic stickers, electronic price tags, near field communication (NFC) devices, wireless operated devices, wireless receivers, wireless transmitters, sensor devices, motes, sales terminals, checkout terminals, electronic toys, toy systems, gaming systems, information appliances, information and other kiosks, sales displays, sales devices, electronic menus, coupon systems, shop displays, street displays, electronic advertising systems, traffic control systems, traffic signs, parking systems, parking garage devices, elevators and elevator systems, building systems, mailboxes, electronic signs, video cameras, security systems, surveillance systems, electronic locks, electronic keys, electronic key fobs, access devices, access controls, electronic actuators, safety systems, smoke detectors, fire control systems, fire detection systems, locking devices, electronic safes, electronic doors, music devices, storage devices, back-up devices, USB keys, portable disks, exercise machines, sports equipment, medical devices, medical systems, personal medical devices, wearable medical devices, portable medical devices, mobile medical devices, blood pressure sensors, heart rate monitors, blood sugar monitors, vital sign monitors, ultrasound devices, medical imagers, drug delivery systems, drug monitoring systems, patient monitoring systems, medical records systems, industrial monitoring systems, robots, robotic devices, home robots, industrial robots, electric tools, power tools, construction equipment, electronic jewelry, wearable devices, wearable electronic devices, wearable cameras, wearable video cameras, wearable systems, electronic dispensing systems, handheld computing devices, handheld electronic devices, electronic clothing, combinations of these and/or any other like or similar devices, multi-function devices, multi-purpose devices, combination devices, one or more of tehse and/or other devices that may be used together, coupled, otherwise connected etc. and/or cooperating devices, and the like, etc.

The devices may support (e.g., include, comprise, contain, implement, execute, be part of, be operable to execute, display, source, provide, store, etc.) one or more applications and/or functions e.g., search applications, contacts and/or friends applications, social interaction applications, social media applications, messaging applications, telephone applications, video conferencing applications, e-mail applications, voicemail applications, communications applications, voice recognition applications, instant messaging (IM) applications, texting applications, blog and/or blogging applications, photographic applications (e.g., catalog, management, upload, editing, etc.), shopping, advertising, sales, purchasing, selling, vending, ticketing, payment, digital camera applications, digital video camera applications, web browsing and browser applications, digital music player applications, digital video player applications, cloud applications, office productivity applications, database applications, cataloging applications, inventory control, medical applications, electronic book and newspaper applications, travel applications, dictionary and other reference work applications, language translation, spreadsheet applications, word processing applications, presentation applications, business applications, finance applications, accounting applications, publishing applications, web authoring applications, multimedia editing, computer-aided design (CAD), manufacturing applications, home automation and control, backup and/or storage applications, help and/or manuals, banking applications, stock trading applications, calendar applications, voice driven applications, map applications, consumer entertainment applications, games, other applications and/or combinations of these and/or multiple instances (e.g., versions, copies, etc.) of these and/or other applications, and the like, etc.

The devices may include (e.g., comprise, be capable of including, have features to include, have attachments, communicate with, be linked to, be coupled with, paired with, operable to be coupled with, be connected to, be operable to connect to, be operable to be paired with, etc.) one or more devices (e.g., there may be a hierarchy of devices, nested devices, etc.). The devices may operate, function, run, etc. as separate components, working in cooperation, as a cooperative hive, as a confederation of devices, as a federation, as a collection of devices, as a cluster, as a multi-function device, with sockets, ports, connectivity, etc. for extra, additional, add-on, optional, etc. devices and/or components, attached devices (e.g., direct attach, network attached, remote attach, cloud attach, add on, plug in, etc.), upgrade components, helper devices, input and/or output devices, acceleration devices, support devices, engines, expansion devices and/or modules, combinations of these and/or other components, hardware, software, firmware, devices, and the like, etc.

The devices may have (e.g., implement, comprise, include, execute, perform, capable of being programmed to perform, cooperate to perform, etc.) one or more device functions (e.g., telephone, video conferencing, e-mail, instant messaging, blogging, digital photography, digital video, web browsing, digital music playing, social interaction, shopping, searching, banking, combinations of these and/or other functions, and the like, etc.). Instructions, help, guides, manuals, procedures, algorithms, processes, methods, techniques, etc. for performing and/or helping to perform, etc. the device functions, etc. may be included in a computer readable storage medium, computer readable memory medium, or other computer program product configured for execution, for example, by one or more processors.

The devices may include one or more processors (e.g., central processing units (CPUs), multicore CPUs, homogeneous CPUs, heterogeneous CPUs, graphics processing units (GPUs), computing arrays, CPU arrays, microprocessors, controllers, microcontrollers, engines, accelerators, compute arrays, programmable logic, DSP, dedicated logic, combinations of these and the like, etc.). Devices and/or processors, etc. may include, contain, comprise, etc. one or more operating systems (OSs) or the like. Processors may use one or more machine or system architectures (e.g., ARM, Intel, x86, hybrids, emulators, other architectures, combinations of these, and/or similar structures, frameworks, and the like, etc.).

Processor architectures may use one or more privilege levels. For example, the x86 architecture may include four hardware resource privilege levels or rings. The OS kernel, for example, may run in privilege level 0 or ring 0 with complete control over the machine or system. In the Linux OS, for example, ring 0 may be kernel space, and user mode may run in ring 3.

A multi-core processor (multicore processor, multicore CPU, etc.) may be a single computing component (e.g., a single chip, a single logical component, a single physical component, a single package, an integrated circuit, a multi-chip package, combinations of these and the like, etc.). A multicore processor may include (e.g., comprise, contain, etc.) two or more central processing units, etc. called cores. The cores may be independent, relatively independent and/or connected, coupled, integrated, logically connected, etc. in any way. The cores, for example, may be the units that read and execute program instructions. The instructions may be ordinary CPU instructions such as add, move data, and branch, but the multiple cores may run multiple instructions at the same time, increasing overall speed, for example, for programs amenable to parallel computing. Manufacturers may typically integrate the cores onto a single integrated circuit die (known as a chip multiprocessor or CMP), or onto multiple dies in a single chip package, but any implementation, construction, assembly, manufacture, packaging method and/or process, etc. is possible.

The devices may use one or more virtualization methods. In computing, virtualization refers to the act of creating (e.g., simulating, emulating, etc.) a virtual (rather than actual) version of something, including but not limited to a virtual computer hardware platform, operating system (OS), storage device, computer network resources and the like.

For example, a hypervisor or virtual machine monitor (VMM) may be a virtualization method and may allow (e.g., permit, implement, etc.) hardware virtualization. A hypervisor may run (e.g., execute, operate, control, etc.) one or more operating systems (e.g., guest OSs, etc.) simultaneously (e.g., concurrently, at the same time, at nearly the same time, in a time multiplexed fashion, etc.), and each may run on its own virtual machine (VM) on a host machine and/or host hardware (e.g., device, combination of devices, combinations of devices with other computer(s), etc.). A hypervisor, for example, may run at a higher level than a supervisor.

Multiple instances of OSs may share virtualized hardware resources. A hypervisor, for example, may present a virtual platform, architecture, design, etc. to a guest OS and may monitor the execution of one or more guest OSs. A Type 1 hypervisor (also type I, native, or bare metal hypervisor, etc.) may run directly on the host hardware to control the hardware and monitor guest OSs. A guest OS thus may run at a level above (e.g., logically above, etc.) a hypervisor. Examples of Type 1 hypervisors may include VMware ESXi, Citrix XenServer, Microsoft Hyper-V, etc. A Type 2 hypervisor (also type II, or hosted hypervisor) may run within a conventional OS (e.g., Linux, Windows, Apple iOS, etc.). A Type 2 hypervisor may run at a second level (e.g., logical level, etc.) above the hardware. Guest OSs may run at a third level above a Type 2 hypervisor. Examples of Type 2 hypervisors may include VMware Server, Linux KVM, VirtualBox, etc. A hypervisor thus may run one or more other hypervisors with their associated VMs. In some cases, virtualization and nested virtualization may be part of an OS. For example, Microsoft Windows 7 may run Windows XP in a VM. For example, the IBM turtles project, part of the Linux KVM hypervisor, may run multiple hypervisors (e.g., KVM and VMware, etc.) and operating systems (e.g., Linux and Windows, etc.). The term embedded hypervisor may refer to a form of hypervisor that may allow, for example, one or more applications to run above the embedded hypervisor without an OS.

The term hardware virtualization may refer to virtualization of machines, devices, computers, operating systems, combinations of these, etc. that may hide the physical aspects of a computer system and instead present (e.g., show, manifest, demonstrate, etc.) an abstract system (e.g., view, aspect, appearance, etc.). For example, x86 hardware virtualization may allow one or more OSs to share x86 processor resources in a secure, protected, safe, etc. manner. Initial versions of x86 hardware virtualization were implemented using software techniques to overcome the lack of processor virtualization support. Manufacturers (e.g., Intel, AMD, etc.) later added (e.g., in later generations, etc.) processor virtualization support to x86 processors, thus simplifying later versions of x86 virtualization software, etc. Continued addition of hardware virtualization features to x86 and other (e.g., ARM) processors has resulted in continued improvements (e.g., in speed, in performance, etc.) of hardware virtualization. Other virtualization methods, such as memory virtualization, I/O virtualization (IOV), etc. may be performed by a chipset, integrated with a CPU, and/or by other hardware components, etc. For example, an input/output memory management unit (IOMMU) may enable guest VMs to access peripheral devices (e.g., network adapters, graphics cards, storage controllers, etc.) e.g., using DMA, interrupt remapping, etc. For example, PCI-SIG IOV may use a set of general (e.g., non-x86 specific) PCI Express (PCI-E) based native hardware I/O virtualization techniques. For example, one such technique may be address translation services (ATSs) that may support native IOV across PCI-E using address translation. For example, single root IOV (SR-IOV) may support native IOV in single root complex PCI-E topologies. For example, multi-root IOV (MR-IOV) may support native IOV by expanding SR-IOV to provide multiple root complexes that may, for example, share a common PCI-E hierarchy. In SR-IOV, for example, a host VMM may configure supported devices to create and allocate virtual shadows of configuration spaces (e.g., shadow devices, etc.) so that VM guests may, for example, configure, access, etc. one or more shadow device resources.

The devices (e.g., device software, device firmware, device applications, OSs, combinations of these, etc.) may use one or more programs (e.g., source code, programming languages, binary code, machine code, applications, apps, functions, etc.). The programs, etc. may use (e.g., require, employ, etc.) one or more code translation techniques (e.g., process, algorithms, etc.) to translate from one form of code to another form of code e.g., to translate from source code (e.g., readable text, abstract representations, high-level representations, graphical representations, etc.) to machine code (e.g., machine language, executable code, binary code, native code, low-level representations, etc.). For example, a compiler may translate (e.g., compile, transform, etc.) source code into object code (e.g., compiled code, etc.). For example, a linker may translate object code into machine code (e.g., linked code, loadable code, etc.). Machine code may be executed by a CPU, etc. at runtime. Computer programming languages (e.g., high-level programming languages, source code, abstract representations, etc.) may be interpreted or compiled. Interpreted code may be translated (e.g., interpreted, by an interpreter, etc.), for example, to machine code during execution (e.g., at runtime, continuously, etc.). Compiled code may be translated (compiled, by a compiler, etc.), for example, to machine code once (e.g., statically, at one time, etc.) before execution. An interpreter may be classified into one or more of the following types: type 1 interpreters may, for example, execute source code directly; type 2 interpreters may, for example, compile or translate source code into an intermediate representation (e.g., intermediate code, intermediate language, temporary form, etc.) and may execute the intermediate code; type 3 interpreters may execute stored precompiled code generated by a compiler that may, for example, be part of the interpreter. For example, languages such as Lisp, etc. may use a type 1 interpreter; languages such as Perl, Python, etc. may use a type 2 interpreter; languages such as Pascal, Java, etc. may use a type 3 interpreter. Some languages, such as Smalltalk, BASIC, etc. may, for example, combine facets, features, properties, etc. of interpreters of type 2 and interpreters of type 3. There may not always, for example, be a clear distinction between interpreters and compilers. For example, interpreters may also perform some translation. For example, some programming languages may be both compiled and interpreted or may include features of both. For example, a compiler may translate source code into an intermediate form (e.g., bytecode, portable code, p-code, intermediate code, etc.), that may then be passed to an interpreter. The terms interpreted language or compiled language applied to describing, classifying, etc. a programming language (e.g., C++ is a compiled programming language, etc.) may thus refer to an example (e.g., canonical, accepted, standard, theoretical, etc.) implementation of a programming language that may use an interpreter, compiler, etc. Thus a high-level computer programming language, for example, may be an abstract, ideal, theoretical, etc. representation that may be independent of a particular, specific, fixed, etc. implementation (e.g., independent of a compiled, interpreted version, etc.).

The devices (e.g., device software, device firmware, device applications, OSs, etc.) may use one or more alternative code forms, representations, etc. For example, a device may use bytecode that may be executed by an interpreter or that may be compiled. Bytecode may take any form. Bytecode, for example, may be based on (e.g., be similar to, use, etc.) hardware instructions and/or use hardware instructions in machine code. Bytecode design (e.g., format, architecture, syntax, appearance, semantics, etc.) may be based on a machine architecture (e.g., virtual stack machine, virtual register machine, etc.). Parts, portions, etc. of bytecode may be stored in files (e.g., modules, similar to object modules, etc.). Parts, portions, modules, etc. of bytecode may be dynamically loaded during execution. Intermediate code (e.g., bytecode, etc.) may be used to simplify and/or improve the performance, etc. of interpretation. Bytecode may be used, for example, in order to reduce hardware dependence, OS dependence, or other dependencies, etc. by allowing the same bytecode to run on different platforms (e.g., architectures, etc.). Bytecode may be directly executed on a VM (e.g., using an interpreter, etc.). Bytecode may be translated (e.g., compiled, etc.) to machine code, for example to improve performance, etc. Bytecode may include compact numeric codes, constants, references, numeric addresses, etc. that may encode the result of translation, parsing, semantic analysis, etc. of the types, scopes, nesting depths, etc. of program objects, constructs, structures, etc. The use of bytecode may, for example, allow improved performance over the direct interpretation of source code. Bytecode may be executed, for example, by parsing and executing bytecode instructions one instruction at a time. A bytecode interpreter may be portable (e.g., independent of device, machine architecture, computer system, computing platform, etc.).

The devices (e.g., device applications, OSs, etc.) may use one or more VMs. For example, a Java virtual machine (JVM) may use Java bytecode as intermediate code. Java bytecode may correspond, for example, to the instruction set of a stack-oriented architecture. For example, Oracle's JVM is called HotSpot. Examples of clean-room Java implementations may include Kaffe, IBM J9, and Dalvik. A software library (library) may be a collection of related object code. A class may be a unit of code. The Java Classloader may be part of the Java runtime environment (JRE) that may, for example, dynamically load Java classes into the JVM. Java libraries may be packaged in Jar files. Libraries may include objects of different types. One type of object in a Jar file may be a Java class. The class loader may locate libraries, read library contents, and load classes included within the libraries. Loading may, for example, be performed on demand, when the class is required by a program. Java may make use of external libraries (e.g., libraries written and provided by a third party, etc.). When a JVM is started, one or more of the following class loaders may be used: (1) bootstrap class loader; (2) extensions class loader; or (3) system class loader. The bootstrap class loader, which may be part of the core JVM, for example, may be written in native code and may load the core Java libraries. The extensions class loader may, for example, load code in the extensions directories. The system class loader may, for example, load code on the java.class.path stored in the system CLASSPATH variable. By default, all user classes may, for example, be loaded by the default system class loader that may be replaced by a user-defined ClassLoader. The Java class library may be a set of dynamically loadable libraries that Java applications may call at runtime. Because the Java platform may be independent of any OS, the Java platform may provide a set of standard class libraries that may, for example, include reusable functions commonly found in an OS. The Java class library may be almost entirely written in Java except, for example, for some parts that may need direct access to hardware, OS functions, etc. (e.g., for I/O, graphics, etc.). The Java classes that may provide access to these functions may, for example, use native interface wrappers, code fragments, etc. to access the API of the OS. Almost all of the Java class library may, for example, be stored in a Java archive file rt.jar, which may be provided with JRE and JDK distributions, for example.

The devices (e.g., device applications, OSs, etc.) may use one or more alternative code translation methods. For example, some code translation systems (e.g., dynamic translators, just-in-time compilers, etc.) may translate bytecode into machine language (e.g., native code, etc.) on demand, as required, etc. at runtime. Thus, for example, source code may be compiled and stored as machine independent code. The machine independent code may be linked at runtime and may, for example, be executed by an interpreter, compiler for JIT systems, etc. This type of translation, for example, may reduce portability, but may not reduce the portability of the bytecode itself. For example, programs may be stored in bytecode that may then be compiled using a JIT compiler that may translate bytecode to machine code. This may add a delay before a program runs and may, for example, improve execution speed relative to the direct interpretation of source code. Translation may, for example, be performed in one or more phases. For example, a first phase may compile source code to bytecode, and a second phase may translate the bytecode to a VM. There may be different VMs for different languages, representations, etc. (e.g., for Java, Python, PHP, Forth, Tcl, etc.). For example, Dalvik bytecode designed for the Android platform, for example, may be executed by the Dalvik VM. For example, the Dalvik VM may use special representations (e.g., DEX, etc.) for storing applications. For example, the Dalvik VM may use its own instruction set (e.g., based on a register-based architecture rather than stack-based architecture, etc.) rather than standard JVM bytecode, etc. Other implementations may be used. For example, the implementation of Perl, Ruby, etc. may use an abstract syntax tree (AST) representation that may be derived from the source code. For example, ActionScript (an object-oriented language that may be a superset of JavaScript, a scripting language) may execute in an ActionScript virtual machine (AVM) that may be part of Flash Player and Adobe Integrated Runtime (AIR). ActionScript code, for example, may be transformed into bytecode by a compiler. ActionScript compilers may be used, for example, in Adobe Flash Professional and in Adobe Flash Builder and may be available as part of the Adobe Flex SDK. A JVM may contain both and interpreter and JIT compiler and switch from interpretation to compilation for frequently executed code. One form of JIT compiler may, for example, represent a hybrid approach between interpreted and compiled code, and translation may occur continuously (e.g., as with interpreted code), but caching of translated code may be used e.g., to increase speed, performance, etc. JIT compilation may also offer advantages over static compiled code, e.g., the use late-bound data types, the ability to use and enforce security constraints, etc. JIT compilation may, for example, combine bytecode compilation and dynamic compilation. JIT compilation may, for example, convert code at runtime prior to executing it natively e.g., by converting bytecode into native machine code. Several runtime environments, (e.g., Microsoft .NET Framework, some implementations of Java, etc.) may, for example, use, employ, depend on, etc. JIT compilers. This specification may avoid the use of the term native machine code to avoid confusion with the terms machine code and native code.

The devices (e.g., device applications, OSs, etc.) may use one or more methods of emulation, simulation, etc. For example, binary translation may refer to the emulation of a first instruction set by a second instruction set (e.g., using code translation). For example, instructions may be translated from a source instruction set to a target instruction set. In some cases, such as instruction set simulation, the target instruction set may be the same as the source instruction set, and may, for example, provide testing features, debugging features, instruction trace, conditional breakpoints, hot spot detection, etc. Binary translation may be further divided into static binary translation and dynamic binary translation. Static binary translation may, for example, convert the code of an executable file to code that may run on a target architecture without, for example, having to run the code first. In dynamic binary translation, for example, the code may be run before conversion. In some cases conversion may not be direct since not all the code may be discoverable (e.g., reachable, etc.) by the translator. For example, parts of executable code may only be reached through indirect branches, with values, state, etc. needed for translation that may be known only at runtime. Dynamic binary translation may parse (e.g., process, read, etc.) a short sequence of code, may translate that code, and may cache the result of the translation. Other code may be translated as the code is discovered and/or when it is possible to be discovered. Branch instructions may point to already translated code and/or saved and/or cached (e.g., using memorization, etc.). Dynamic binary translation may differ from emulation and may eliminate the loop formed by the emulator reading, decoding, executing, etc. Binary translation may, for example, add a potential disadvantage of requiring additional translation overhead. The additional translation overhead may be reduced, ameliorated, etc. as translated code is repeated, executed multiple times, etc. For example, dynamic translators (e.g., Sun/Oracle HotSpot, etc.) may use dynamic recompilation, etc. to monitor translated code and aggressively (e.g., continuously, repeatedly, in an optimized fashion, etc.) optimize code that may be frequently executed, repeatedly executed, etc. This and other optimization techniques may be similar to that of a JIT compiler, and such compilers may be viewed as performing dynamic translation from a virtual instruction set (e.g., using bytecode, etc.) to a physical instruction set.

The term virtualization may refer to the creation (e.g., generation, design, etc.) of a virtual version (e.g., abstract version, apparent version, appearance of, illusion rather than actual, non-tangible object, etc.) of something (e.g., an object, tangible object, etc.) that may be real (e.g., tangible, non-abstract, physical, actual, etc.). For example, virtualization may apply to a device, mobile device, computer system, machine, server, hardware platform, platform, PC, tablet, operating system (OS), storage device, network resource, software, firmware, combinations of these and/or other objects, etc. For example, a VM may provide, present, etc. a virtual version of a real machine and may run (e.g., execute, etc.) a host OS, other software, etc. A VMM may be software (e.g., monitor, controller, supervisor, etc.) that may allow one or more VMs to run (e.g., be multiplexed, etc.) on one real machine. A hypervisor may be similar to a VMM. A hypervisor, for example, may be higher in functional hierarchy (e.g., logically, etc.) than a supervisor and may, for example, manage multiple supervisors (e.g., kernels, etc.). A domain (also logical domain, etc.) may run in (e.g., execute on, be loaded to, be joined with, etc.) a VM. The relationship between VMs and domains, for example, may be similar to that between programs and processes (or threads, etc.) in an OS. A VM may be a persistent (e.g., non-volatile, stored, permanent, etc.) entity that may reside (e.g., be stored, etc.) on disk and/or other storage, loaded into memory, etc. (e.g., and be analogous to a program, application, software, etc.). Each domain may have a domain identifier (also domain ID) that may be a unique identifier for a domain, and may be analogous (e.g., equivalent, etc.), for example, to a process ID in an OS. The term live migration may be a technique that may move a running (e.g., executing, live, operational, functional, etc.) VM to another physical host (e.g., machine, system, device, etc.) without stopping (e.g., halting, terminating, etc.) the VM and/or stopping any services, processes, threads, etc. that may be running on the VM.

Different types of hardware virtualization may include:
Full virtualization: Complete or almost complete simulation of actual hardware to allow software, which may comprise a guest operating system, to run unmodified. A VM may be (e.g., appear to be, etc.) identical (e.g., equivalent to, etc.) to the underlying hardware in full virtualization.
Partial virtualization: Some but not all of the target environment may be simulated. Some guest programs, therefore, may need modifications to run in this type of virtual environment.
Paravirtualization: A hardware environment is not necessarily simulated; however, the guest programs may be executed in their own isolated domains, as if they are running on a separate system. Guest programs may need to be specifically modified to run in this type of environment. A VM may differ (e.g., in appearance, in functionality, in behavior, etc.) from the underlying (e.g., native, real, etc.) hardware in paravirtualization.

There may be other differences between these different types of hardware virtualization environments. Full virtualization may not require modifications (e.g., changes, alterations, etc.) to the host OS and may abstract (e.g., virtualize, hide, obscure, etc.) underlying hardware. Paravirtualization may also require modifications to the host OS in order to run in a VM. In full virtualization, for example, privileged instructions and/or other system operations, etc. may be handled by the hypervisor with other instructions running on native hardware. In paravirtualization, for example, code may be modified e.g., at compile-time, runtime, etc. For example, in paravirtualization privileged instructions may be removed, modified, etc. and, for example, replaced with calls to a hypervisor e.g., using APIs, hypercalls, etc. For example, Xen may be an example of an OS that may use paravirtualization, but may preserve binary compatibility for user-space applications, etc.

Virtualization may be applied to an entire OS and/or parts of an OS. For example, a kernel may be a main (e.g., basic, essential, key, etc.) software component of an OS. A kernel may form a bridge (e.g., link, coupling, layer, conduit, etc.) between applications (e.g., software, programs, etc.) and underlying hardware, firmware, software, etc. A kernel may, for example, manage, control, etc. one or more (including all) system resources e.g., CPUs, processors, I/O devices, interrupt controllers, timers, etc. A kernel may, for example, provide a low-level abstraction layer for the system resources that applications may control, manage, etc. A kernel running, for example, at the highest hardware privilege level may make system resources available to user-space applications through inter-process communication (IPC) mechanisms, system calls, etc. A microkernel, for example, may be a smaller (e.g., smaller than a kernel, etc.) OS software component. In a microkernel the majority of the kernel code may be implemented, for example, in a set of kernel servers (also just servers) that may communicate through a small kernel, using a small amount of code running in system (e.g., kernel) space and the majority of code in user space. A microkernel may, for example, comprise a simple (e.g., relative to a kernel, etc.) abstraction over (e.g., logically above, etc.) underlying hardware, with a set of primitives, system calls, other code, etc. that may implement basic (e.g., minimal, key, etc.) OS services (e.g., memory management, multitasking, IPC, etc.). Other OS services, (e.g., networking, storage drivers, high-level functions, etc.) may be implemented, for example, in one or more kernel servers. An exokernel may, for example, be similar to a microkernel but may provide a more hardware-like interface e.g., more direct interface, etc. For example, an exokernel may be similar to a paravirtualizing VMM (e.g., Xen, etc.), but an exokernel may be designed as a distinct and separate OS structure rather than to run multiple conventional OSs. A nanokernel may, for example, delegate (e.g., assign, etc.) virtually all services (e.g., including interrupt controllers, timers, etc.), for example, to device drivers. The term operating system-level virtualization (also OS virtualization, container, virtual private server (VPS), virtual environment (VE), jail, etc.) may refer to a server virtualization technique. In OS virtualization, for example, the kernel of an OS may allow (e.g., permit, enable, implement, etc.) one or more isolated user-space instances or containers. For example, a container may appear to be a real server from the view of a user. For example, a container may be based on standard Linux chroot techniques. In addition to isolation, a kernel may control (e.g., limit, stop, regulate, manage, prevent, etc.) interaction between containers.

Virtualization may be applied to one or more hardware components. For example, VMs may include one or more virtual components. The hardware components and/or virtual components may be inside (e.g., included within, part of, etc.) or outside (e.g., connected to, external to, etc.) a CPU, and may be part of or include parts of a memory system and/or subsystem, or may be any part or parts of a system, device, or may be any combinations of such parts and the like, etc. A memory page (also virtual page, or just page) may, for example, be a contiguous block of virtual memory of fixed-length that may be the smallest unit used for (e.g., granularity of, etc.) memory allocation performed by the OS e.g., for a program, etc. A page table may be a data structure, hardware component, etc. used, for example, by a virtual memory system in an OS to store the mapping from virtual addresses to physical addresses. A memory management unit (MMU) may, for example, store a cache of memory mappings from the OS page table in a translation lookaside buffer (TLB). A shadow page table may be a component that is used, for example, by a technique to abstract memory layout from a VM OS. For example, one or more shadow page tables may be used in a VMM to provide an abstraction of (e.g., an appearance of, a view of, etc.) contiguous physical memory. A CPU may include one or more CPU components, circuit, blocks, etc. that may include one or more of the following, but not limited to the following: caches, TLBs, MMUs, page tables, etc. at one or more levels (e.g., L1, L2, L3, etc.). A CPU may include one or more shadow copies of one or more CPU components, etc. One or more shadow page tables may be used, for example, during live migration. One or more virtual devices may include one or more physical system hardware components (e.g., CPU, memory, I/O devices, etc.) that may be virtualized (e.g., abstracted, etc.) by, for example, a hypervisor and presented to one or more domains. In this description the term virtual device, for example, may also apply to virtualization of a device (and/or part(s), portion(s) of a device, etc.) such as a mobile phone or other mobile device, electronic system, appliance, etc. A virtual device may, for example, also apply to (e.g., correspond to, represent, be equivalent to, etc.) virtualization of a collection, set, group, etc. of devices and/or other hardware components, etc.

Virtualization may be applied to I/O hardware, one or more I/O devices (e.g., storage devices, cameras, graphics cards, input devices, printers, network interface cards, etc.), I/O device resources, etc. For example, an IOMMU may be a MMU that connects one or more I/O devices on one or more I/O buses to the memory system. The IOMMU may, for example, map (e.g., translate, etc.) I/O device virtual addresses (e.g., device addresses, I/O addresses, etc.) to physical addresses. The IOMMU may also include memory protection (e.g., preventing and/or controlling unauthorized access to I/O devices, I/O device resources, etc.), one or more memory protection tables, etc. The IOMMU may, for example, also allow (e.g., control, manage, etc.) direct memory access (DMA) and allow (e.g., enable, etc.) one or more VMs, etc. to access DMA hardware.

Virtualization may be applied to software (e.g., applications, programs, etc.). For example, the term application virtualization may refer to techniques that may provide one or more application features. For example, application virtualization may isolate (e.g., protect, separate, divide, insulate, etc.) applications from the underlying OS and/or from other applications. Application virtualization may, for example, enable (e.g., allow, permit, etc.) applications to be copied (e.g., streamed, transferred, pulled, pushed, sent, distributed, etc.) from a source (e.g., centralized location, control center, datacenter server, cloud server, home PC, manufacturer, distributor, licensor, etc.) to one or more target devices (e.g., user devices, mobile devices, clients, etc.). For example, application virtualization may allow (e.g., permit, enable, etc.) the creation of an isolated (e.g., a protected, a safe, an insulated, etc.) environment on a target device. A virtualized application may not necessarily be installed in a conventional (e.g., usual, normal, etc.) manner. For example, a virtualized application (e.g., files, configuration, settings, etc.) may be copied (e.g., streamed, distributed, etc.) to a target (e.g., destination, etc.) device rather than being installed, etc. The execution of a virtualized application at runtime may, for example, be controlled by an application virtualization layer. A virtualized application may, for example, appear to interface directly with the OS, but may actually interface with the virtualization environment. For example, the virtualization environment may proxy (e.g., intercept, forward, manage, control, etc.) one or more (including all) OS requests. The term application streaming may refer, for example, to virtualized application techniques that may use pieces (e.g., parts, portions, etc.) of one or more applications (e.g., code, data, settings, etc.) that may be copied (e.g., streamed, transferred, downloaded, uploaded, moved, pushed, pulled, etc.) to a target device. A software collection (e.g., set, distribution, distro, bundle, package, etc.) may, for example, be a set of software components built, assembled, configured, and ready for use, execution, installation, etc. Applications may be streamed, for example, as one or more collections. Application streaming may, for example, be performed on demand (e.g., as required, etc.) instead of copying or installing an entire application before startup. In some cases a streamed application may, for example, require the installation of a lightweight application on a target device. A streamed application and/or application collections may, for example, be delivered using one or more networking protocols (e.g., HTTP, HTTPS, CIFS, SMB, RTSP, etc.). The term desktop virtualization (also virtual desktop infrastructure (VDI), etc.) may refer, for example, to an application that may be hosted in a VM (or blade PC, appliance, etc.) and that may also include an OS. VDI techniques may, for example, include control of (e.g., management infrastructure for, automated creation of, etc.) one or more virtual desktops. The term session virtualization may refer, for example, to techniques that may use application streaming to deliver applications to one or more hosting servers (e.g., in a remote datacenter, cloud server, cloud service, etc.). The application may then, for example, execute on the hosting server(s). A user may then, for example, connect to (e.g., login, access, etc.) the application, hosting server(s), etc. The user and/or user device may, for example, send input (e.g., mouse-click, keystroke, mouse or other pointer location, audio, video, location, sensor data, control data, combinations of these and/or other data, information, user input, etc.) to the application e.g., on the hosting server(s), etc. The hosting server(s) may, for example, respond by sending output (e.g., screen updates, text, video, audio, signals, code, data, information, etc.) to the user device. A sandbox may, for example, isolate (e.g., insulate, separate, divide, etc.) one or more applications, programs, software, etc. For example, an OS may place an application (e.g., code, preferences, configuration, data, etc.) in a sandbox (e.g., at install time, at boot, or any time). A sandbox may, for example, include controls that may limit the application access (e.g., to files, preferences, network, hardware, firmware, other applications, etc.). As part of the sandbox process, technique, etc. an OS may, for example, install one or more applications in one or more separate sandbox directories (e.g., repositories, storage locations, etc.) that may store the application, application data, configuration data, settings, preferences, files, and/or other information, etc.

Devices may, for example, be protected from accidental faults (e.g., programming errors, bugs, data corruption, hardware faults, network faults, link faults, etc.) or malicious (e.g., deliberate, etc.) attacks (e.g., virus, malware, denial of service attacks, root kits, etc.) by various security, safety, protection mechanisms, etc. For example, CPUs, etc. may include one or more protection rings (or just rings, also hierarchical protection domains, domains, privilege levels, etc.). A protection ring may, for example, include one or more hierarchical levels (e.g., logical layers, etc.) of privilege (e.g., access rights, permissions, gating, etc.). For example, an OS may run (e.g., execute, operate, etc.) in a protection ring. Different protection rings may provide different levels of access (e.g., for programs, applications, etc.) to resources (e.g., hardware, memory, etc.). Rings may be arranged in a hierarchy ranging from the most privileged ring (e.g., most trusted ring, highest ring, inner ring, etc.) to the least privileged ring (e.g., least trusted ring, lowest ring, outer ring, etc.). For example, ring 0 may be a ring that may interact most directly with the real hardware (e.g., CPU, memory, I/O devices, etc.). For example, in a machine without virtualization, ring 0 may contain the OS, kernel, etc.; ring 1 and ring 2 may contain device drivers, etc.; ring 3 may contain user applications, programs, etc. For example, ring 1 may correspond to kernel space (e.g., kernel mode, master mode, supervisor mode, privileged mode, supervisor state, etc.). For example, ring 3 may correspond to user space (e.g., user mode, user state, slave mode, problem state, etc.). There is no fundamental restriction to the use of rings and, in general, any ring may correspond to any type of space, etc.

One or more gates (e.g., hardware gates, controls, call instructions, other hardware and/or software techniques, etc.) may be logically located (e.g., placed, situated, etc.) between rings to control (e.g., gate, secure, manage, etc.) communication, access, resources, transition, etc. between rings e.g., gate the access of an outer ring to resources of an inner ring, etc. For example, there may be gates or call instructions that may transfer control (e.g., may transition, exchange, etc.) to defined entry points in lower-level rings. For example, gating communication or transitions between rings may prevent programs in a first ring from misusing resources of programs in a second ring. For example, software running in ring 3 may be gated from controlling hardware that may only be controlled by device drivers running in ring 1. For example, software running in ring 3 may be required to request access to network resources that may be gated to software running in ring 1.

One or more coupled devices may form a collection, federation, confederation, assembly, set, group, cluster, etc. of devices. A collection of devices may perform operations, processing, computation, functions, etc. in a distributed fashion, manner, etc. In a collection etc. of devices that may perform distributed processing, it may be important to control the order of execution, how updates are made to files and/or databases, and/or other aspects of collective computation, etc. One or more models, frameworks, etc. may describe, define, etc. the use of operations, etc. and may use a set of definitions, rules, syntax, semantics, etc. using the concepts of transactions, tasks, composable tasks, noncomposable tasks, etc.

For example, a bank account transfer operation (e.g., a type of transaction, etc.) might be decomposed (e.g., broken, separated, etc.) into the following steps: withdraw funds from a first account one and deposit funds into a second account.

The transfer operation may be atomic. For example, if either step one fails or step two fails (or a computer crashes between step one and step two, etc.) the entire transfer operation should fail. There should be no possibility (e.g., state, etc.) that the funds are withdrawn from the first account but not deposited into the second account.

The transfer operation may be consistent. For example, after the transfer operation succeeds, any other subsequent transaction should see the results of the transfer operation.

The transfer operation may be isolated. For example, if another transaction tries to simultaneously perform an operation on either the first or second accounts, what they do to those accounts should not affect the outcome of the transfer option.

The transfer operation may be durable. For example, after the transfer operation succeeds, if a computer should fail, etc., there may be a record that the transfer took place.

The terms tasks, transactions, composable, noncomposable, etc. may have different meanings in different contexts (e.g., with different uses, in different applications, etc.). One set of frameworks (e.g., systems, applications, etc.) that may be used, for example, for transaction processing, database processing, etc. may be languages (e.g., computer languages, programming languages, etc.) such as structured transaction definition language (STDL), structured query language (SQL), etc.

For example, a transaction may be a set of operations, actions, etc. to files, databases, etc. that must take place as a set, group, etc. For example, operations may include read, write, add, delete, etc. All the operations in the set must complete or all operations may be reversed. Reversing the effects of a set of operations may roll back the transaction. If the transaction completes, the transaction may be committed. After a transaction is committed, the results of the set of operations may be available to other transactions.

For example, a task may be a procedure that may control execution flow, delimit or demarcate transactions, handle exceptions, and may call procedures to perform, for example, processing functions, computation, access files, access databases (e.g., processing procedures) or obtain input, provide output (e.g., presentation procedures).

For example, a composable task may execute within a transaction. For example, a noncomposable task may demarcate (e.g., delimit, set the boundaries for, etc.) the beginning and end of a transaction. A composable task may execute within a transaction started by a noncomposable task. Therefore, the composable task may always be part of another task's work. Calling a composable task may be similar to calling a processing procedure, e.g., based on a call and return model. Execution of the calling task may continue only when the called task completes. Control may pass to the called task (possibly with parameters, etc.) and then control may return to the calling task. The composable task may always be part of another task's transaction. A noncomposable task may call a composable task and both tasks may be located on different devices. In this case, their transaction may be a distributed transaction. There may be no logical distinction between a distributed and nondistributed transaction.

Transactions may compose. For example, the process of composition may take separate transactions and add them together to create a larger single transaction. A composable system, for example, may be a system whose component parts do not interfere with each other.

For example, a distributed car reservation system may access remote databases by calling composable tasks in remote task servers. For example, a reservation task at a rental site may call a task at the central site to store customer data in the central site rental database. The reservation task may call another task at the central site to store reservation data in the central site rental database and the history database.

The use of composable tasks may enable a library of common functions to be implemented as tasks. For example, applications may require similar processing steps, operations, etc. to be performed at multiple stages, points, etc. For example, applications may require one or more tasks to perform the same processing function. Using a library, for example, common functions may be called from multiple points within a task or from different tasks.

A uniform resource locator (URL) is a uniform resource identifier (URI) that specifies where a known resource is available and the mechanism for retrieving it. A URL comprises the following: the scheme name (also called protocol, e.g., http, https, etc.), a colon (“:”), a domain name (or IP address), a port number, and the path of the resource to be fetched. The syntax of a URL is scheme://domain:port/path.

HTTP is the hypertext transfer protocol.

HTTPS is the hypertext transfer protocol secure (HTTPS) and is a combination of the HTTP with the SSL/TLS protocol to provide encrypted communication and secure identification.

A session is a sequence of network request-response transactions.

An IP address is a binary number assigned to a device on an IP network (e.g., 172.16.254.1) and can be formatted as a 32-bit dot-decimal notation (e.g., for IPv4) or in a notation to represent 128-bits, such as “2001:db8:0:1234:0:567:8:1” (e.g., for IPv6).

A domain name comprises one or more concatenated labels delimited by dots (periods), e.g., “en.wikipedia.org”. The domain name “en.wikipedia.org” includes labels “en” (the leaf domain), “wikipedia” (the second-level domain), and “org” (the top-level domain).

A hostname is a domain name that has at least one IP address. A hostname is used to identify a device (e.g., in an IP network, on the World Wide Web, in an e-mail header, etc.). Note that all hostnames are domain names, but not all domain names are hostnames. For example, both en.wikipedia.org and wikipedia.org are hostnames if they both have IP addresses assigned to them. The domain name xyz.wikipedia.org is not a hostname if it does not have an IP address, but aa.xyz.wikipedia.org is a hostname if it does have an IP address.

A domain name comprises one or more parts, the labels that are concatenated, being delimited by dots such as “example.com”. Such a concatenated domain name represents a hierarchy. The right-most label conveys the top-level domain; for example, the domain name www.example.com belongs to the top-level domain corn. The hierarchy of domains descends from the right to the left label in the name; each label to the left specifies a subdivision, or subdomain of the domain to the right. For example, the label example specifies a node example.com as a subdomain of the corn domain, and www is a label to create www.example.com, a subdomain of example.com.

The DHCP is the dynamic host configuration protocol (described in RFC 1531 and RFC 2131) and is an automatic configuration protocol for IP networks. When a DHCP-configured device (DHCP client) connects to a network, the DHCP client sends a broadcast query requesting an IP address from a DHCP server that maintains a pool of IP addresses. The DHCP server assigns the DHCP client an IP address and lease (the length of time the IP address is valid).

A media access control address (MAC address, also Ethernet hardware address (EHA), hardware address, physical address) is a unique identifier (e.g., 00-B0-D0-86-BB-F7) assigned to a network interface (e.g., address of a network interface card (NIC), etc.) for communications on a physical network (e.g., Ethernet).

A trusted path (and thus trusted user, and/or trusted device, etc.) is a mechanism that provides confidence that a user is communicating with what the user intended to communicate with, ensuring that attackers cannot intercept or modify the information being communicated.

A proxy server (also proxy) is a server that acts as an intermediary (e.g., gateway, go-between, helper, relay, etc.) for requests from clients seeking resources from other servers. A client connects to the proxy server, requesting a service (e.g., file, connection, web page, or other resource, etc.) available from a different server, the origin server. The proxy server provides the resource by connecting to the origin server and requesting the service on behalf of the client. A proxy server may alter the client request or the server response.

A forward proxy located in an internal network receives requests from users inside an internal network and forwards the requests to the Internet outside the internal network. A forward proxy typically acts a gateway for a client browser (e.g., user, client, etc.) on an internal network and sends HTTP requests on behalf of the client browser to the Internet. The forward proxy protects the internal network by hiding the client IP address by using the forward proxy IP address. The external HTTP server on the Internet sees requests originating from the forward proxy rather than the client.

A reverse proxy (also origin-side proxy, server-side proxy) located in an internal network receives requests from Internet users outside the internal network and forwards the requests to origin servers in the internal network. Users connect to the reverse proxy and may not be aware of the internal network. A reverse proxy on an internal network typically acts as a gateway to an HTTP server on the internal network by acting as the final IP address for requests from clients that are outside the internal network. A firewall is typically used with the reverse proxy to ensure that only the reverse proxy can access the HTTP servers behind the reverse proxy. The external client sees the reverse proxy as the HTTP server.

An open proxy forwards requests to and from anywhere on the Internet.

In network computing, the term demilitarized zone (DMZ, also perimeter network), is used to describe a network (e.g., physical network, logical subnetwork, etc.) exposed to a larger untrusted network (e.g., Internet, cloud, etc.). A DMZ may, for example, expose external services (e.g., of an organization, company, device, etc.). One function of a DMZ is to add an additional layer of security to a local area network (LAN). In the event of an external attack, the attacker only has access to resources (e.g., equipment, server(s), router(s), etc.) in the DMZ.

In the HTTP protocol a redirect is a response (containing header, status code, message body, etc.) to a request (e.g., GET, etc.) that directs a client (e.g., browser, etc.) to go to another location (e.g., site, URL, etc.)

A localhost (as described, for example, in RFC 2606) is the hostname given to the address of the loopback interface (also virtual loopback interface, loopback network interface, loopback device, network loopback), referring to “this computer”. For example, directing a browser on a computer running an HTTP server to a loopback address (e.g., http://localhost, http://127.0.0.1, etc.) may display the website of the computer (assuming a web server is running on the computer and is properly configured). Using a loopback address allows connection to any locally hosted network service (e.g., computer game server, or other inter-process communications, etc.).

The localhost hostname corresponds to an IPv4 address in the 127.0.0.0/8 net block i.e., 127.0.0.1 (for IPv4, see RFC 3330) or ::1 (for IPv6, see RFC 3513). The most common IP address for the loopback interface is 127.0.0.1 for IPv4, but any address in the range 127.0.0.0 to 127.255.255.255 maps to the loopback device. The routing table of an operating system (OS) may contain an entry so that traffic (e.g., packet, network traffic, IP datagram, etc.) with destination IP address set to a loopback address (the loopback destination address) is routed internally to the loopback interface. In the TCP/IP stack of an OS the loopback interface is typically contained in software (and not connected to any network hardware).

An Internet socket (also network socket or just socket) is an endpoint of a bidirectional inter-process communication (IPC) flow across a network (e.g., IP-based computer network such as the Internet, etc.). The term socket is also used for the API for the TCP/IP protocol stack. Sockets provide the mechanism to deliver incoming data packets to a process (e.g., application, program, application process, thread, etc.), based on a combination of local (also source) IP address, local port number, remote (also destination) IP address, and remote port number. Each socket is mapped by the OS to a process. A socket address is the combination of an IP address and a port number.

Communication between server and client (which are types of endpoints) may use a socket. Communicating local and remote sockets are socket pairs. A socket pair is described by a unique 4-tuple (e.g., four numbers, four sets of numbers, etc.) of source IP address, destination IP address, source port number, destination port number, (e.g., local and remote socket addresses). For TCP, each socket pair is assigned a unique socket number. For UDP, each local socket address is assigned a unique socket number.

A computer program may be described using one or more function calls (e.g., macros, subroutines, routines, processes, etc.) written as function_name ( ), where function_name is the name of the function. The process (e.g., a computer program, etc.) by which a local server establishes a TCP socket may include (but is not limited to) the following steps and functions:
1. socket ( ) creates a new local socket.
2. bind ( ) associates (e.g., binds, links, ties, etc.) the local socket with a local socket address i.e., a local port number and IP address (the socket and port are thus bound to a software application running on the server).
3. listen ( ) causes a bound local socket to enter the listen state. A remote client then establishes connections with the following steps:
1. socket ( ) creates a new remote socket.
2. connect ( ) assigns a free local port number to the remote socket and attempts to establishes a new connection with the local server.

The local server then establishes the new connection with the following step:
1. accept ( ) accepts the request to create a new connection from the remote client.

Client and server may now communicate using send ( ) and receive ( ).

An abstraction of the architecture of the World Wide Web is representational state transfer (REST). The REST architectural style was developed by the W3C Technical Architecture Group (TAG) in parallel with HTTP 1.1, based on the existing design of HTTP 1.0 The World Wide Web represents the largest implementation of a system conforming to the REST architectural style. A REST architectural style may consist of a set of constraints applied to components, connectors, and data elements, e.g., within a distributed hypermedia system. REST ignores the details of component implementation and protocol syntax in order to focus on the roles of components, the constraints upon their interaction with other components, and their interpretation of significant data elements. REST may be used to describe desired web architecture, to identify existing problems, to compare alternative solutions, and to ensure that protocol extensions do not violate the core constraints of the web. The REST architectural style may also be applied to the development of web services as an alternative to other distributed-computing specifications such as SOAP.

The REST architectural style describes six constraints: (1) Uniform Interface. The uniform interface constraint defines the interface between clients and servers. It simplifies and decouples the architecture, which enables each part to evolve independently. The uniform interface that any REST services must provide is fundamental to its design. The four principles of the uniform interface are: (1.1) Resource-Based. Individual resources are identified in requests using URIs as resource identifiers. The resources themselves are conceptually separate from the representations that are returned to the client. For example, the server does not send its database, but rather, some HTML, XML or JSON that represents some database records expressed, for instance, in Finnish and encoded in UTF-8, depending on the details of the request and the server implementation.

### Manipulation of Resources Through Representations.

When a client holds a representation of a resource, including any metadata attached, it has enough information to modify or delete the resource on the server, provided it has permission to do so. (1.3) Self-descriptive Messages. Each message includes enough information to describe how to process the message. For example, which parser to invoke may be specified by an Internet media type (previously known as a MIME type). Responses also explicitly indicate their cache-ability. (1.4) Hypermedia as the Engine of Application State (HATEOAS). Clients deliver state via body contents, query-string parameters, request headers and the requested URI (the resource name). Services deliver state to clients via body content, response codes, and response headers. This is technically referred to as hypermedia (or hyperlinks within hypertext). HATEOAS also means that, where necessary, links are contained in the returned body (or headers) to supply the URI for retrieval of the object itself or related objects. (2) Stateless. The necessary state to handle the request is contained within the request itself, whether as part of the URI, query-string parameters, body, or headers. The URI uniquely identifies the resource and the body contains the state (or state change) of that resource. Then, after the server completes processing, the appropriate state, or the piece(s) of state that matter, are communicated back to the client via headers, status and response body. A container provides the concept of “session” that maintains state across multiple HTTP requests. In REST, the client must include all information for the server to fulfill the request, resending state as necessary if that state must span multiple requests. Statelessness enables greater scalability since the server does not have to maintain, update, or communicate that session state. Additionally, load balancers do not have to deal with session affinity for stateless systems. State, or application state, is that which the server cares about to fulfill a request-data necessary for the current session or request. A resource, or resource state, is the data that defines the resource representation-the data stored in the database, for instance. Application state may be data that could vary by client, and per request. Resource state, on the other hand, is constant across every client who requests it. (3) Cacheable. Clients may cache responses. Responses must therefore, implicitly or explicitly, define themselves as cacheable, or not, to prevent clients reusing stale or inappropriate data in response to further requests. Well-managed caching partially or completely eliminates some client-server interactions, further improving scalability and performance. (4) Client-Server. The uniform interface separates clients from servers. This separation of concerns means that, for example, clients are not concerned with data storage, which remains internal to each server, so that the portability of client code is improved. Servers are not concerned with the user interface or user state, so that servers can be simpler and more scalable. Servers and clients may also be replaced and developed independently, as long as the interface is not altered. (5) Layered System. A client cannot ordinarily tell whether it is connected directly to the end server, or to an intermediary along the way. Intermediary servers may improve system scalability by enabling load-balancing and by providing shared caches. Layers may also enforce security policies. (6) Code on Demand (optional). Servers are able to temporarily extend or customize the functionality of a client by transferring logic to the client that it can then execute. Examples of this may include compiled components such as Java applets and client-side scripts such as JavaScript. Complying with these constraints, and thus conforming to the REST architectural style, will enable any kind of distributed hypermedia system to have desirable emergent properties such as performance, scalability, simplicity, modifiability, visibility, portability and reliability. The only optional constraint of REST architecture is code on demand. If a service violates any other constraint, it cannot strictly be referred to as RESTful.

In computer programming, an application programming interface (API) specifies how software components should interact with each other. In addition to accessing databases or computer hardware such as hard disk drives or video cards, an API may be used to simplify the programming of graphical user interface components. An API may be provided in the form of a library that includes specifications for routines, data structures, object classes, and variables. In other cases, notably for SOAP and REST services, an API may be provided as a specification of remote calls exposed to the API consumers. An API specification may take many forms, including an international standard such as POSIX, vendor documentation such as the Microsoft Windows API, or the libraries of a programming language, e.g., Standard Template Library in C++ or Java API. Web APIs may also be a component of the web fabric. An API may differ from an application binary interface (ABI) in that an API may be source code based while an ABI may be a binary interface. For instance POSIX may be an API, while the Linux standard base may be an ABI.

### Overview

Some embodiments of the present disclosure address the problem of massive deployments of remote devices and some embodiments are directed to approaches for systems and protocols for auto-configuration of remote devices upon deployment. More particularly, disclosed herein and in the accompanying figures are exemplary environments, methods, and systems for auto-configuration of remote devices upon deployment.

What is needed is a technological solution to problems attendant to remote device deployment. More specifically, what is needed is a technological solution that eliminates the need for on-premises IT skills and/or eliminates the need for dedicated on-premises hardware. In the embodiments described herein, the disclosed techniques connect a user-specified host computer to any device in the field that has an IP address and a route to the Internet. As discussed, such embodiments do not rely on dedicated VPN equipment and do not rely on firewall equipment. By merely installing a device-side agent onto any device with a TCP/IP stack (e.g., Android, Linux, iOS, OS X, Windows, CE, ecos, etc.), the device can be deployed without additional pre-configuration.

### Conventions and Use of Terms

Some of the terms used in this disclosure are defined below for easy reference. The presented terms and their respective definitions are not rigidly restricted to these definitions-a term may be further defined by the term's use within this disclosure. The term “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the appended claims, the term “or” is intended to mean an inclusive “or” rather than an exclusive “or”. That is, unless specified otherwise, or is clear from the context, “X employs A or B” is intended to mean any of the natural inclusive permutations. That is, if X employs A, X employs B, or X employs both A and B, then “X employs A or B” is satisfied under any of the foregoing instances. The articles “a” and “an” as used in this application and the appended claims should generally be construed to mean “one or more” unless specified otherwise or is clear from the context to be directed to a singular form.

If any definitions (e.g., figure reference signs, specialized terms, examples, data, information, definitions, conventions, glossary, etc.) from any related material (e.g., parent application, other related application, material incorporated by reference, material cited, extrinsic reference, etc.) conflict with this application (e.g., abstract, description, summary, claims, etc.) for any purpose (e.g., prosecution, claim support, claim interpretation, claim construction, etc.), then the definitions in this application shall apply.

This section may include terms and definitions that may be applicable to all embodiments described in this specification and/or described in specifications incorporated by reference. Terms that may be special to the field of the various embodiments of the disclosure or specific to this description may, in some circumstances, be defined in this description. Further, the first use of such terms (which may include the definition of that term) may be highlighted in italics just for the convenience of the reader. Similarly, some terms may be capitalized, again just for the convenience of the reader. It should be noted that such use of italics and/or capitalization and/or use of other conventions, styles, formats, etc. by itself, should not be construed as somehow limiting such terms beyond any given definition and/or to any specific embodiments disclosed herein, etc.

### Use of Equivalents

The terminology used herein is for the purpose of describing particular embodiments only and is not intended to be limiting of the invention. As used herein, the singular forms (e.g., a, an, the, etc.) are intended to include the plural forms as well, unless the context clearly indicates otherwise.

The terms comprises and/or comprising, when used in this specification, specify the presence of stated features, integers, steps, operations, elements, and/or components, but do not preclude the presence or addition of one or more other features, integers, steps, operations, elements, components, and/or groups thereof.

In the following description and claims, the terms include and comprise, along with their derivatives, may be used, and are intended to be treated as synonyms for each other.

In the following description and claims, the terms coupled and connected, along with their derivatives, may be used. It should be understood that these terms are not necessarily intended as synonyms for each other. For example, connected may be used to indicate that two or more elements (e.g., circuits, components, logical blocks, hardware, software, firmware, processes, computer programs, etc.) are in direct physical, logical, and/or electrical contact with each other. Further, coupled may be used to indicate that that two or more elements are in direct or indirect physical, electrical and/or logical contact. For example, coupled may be used to indicate that that two or more elements are not in direct contact with each other, but the two or more elements still cooperate or interact with each other.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The terms that are explained, described, defined, etc. here and other related terms in the fields of systems design may have different meanings depending, for example, on their use, context, etc. For example, task may carry a generic or general meaning encompassing, for example, the notion of work to be done, etc. or may have a very specific meaning particular to a computer language construct (e.g., in STDL or similar). For example, the term transaction may be used in a very general sense or as a very specific term in a computer program or computer language, etc. Where confusion may arise over these and other related terms, further clarification may be given at their point of use herein.

Reference is now made in detail to certain embodiments. The disclosed embodiments are not intended to be limiting of the claims.

### Descriptions of Exemplary Embodiments

FIG. Y5-1A depicts an Internet-connected system Y5-1A00 that, for example, carries out a protocol for auto-configuration of remote devices upon deployment, in one embodiment. As an option, one or more instances of system Y5-1A00 may, for example, perform several other connection operations to, from, or between one or more devices.

As a further option, one or more instances of Internet-connected system Y5-1A00 or any aspect thereof may be implemented in the context of the architecture and functionality of various embodiments described herein. Also, the Internet-connected system Y5-1A00 or any aspect thereof may be implemented in any desired environment. It should also be noted that the aforementioned definitions may apply within the context of the present description.

The Internet-connected system Y5-1A00 comprises the aspects shown. This exemplary embodiment as well as other embodiments may implement additional features.

FIG. Y5-1B depicts a sample set of configuration protocol communications Y5-1B00 to carry communications between Internet-connected system components for auto-configuration of remote devices upon deployment, for example, in one embodiment. As an option, one or more instances of configuration protocol communications Y5-1B00 or any aspect thereof may be implemented in the context of the architecture and functionality of various embodiments described herein. Also, the configuration protocol communications Y5-1B00 or any aspect thereof may be implemented in any desired environment. It should also be noted that the aforementioned definitions may apply within the context of the present description.

The configuration protocol communications Y5-1B00 comprises the aspects shown. This exemplary embodiment as well as other embodiments may implement additional features.

FIG. Y5-1C depicts a sample set of terms used in describing configuration protocol communications Y5-1C00 to carry communications between Internet-connected system components for auto-configuration of remote devices upon deployment, for example, in one embodiment. As an option, one or more instances of configuration protocol communications Y5-1C00 or any aspect thereof may be implemented in the context of the architecture and functionality of various embodiments described herein. Also, the configuration protocol communications Y5-1C00 or any aspect thereof may be implemented in any desired environment. It should also be noted that the aforementioned definitions may apply within the context of the present description.

The configuration protocol communications Y5-1C00 comprises the aspects shown. This exemplary embodiment as well as other embodiments may implement additional features.

FIG. Y5-2A through FIG. YB-2N depict a sample set of configuration protocol communications to carry communications between Internet-connected system components for auto-configuration of remote devices upon deployment, for example, in one embodiment.

As an option, one or more instances of configuration protocol communications (e.g., sample set Y5-2A00, sample set Y5-2B00, sample set Y5-2C00, sample set Y5-2D00, sample set Y5-2E00, sample set Y5-2F00, sample set Y5-2G00, sample set Y5-2H00, sample set Y5-2100, sample set Y5-2J00, sample set Y5-2K00, sample set Y5-2L00, sample set Y5-2M00, or sample set Y5-2N00) or any combination or aspect thereof may be implemented in the context of the architecture and functionality of various embodiments described herein. Also, the configuration protocol communications or any aspect thereof may be implemented in any desired environment. It should also be noted that the aforementioned definitions may apply within the context of the present description.

The configuration protocol communications may comprise the aspects shown. This exemplary embodiment as well as other embodiments may implement additional features.

FIG. Y5-3A through FIG. Y5-3G depict a packet trace for a proxy connection as used in auto-configuration of remote devices upon deployment, for example, in one embodiment.

As an option, one or more instances of a packet trace (e.g., packet trace Y5-3A00, Y5-3B00, Y5-3C00, Y5-3D00, Y5-3E00, Y5-3F00, or Y5-3G00) or any aspect thereof may be implemented in the context of the architecture and functionality of various embodiments described herein. Also, the packet trace or any aspect thereof may be implemented in any desired environment. It should also be noted that the aforementioned definitions may apply within the context of the present description.

The packet trace comprises the aspects shown. This exemplary embodiment as well as other embodiments may implement additional features.

FIG. Y5-4 is a CHAT protocol packet structure Y5-400, according to an embodiment. This exemplary embodiment may implement additional features.

FIG. Y5-5 is the packet structure Y5-500 of a TLV (type-length-value) element used for (device to) server communications, according to an embodiment. This exemplary embodiment may implement additional features.

FIG. Y5-6 is an example server communications packet format Y5-600 with a sequence of two TLV elements, according to an embodiment. This exemplary embodiment may implement additional features.

FIG. Y5-7 is an example server communications packet format Y5-700 encapsulated in UDP and showing a server communications packet type that includes two data types and thus a sequence of two TLV elements, according to an embodiment.

FIG. Y5-8 depicts an example server communications protocol Y5-800 using a packet format encapsulated in UDP and showing a server communications packet type that includes two data types and thus a sequence of two TLV elements, according to an embodiment. As shown, the communication includes aerver communications packet type having a sequence of two TLV elements, specifically the shown first TLV element and the second TLV element.

FIG. Y5-9 is an example remot3.it server communications packet format Y5-900, according to an embodiment, showing extra CHAT protocol header fields used for encryption.

FIG. Y5-10 is an example remot3.it P2P communications packet diagram Y5-1000, according to embodiments as discussed infra.

FIG. Y5-11 is a packet format Y5-1100 of an ssh2 packet type 20 SSH_MSG_KEXINIT, according to embodiments as discussed infra.

FIG. Y5-12 is a chart Y5-1200 for comparing SSH key exchange techniques, according to embodiments as discussed infra.

FIG. Y5-13 depicts a user interface Y5-1300 for a proxy connection as used in for managing remote devices, in one embodiment. As an option, one or more instances of user interface Y5-1300 or any aspect thereof may be implemented in the context of the architecture and functionality of various embodiments described herein. Also, the user interface Y5-1300 or any aspect thereof may be implemented in any desired environment. It should also be noted that the aforementioned definitions may apply within the context of the present description.

The user interface Y5-1300 comprises the aspects shown. This exemplary embodiment as well as other embodiments may implement additional features.

The remot3.it system allows any device to communicate with any other device on the Internet, no matter what the network looks like or where the devices may be located. In the following sections, we describe the remot3.it system:

### Additional Embodiments

The remot3.it system allows any device to communicate with any other device on the Internet, no matter what the network looks like or where the devices may be located. One Internet connection technology uses STUN and related NAT traversal technology.

This section describes design decisions behind the remot3.it system architecture. This section focuses on an analysis between the use of STUN and related NAT traversal technology and the comparable functions in the remot3.it system architecture.

In this section we do not cover all of the difference between STUN and remoteit, but will focus on the following seven examples of key differences between remot3.it and STUN technology:
Security: STUN has been demonstrated to be insecure. The remot3.it system is designed to be secure.
Complexity: STUN is just one part of a very complex collection of parts required for NAT traversal. The remot3.it system includes all required parts.
Open-Source: Only a few types of STUN server systems are available, most use open-source. Functions such as STUN are not necessarily best suited for open-source.
Standard vs proprietary: It is very hard to use completely standard technology, such as STUN, to solve a set of completely non-standard problems caused by NAT.
Complete System Architecture: A STUN server is designed in isolation from the rest of the system components. In one embodiment, the remot3.it system is designed as a whole, including, for example, the client software.
Architectural Advantages: A STUN server that is based on IETF standards, and designed to support applications such as SIP and WebRTC for example, may not be the best architecture for other applications. In one embodiment, the remot3.it system is designed to be tailored and optimized for different applications.
Extensions: STUN solves just a small part of the NAT traversal problem. In one embodiment, the remot3.it system is designed to be extensible to solve more than just NAT traversal.

We will discuss each of these example areas briefly to present an idea of the issues and problems that are addressed in the design of the remot3.it architecture. We provide a summary and references that provide further details that may go beyond the explanations provided here in this section.

### Security

As an example of potential security issues, a STUN binding request is not authenticated. STUN servers have been the principal attack surface for several serious malware incidents, including massive bank fraud. As a simple demonstration of STUN server vulnerability, anyone can use the Linux netcat utility to craft a packet that demonstrates part of a STUN attack. For example, consider the following commands (using MacOS X):

TABLE 1
MacBook-Air:~ mike$ dig +short myip.opendns.com @resolver1.opendns.com
50.184.238.5
MacBook-Air:~ mike$ echo -en
‘\x00\x01\x00\x08\xc0\x0c\xee\x42\x7c\x20\x25\xa3\x3f\x0f\xa1\x7f\xfd\x7f\x00\x00
\x00\x03\x00\x04\x00\x00\x00\x00’ | nc -u -w 2 stun.l.google.com 19302 |
dd bs=1 count=4 skip=28 2>/dev/null | hexdump -e ‘1/1 “%u.”’ | sed
‘s/\.$/\n/’
50.184.238.5
\hat{ }CMacBook-Air:~ mike$

The first command (dig) shows an external, public IP address. The second command (using netcat, nc) crafts a packet to send to a Google STUN server at stun.l.google.com. The Google STUN server replies with an unencrypted packet that exposes the external IP address to anyone, and exposing the first part of the connection request, as well as exposing other connection details that have been filtered from the response in the above example. Although a complete attack is much more complicated, this simple example shows the vulnerability of connections using a STUN server. A basic weakness of the STUN server connection mechanism is that the protocol supports unauthenticated connection requests.

In one embodiment, the remot3.it system architecture is designed so that connection cannot be established without authentication. In one embodiment, the remot3.it connections are encrypted.

### Complexity

A STUN server is not enough to provide NAT traversal. A complete system requires, at least, TURN and ICE functions in addition to the simple function provided by a STUN server in to establish connections in situations where STUN alone is not sufficient. An entire system constructed around a STUN server is extremely complex and prone to failure due to its sheer size and complexity. For example, the open-source STUN project coturn provides functions that are specified in the following 22 separate IETF RFCs and drafts, spanning hundreds of pages:

TABLE 2
TURN specs:
RFC 5766-base TURN specs
RFC 6062-TCP relaying TURN extension
RFC 6156-IPv6 extension for TURN
RFC 7443-ALPN support for STUN & TURN
RFC 7635-oAuth third-party TURN/STUN authorization
DTLS IETF Draft
Mobile ICE (MICE) DTLS IETF Draft
TURN REST API IETF Draft
Origin field in TURN IETF Draft
TURN Bandwidth IETF Draft
TURN-bis (with dual allocation) IETF Draft
STUN specs:
RFC 3489-classic STUN
RFC 5389-base “new” STUN specs
RFC 5769-test vectors for STUN protocol testing
RFC 5780-NAT behavior discovery support
RFC 7443-ALPN support for STUN & TURN
RFC 7635-oAuth third-party TURN/STUN authorization
ICE and related specs:
RFC 5245-ICE
RFC 5768-ICE-SIP
RFC 6336-ICE-IANA Registry
RFC 6544-ICE-TCP
RFC 5928-TURN Resolution Mechanism

The functions that coturn (or other similar systems based on STUN) provides are briefly as follows: STUN is a service that allows a client to self-discover a public IP and port mapping; TURN is a relay server and when two nodes cannot establish a P2P link directly, they can fall back to TURN; ICE is a method of performing NAT traversal using STUN and/or TURN servers possibly also using another rendezvous mechanism. Part of the complexity of such systems is because the development of STUN, TURN and ICE were driven by the communication and telephony industry needs including VoIP, SIP, and WebRTC; these are all by themselves very complex systems.

However, a complete system becomes even more complex when you include other essential features. Any working complete system must also support features and functions such as: installation of client, installation of server, APIs, over-the-air update (OTA), bulk management, authentication, user database, device database, bulk registration, user authentication, access permissions, file storage, and other similar requirements each of which may vary greatly according to application. Assembling such a system from general constituent parts, such as a STUN server, becomes too complex to allow for stable software given the range and scope of the system, and thus its overall complexity.

In one embodiment, the remot3.it system, including software, mechanisms, methods, architecture, etc. may include support for one or more of the following, but not limited to to following: installation of client, installation of server, APIs, over-the-air update (OTA), bulk management, authentication, user database, device database, bulk registration, user authentication, access permissions, file storage, combinations of these and other similar requirements and the like.

In one embodiment, the remot3.it system, including software, mechanisms, methods, architecture, etc. may vary, be configured, include options, be tailored, be capable of being configured, etc. depending on the application, application type, use, mode, employment, deployment, combinations of these and the like, etc.

In one embodiment, the remot3.it system architecture is designed to support only what is necessary for an application. The remot3.it system architecture thus simplifies code design, testing, maintenance, and improves reliability, stability and performance.

In one embodiment, the remot3.it system, including software, mechanisms, methods, architecture, etc. may be statically configured, modified, changed, updated, and/or may be dynamically configured (e.g. at run time, during normal opertation, at start-up, etc.) etc. in order to simplify, improve reliability, improve performance, reduce cost, etc. of code design, testing, functional testing, network testing, maintainance, firmware update, software update, etc.

In one embodiment, the remot3.it system, including software, mechanisms, methods, architecture, etc. may be statically configured, modified, changed, updated, programmed, and/or may be dynamically configured (e.g. at run time, during normal opertation, at start-up, on first use, at connection time, on failure, on event detection, etc.) etc. in order to support any feature, function, metric, algorithm, external standard, recovery mechanism, fallback mechanism, connection recovery, and/or other similar requirement and the like, etc.

In one embodiment, the remot3.it system, including software, mechanisms, methods, architecture, etc. may support NAT traversal, other network connection traversal mechanisms, or any networking feature, function, etc. using configureable, programmable means, methods, functions, etc. (e.g. statically in compiled code, dynamically at run-time, etc.). For example, a Lua plug-in may be provided to support run-time configuration of NAT traversal or other features. Of course, any programming and/or configuration means, methods, language, plug-in, etc. may be used.

### Open-Source

Open-source software may work when widely deployed, heavily used, and well supported by a large community.

However, the complexity of establishing network connections in the face of NAT and the nature and type of the systems used are such that the use of open-source software, such as STUN and related technology, may actually be a disadvantage rather than providing an advantage. There are few commercial STUN server suites available. There are only two principal open-source STUN servers: coturn and Stuntman. This means that there are not enough users and not enough contributors to provide a good ecosystem to support a stable and secure platform.

In one embodiment, the remot3.it system architecture does not use a STUN server. The remot3.it system architecture and the core remot3.it NAT traversal system was created before the advent of STUN. Despite the availability of alternative NAT traversal solutions, such as STUN, there are too many fatal weaknesses of large, complex software systems such as those comprising a STUN server and other required components.

Part of the remot3.it system is open-source including scripts and tools that are widely used by users including client software and installers for example.

### Standard vs Proprietary

Standards are fundamental in many areas of networking. IETF standards in particular allow connection systems to permit predictable and stable operation. NAT traversal is an unusual case simply because NAT itself is completely non-standard: NAT algorithms and the behavior of equipment using NAT changes, sometimes rapidly as new technologies emerge—with mobile being an example. In the case of NAT traversal, we believe that software, such as a STUN server, based on a fixed standard may be the wrong approach. In the area of NAT traversal, in particular, standards may be a temporary and transient solution at best. As an example, the many IETF RFCs covering and related to NAT traversal have changed, continue to change and be updated. In addition, the creation and update of the IETF standards related to NAT traversal is a slow process with many steps. The lag and instability in standards has led to interoperability and software stability problems. For example, STUN servers that are compatible with RFC5389 (sometimes called “new” NAT traversal) are not backwards compatible with RFC3489 (sometimes called “classic” NAT traversal). Similar interoperability and compatibility problems are present with more recent updates to STUN and related RFCs and standards. Thus, in one sense, there is in fact no real standard for a STUN server, for example.

Interoperability testing is a critical part of the IETF standardization process. Because of the very small number of available NAT traversal software systems (with STUN server software being an example), there is little to no open interoperability testing for NAT traversal solutions. For example, a search for “stun server interoperability” generates only one relevant hit, and that is to a site that has been hacked. STUN server and NAT traversal systems and IETF standards have been developed largely by the carriers (companies such as Verizon, ATT, T-Mobile) and VoIP providers together with more recent input from cloud communications platforms (such as Twilio). A search on “stun server” reveals that the majority of hits relate to VoIP and WebRTC applications for STUN. It has been our experience in developing remoteit, starting from before the first IETF proposals for STUN, that a standards-based approach was difficult because (a) of the constantly changing nature of systems using NAT (b) often the requirements for NAT traversal (in IoT systems, for example) were different and sometime directly opposite to the requirements for VoIP applications for example.

For these and many of the other (some related) reasons described here, the remot3.it architecture does not employ standards (such as a STUN server) where it would compromise or otherwise decrease the performance, stability, or reliability of the remot3.it system. Of course, where it makes sense to employ standards—across standard interfaces, for example or in using security standards—the remot3.it system adheres to standards when doing so decreases complexity or increases the security, performance, stability, or reliability of the remot3.it system.

### Complete System Architecture

In one embodiment, the remot3.it architecture is designed as a complete system that includes both client and server software. There are a number of areas that the remot3.it architecture provides advantages because it is designed as a complete system.

As just one example of the effects of complete system architecture, in one embodiment the remot3.it system uses a single remot3.it daemon per service. A service may be ssh, VPN, web, RDP, etc. In one embodiment, for example, one daemon is used for ssh, another copy of exactly the same daemon may be used for vnc and so on. This architecture may allow each daemon to use a single socket whereas a different architecture (for example a client using a STUN server) may use multiple sockets. In one embodiment, the remot3.it system may use a single daemon per connection service. In one embodiment, the remot3.it system may use any number, type, form etc. of daemon per connection service. In one embodiment, the remot3.it system may allow any number of connection services to use a single daemon. In one embodiment, the remot3.it system may employ a daemon that uses a single socket. In one embodiment, the remot3.it system may employ a daemon that uses any number of sockets.

In addition, this remot3.it architecture allows the remot3.it client daemon to be very small, typically about 100K bytes. For example, on a MacOS client, the following shows the remot3.it daemon size at 152 kb. The remot3.it daemon can be under 100K for use on very constrained microcontroller based systems.

TABLE 3

MacBook-Air:~ mike$ ls -alh /usr/local/bin/weavedConnectd
-rwxr-xr-x@ 1 mike admin 152K Dec 27 18:22
/usr/local/bin/weavedConnectd

Such extreme optimization for a particular application (such as low computational power, code-size constrained devices) is much harder if not impossible with a standard server software system, such as a STUN server.

In other embodiments, the remot3.it system may use any number of remot3.it daemons per service. In other embodiments, the remot3.it system may use any a single daemon for one or more services. In one embodiment, the remot3.it system may use a different daemon type (e.g. different source code, options, or other differences, etc.) may be used for different services. In one embodiment, the remot3.it system may use any number of sockets may be used per daemon. In one embodiment, the remot3.it system may use one or more types of sockets, or other communication channels, interfaces, etc.may be used. In one embodiment, the remot3.it system may use different types, forms, methods etc. of optimization, customization, configuration, etc. (e.g. for power, code size, other features, factores, metrics etc.) that may be used for different daemons, versions of daemons, etc. In one embodiment, the remot3.it system may use any number, type, form etc. of executable program including but not limited to one or more of the following: a daemon, tray application, plug-in, script, engine, background process, foreground process, combinations of these and/or other form of executable and the like, etc.

### Architectural Advantages

There are a number of areas where the remot3.it architecture provides important advantages over a system based on STUN and related technology because remot3.it is designed as a complete system, not as parts. Such advantages are often initially difficult to see and understand, but we have found that they are important and fundamental. We will cover just two examples of such remot3.it architectural advantages, by way of illustration, though we have discovered through experience there are many.

Database: Any connection system requiring NAT traversal must maintain a database, and often several databases. Any database used must be tuned to the NAT traversal functions. The use of either open-source or commercial STUN, TURN and ICE networking solutions for NAT traversal does not allow the optimum architecture of the database functions. For example, the incorrect use of a database that is merely bolted on to a STUN server quickly leads to problems that are best described as “Database as anti-pattern” [10]. Briefly if the database is not correctly attached to the NAT traversal functions, such as STUN, the database quickly becomes a system bottleneck. In fact, the remot3.it architecture provides for the use of several databases around a messaging system. In one embodiment, the remot3.it architecture permits low-access-frequency data (for example user account information, device registration, etc.) to be stored separately from high-access-frequency data (connection requests, data transfer, etc.). As another example of optimization, in one embodiment the the remot3.it architecture permits some data to be stored in-memory or cached for rapid access to the remot3.it equivalent of STUN functions. Such architectural optimization, necessary to support high numbers of high-performance connections, is just not possible using a STUN server architecture.

In one embodiment, the remot3.it system may use data that is stored in memory, cached, etc. In one embodiment, the remot3.it system may store different forms, types, classes, etc. of data, status, other information, etc. in different locations, using different methods, using different databases, combinations of these and other similar methods and the like, etc. In one embodiment, the remot3.it system may store low-frequency data in a different form, manner, location, database, etc. from high-frequency data.

Client Software: In addition to the server based NAT traversal solutions, the client software is as important, if not more important, than the server architecture in any system employing NAT traversal. Correct architecture and design of the client software is needed in order to perform functions including, but not limited to: reducing code size, simplifying the code to allow deployment on any platform, reducing power dissipation, reducing mobile bandwidth, allowing for operation on platforms with low computational power, and other similar restrictions, constraints and requirements.

In one embodiment, the remot3.it system may use client software, code, etc. that may be optimized, configured, etc. to perform functions including, but not limited to: reducing code size, simplifying the code to allow deployment on any platform, reducing power dissipation, reducing mobile bandwidth, allowing for operation on platforms with low computational power, and other similar restrictions, constraints and requirements, etc.

These are just two examples to illustrate the need to architect a system as a whole rather than around parts, such as a STUN server. Only a system that is architected as a whole, such as remoteit, can comprehend and solve these types of architectural issues. The use of a STUN server cannot provide the architecture needed: the problem is that the STUN server is based on specifications (the IETF RFCs and draft RFCs) that have been crafted in isolation, not as a part of an entire system that can address commercial needs and requirements.

### Flexibility

The ability to add new NAT traversal techniques, functions to existing techniques is important. Any such methods that the remot3.it architecture team develops from experience with new systems, networks, and NAT structures can easily be included in the remot3.it framework and architecture. Such changes may touch and require changes to many parts of a complete system, not just, for example, the STUN server functions. Such flexibility and adaptability to changes is just not possible from a system employing parts such as a STUN server.

In one embodiment, the remot3.it system may use client software, server software, other code, functionality and means etc. that may be optimized, configured, programmed, tailored, modified, changed, reconfigured, dynamically configured, updated, combinations of these and/or other similar programming means and the like etc. to allow modification, inclusion, configuration, removal, update, etc. of plug-ins, code add-ons, programmable functions, extensions, modules, combinations of these and the like etc.

### Extensions

NATs may cause more problems than just NAT traversal. The following list includes several examples of such problems:
Global addressability
Global Uniqueness
Persistence of host-to-address binding
Address structure
Deploy ability of new applications
Reliability
Scalability
Private address spaces and VPNs

In one embodiment, the remot3.it architecture allows point solutions to these problems to be included, if, as, and when needed. Such extensions are not easily included in a modular system architecture that results by including such functions as a STUN server.

### IETF RFC3489

IETF RFC3489 summarizes problems with STUN as follows:
“The problems with STUN are not design flaws in STUN. The problems in STUN have to do with the lack of standardized behaviors and controls in NATs. The result of this lack of standardization has been a proliferation of devices whose behavior is highly unpredictable, extremely variable, and uncontrollable. STUN does the best it can in such a hostile environment. Ultimately, the solution is to make the environment less hostile, and to introduce controls and standardized behaviors into NAT. However, until such time as that happens, STUN provides a good short term solution given the terrible conditions under which it is forced to operate.”

Adding to this assessment included here are seven additional areas of concern with STUN that were outlined above. Other RFCs describe some of the other problems with STUN, including security issues, in RFC7376. In practice the RFC comment that “ . . . the solution is to make the environment less hostile, and to introduce controls and standardized behaviors into NAT” (from the above) has not happened and in fact with the emergence of mobile things have become much worse. The remot3.it system was designed from the beginning, before even the emergence of STUN, to address the widest possible variety of networks, including mobile. The remot3.it system architecture provides a better solution than systems that employ STUN.

How Remot3.it makes Connections

In one embodiment, the remot3.it system allows any device to communicate with any other device on the Internet, no matter what the network may look like or where the devices may be located. This section provides a basic overview of how remot3.it makes a connection between two (or more) devices.

### Types of Remot3.it Connections

Connections on the Internet, using a very simple analogy, work like posting letters. In one embodiment, in a first type of connection remot3.it provides a proxy to allow two devices to connect. A connection via a proxy, which we will call a proxy connection, behaves rather like two people exchanging letters exchanged via a PO Box, with the PO Box being the proxy. In one embodiment, in a second type of connection, remot3.it allows two devices to connect directly with each other, as if two people were exchanging letters directly. This second type of connection is called a peer-to-peer or P2P connection. A proxy connection has some features that make it useful in certain situations. For example, remot3.it can assign the equivalent of a random PO Box number for one-time connections. A proxy connection may also be used as a fallback in the rare event that a P2P connection cannot be made for some reason. In this section, we will describe an example of how remot3.it makes a P2P connection because once you understand the basic P2P remot3.it connection mechanism, it is much easier to explain other types of remot3.it connection. In various embodiment, the remot3.it system may use any type of connection including but not limiuted to a proxy conection, a peer-to-peer connection, a direct connection, combinations of these and any other types of connection. In some embodiments the remot3.it connection, from end to end, may include one or more types of non-Internet connection, For example, in one embodiment, the remot3.it system may use serial communications and/or serial communications protocols etc. In one embodiment, the remot3.it Internet protocols may be translated, tunneled, encapsulated, or otherwise carried, conveyed, communicated using one or more different (e.g. non-Intenet, non TCP/IP etc) protocols. In one embodiment, the remote3.it protocls may be translated, altered, changed etc. and carried, conveyed, communicated etc. over one or more non-Internet connections etc. In one embodiment, one or more parallel communications paths, redundant networks, ganged connections, bonded channels, or other combinations of one or more communications channels, networks, etc. may be used.

### IP Address Space

Connections on the Internet use IP addresses. IP addresses work like phone numbers. There are two kinds of IP address: old addresses called IPv4 addresses and new addresses called IPv6 addresses. IPv4 addresses look like this: 172.217.5.110 (which happens to belong to google.com) and work like a US phone number with area code plus local number like this: (650) 555-1212. There are 4,294,967,296 possible IPv4 addresses. IPv6 address are longer, look like this: 2a00:1450:400e:801::200e (which is also google.com), there are many more IPv6 addresses than 1Pv4 addresses, and IPv6 addresses work rather like an international phone number like this: +1 (650) 555-1212. There are 3.4×10̂38 IPv6 addresses. We have the same problem with IP addresses that we often face with phone numbers in a dense area code, except we have now completely run out of IPv4 addresses. Using IPv6 addresses would solve this problem, but since it is now apparent that nobody is going to switch over completely to IPv6 for a long time, we are stuck with too many devices and too few addresses. The solution is to find some way to extend IPv4 addresses. We need another number to add to an IPv4 address from somewhere. What we do is use a port number, so an address might now be 172.217.5.110:33013, where 33013 is a port number (which may range from 0 to 65535, with certain restrictions). The problem is that while the Internet “keeps track” of IP addresses, nobody “keeps track” of the use of port numbers with IPv4 addresses to extend the IPv4 address space. In order to use port numbers, we have to “keep track” of the port numbers somehow and that is where Network Address Translation (NAT) comes in.

In one embodiment, the remot3.it system may thus use a database, file, cache, table, data structure, array, spreadsheet, index, combinations of these or other similar information storage, data and/or storage structures, etc. in one or more locations to store, track, record, trace, monitor, follow, etc. one or more addresses (e.g. device address, IP address, IPv4 address, IPv6 address, other network address, other network identifying information, other device identifying information, other related information for a device and/or device address or the like, combinations of these and the like, etc.), port numbers, and/or other identifying information related to a network, devices, etc.

In one embodiment, the remot3.it system may use any such stored information together with any other data, information, parameters, etc. to allow NAT traversal and/or other techniques, methods, means, etc. in order to establish communications, establish connections, perform other network operations, connection operations and functions and the like, etc.

In one embodiment, the remot3.it system may thus use such stored information, other data etc. to perform name lookup, device lookup or other fetching, retrieving, lookup, etc. of device information, including, but not limited to, device address and other related networking data, information, metrics, etc.

In one embodiment, the remot3.it system may thus use such stored information, other data etc. to perform account, user, customer, etc. operations, and/or the analysis, prediction, monitoring, of connection paramters, metric and similar data, information and the like or any other similar function and the like etc.

Thus, for example, in one embodiment, the remot3.it system may perform the equivalanr of a DNS function or address lookup for Internet devices. An analogy would be a private phone book or phone directory, for example.

### Network Address Translation

Network Address Translation or NAT is a method of mapping one IP address space into another by modifying network address information in Internet Protocol (IP) datagram packet headers while they flow across a traffic routing device, such as a home router. To understand how NAT works, suppose we are in Palo Alto, California with a first device, an Apple laptop, that we will call the originating device. Suppose we want to connect to a second device, a RaspberryPi, that we will call the target device, located remotely at an office somewhere else in California; but it could be anywhere in the world. The laptop has a local IP address 10.0.1.29 issued via DHCP from the home router:

TABLE 4

MacBook-Air:~ mike$ ipconfig getifaddr en0 # local address
10.0.1.29

In order for connections to be made to the laptop, other devices on the Internet see an external IP address, which is 50.184.238.5:

TABLE 5

MacBook-Air:~ mike$ dig +short myip.opendns.com
@resolver1.opendns.com # external
IP address
50.184.238.5

NAT has become an essential tool in the face of IPv4 address exhaustion by sharing one Internet-routable IP address of a NAT gateway, such as the 50.184.238.5 address, for the entire private network, including the laptop at 10.0.1.29. The home router “keeps track” of ports used by NAT. When the home router (which is thus “keeping track” of the NAT ports on the home network that includes the laptop at 10.0.1.29) sees an incoming packet, it looks at the port number and knows, for example, that a packet addressed to the external IP address 50.184.238.5 with destination port 33013 (it could be any port) is meant for the laptop at 10.0.1.29. The home router has performed a translation of network addresses, or NAT. The same thing happens with the RaspberryPi behind the office router (which “keeps track” of ports on the office 10.0.0.123 network). The RaspberryPi has a local IP address, 10.0.0.123 for example, issued via DHCP by the office wireless router. The laptop at home can't see or connect to the remote RaspberryPi at the office. If we wanted to make a connection and send some packets to 10.0.0.123, we can't. However, with a help from a third-party, such as a remot3.it server, we can make such a connection. In order to make such a connection we must cross or traverse NAT, in a process called NAT traversal. remot3.it allows us to do just that.

In one embodiment, the remot3.it system may thus allow NAT traversal and/or enable, permit, allow, etc. one or more other address sharing techniques. In one embodiment, the remot3.it system may perform, allow, enable, establish, control, etc. one or more network connections, one or more network connections types, etc. across one or more networks that use, employ, etc. network address translation. In one embodiment, the remot3.it system may allow wtc. Connections etc. across networks that employ one or more types of network mapping etc. In one embodiment, the remot3.it system may allow etc. connections etc. across one or more IPv4 networks that may use etc. NAT. In one embodiment, the remot3.it system may allow etc. connections etc. across one or more IPv6 networks that may use etc. NAT. In one embodiment, the remot3.it system may allow etc. connections etc. across one or more networks that may use a combination of IPv4, IPv6 and/or other protocols etc. and that may use etc. NAT.

### NAT Traversal

We need to find a way to make the laptop, the home router, the RaspberryPi and the office router cooperate in order to make a connection between the laptop and the RaspberryPi. That process of cooperation is called NAT traversal. In order to understand how a remot3.it server can help with that cooperation process and “broker” such a connection using NAT traversal, we need to understand the details of the packets flowing between the devices and the remot3.it server. In order to understand such a packet flow, we need to use a picture that represents packet flow called a ladder diagram. In the next section, we will use a very simple example to explain how ladder diagrams work before we use a more complex ladder diagram to explain how remot3.it works.

In one embodiment, the remot3.it system may thus broker, manage, control, etc. one or more connections between a plurality of devices. Thus, for example, the remot3.it system may initiate, establish, broker, manage, control, etc. one or more connections or may otherwise step in, intervene, participate, etc. and/or otherwise cooperate in the initiation, establishment, etc. of one or more connections between a plurality of devices.

### Ladder Diagrams

A ladder diagram will help us explain how the remot3.it connection is made in the face of NAT using NAT traversal. We will use a very simple example to show how ladder diagrams work. In another analogy of Internet connections, we can draw a parallel with a phone system used for a conference call. Suppose Jim dials in to the conference call ahead of time and hears hold music. Then Gary dials in and joins the conference. Gary does not know Jim's phone number and Jim does not know Gary's phone number, yet they are able to talk directly to each other.

The ladder diagram below is for a conference call between Jim and Gary. Each arrow represents information flowing to and from Jim. The vertical axis represents time increasing in a downward direction. The vertical lines represent the endpoints for information flow that are Jim, the conference call number, and Gary.

The “rungs” or arrows in a ladder diagram represent information flow in general and for networks in particular represent packets or datagrams or “messages” that contain information that flows in the direction of each arrow. The information flows between “sides” of the ladder with each side representing an endpoint. The ladder sides or vertical lines represent the endpoints for Jim, the conference call number, and Gary. The information flow in our conference call goes like this:

Message 1: Jim dials the conference call number, 1(800)555-1212

Message 2: Jim hears “Enter access code”

Message 3: Jim enters access code 1234

Not shown: Gary dials 1.800.555.1212 and enters access code 1234

Message 4: Jim says: “Hello Gary”

Message 5: Gary replies: “Gary here”

Message 6: Jim talks to Gary

Message 7: Gary talks to Jim

Message 8: Jim hangs up

Note that this ladder diagram shows the information flow from Jim's perspective: that is only information in messages that Jim can see flowing to him and from him are shown. That doesn't have to be the case, we could also show all of Gary's messages with their information too, but limiting the messages and information flow shown on the ladder diagram in this way does make the ladder diagram simpler.

### Remot3.it Connection Ladder Diagram

FIG. Y5-1B is a ladder diagram showing how a basic remot3.it connection is established. The originating client local address is 10.0.1.29 (laptop). The remot3.it front-end server address is 174.36.235.146 and remot3.it chat sever address is 209.235.201.53. The target device (RaspberryPi) external address is 73.15.2.31 and internal address is 10.0.0.123. This ladder diagram was generated directly by Wireshark from a packet trace on the originating client device using a special version of remot3.it software. The ladder diagram in FIG. Y5-1B corresponds to a basic remot3.it connection. This ladder diagram shows the UDP datagram traffic between endpoints during connection. Before we describe the ladder diagram message by message, a few notes may help understand this more complicated ladder diagram.

FIG. Y5-1C shows a table containing the message content and functions for a basic remot3.it connection. Each line in the table corresponds to a line in the ladder diagram in FIG. Y5-1B. If you print these two pages or view them side-by-side on a wide screen, they should line up and allow you to read across both pages to determine the timing, direction, endpoints and function of each remot3.it CHAT protocol message. More details for each message are given in the text.

In one embodiment, the network traffic between devices over remot3.it uses UDP and thus the devices and intermediate routers must be open to UDP traffic. This is normally the case because of the very wide deployment of peer-peer networking applications, such as Skype, for example. If necessary, UDP traffic may be port restricted since it is possible to control which UDP ports remot3.it uses. It should be noted that any device with a UDP port used by remot3.it may still be hidden from anything other than remot3.it traffic.

In one embodiment, the remot3.it system may thus use UDP to establish, manage, control, initiate, maintain, etc. one or more network connections between a plurality of devices. In one embodiment, the remot3.it system may use any protocol, including but not limited to UDP, IP, TCP, combinations of these and/or other protocols, to establish, manage, control, initiate, create, maintain, etc. one or more network connections between a plurality of devices.

In one embodiment, the remot3.it system may be used to hide, cloak, or otherwise render a device invisible (e.g. to a network scan, intruder, virus software, attacker, etc.). In one embodiment, the remot3.it system may allow a user or other control means to turn off, disable, or otherwise limit the ability of a device, application software or other software etc. to initiate or respond to external devices, network traffic etc. In one embodiment, the remot3.it system may allow firewall rules, network access, iptables, other network restrictions, etc. may be set to allow only outgoing connection traffic (e.g. connections may only be initiated by a device and not from an external source).

The ladder diagram of FIG. Y5-1B was generated directly by Wireshark from a packet trace on the originating client (the home laptop) using a special instrumented version of the remot3.it software. In one embodiment, the remot3.it network traffic is encrypted and thus the data, packet types, messages and packet flow cannot be seen by Wireshark or any packet inspection techniques.

Only the start of the connection is shown in FIG. Y5-1B, up to the point that data start flowing between the two devices. The originating client local address is 10.0.1.29 (the laptop at home). Two remot3.it servers are involved in the connection process: a remot3.it front-end server and a remot3.it chat sever. The remot3.it front-end server address is 174.36.235.146. The remot3.it chat sever address is 209.235.201.53.

The target device external IP address is 73.15.2.31 (a RaspberryPi at the office behind a NAT router) on UDP port 55438. This is the IP address of the NAT router and the external IP address of the RaspberryPi. Since the ladder diagram FIG. Y5-1B was generated by Wireshark on the originating client (the home laptop) there is no way for Wireshark to know the internal IP address of the RaspberryPi. Only remot3.it knows the RaspberryPi internal IP address which is 10.0.0.123. You also see the RaspberryPi internal IP address 10.0.0.123 on the ladder diagram and we will explain this shortly.

In the ladder diagram of FIG. Y5-1B, the arrows have corresponding UDP port numbers in parentheses and thus the arrow heads don't reach and touch the endpoints, the ladder sides, as is customary in ladder diagrams and as was shown in the conference call ladder diagram; but this is how Wireshark generates the ASCII version of the ladder diagram (or flow graph as it is called in Wireshark). For example, traffic to and from the originating device (the laptop at 10.0.1.29) is shown on UDP port number 33013, but any port number could be used and in this case, could be specified when the remot3.it software is launched on the originating device. Similarly, the remot3.it front-end server (at 174.36.235.146) traffic is shown on UDP port number 5959, the remot3.it chat server (at 209.235.201.53) traffic is shown on UDP port number 5963, and the RaspberryPi (external address 73.15.2.31) is shown on UDP port number 55438. In one embodiment, the remot3.it system may use any port numbers. In one embodiment, the remot3.it system may use any port allocation scheme, and/or method or algorithm to generate port numbers, etc.

You may have noticed we just called what we have been calling the originating device (the laptop), the originating client. That is because we are initiating the remot3.it connection as a remot3.it user and we authenticate with remot3.it using a remot3.it login. If the device itself were originating the connection, we call the originator the originating device (rather than originating client). Note that remot3.it can perform device to device connections and in that case, we would have a true device to device connection without a user login involved. The RaspberryPi at the office is still called the target device. In one embodiment, the remot3.it system may create, establish, generate, etc. a direct device to device connection. In one embodiment, the remot3.it system may create, establish, generate, etc. any type, form, topology etc. of connections between any number, type, form, etc. of devices.

In the ladder diagram of FIG. Y5-1B, the initial four messages exchanged are part of the example authentication process. In one embodiment, the remot3.system is flexible in how authentication is performed. In one embodiment, for example, OAuth or OAuth 2.0 may be used. To illustrate how authentication may be used, we have shown a simple example. Authentication is used to verify the identification of a user as an originating client (or an originating device) to the remot3.it server. In one embodiment, authentication takes a nonce (a one-time use random number) generated by the remot3.it server and sent to the client together with a secret (or password) that is shared by the originating client and the remot3.it server and generates a hash. In one embodiment, the hash is sent to the remot3.it server to be authenticated and if the hash sent matches the hash generated by the remot3.it server, then authentication is successful. In one embodiment, the successful authentication allows keys to be generated for shared secret keys, encrypting session keys, and for keying server to client encryption. Some, but not all, of the details of key generation and exchange are described below. The authentication traffic is shown tagged as AU in the message explanations below. Once keys have been exchanged all encrypted message traffic is shown tagged as E1 and E2 in the message explanations below. E1 is used to denote encrypted server traffic. E2 is used to denote encrypted P2P traffic between devices. E1 and E2 use separate keys and separate encryption mechanisms.

In one embodiment, the remot3.it system may use any form of keys, key exchange, encryption, etc.

In the ladder diagram of FIG. Y5-1B, the messages such as REQUEST_AUTH_MESSAGE are remot3.it CHAT protocol messages that are contained within UDP datagrams. In one embodiment, the remot3.it CHAT protocol is the underlying protocol used by remot3.it to connect devices. In one embodiment, the remot3.it CHAT protocol message has a packet type. In this example trace, the remot3.it CHAT protocol message type has been decoded by a custom Lua Wireshark dissector, and that is how you can see the message types in the ladder diagram. It should be emphasized again that in one embodiment, the remot3.it traffic is encrypted and thus not normally visible without the special version of the remot3.it device software used in this example.

In one embodiment, the remot3.it system may use any form of authentication, etc. For example, in one embodiment, the remot3.it system may use accounts and password. For example, in one embodiment, the remot3.it system may use multi-factor authentication. For example, in one embodiment, the remot3.it system may use biometric authentication. For example, in one embodiment, the remot3.it system may use one or more means of authentication. For example, in one embodiment, the remot3.it system may use configurable authentication, authentication methods selected by the user, combinations of these and other similar authentication methods and the like, etc.

In the ladder diagram of FIG. Y5-1B, the elapsed time in seconds from the start of a connection is shown on the left-hand side of the ladder diagram. The start of a connection is, in this simple example, the launch of the remot3.it software on the originating client (the laptop at 10.0.1.29).

TABLE 7
MacBook-Air:test_rpi_1 mike$ ./sshw.16.sh “pi@B2 RPi3 v1 ssh”
Weaved sshw.sh Version 0.0.9.16 Jan 4, 2017
.........P2P tunnel connected on port 33013
pi@127.0.0.1's password:

There are two important commands to understand here. The script sshw.16.sh launches the remot3.it software with a known user (with a remot3.it login account) and a known device, a RaspberryPi, that we own and have rights to connect to and known to remot3.it as the remot3.it service that we have named “B2 RPi3 v1 ssh”. This service is known to remot3.it, because we registered the service with remot3.it, to be of type ssh and to be used for ssh connections. We have asked to be connected to the RaspberryPi as user “pi”. Notice that the script then prints “P2P tunnel connected on port 33013” which means that the P2P tunnel has been established by remot3.it and now the ssh connection using that tunnel can proceed. The next command is the password prompt coming from the remote RaspberryPi via ssh over the remot3.it connection tunnel. Notice very carefully that the prompt is as though the connection were to 127.0.01 or localhost. This is because in one embodiment, the remot3.it software terminates the TCP connection and then passes the TCP data on to the host using a separate localhost connection. This means the host can be completely hidden or cloaked from the outside as only localhost connections need be allowed. This is a very important feature of the remot3.it system. In addition to this very important concept, notice how fast the remot3.it connection occurs: from connection start to the point that ssh is ready to take the remot3.it connection and negotiate ssh connection is 0.55 seconds at the P2P_CONNECTED_MESSAGE. (The point at which ssh connects using TCP within the P2P connection is marked by the TUNNEL_CREATE_MESSAGE but that further delay is due to ssh.)

In one embodiment, the remot3.it system may be used to hide, cloak, or otherwise render a device invisible (e.g. to a network scan, intruder, virus software, attacker, etc.) by using one or more connections established using a localhost address. In one embodiment, the remot3.it system may allow a user or other control means to turn off, disable, or otherwise limit the ability of a device, application software or other software etc. to initiate or respond to external devices, network traffic etc. with the exception of traffic directed to a localhost address. In one embodiment, the remot3.it system may allow firewall rules, network access, iptables, other network restrictions, etc. may be set to allow only outgoing traffic. In one embodiment, the remot3.it system may allow firewall rules, network access, iptables, other network restrictions, etc. may be set to allow only incoming traffic to a localhost address.

In the ladder diagram of FIG. Y5-1B, the remot3.it connection process has been shown up to the point that data flows over the established remot3.it connection. In a complete remot3.it connection session several more exchanges of TUNNEL_DATA_MESSAGE and TUNNEL_ACK_MESSAGE would occur as ssh transfers data over the remot3.it connection. Finally, several messages would be exchanged once the connection is terminated, for example we could enter “exit” at the RaspberryPi system prompt.

### Remot3.it Connection Messages

An example information flow in each remot3.it CHAT protocol message is shown in more detail as follows. Each remot3.it CHAT protocol message corresponds to each line in the ladder diagram of FIG. Y5-1B.
(REQUEST_AUTH_MESSAGE) AU: The first four messages starting with this one, and including this message, are a simple example of secure authentication; and these four datagrams are flagged as “AU”. This is a message from the laptop to the remot3.it front-end server that “I am a remot3.it user”, and containing a one-time generated originating client UID that will be used to identify this connection session, and the last-connected IP address and port.
(RESPONSE_AUTH_MESSAGE) AU: A re-direct to the remot3.it chat sever IP address and port, also contains the NAT mapped IP address and port as seen by the remot3.it front-end server.
(REQUEST_AUTH_MESSAGE) AU: Same as first REQUEST_AUTH_MESSAGE message but re-directed to the remot3.it chat sever IP address and port.
(RESPONSE_AUTH_MESSAGE) AU: A message from the remot3.it front-end server to the laptop. Contains: originating client UID, a nonce (one-time random number), the encryption type to use, login salt (seed added to data before encryption), and also the NAT mapped IP address and port as seen as by the remot3.it chat server. The NAT mapped IP address and port as seen by the remot3.it front-end server together with the NAT mapped IP address and port as seen as by the remot3.it chat server are used by remot3.it to help determine the NAT type.
(IDENTIFICATION_MESSAGE) E1: Note that from now on all remot3.it server traffic is encrypted (all datagrams that are encrypted using this encryption type are flagged as E1). Contains: SPI, packet salt, (auth hash), (sequence number). ( )=not used, local IP address and port, NAT type, client flags (manufacturing ID etc.), protocol support (TCP tunnel), P2P encryption supported, and use restrictions.
(ACK_MESSAGE) E1: Contains: SPI, packet salt, session restrictions.
(REQUEST_P2P_MESSAGE) E1: Contains: SPI, salt, target device UID (data type 0x0a), originating client or UID (data type 0x01), encryption supported by the originating client, predicated port if required by NAT type, and use restrictions. This is an important message as it contains the UID of the target device that we wish to connect to.
(INITIATE_P2P_MESSAGE) E1: Contains: SPI, salt. Note that two identical INITIATE_P2P_MESSAGE messages are sent as a result of tuning experience for reliability and speed. Contains: SPI, salt, encryption type to use for this session, session ID, target device UID, internal IP address and port ort if required by NAT type, and use restrictions.
(INITIATE_P2P_MESSAGE) E1: This message is the same as first INITIATE_P2P_MESSAGE. Note: that two INITIATE_P2P_MESSAGE are sent from the remot3.it chat server to the target device for reliability and speed.
(P2P_HELLO_MESSAGE) E2: This message is encrypted using the negotiated encryption type. Contains: session ID, target device UID, originating client UID, maximum packet size, maximum outstanding requests which is related to the buffer depth. Note this message is a connection attempt to the RaspberryPi local address 10.0.0.123, which is known only to remot3.it. For example, it could be that the laptop at 10.0.1.29 can be routed to 10.0.0.123. In this case, it cannot. This mechanism is important as it may allow connection in some unusual NAT and network environments.
(P2P_HELLO_MESSAGE) E2: This message is exactly same as first local connect P2P_HELLO_MESSAGE to the target device, but now to the target device RaspberryPi external IP address 73.15.2.31. Note: that whichever P2P_HELLO_MESSAGE reaches destination first (either originating client or target device) will complete the P2P connection.
(P2P_HELLO_MESSAGE) E2: Exactly same as the P2P_HELLO_MESSAGE from the originating client but with swapped UIDs.
(ACK_MESSAGE) E2: This ACK_MESSAGE completes P2P connection or else more P2P_HELLO_MESSAGE messages are sent.
(ACK_MESSAGE) E2: The ACK_MESSAGE must flow in both directions to complete the P2P connection in both directions.
(P2P_CONNECTED_MESSAGE) E1: This ACK_MESSAGE informs the remot3.it sever that connection is complete.
(P2P_CONNECTED_MESSAGE) E1: Note that two P2P_CONNECTED_MESSAGE messages are sent for reliability etc.
:33013→5963 Len=1 U: This is a packet with deliberately short TTL to keep the required router NAT table parameters from expiring. This packet may not actually reach the remot3.it server. In this case, the user may not be charged for the data in the keepalive packet. Such a packet is sometimes called a “keepalive” packet, or sometimes “heartbeat” as the packets may be sent at regular intervals for example. Note that there may be more than one type of “keepalive” packet (or packet that performs a “keepalive” function, or function similar to “keepalive”) in the remot3.it system.
(TUNNEL_CREATE_MESSAGE) E2: This message is triggered by any TCP connection establishment process. For example, ssh when started will establish a TCP connection. This message will cause the formation of a TCP data pipe inside the already established encrypted UDP tunnel. Note that remot3.it software on each device terminates the TCP connection. TCP data and only the TCP data is then passed to the host via a localhost connection, for example with a 127.0.0.1 address. There is therefore no TCP header inside the remot3.it UDP tunnel. This means there is never any TCP header information conveyed using remot3.it. This means that even if somehow multiple layers of encryption are broken and the TCP data is exposed, there is nothing that can be done with that TCP data; there is no routable information.
(TUNNEL_ACK_MESSAGE) E2: This message acknowledges success in the encrypted remot3.it P2P UDP tunnel creation and that TCP connection is established on target device else we try TUNNEL_CREATE_MESSAGE again.
(TUNNEL_DATA_MESSAGE) E2: This message contains TCP data (and only TCP data, with no TCP header information) inside the encrypted remot3.it P2P UDP tunnel.
(TUNNEL_ACK_MESSAGE) E2: This message acknowledges and performs a flow-controlled exchange of data over the encrypted remot3.it P2P UDP tunnel.

Even though we have added more message contents in the above than shown in FIG. Y5-1B, still not all information may be shown. For example, in various embodiments, one or more features including, but not limited to: connection and use restrictions, various manufacturing and deployment options, other connection information, data, options, flags, combinations of these and the like etc. may be used, conveyed, carried, communicated, etc. but may not be shown in figures such as FIG. Y5-1B where they are not essential to understanding how connections are established.

### More Remot3.it Details

The ladder diagram in FIG. Y5-1B shows an example use of the remot3.it CHAT protocol in a simple NAT situation. The remot3.it CHAT protocol is efficient but flexible. In one embodiment, the CHAT protocol uses packet types that have a flexible structure using several data types. The protocol was designed to make the remot3.it device software small and easy to configure for use, for example, in small embedded systems with limited processing power and low memory footprint.

The ladder diagram in FIG. Y5-1B covers the situation of a simple NAT traversal, but, in one embodiment, the remot3.it uses a flexible, programmable engine that is programmed to handle all known NAT types and can be programmed to handle special NAT situations, including the more complex CG-NAT configurations. In one embodiment, the remot3.it system may use remot3.it CHAT protocol messages that can be sent from server to/from each device to help with NAT traversal in difficult situations. In one embodiment, the remot3.it system may fallback to a proxy connection in the rare case that a P2P connection fails.

In the Wireshark trace that we used for the connection ladder diagram of FIG. Y5-1B, we did not show the UDP packet contents. If we had shown those UDP datagrams we would see the TCP data and TCP connections details (flow control and so forth), but we would not see any TCP header information. This means that even if multiple layers of encryption in a remot3.it connection were to be somehow broken, the TCP data that would be uncovered is not usable since there is no header and thus no routing information.

In one embodiment, the remot3.it system may convey, tunnel, communicate, carry, encapsulate, etc. one or more protocols (e.g. TCP. UDP. IP, other similar transport protocols, combinations of these and/or other protocols and the like, etc.). In one embodiment, the remot3.it system may convey etc. one or more parts of a protocol packet. For example, the remot3.it system may convey only the packet data without header information, or may convey any part or parts of the data, part of the header, or any number of parts, portions, pieces, fields, parts of any fields, combinations of these, etc. In one embodiment, the remot3.it system may convey one or more parts of one or more protocol packets. For example, the remot3.it system may combine packets, compress one or more packets, combine data from one or more packets, etc. In some embodiments, for example when combining packets or packet data etc, the remot3.it system may re-write, modify, change, alter or otherwise modify one or more parts of one or more packets. For example, the remot3.it system may change header information, change packet length fields, insert or modify CRC or other error checking fields (checksums and the like), or may change any field or fields, flags, options, and so on.

In the Wireshark trace that we used for the connection ladder diagram in FIG. Y5-1B we did not show the UDP packet lengths and total data use. In one embodiment, the remot3.it CHAT protocol is designed to have very low overhead and includes messages that allow data usage monitoring for example.

In one embodiment, the remot3.it system may convey, communicate, carry, etc. information, data, etc. in a connection that may allow data gathering, monitoring or otherwise collecting information, statistics, metrics, measurements etc. In one embodiment, the remot3.it system may add data, information, fields, flags, options, counters, timestamps, measurements or other information, data and the like to connections, conveyed network traffic, packets, datagrams, and the like. For example, the remot3.it system may add such information at any ISO layer (inside packets, inside the tunnel layer, inside the data transport layer, inside connection traffic, layerd on to of connection traffic, etc). For example, the remot3.it system may monitor bandwidth use, length of connection, type of connection, application type, or any feature, function, metric, etc. For example, the remot3.it system may also detect or gather data that may be used to detect, the type of router, switch, platform, network, carrier, or other information related to the type of equipment, software, firmware, being used by network trsffic etc. For example, the remot3.it system may detect or gather data that may be used to detect, the type of wireless carrier being used. In one embodiment, the remot3.it system may use such detected information to modify, configure, alter, change, program etc. any aspect of the system. For example, the remot3.it system may detect that a router is being used that requires a keepalive packet interval of 60 seconds and the system may be programmed to generate keepalive packets at that interval or less, etc. For example, the remot3.it system may detect that a router is being used that requires a configuration of the system to use a certain type of sequence of one or more types of keepalive packets. For example, a combination of router and carrier equipment may require ping and acknowledgement packets to be sent at a first interval to keep the connection open as well as generate short-TTL packets at a second interval to keep a NAT router table from expiring. In one embodiment, the remot3.it system may use such detected information to modify any aspect of connection establishment, connection close, connection control, connection maintainance (e.g. keeping a connection open, restoring a connection, recovering a connection, connection failover, switching connection mechanisms, controlling a connection, and combinations of these or any other finctions that relate to maintaining connections etc.), combinations of these functions and any other functions related to establishing, maintaining, and closing one or more connections between devices etc.

In the Wireshark trace that we used for the connection ladder diagram in FIG. Y5-1B it may not be apparent that remot3.it connections appear to be a 127.0.0.1 connection. This is as a result of the remot3.it device software terminating the TCP connection carried inside the encrypted remot3.it P2P UDP tunnel. This feature allows the host device to close all ports in a cloaked fashion. Only 127.0.0.1 or other localhost connections need be allowed.

In one embodiment, the remot3.it system may cloak or hide one or more ports by using a localhost address for connection. In one embodiment, the remot3.it system may terminate a TCP connection conveyed, carried, tunneled, etc. inside a UDP tunnel. In one embodiment, the UDP tunnel may be encrypted. In one embodiment, the remot3.it system may allow, permit, enable, etc. one or more devices to be operated, configured, etc. in a cloaked, disguised, hidden, etc. fashion, manner or mode. For example, in such a cloaked mode, the device may be configured to only allow, permit, etc. localhost connections. In one embodiment, the remot3.it system may use any type, form, version of tunnel, encapsulation layer, etc. In one embodiment, the remot3.it system may use any forms of encryption, security layer, security system, etc. in order to encrypt, protect, secure, etc. connections, connection information, or any part of network communications etc. For example, the remot3.it system may use one or more combinations of security protocols etc. for different parts of the remot3.it protocol communications. For example, control functions, and/or packets corresponding to control, management, remote management, bulk management, fleet management, etc. functions may use a first security mechanism, protocol, etc. while other functions, services, tunneled protocols, etc. may use a second type, form, version, etc. of security mechanism, protocol, etc.

In the Wireshark trace that we used for the connection ladder diagram in FIG. Y5-1B we explained some, but not all, of the subtle features of the remot3.it system. For example, experience in real-world deployment has shown us that sending multiple datagrams with duplicate messages improves speed and reliability, but only in certain cases. We also showed, for example, that sending special keepalive packets through the NAT routers with short TTL are sufficient to keep the NAT router tables in place without consuming bandwidth. Note that there may be more than one type of “keepalive” packet in the remot3.it system. In one embodiment, the remot3.it system may use one or more packets to maintain connections e.g. keepalive packets.

In one embodiment, the remot3.it system may send, convey, carry, copy etc. one or more duplicate messages. For example, it may be more reliable to convey multiple copies of certain messages (e.g. messages related to the opening, establishment, etc. of a connection). For example, it may be faster and/or more reliable to have two devices send one or more copies of a message, signal, ping, acknowledgement, or other signal, information, etc. to each other, thus effectively doubling the chance that a message will be received by one or the other device. In one embodiment, the remot3.it system may send, convey, carry, copy etc. one or more exact copies of messages as duplicates. In one embodiment, the remot3.it system may send, convey, carry, copy etc. one or more copies of messages as duplicates but with one or more changes e.g. a counter, marker, flag, nonce, or other field or fields etc. that may allow the system, for example, to detect, manage, or otherwise control the transmission and receiving of duplicate messages.

### Summary

In this section, we have described what remot3.it is, what it does and how a basic connection is established by remot3.it. We showed an example ladder diagram in FIG. Y5-1B corresponding to establishing an encrypted remot3.it P2P UDP tunnel that carried an ssh connection. Using a simple connection example, we showed some, but not all, of the features of the remot3.it system and in particular the remot3.it CHAT protocol.

Advanced Remot3.it—a Proxy Connection

The remot3.it system allows any device to communicate with any other device on the Internet, no matter what the network looks like or where the devices may be located. This section provides a more advanced look of how remot3.it makes a connection between two devices using a proxy connection.

Once you understand the basic P2P remot3.it connection mechanism, the remot3.it protocols, and the packet flow for a connection, it is much easier to understand how a remot3.it proxy connection is made. It is then also easier to understand the other types of remot3.it connections.

### What is a Proxy Connection?

Connections on the Internet, using a very simple analogy, work like posting letters. In a first type of connection remot3.it provides a proxy to allow two devices to connect. A connection via a proxy, which we will call a proxy connection, behaves rather like two people exchanging letters exchanged via a PO Box, with the PO Box being the proxy. In a second type of connection, remot3.it allows two devices to connect directly with each other, as if two people were exchanging letters directly. This second type of connection is called a peer-to-peer or P2P connection. A proxy connection has some features that make it useful in certain situations. For example, remot3.it can assign the equivalent of a random PO Box number for one-time connections. A proxy connection is also used as a fallback in the rare event that a P2P connection cannot be made for some reason. In this section, we will describe an example of how remot3.it makes a proxy connection.

### What is a Ladder Diagram?

A ladder diagram will help us explain how the remot3.it proxy connection is made. We will use a very simple example to show how ladder diagrams work. In another analogy of Internet connections, we can draw a parallel with a phone system used for a conference call. Suppose Jim dials in to the conference call ahead of time and hears hold music. Then Gary dials in and joins the conference. Gary does not know Jim's phone number and Jim does not know Gary's phone number, yet they are able to talk directly to each other. The ladder diagram below shows the information flowing to and from the Jim and to and from Gary in their conference call.

The “rungs” or arrows in a ladder diagram represent information flow in general and for networks in particular represent packets or datagrams or “messages” that contain information that flows in the direction of each arrow. The information flows between “sides” of the ladder with each side representing an endpoint. The ladder sides or vertical lines represent the endpoints for Jim, the conference call number, and Gary. The information flow in our conference call goes like this:

Message 1: Jim dials the conference call number, 1(800)555-1212

Message 2: Jim hears “Enter access code”

Message 3: Jim enters access code 1234

Not shown: Gary dials 1.800.555.1212 and enters access code 1234

Message 4: Jim says: “Hello Gary”

Message 5: Gary replies: “Gary here”

Message 6: Jim talks to Gary

Message 7: Gary talks to Jim

Message 8: Jim hangs up

Note that this ladder diagram shows the information flow from Jim's perspective: that is only information in messages that Jim can see flowing to him and from him are shown. That doesn't have to be the case, we could also show all of Gary's messages with their information too, but limiting the messages and information flow shown on the ladder diagram in this way does make the ladder diagram simpler.

### The Network

The remot3.it proxy connection we are going to make is between two endpoints: an initiating device and a target device. In one embodiment, the remot3.it proxy connection is made via a proxy, a remot3.it/Weaved server. In other embodiments, the remot3.it proxy connection may be made using any one or more servers configured as a proxy, relay, jump host, combinations of these and the like, etc.

The initiating device is an iPhone on the ATT carrier network. The iPhone is running the remot3.it/Weaved mobile application. The remot3.it/Weaved software on the LG phone is thus behind the ATT network.

The target device is a MacBook laptop (with hostname MacBook-Air) tethered via Wi-Fi to an LG Android cell phone on the Verizon carrier network. The LG phone is acting as a Wi-Fi hotspot. The MacBook is thus behind the Verizon cell phone and the Verizon carrier network. The MacBook is running a special version of the remot3.it software that allows us to trace the packet flow to and from the remot3.it software.

The combination of the Verizon network and the ATT network makes connection challenging. In the next section, we will study a remot3.it proxy connection across the ATT and Verizon networks. In another section, we will study the types of networks that result when using mobile carrier connections and making other types of remot3.it connections in such networks.

### The Ladder Diagram

FIGS. Y5-2A-Y5-2N show a ladder diagram that corresponds to a remot3.it proxy connection. This ladder diagram in FIGS. Y5-2A-Y5-2N shows the UDP datagram traffic between endpoints during connection. Before we describe the ladder diagram, a few notes may help you understand this particular ladder diagram.

In one embodiment, the network traffic between devices over remot3.it typically uses UDP and thus the devices and intermediate routers must be open to UDP traffic. This is normally the case because of the very wide deployment of peer-peer networking applications, such as Skype, for example. If necessary, UDP traffic may be port restricted since it is possible to control which UDP ports remot3.it uses. It should be noted that any device with a UDP port used by remot3.it may still be hidden from anything other than remot3.it traffic.

The ladder diagram in FIGS. Y5-2A-Y5-2N that we will use to illustrate a proxy connection was generated directly by Wireshark from a packet trace on the target device (the MacBook, the home laptop, also sometimes called the target client) using a special instrumented version of the remot3.it software. In one embodiment, the normal remot3.it network traffic is encrypted and thus the remot3.it data, packet types, messages, and packet flow cannot be seen by Wireshark or any packet inspection techniques. We need special remot3.it software to examine what is going on at the packet level.

The Wireshark packet trace shown in FIGS. Y5-3A-Y5-3G is exactly the same capture as the Wireshark ladder diagram shown in FIGS. Y5-2A-Y5-2N. The Wireshark packet trace in FIGS. Y5-3A-Y5-3G was generated using File>Export Specified Packets . . . in Wireshark.

### The Endpoints

At the top of the Wireshark ladder diagram in FIGS. Y5-2A-Y5-2N we can see the following five endpoints:

TABLE 9

| \| Time | \| MacBook-Air | \| fe1.yoics.net | |
|---|---|---|---|
| \| 74.91.27.90 | | | |
| \| | \| \| 255.255.255.255 | \| | \| yoics-ds- |

2013-1.inetuhosted.net

The five endpoints in the Wireshark ladder diagram in FIGS. Y5-2A-Y5-2N have the following properties:
MacBook-Air: The target device. The laptop behind the Verizon network using an LG Android phone running remot3.it software. IP address (internal) 192.168.43.125. Geo-location: Palo Alto, CA. IP address (external) 70.197.5.131. Geo-location: San Jose, CA.
fe1.yoics.net: A remot3.it front-end server. IP address 174.36.235.146.
74.91.27.90: A remot3.it proxy server. This server will relay all data from the originating device (the iPhone) to the target device (hostname MacBook-Air). This is as far as we can see from the target device, we cannot see the iPhone itself that is behind the proxy.
255.255.255.255: The broadcast address. This address will receive copies of all the remt3.it traffic from the special debug version of the remot3.it software running on target device, the laptop, at 192.168.43.125. We will explain this further shortly.
yoics-ds-2013-1.inetuhosted. net: A remot3.it server. IP address 209.235.201.53.

At the top of the packet trace in FIGS. Y5-3A-Y5-3G, after the ladder diagram in FIGS. Y5-2A-Y5-2N, we can see the following:

TABLE 10

| | | | | | | |
|---|---|---|---|---|---|---|
| No. | Time | Source | Destination | Protocol | Length | Info |

| | | | | |
|---|---|---|---|---|
| 32 27.005489 | MacBook-Air | 255.255.255.255 | CHAT | 104 |

(REQUEST_AUTH_MESSAGE)

| | | | | | |
|---|---|---|---|---|---|
| 33 27.005547 | MacBook-Air | fe1.yoics.net | UDP | 104 | 53973 → 5959 |

Len=62

First is the packet number (not all packets are shown, for example DNS packets are filtered). Packet time also uniquely identifies a packet. The source and destination addresses in the packet trace of FIGS. Y5-3A-Y5-3G correspond to the source and destination endpoints in the ladder diagram of FIGS. Y5-2A-Y5-2N. Protocol is CHAT or UDP and we will explain the difference shortly. Length is the total packet length. The Info field contains the decoded CHAT protocol packet type, for example, (REQUEST_AUTH_MESSAGE). In the packet trace below, at the very far right, is the packet type number (decimal) for example 1 (decimal) for decoded packet type (REQUEST_AUTH_MESSAGE), this is not shown above. For packets that cannot be decoded (which is explained below), the Info field shows ports and payload length.

### The Packets

Wireshark does not currently export packet numbers when exporting an ASCII version of a ladder diagram (or Flow Graph as it is called in Wireshark). Thus, in the ladder diagram in FIGS. Y5-2A-Y5-2N, we have added line numbers to allow us to refer to a particular packet.

In the ladder diagram of FIGS. Y5-2A-Y5-2N, the arrows have corresponding UDP port numbers in parentheses at the end of each arrow on a ladder rung. The spacing on a line is such that the arrow heads don't reach and touch the vertical endpoint lines, the ladder sides, as is customary in ladder diagrams. Notice also that when the time field increases beyond 100 seconds, not all the vertical lines that represent the endpoints align perfectly. So, the ladder diagram in FIGS. Y5-2A-Y5-2N does not look exactly the same as the conference call ladder diagram we showed earlier, but this is how Wireshark generates the ASCII version of a ladder diagram. In earlier sections, we sometimes edited the Wireshark output in order to simplify the ladder diagrams and packet traces in order to make things easier to explain. In this section, we will show you exactly how the Wireshark output appears without editing.

The ladder diagram in in FIGS. Y5-2A-Y5-2N shows two kinds of packets:
Packets that are sent by a special version of the remot3.it software to the broadcast address 255.255.255.255. We call these DEBUG packets. Packets that are normally sent by remot3.it. We call these REAL packets.

Note very carefully that you would not normally see all of the packets shown in this ladder diagram of in FIGS. Y5-2A-Y5-2N. You would normally see only the REAL packets and they would be encrypted.

The DEBUG packets sent to the broadcast address 255.255.255.255 are in turn divided into four classes that are sent to the following UDP destination ports according to the class that the DEBUG packet is in:
UDP port 63000: an unencrypted copy of all packets received from the remot3.it sever
UDP port 63001: an unencrypted copy of all packets transmitted to the remot3.it sever
UDP port 63002: an unencrypted copy of all packets received from the target device
UDP port 63003: an unencrypted copy of all packets transmitted to the target device

The DEBUG packets sent to the broadcast address 255.255.255.255 are sent unencrypted allowing us to use a Lua Wireshark dissector to determine their remot3.it packet type. That is why you can see the remot3.it packet type information in the ladder diagram. Again, it must be emphasized, you cannot normally see this or any information in a remot3.it connection. If you were looking very carefully at packet traces in earlier sections, you may have noticed that the Ethernet broadcast address ff:ff:ff:ff:ff:ff was still present in some remot3.it packets, even though source and destination IP address had been edited!

In order to follow the ladder diagram in FIGS. Y5-2A-Y5-2N, you can focus on the DEBUG packets or on the REAL packets, or both depending on your view. For example, if you just need to follow the flow and remot3.it protocol, ignore the REAL packets and focus on the DEBUG packets with their packet types. Each REAL encrypted packet has a corresponding unencrypted DEBUG packet. In order to help you determine which REAL packet corresponds to which DEBUG packet (or vice versa), We have also included the Wireshark trace.

Thus, for example, in the ladder diagram in FIGS. Y5-2A-Y5-2N we see (from the first few lines):

In the packet trace of FIGS. Y5-3A-Y5-3G following the ladder diagram in FIGS. Y5-2A-Y5-2N, we see (from the first few lines):

TABLE 12

| | | | | |
|---|---|---|---|---|
| 32 27.005489 | MacBook-Air | 255.255.255.255 | CHAT | 104 |

(REQUEST_AUTH_MESSAGE)

| | | | | |
|---|---|---|---|---|
| 33 27.005547 | MacBook-Air | fe1.yoics.net | UDP | 104 |

53973 → 5959 Len=62

What does this information tell us? By looking at both the ladder diagram information and the packet trace we can tell that:
Packet 32 in this trace is the first DEBUG packet we see (not all packets captured by Wireshark are shown, for example DNS packets etc. were filtered out).
DEBUG packet 32 is sent to broadcast address 255.255.255.255. That is why we know it is a DEBUG packet.
DEBUG packet 32 is sent to destination UDP port 61001. That means it is a copy of a packet transmitted to the remot3.it sever.
DEBUG packet 32 has a remot3.it packet type (REQUEST_AUTH_MESSAGE)
DEBUG packet 32 total length is 104 bytes.
DEBUG packet 32 with total length 104 bytes corresponds to REAL packet 33 whose total length is also 104. Matching packets is more easily seen from the packet trace than the ladder diagram. We will use both traces and diagrams.

There are a few special cases and issues with the ladder diagram and packet trace that make things slightly more complicated (and this is why we have used simplified versions in some earlier sections):
DEBUG packets that are sent to the broadcast address 255.255.255.255 on UDP ports 63000/63001/63002/63003 are decoded with their message type as CHAT protocol. For example, as CHAT: (REQUEST_AUTH_MESSAGE)
REAL packets that are not sent to the broadcast address 255.255.255.255 are (except for initial authorization) encrypted and cannot be decoded. Therefore, these packets are shown as UDP. For example, as UDP: 53973→5959 Len=62 For each REAL packet (with only a few exceptions) there is a corresponding DEBUG packet.
A DEBUG copy of the minimum length=1 keepalive (also called keep-alive) packet is not decoded to a remot3.it packet type but are decoded as belonging to CHAT. See line 31 in the ladder diagram for an example. These remot3.it packets show as CHAT: 61004→63001 Len=1. Note that there may be more than one type of “keepalive” packet in the remot3.it system.
When we see the port prediction algorithm at work we will only see a copy of the first REAL packet that is sent in a burst of packets as an unencrypted DEBUG packet. We can only see the port prediction packets when we see all packets on both side of the connection, that is both endpoints. We are only looking at the target device here and on a proxy connection, so we do not see port prediction packets.
   What Happened in this Connection?

In this section, we will step through the actions performed to start the proxy connection, actions performed using the example proxy connection, and how the proxy connection was closed. In describing the first few actions we will step through the ladder diagram and packet exchange in detail to illustrate the use of both sources of information. In the example proxy connection, the ladder diagram and packet trace show the packets exchanged as a result of the following actions:
The remote3.it software is started on endpoint with hostname MacBook-Air, the target device, which is the laptop behind the Verizon network using an LG Android phone. The (internal) IP address is 192.168.43.125 and the (external) IP address is 70.197.5.131. All other remot3.it services except the service for an ssh connection were stopped on hostname MacBook-Air in order to simplify the packet trace. If there were other services running, but they were idle with no data, we would just see keepalive packets flowing for those other services. The remot3.it software on the target device MacBook-Air is called WeavedConnectd. The WeavedConnectd software runs as a daemon. The configuration file for this ssh service on the laptop is Weavedssh22.conf, which is shown in Appendix 1A.

TABLE 13

MacBook-Air:~ mike$ sudo /usr/local/bin/Weavedssh22.sh start
Starting Weavedssh22...
WeavedConnectd built Feb 11 2017 at 09:23:22 Now Starting Up

Version 3.7 - (c)2016 Weaved, Inc. All Rights Reserved
Built with BCASTER MALLOC_POOL RESOLVE BIGBUF NOTE pool=262144

config file /etc/weaved/services/Weavedssh22.conf
Starting up as daemon
PID file specified as /var/run/Weavedssh22.pid
setting web config port to dest_server_port 80
primary local ip = 192.168.43.125

MacBook-Air:~ mike$

The remot3.it daemon on the target device MacBook-Air then performs a “sign in” exchange with the remot3.it servers. The exchange is performed first to a remot3.it front-end server, fel.yoics.net, then after a re-direct to remot3.it server yoics-ds-2013-1.inetuhosted.net. The “sign in” exchange is shown in lines 1-58 of the ladder diagram and packets 32-93 (remember not all packets, such as DNS etc. are shown). Line 52 in the ladder diagram shows the last remot3.it (IDENTIFICATION_MESSAGE) in the initial start-up exchange of information:

TABLE 14

| | | | |
|---|---|---|---|
| \|46.978211\| | (IDENTIFICATION_MESS | \| | \| |

| | |
|---|---|
| \| | \|CHAT: (IDENTIFICATION_MESSAGE) |

This rung in the ladder corresponds to DEBUG packet 90 and REAL packet 91 (both total length 130) in the packet trace:

TABLE 15

| | | | | |
|---|---|---|---|---|
| 90 46.978211 | MacBook-Air | 255.255.255.255 | CHAT | 130 |

| | |
|---|---|
| (IDENTIFICATION_MESSAGE) | 3 |

| | | |
|---|---|---|
| 91 46.978266 | MacBook-Air | yoics-ds-2013-1.inetuhosted.net UDP |

130 53973 → 5965 Len=88

The next remot3.it (ACK_MESSAGE) packet from remot3.it server yoics-ds-2013-1.inetuhosted.net to target device MacBook-Air is at line 58 in the ladder diagram:

TABLE 16

| | | | |
|---|---|---|---|
| \|47.112264\| | (ACK_MESSAGE) | \| | \| |

| | |
|---|---|
| \| | \|CHAT: (ACK_MESSAGE) |

This (ACK_MESSAGE) packet marks the completion of “sign in” and the remot3.it software goes into an “idle” mode waiting for a connection to be made. Keepalive packets will be sent in such an “idle” mode, for example. Note that there may be more than one type of “keepalive” packet in the remot3.it system. The keepalive packet for the CHAT protocol may, for example, be also be called a ping message. This (ACK_MESSAGE) packet rung in the ladder corresponds to DEBUG packet 92 and REAL packet 93 (both total length 62):

TABLE 17

| 92 47.112134 | | yoics-ds-2013-1.inetuhosted.net MacBook-Air |
|---|---|---|
| UDP | 62 | 5965 → 53973 Len=20 |

| | | | |
|---|---|---|---|
| 93 47.112264 | MacBook-Air | 255.255.255.255 | CHAT |

| | |
|---|---|
| 62 | (ACK_MESSAGE) 4 |

The Weaved iOS app is started on the iPhone, which is the initiating device. At this point remot3.it authentication is performed as we use the remot3.it/Weaved iOS app to login to a remot3.it account with appropriate and corresponding remot3.it credentials. In this case we use a remot3.it login account name and a password. In other cases, we can use OAuth or any multi-factor authentication, for example. The connection attempt starts with a (INITIATE_P2P_MESSAGE) on Line 66 (from this point on we will include less detail now that you should be more familiar with using both the ladder diagram and packet trace):

TABLE 18

| | | | |
|---|---|---|---|
| \|47.903012\| | (INITIATE_P2P_MESSAG | \| | \| |

| | |
|---|---|
| \| | \|CHAT: (INITIATE_P2P_MESSAGE) |

The corresponding DEBUG packet is packet 97:

TABLE 19

| | | | | |
|---|---|---|---|---|
| 97 47.903012 | MacBook-Air | 255.255.255.255 | CHAT | 138 |

(INITIATE_P2P_MESSAGE) 6

The connection is made from iPhone to MacBook-Air. At lines 76-100 the (P2P_HELLO_MESSAGE) packets are exchanged, and acknowledged. We are watching the process from the target device, the MacBook-Air. From now on we will just refer to line numbers in the ladder diagram and packet numbers in the trace to show the packets corresponding to actions performed. The connection corresponds to packets 97-116.
A remot3.it tunnel is created between iPhone and MacBook-Air. See lines 114 and 116 in the ladder diagram and packets 122-125 in the packet trace. After remot3.it connection and the remot3.it tunnel setup is complete, the Weaved iOS app automatically launches a terminal client on the iPhone. In this case, Weaved has partnered with ServerAuditor to automatically launch the ServerAuditor iOS terminal program, Termius. As far as the iPhone is concerned, the iPhone connects to a remot3.it proxy server with address such as proxy19.weaved.com and a random port, such as 53973. The remot3.it proxy address and port, as well as the login name, are automatically passed from the Weaved app to the iPhone terminal client via a launch URL. We then see the ssh login prompt for the MacBook-Air appear on the iPhone inside the Termius iOS app. If we were using a web service to connect to a web server, then Safari would automatically be launched on the iPhone. Any service can be programmed to automatically launch the correct application (Safari, VNC, etc.).
Data is exchanged between iPhone terminal app, Termius and the target device MacBook-Air. We login to the MacBook-Air account with a password. The remot3.it (TUNNEL_DATA_MESSAGE) packets carry the data and (TUNNEL_ACK_MESSAGE) acknowledge and control flow. Packets 126-477.
I then performed an “ls” command. This is the reason there are so many data packets in this exchange.
We type “exit” at the MacBook-Air system prompt and the Termius app on the iPhone closes. The remot3.it tunnel between MacBook-Air and iPhone is closed.
A (TUNNEL_DESTROY_MESSAGE) is sent as packet 478.
We send a stop signal to the daemon on the MacBook-Air (using a script Weavedssh22.sh) and the connection is closed and the daemon is gracefully shut-down.
Packet 501. Finally, a (LOGOUT_MESSAGE), packet 507, tells the remot3.it server that the daemon on the MacBook-Air is shutting down.

TABLE 20

MacBook-Air:~ mike$ sudo /usr/local/bin/Weavedssh22.sh stop
Stopping Weavedssh22...

MacBook-Air:~ mike$

### Appendix 1A: an Example Remot3.it Configuration File

This is the remot3.it configuration file used for the target device, MacBook-Air, the laptop (the UID uniquely identifies this device and service to the remot3.it server):

TABLE 21
MacBook-Air:~ mike$ cat /etc/weaved/services/Weavedssh22.conf
#begin <do not modify section> of weaved provisioning file.
4E17A60E-7C0A-71EC-3377-2C0986E1119C
1
f+0FolYYmYq2Ij2LzPgkfcsIMHA=
-----BEGIN CONFIG-----
3QBAa/rrkPsLC4+CmznmB9Zei+YPuymBhmAZ/nJRSaswtP1HnHG1EskVmITxEsOO
ZPZSG+s8Rk6C8auWJw+fUq+lB7WHRR6xRgfxzBqVHEpephrGXiiRR257FOockb3H
2Y62hI5vjUDE7BTYTbvaboh9c2+DbFY5JrBstNNiJPydvDDgQBaZFcwTpNSjpayQ
b5PMWBvrC8A3r3uOtsXwmuLTcTCSebetbFIFvbUE4mJ1Lej3Tvz9PVlNw4PzWs4x
paWZAAy1mh6EVDCkqNRILYayfgPKSw3D7ilAxmWVf22k0qmF7Hr2x0MtUoVMH442
Bd0R1Bo67z5+/GOCyzhZbtVryssHX/PlZ7cYk9S84y1Ts6BKdV9SYKMfN+hcoQkN
aTcoza/m9+kAea0S1c99zlSSt0ZNrtStw/IfbdKnz6+mKXLfM9Bs+W+hkgcmTWBv
ARjQgWk/uO1iKp/qRv9geaz3R9HhTYHBzkXBjUMS9RmoZLe2G8wDAasVSz8jGWxE
T7Gbw6KN9Of499z5
-----END CONFIG-----
#end <do not modify section> custom configurations after this line>
#note <you must remove all the lines below to copy this enablement to another
device>
# server retrieved UID
UID 80:00:00:05:46:02:50:54
# password - erase this line to unregister the device
password 4B0823BF4601F1384276C0FCDEDD9C36CC22FE8D
MacBook-Air:~ mike$

In one embodiment, the remot3.it system may use one or more configuration files, command-line options, combinations of these and/or other configuration means, options, etc.

### Summary

In this section, we have described what remot3.it is, what remot3.it does, and how a remot3.it proxy connection is established by remot3.it. The proxy connection example connected a MacBook laptop behind a Verizon phone to an ATT iPhone. We explained how we can use a special version of the remot3.it software to capture and see the remot3.it packets. We showed an example Wireshark ladder diagram and Wireshark packet trace corresponding to establishing an encrypted remot3.it proxy UDP tunnel that carried an ssh connection.

We described the features, appearance, and details of the ladder diagrams and packet traces using the special remot3.it software. In particular, we explained the use of both DEBUG and REAL remot3.it packets in the ladder diagrams and packet traces. In future sections, armed with this knowledge of the more detailed view of remot3.it communications and the remot3.it protocols, we can show the workings of more complex connection types. For example, we can show how remot3.it uses a failover mechanism to a proxy connection if a P2P connection fails. We can show how a “reverse proxy” connection can be made. We can show how the port prediction algorithms are used to traverse networks with complex NAT networks.

### The Remot3.it Packet Structures

What is remot3.it? remot3.it allows any device to communicate with any other device on the Internet, no matter what the network looks like or where the devices may be located. This section provides a basic overview of the remot3.it packet structures that allow devices to communicate using remot3.it.

The examples of remot3.it packets shown in this section are the same packets from the same example remot3.it connections used in the section, “How remot3.it makes connections”.

In one embodiment, the remot3.it packets are described in this section and may be divided into two categories:
Packets used for server to a device (or to a client) communications that we will shorten to just server communications in this section. Note that the term server communications as used here refers to communications between a device and a server.
Packets used for peer-peer (P2P, or device-to-device) communications that we will call tunnel or P2P communications (or sometimes just P2P) in this section.

In one embodiment, the remot3.it server communications use a nested protocol (also known as a chained protocol). In one embodiment, the server communications nested protocol uses an outer remot3.it CHAT protocol (often shortened to just CHAT) with a remot3.it CHAT packet header and a nested inner remot3.it type-length-value (TLV) protocol, which we call a remot3.it TLV protocol here (sometimes just shortened to TLV). In one embodiment, the remot3.it system may use a CHAT protocol, other similar TLV protocol, or any tytpe, form, structure of protocol, combinations of these etc. In one embodiment, the remot3.it system may use a chained protocol, a nested protocol, or any hierarchical combination of protocols, etc. In one embodiment, the remot3.it system may use chained etc. protocols of any level (e.g. multiple nested protocols, nested protocols within nested protocls, etc.).

In one embodiment, the remot3.it P2P communications use the outer remot3.it CHAT protocol with a remot3.it CHAT packet header and a P2P data payload (which may also be thought of as a tunnel containing tunneled data). In one embodiment, the remot3.it system may use any combination of tunneled, netsted, chained, or other similar combinations of protocols etc.

We will start by describing the outer remot3.it CHAT protocol and packet structure used for both server communications and P2P communications. We will then describe the TLV inner protocol and packet structures as well as the TLV data types used for server communications. We will examine in detail an example of a remot3.it server communications packet that uses the TLV protocol. We will then examine the P2P communications protocol and packet structure using a detailed P2P communications packet example.

### Packet Structure for the Remot3.it CHAT Protocol

The remot3.it CHAT protocol packet structure is shown in FIG. Y5-4.

The remot3.it CHAT protocol packet structure of FIG. Y5-4 shows the outer remot3.it CHAT protocol packet header and remot3.it CHAT data payload. The CHAT packet header contains the CHAT Packet Type and CHAT Source. The CHAT packet header is followed by CHAT Data that may be one or more remot3.it TLV elements or P2P (tunnel) packet data in the data payload.

In one embodiment, with a few exceptions, the remot3.it packet fields are network byte order (NBO). However, remot3.it is architected to handle a wide variety of embedded systems, some of which may use various byte ordering. For example, remot3.it runs on some little-endian systems that use big-endian software. In some cases, remot3.it network data that would normally be NBO is handled in remot3.it data packets as LE. Those fields that are exceptions to NBO are marked here as (LE). In various embodiments, the packet fields, data, information, flags, options, or any data, information, etc. may be in network order, network byte order, little endian order, big endian order, or in any order, using any orientation, packaging, convention, arrangement, encoding, combinations of these and the like, etc. In one embodiment, the remot3.it system may translate, change, modify, configure, alter, or otherwise manipulate one or more packet fields, other fields, data, etc. For example, the remot3.it system may translate from little-endian or big-endian, vice versa, and/or perform any similar translation etc. In one embodiment, the remot3.it system may translate from different network byte ordering conventions. In one embodiment, the remot3.it system may use combinations of different network byte ordering conventions within a packet.

We need to add some more fields to the above CHAT protocol packet in order to support encryption, and these extra fields will be shown presently using a server communications packet as an example.

### Packet Structure for the Remot3.it TLV Protocol

In one embodiment, the packet structure of the remot3.it TLV (type-length-value) element used for (device to) server communications is shown in FIG. Y5-5.

In one embodiment, the remot3.it TLV protocol and packet structure is used by the inner remot3.it protocol for remot3.it server communications. The combination of Data Type, Length, and Value is called a TLV element here. The CHAT data in a remot3.it CHAT packet may contain multiple copies of this TLV packet structure and thus contain multiple TLV elements in one server communications CHAT packet.

In one embodiment, the Data Type is a binary code, with character or string equivalent names, that indicates the kind of field that this part of the packet or TLV element represents. Thus, data type with binary code 0x02 or character representation of NONCE may indicate a TLV element that contains a random number nonce. A complete list of data types used by a device for remot3.it server communications is given below. In one embodiment, the Length is the size of the value field (which is typically, as in remot3.it, in bytes). In one embodiment, the Value is a variable-sized series of bytes that contain data for this element or part of the message. In other embodiments, the packet structure may be TLV or of any format, protocol, or structure and the like, etc.

Some advantages of using a TLV protocol for remot3.it server communications include:
TLV elements and sequences of TLV elements in packets are easily parsed (and searched if required) using simple and generalized parsing functions.
New packet formats with new TLV elements that may contain new data types and that are received at an older node (device or even server) supporting older protocol versions can be safely skipped and the rest of the packet may still be parsed without changing code.
TLV elements can be placed in any order inside the packet.
TLV elements may use a binary format that may make parsing packets faster and the packets smaller.

### Packet Structure for Remot3.it Server Communications Protocol

An example remot3.it server communications packet format with a sequence of two TLV elements is shown in FIG. Y5-6.

The remot3.it server communications example packet structure in FIG. Y5-6 shows the outer remot3.it protocol with a remot3.it packet header and remot3.it data payload. The packet header contains the Packet Type and Source followed by one or more TLV elements in the TLV data payload. Two or more TLV elements in a packet form a TLV sequence.

The packet structure in in FIG. Y5-6 also shows the inner remot3.it protocol used for server communications. The repeated TLV elements in this packet structure allow for protocol extensions, updates and new remot3.it protocol versions as more data types may easily added to the protocol while maintaining backward compatibility. The repeated TLV elements and structure also allows for simple stream packet processing by any device, including embedded systems and embedded devices that may have limited processing capability and/or limited memory. All remot3.it P2P communications may also use the same outer remot3.it protocol with the same remot3.it packet header and data payload shown above, but may use a different inner protocol (or none). Examples of server communications packets as well as the P2P communications packet structures will be shown in much greater detail in the following sections. In various embodiments, any combination of protocols, nested protocols, chained protocols, inner protocols, outer protocols, combinations of these and the like may be used.

### Packet Structure for UDP Encapsulated Remot3.it Protocol

FIG. Y5-7 shows an example remot3.it server communications packet format encapsulated in UDP (showing a server communications packet type that includes two data types and thus a sequence of two TLV elements).

The remot3.it packets described in this section are encapsulated in UDP, but remot3.it was architected so that it is also possible to encapsulate remot3.it packets in TCP (or any similar transport layer protocol). For simplicity, only remot3.it operation using UDP encapsulation is described in this section. In various embodiments, UDP, TCP, or any protocol, communications method and the like may be used for connection, encapsulation, tunneling, combinations of these methods and the like, etc.

The example remot3.it packet structure in FIG. Y5-7 shows the nested remot3.it protocol used for server communications. The example remot3.it packet shows both the outer remot3.it protocol with a remot3.it packet header and a nested inner remot3.it TLV protocol.

We still have not shown all the possible fields in a remot3.it packet (for example, we have not yet shown the fields that handle encryption), but further examples in the following sections show how such additional fields may be added to the basic remot3.it packet shown above. In various embodiments, different fields, packet fields, etc. (e.g. one or more additional fierlds, one or more modified fields, or one or more fewer fields, etc.) may be used. In one embodiment, the remot3.it system may use one or more features, functions, methods, algorithms, systems and the like that are implemented, function as described by one or more packet traces, packet examples that may be shown, included, etc. in the description but that may not necessarily be described in detail in the description text.

### The Remot3.it Server Communications Packets by Example

An example remot3.it server communications packet format is shown in FIG. Y5-9. This packet illustrates the extra CHAT protocol header fields used for encryption. These fields are common to all remot3.it CHAT protocol packets. This particular packet is a request authorization, with packet type of 0x01 or REQ_AUTH_MSG (and containing three TLV elements with data types: Client UID, remot3.it ID, and Address, plus the 0x00 end-of-packet data type).

The remot3.it packet shown in FIG. Y5-9 is identical in format to a packet shown in the section, “How remot3.it makes connections”. The packet format in FIG. Y5-9 occurs in the packet received at time=0.122795 seconds, and is the packet 3 in the message flow exchange shown in the ladder diagram in the section, “How remot3.it makes connections”. We will use packet 3 as an example that we will examine down to the bit level in the following sections.

If you are reading the description carefully, you might notice the packet type in the section, “How remot3.it makes connections” that is shown in detail above is shown as REQUEST_AUTH_MESSAGE rather than REQ_AUTH_MSG as used here in this section. The packets and packet types are in fact identical, but the shortened name of REQ_AUTH_MSG is simply a convenience used in the above diagram (and also elsewhere, for example in some Wireshark packet traces) simply because the shorter packet type description “fits” better in the packet diagrams and packet traces. In fact, we used a different Wireshark dissector for the packet-level dissection (as shown here in this section) and the message flow dissection shown in the section, “How remot3.it makes connections”. Again, though, the actual packets (as captured on the wire) used in other sections are identical. As explained in the section, “How remot3.it makes connections”. because the remot3.it packets captured on the wire would normally be encrypted, special software was used to capture the packets shown in this section. We will explain the method used to capture the contents of the packets shown here in more detail in the following sections. Next we will look at a Wireshark trace of the above packet.

TABLE 22
Wireshark trace for packet 3, a remot3.it REQ_AUTH_MSG (line numbers added).

| | | | | | |
|---|---|---|---|---|---|
| 1. | No. | Time | Source | Destination | Protocol Length |

| | |
|---|---|
| Info | MessageType |

| | | | | |
|---|---|---|---|---|
| 2. | 3 | 0.122795 | 10.0.1.29 | yoics-ds-2013-1.inetuhosted.net CHAT |

| | |
|---|---|
| 93 | 33013 → 5963 Len=51 |

| 3. | Frame 3: 93 bytes on wire (744 bits), 93 bytes captured (744 bits) on | | | | | | | | | | | | | | | | | |
|---|---|---|---|---|---|---|---|---|---|---|---|---|---|---|---|---|---|---|
| | interface 0 | | | | | | | | | | | | | | | | | |
| 4. | Interface id: 0 (unknown) | | | | | | | | | | | | | | | | | |
| 5. | Encapsulation type: Ethernet (1) | | | | | | | | | | | | | | | | | |
| 6. | Arrival Time: Feb 11, 2017 10:50:08.199822000 PST | | | | | | | | | | | | | | | | | |
| 7. | [Time shift for this packet: 0.000000000 seconds] | | | | | | | | | | | | | | | | | |
| 8. | Epoch Time: 1486839008.199822000 seconds | | | | | | | | | | | | | | | | | |
| 9. | [Time delta from previous captured frame: 0.000109000 seconds] | | | | | | | | | | | | | | | | | |
| 10. | [Time delta from previous displayed frame: 0.000109000 seconds] | | | | | | | | | | | | | | | | | |
| 11. | [Time since reference or first frame: 0.122795000 seconds] | | | | | | | | | | | | | | | | | |
| 12. | Frame Number: 3 | | | | | | | | | | | | | | | | | |
| 13. | Frame Length: 93 bytes (744 bits) | | | | | | | | | | | | | | | | | |
| 14. | Capture Length: 93 bytes (744 bits) | | | | | | | | | | | | | | | | | |
| 15. | [Frame is marked: False] | | | | | | | | | | | | | | | | | |
| 16. | [Frame is ignored: False] | | | | | | | | | | | | | | | | | |
| 17. | [Protocols in frame: eth:ethertype:ip:udp:chat] | | | | | | | | | | | | | | | | | |
| 18. | [Coloring Rule Name: UDP] | | | | | | | | | | | | | | | | | |
| 19. | [Coloring Rule String: udp] | | | | | | | | | | | | | | | | | |
| 20. | Ethernet II, Src: Apple_01:30:b2 (2c:f0:ee:01:30:b2), Dst: Broadcast | | | | | | | | | | | | | | | | | |
| | (ff:ff:ff:ff:ff:ff) | | | | | | | | | | | | | | | | | |
| 21. | Destination: Broadcast (ff:ff:ff:ff:ff:ff) | | | | | | | | | | | | | | | | | |
| 22. | Address: Broadcast (ff:ff:ff:ff:ff:ff) | | | | | | | | | | | | | | | | | |
| 23. | .... ..1. .... .... .... .... = LG bit: Locally administered address (this | | | | | | | | | | | | | | | | | |
| | is NOT the factory default) | | | | | | | | | | | | | | | | | |
| 24. | .... ...1 .... .... .... .... = IG bit: Group address | | | | | | | | | | | | | | | | | |
| | (multicast/broadcast) | | | | | | | | | | | | | | | | | |
| 25. | Source: Apple_01:30:b2 (2c:f0:ee:01:30:b2) | | | | | | | | | | | | | | | | | |
| 26. | Address: Apple_01:30:b2 (2c:f0:ee:01:30:b2) | | | | | | | | | | | | | | | | | |
| 27. | .... ..0. .... .... .... .... = LG bit: Globally unique address (factory | | | | | | | | | | | | | | | | | |
| | default) | | | | | | | | | | | | | | | | | |
| 28. | .... ...0 .... .... .... .... = IG bit: Individual address (unicast) | | | | | | | | | | | | | | | | | |
| 29. | Type: IPv4 (0x0800) | | | | | | | | | | | | | | | | | |
| 30. | Internet Protocol Version 4, Src: 10.0.1.29 (10.0.1.29), Dst: yoics-ds- | | | | | | | | | | | | | | | | | |
| | 2013-1.inetuhosted.net (209.235.201.53) | | | | | | | | | | | | | | | | | |
| 31. | 0100 .... = Version: 4 | | | | | | | | | | | | | | | | | |
| 32. | .... 0101 = Header Length: 20 bytes (5) | | | | | | | | | | | | | | | | | |
| 33. | Differentiated Services Field: 0x00 (DSCP: CS0, ECN: Not-ECT) | | | | | | | | | | | | | | | | | |
| 34. | 0000 00.. = Differentiated Services Codepoint: Default (0) | | | | | | | | | | | | | | | | | |
| 35. | .... ..00 = Explicit Congestion Notification: Not ECN-Capable Transport | | | | | | | | | | | | | | | | | |
| | (0) | | | | | | | | | | | | | | | | | |
| 36. | Total Length: 79 | | | | | | | | | | | | | | | | | |
| 37. | Identification: 0xbd8e (48526) | | | | | | | | | | | | | | | | | |
| 38. | Flags: 0x00 | | | | | | | | | | | | | | | | | |
| 39. | 0... .... = Reserved bit: Not set | | | | | | | | | | | | | | | | | |
| 40. | .0.. .... = Don't fragment: Not set | | | | | | | | | | | | | | | | | |
| 41. | ..0. .... = More fragments: Not set | | | | | | | | | | | | | | | | | |
| 42. | Fragment offset: 0 | | | | | | | | | | | | | | | | | |
| 43. | Time to live: 64 | | | | | | | | | | | | | | | | | |
| 44. | Protocol: UDP (17) | | | | | | | | | | | | | | | | | |
| 45. | Header checksum: 0x16d2 [correct] | | | | | | | | | | | | | | | | | |
| 46. | [Header checksum status: Good] | | | | | | | | | | | | | | | | | |
| 47. | [Calculated Checksum: 0x16d2] | | | | | | | | | | | | | | | | | |
| 48. | Source: 10.0.1.29 (10.0.1.29) | | | | | | | | | | | | | | | | | |
| 49. | Destination: yoics-ds-2013-1.inetuhosted.net (209.235.201.53) | | | | | | | | | | | | | | | | | |
| 50. | [Source GeoIP: Unknown] | | | | | | | | | | | | | | | | | |
| 51. | [Destination GeoIP: Unknown] | | | | | | | | | | | | | | | | | |
| 52. | User Datagram Protocol, Src Port: 33013, Dst Port: 5963 | | | | | | | | | | | | | | | | | |
| 53. | Source Port: 33013 | | | | | | | | | | | | | | | | | |
| 54. | Destination Port: 5963 | | | | | | | | | | | | | | | | | |
| 55. | Length: 59 | | | | | | | | | | | | | | | | | |
| 56. | Checksum: 0xc70c [correct] | | | | | | | | | | | | | | | | | |
| 57. | [Calculated Checksum: 0xc70c] | | | | | | | | | | | | | | | | | |
| 58. | [Checksum Status: Good] | | | | | | | | | | | | | | | | | |
| 59. | [Stream index: 1] | | | | | | | | | | | | | | | | | |
| 60. | CHAT Protocol Data | | | | | | | | | | | | | | | | | |
| 61. | SPI (zero for Authorization): 0x00000000 | | | | | | | | | | | | | | | | | |
| 62. | Salt (zero for Authorization): 0x00000000 | | | | | | | | | | | | | | | | | |
| 63. | Packet Type: 0x0001 | | | | | | | | | | | | | | | | | |
| 64. | Source (zero for Server to Client): 0x0000 | | | | | | | | | | | | | | | | | |
| 65. | Data Type: 0x01 | | | | | | | | | | | | | | | | | |
| 66. | Length: 8 | | | | | | | | | | | | | | | | | |
| 67. | 8 byte UID: 0xf3e5549f0607ab37 | | | | | | | | | | | | | | | | | |
| 68. | Data Type: 0x20 | | | | | | | | | | | | | | | | | |
| 69. | Length: 17 | | | | | | | | | | | | | | | | | |
| 70. | ID: jsmith@weaved.com | | | | | | | | | | | | | | | | | |
| 71. | Data Type: 0x07 | | | | | | | | | | | | | | | | | |
| 72. | Length: 6 | | | | | | | | | | | | | | | | | |
| 73. | Last Server IP Address: yoics-ds-2013-1.inetuhosted.net (209.235.201.53) | | | | | | | | | | | | | | | | | |
| 74. | Last Server Port: 5963 | | | | | | | | | | | | | | | | | |
| 75. | Data Type: 0x00 | | | | | | | | | | | | | | | | | |
| 76. | Length: 0 | | | | | | | | | | | | | | | | | |
| 77. | 0000 | ff | ff | ff | ff | ff | ff | 2c | f0 | ee | 01 | 30 | b2 | 08 | 00 | 45 | 00 | ......,...0...E. |
| 78. | 0010 | 00 | 4f | bd | 8e | 00 | 00 | 40 | 11 | 16 | d2 | 0a | 00 | 01 | 1d | d1 | eb | .O....@......... |
| 79. | 0020 | c9 | 35 | 80 | f5 | 17 | 4b | 00 | 3b | c7 | 0c | 00 | 00 | 00 | 00 | 00 | 00 | .5...K.;........ |
| 80. | 0030 | 00 | 00 | 00 | 01 | 00 | 00 | 01 | 08 | f3 | e5 | 54 | 9f | 06 | 07 | ab | 37 | ..........T....7 |
| 81. | 0040 | 20 | 11 | 6d | 73 | 6d | 69 | 74 | 68 | 40 | 77 | 65 | 61 | 76 | 65 | 64 | 2e | .jsmith@weaved. |
| 82. | 0050 | 63 | 6f | 6d | 07 | 06 | d1 | eb | c9 | 35 | 4b | 17 | 00 | 00 | | | | com.....5K... |

The following table shows important information by line number in the above Wireshark trace for the example remot3.it CHAT REQ_AUTH_MSG packet.

TABLE 23

| Line | Comment |
|---|---|
| 2 | Packet No. = 3 |
| | Time = 0.122795 (seconds) |
| | Source = 10.0.1.29 (device, my laptop) |
| | Destination = yoics-ds-2013-1.inetuhosted.net (remot3.it server) |
| | Protocol = CHAT (remot3.it) |
| | (Frame) Length = 93 (bytes on the wire) = 14 (Ethernet II) + 20 |
| | (IPv4) + 59 (UDP) |
| | 33013 → 5963 |
| | (CHAT Data) Len = 51 |
| 21 | Destination: Broadcast (ff:ff:ff:ff:ff:ff). See below. |
| 22 | Address: Broadcast (ff:ff:ff:ff:ff:ff). See below. |
| 25 | Source: Apple_01:30:b2 (2c:f0:ee:01:30:b2). See below. |
| 26 | Address: Apple_01:30:b2 (2c:f0:ee:01:30:b2). See below. |
| 44 | Protocol: UDP (17) |
| 49 | Destination: yoics-ds-2013-1.inetuhosted.net (209.235.201.53) |
| 52 | User Datagram Protocol, Src Port: 33013, Dst Port: 5963 |
| 55 | (UDP) Length: 59 |
| | (Length = 8 (UDP header) + 51 (UDP data = CHAT packet) |
| 60 | CHAT Protocol Data |
| | (Length = 51 = 4 + 4 + 2 + 2 + 1 + 1 + 8 + 1 + 1 + 17 + 1 + |
| | 1 + 6 + 1 + 1 + 0) |
| 61 | SPI (zero for Authorization): 0x00000000 |
| 62 | Salt (zero for Authorization): 0x00000000 |
| 63 | Packet Type: 0x0001 |
| 64 | Source (zero for Server to Client): 0x0000 |
| 65 | Data Type: 0x01 |
| 66 | Length: 8 |
| 67 | 8 byte UID: 0xf3e5549f0607ab37 |
| 68 | Data Type: 0x20 |
| 69 | Length: 17 |
| 70 | ID: jsmith@weaved.com |
| 71 | Data Type: 0x07 |
| 72 | Length: 6 |
| 73 | Last Server IP Address: yoics-ds-2013-1.inetuhosted.net |
| | (209.235.201.53) |
| 74 | Last Server Port: 5963 |
| 75 | Data Type: 0x00 |
| 76 | Length: 0 |

You can see that this Wireshark trace corresponds exactly with the fields and lengths of the packet format diagrams for the example remot3.it CHAT REQ_AUTH_MSG packet. We can now explain how these packets were captured with Wireshark.

### Wireshark Capture of Remot3.it Packets

The packets in this section was captured directly by Wireshark on the originating client (a home laptop) using a special instrumented version of the remot3.it software. The remot3.it network traffic is encrypted and thus the data, packet types, messages and packet flow cannot normally be seen by Wireshark or any packet inspection techniques.

The originating client local address is 10.0.1.29 (the laptop at home). Two remot3.it servers are involved in the connection process: a remot3.it front-end server and a remot3.it chat sever. The remot3.it front-end server address is 174.36.235.146. The remot3.it chat sever address is 209.235.201.53 and it is this chat server that we see in the above packet trace.

The target device external IP address is 73.15.2.31 (a RaspberryPi at the office behind a NAT router) on UDP port 55438. This is the IP address of the NAT router and the external IP address of the RaspberryPi. Since the packet traces were generated by Wireshark on the originating client (the home laptop) there is no way for Wireshark to know the internal IP address of the RaspberryPi. Only remot3.it knows the RaspberryPi internal IP address which is 10.0.0.123. In a later Wireshark packet trace, we will see the target device external IP address of 73.15.2.31.

Notice that the remot3.it chat server (at 209.235.201.53) traffic is shown in the above trace on UDP port number 5963, and later, when we are connected, we will see the RaspberryPi (with external address 73.15.2.31) is connected on UDP port number 55438.

You may have noticed that we called the originating device (the laptop) the originating client. That is because we are initiating the remot3.it connection as a remot3.it user and we authenticate with remot3.it using a remot3.it login. This login string appears in the remot3.it CHAT REQ_AUTH_MSG packet that is shown above. If the device itself were originating the connection, we call the originator the originating device (rather than originating client). Note that remot3.it can perform a direct device to device connection and in that case, we would have a true device to device connection without a user login involved. The RaspberryPi at the office is called the target device and we will see that appear presently.

Now we can explain lines 21 and 22 (as well as 25 and 26) in the above Wireshark packet trace. You will notice that in the Ethernet II frame, the source MAC address (lines 25 and 26, Wireshark outputs both) is the laptop (Wi-Fi on en0):

TABLE 24
MacBook-Air:~ mike$ ifconfig
...
en0: flags=8863<UP,BROADCAST,SMART,RUNNING,SIMPLEX,MULTICAST> mtu 1500

ether 2c:f0:ee:01:30:b2

...

The destination MAC address (lines 21 and 22) is the broadcast address ff:ff:ff:ff:ff:ff. The special version of the remot3.it device software running on the laptop has extra code to re-transmit all received and transmitted remot3.it CHAT protocol packets. The server communications packets are transmitted via UDP on ports 63000 (Rx) and 63001 (Tx). The P2P communications packets are transmitted via UDP on ports 63002 (Rx) and 63003 (Tx). All packets are sent or relayed to the broadcast address so that they are easy to capture. A Wireshark packet trace is then post-processed to match the “real” encrypted CHAT protocol packets with the corresponding “relayed” unencrypted packets. The “real” source and destination IP address and ports are then inserted into the “relayed” packets (along with checksum correction etc.). The one thing we did not change was the broadcast MAC address. This way, we can always tell which packets are “real” and which come from “relayed” packets.

In the section, “How remot3.it makes connections,” we explained that the initial four packets or messages in an exchange with a device are part of the authentication process used in our simple example. remot3.it is flexible in how authentication is performed. In our simple connection example, the messages such as the third packet or message, REQUEST_AUTH_MESSAGE, are the remot3.it CHAT protocol messages that are contained within UDP datagrams that perform authentication. In one embodiment, the remot3.it system may use any authentication flow, process, algorithm, exchange, packet sequence, connection flow, etc. In one embodiment, the remot3.it system may use any authorization flow, process, algorithm, exchange, packet sequence, connection flow, etc.

The first four packets in the connection flow are all involved with authorization (and thus labelled AU below) and are as follows:
(REQUEST_AUTH_MESSAGE) AU: The first four messages starting with this one, and including this message, are a simple example of secure authentication; and these four datagrams are flagged as “AU”. This is a message from the laptop to the remot3.it front-end server that we are a remot3.it user, and containing a one-time generated originating client UID that will be used to identify this connection session, and the last-connected IP address and port.
(RESPONSE_AUTH_MESSAGE) AU: A re-direct to the remot3.it chat sever IP address and port, also contains the NAT mapped IP address and port as seen by the remot3.it front-end server.
(REQUEST_AUTH_MESSAGE) AU: Same as first REQUEST_AUTH_MESSAGE message but re-directed to the remot3.it chat sever IP address and port.
(RESPONSE_AUTH_MESSAGE) AU: A message from the remot3.it front-end server to the laptop. Contains: originating client UID, a nonce (one-time random number), the encryption type to use, login salt (seed added to data before encryption), and also the NAT mapped IP address and port as seen as by the remot3.it chat server. The NAT mapped IP address and port as seen by the remot3.it front-end server together with the NAT mapped IP address and port as seen as by the remot3.it chat server are used by remot3.it to help determine the NAT type.

The Wireshark trace above shows the third packet in this sequence of four, which is the second REQUEST_AUTH_MESSAGE. The next sections show the packet type (for the outer remot3.it CHAT protocol) and the data types (for the inner remt3.it TLV protocol).

### Packet Structure for the Remot3.it P2P Communications Protocol

An example remot3.it P2P communications packet diagram is shown in FIG. Y5-10.

This particular packet has Packet Type 0x0032, which from the table of packet types is a TUNNEL_DATA_MSG.

Not all of the options and features of the TUNNEL_DATA_MSG are shown in FIG. Y5-10. For example, one of the additional features is an optional CRC field that may be used to provide Reliability, Availability and Serviceability (RAS) features in systems that require protection against memory faults etc. For example, an IoT device may depend on a single bit message (to turn a switch on or off for example). Enabling the CRC field protects tunnel data from corruption. There are several other similar features built in to the remot3.it P2P communications protocol. In various embodiments, support for features including, but not limited to, one or more of the following may be used: RAS, CRC, error correction, error detection, encoding, combinations of these and other similar reliability, serviceability, availability, security, data protection feaures etc. may be used. In various embodiments, such support may be applied to any type of remot3.it communications etc. including, but not limited to, P2P, proxy communications, or any communication types, combinations of types, etc.

The typical remot3.it packet types used in P2P communications are: P2P_HELLO_MSG, P2P_CONNECTED, P2P_DISCONNECTED, P2P_BW_MSG, P2P_DISCONNECT, TUNNEL_CREATE_MSG, TUNNEL_DESTROY_MSG, TUNNEL_DATA_MSG, TUNNEL_ACK_MSG, SHUTDOWN_MSG. Examples of the use of most of these remot3.it packet types are provided and explained in the section, “How remot3.it makes connections.” In various embodiments, one or more different packet types may be used in P2P communcations. In various embodiments, one or more different packet types may be used in P2P communcations, proxy connections, or any similar type of connection mechanism etc.

The remot3.it P2P communications protocol has been designed to convey or tunnel any type of data. The most common use for remot3.it is to tunnel TCP traffic (e.g. ssh, VNC, HTTP, etc.). We will examine more closely the contents and structure of a typical P2P communications packet using Wireshark shortly, but note that the remot3.it P2P packet conveys only the TCP data with no TCP header. As described above, the remot3.it P2P packets contain information to allow remot3.it to perform its own functions corresponding to, for example, TCP flow control, window sizing, re-transmit etc.

In one embodiment, TCP data may be conveyed, carried, transmitted, received, tunneled, etc. with no header information. In one embodiment, any protocol data (e.g. TCP. UDP. other protocols, combinations of protocols and the like etc. may be conveyed, carried, transmitted, received, tunneled, etc. with no header information. In one embodiment, any protocol data (e.g. TCP. UDP. other protocols, combinations of protocols and the like etc. may be conveyed, carried, transmitted, received, tunneled, etc. with or without header information. In one embodiment, any protocol data (e.g. TCP. UDP. other protocols, combinations of protocols and the like etc. may be conveyed, carried, transmitted, received, tunneled, etc. with or without modified, changed, altered, configures, permuted, combinations of these modifications and the like etc. header or any other protocol, packet, field, etc. information. In one embodiment, one or more portions of the information in a protocol may be conveyed, carried, transmitted, received, tunneled, etc including but not limited to portions of one or more of the following: packets, frames, protocol data units, PDU, other packet fields, groups of fields, portions of fields, combinations of these and the like, and/or other similar information.

In one embodiment, one or more functions corresponding to one or more of the following (but not limited to the following) protocol features may be supported: flow control, window sizing, retransmission, fragmentation support, combinations of these and other similar protocol features, functions, methods, mechanisms, and the like etc.

### A Remot3.it P2P Connection Example

We will illustrate the packet structure of the remot3.it P2P communications protocol with a detailed example of a connection using ssh. The remot3.it packet shown in the previous section in FIG. Y5-10 is identical in format to a packet shown in the section, “How remot3.it makes connections.” The exact packet format shown in the previous section occurs in the packet received at time=5.532799 (seconds), and is packet number 22 in the message flow exchange shown in the ladder diagram in the section, “How remot3.it makes connections.” We will use packet 22 as an example that we will examine down to the bit level in the sections that follow.

First we will explain what packet 22 is, what it contains, and the packet structure on the wire. Then we will compare, as we did for the server communications packet, a Wireshark trace with the packet structure diagram. Finally, after our analysis is complete, we can then explain why we chose this particular packet.

The start of our example P2P connection is, in this simple example, the launch of the remot3.it software on the originating client (the laptop at 10.0.1.29).

TABLE 25
MacBook-Air:test_rpi_1 mike$ ./sshw.16.sh “pi@B2 RPi3 v1 ssh”
Weaved sshw.sh Version 0.0.9.16 Jan 4, 2017
.........P2P tunnel connected on port 33013
pi@127.0.0.1's password:

The script sshw.16.sh launches the remot3.it software with a known user (with a remot3.it login user account and a known device, a RaspberryPi, that the user owns and have rights to connect to and is known to remot3.it as the remot3.it service that is named “B2 RPi3 v1 ssh”. This service is known to remot3.it, because it was registered as a service with remot3.it, to be of type ssh and to be used for ssh connections. We have asked to be connected to the RaspberryPi as user “pi” . Notice that the script prints “P2P tunnel connected on port 33013” which means that the P2P tunnel has been established by remot3.it and now the ssh connection using that tunnel can proceed. The next command that we will see on the laptop is the password prompt “pi@127.0.0.1's password:” that comes from the ssh software on the remote RaspberryPi via ssh and tunneled over the remot3.it connection tunnel.

Notice very carefully that the ssh password prompt above appears as though the connection were to 127.0.01 or localhost. This is because to the local machine, the originating device (the laptop) the remot3.it connection is to localhost. This is because the remot3.it software on the laptop terminates the TCP connection and then passes the TCP data on to the host using a separate localhost connection. This means the host (the laptop in this case, but any device in the general case) can be completely hidden or cloaked from the outside as only localhost connections need be allowed. This is a very important feature of the remot3.it system. In one embodiment, connections may be created, established, made, attempted, completed, etc. as though to, or as, etc. localhost (e.g. using the built-in localhost, “this computer”, local loopback mechanism, loopback address, IPv4 loopback address, 127.0.0.1 or similar address, IPv6 loopback address, etc.). In one embodiment, connections may be established, created, made, completed, attempted, etc. using any address, mechanism, method, filter, etc.

In a complete remot3.it connection session there are several exchanges of TUNNEL_DATA_MESSAGE and TUNNEL_ACK_MESSAGE as ssh transfers data over the remot3.it connection. Finally, several messages would be exchanged once the connection is terminated, for example we could enter “exit” at the RaspberryPi system prompt. We are going to look at a particular message or packet that occurs in the middle of the ssh connection.

The remot3.it CHAT protocol packet 22 is a remot3.it P2P communications packet that is part of the ssh2 key exchange (KEX) process. Packet 22 contains an ssh2 type 20 SSH_MSG_KEXINIT message. First we will look at the Wireshark trace of packet 22. Next we look at the ssh2 type 20 SSH_MSG_KEXINIT message. Then we can compare what the remot3.it CHAT protocol packet looks like on the wire to what an ssh2 type 20 SSH_MSG_KEXINIT message without remot3.it looks like on the wire.

We are going to have to go through a bit of detail on what an ssh2 packet looks like. Our goal is not to understand the ssh packets, but simply to understand exactly what is inside the remot3.it packets. In order to expose the details of remot3.it for you, without hiding anything, we do need to understand what is in the remot3.it packet data, which in this case includes the ssh2 packet contents.

### The Remot3.it P2P Communications Packets by Example

The following is a Wireshark trace of packet 22, a remot3.it P2P packet (line numbers added):

TABLE 26

| | | | | | | |
|---|---|---|---|---|---|---|
| No. | Time | Source | Destination | Protocol | Length | Info |

| | | | | | |
|---|---|---|---|---|---|
| 22 | 5.532799 | c-73-15-2-31.hsd1.ca.comcast.net 10.0.1.29 | CHAT | 1014 | 55438 |

→ 33013 Len=972
Frame 22: 1014 bytes on wire (8112 bits), 1014 bytes captured (8112 bits) on
interface 0
Interface id: 0 (unknown)
Encapsulation type: Ethernet (1)
Arrival Time: Feb 11, 2017 10:50:13.609826000 PST
[Time shift for this packet: 0.000000000 seconds]
Epoch Time: 1486839013.609826000 seconds
[Time delta from previous captured frame: 0.030162000 seconds]
[Time delta from previous displayed frame: 0.030162000 seconds]
[Time since reference or first frame: 5.532799000 seconds]
Frame Number: 22
Frame Length: 1014 bytes (8112 bits)
Capture Length: 1014 bytes (8112 bits)
[Frame is marked: False]
[Frame is ignored: False]
[Protocols in frame: eth:ethertype:ip:udp:chat:data]
[Coloring Rule Name: UDP]
[Coloring Rule String: udp]
Ethernet II, Src: Apple_01:30:b2 (2c:f0:ee:01:30:b2), Dst: Broadcast
(ff:ff:ff:ff:ff:ff)
Destination: Broadcast (ff:ff:ff:ff:ff:ff)
Address: Broadcast (ff:ff:ff:ff:ff:ff)
.... ..1. .... .... .... .... = LG bit: Locally administered address (this is NOT
the factory default)
.... ...1 .... .... .... .... = IG bit: Group address (multicast/broadcast)
Source: Apple_01:30:b2 (2c:f0:ee:01:30:b2)
Address: Apple_01:30:b2 (2c:f0:ee:01:30:b2)
.... ..0. .... .... .... .... = LG bit: Globally unique address (factory default)
.... ...0 .... .... .... .... = IG bit: Individual address (unicast)
Type: IPv4 (0x0800)
Internet Protocol Version 4, Src: c-73-15-2-31.hsd1.ca.comcast.net (73.15.2.31),
Dst: 10.0.1.29 (10.0.1.29)
0100 .... = Version: 4
.... 0101 = Header Length: 20 bytes (5)
Differentiated Services Field: 0x00 (DSCP: CS0, ECN: Not-ECT)
0000 00.. = Differentiated Services Codepoint: Default (0)
.... ..00 = Explicit Congestion Notification: Not ECN-Capable Transport (0)
Total Length: 1000
Identification: 0x2085 (8325)
Flags: 0x00
0... .... = Reserved bit: Not set
.0.. .... = Don't fragment: Not set
..0. .... = More fragments: Not set
Fragment offset: 0
Time to live: 64
Protocol: UDP (17)
Header checksum: 0x0036 [correct]
[Header checksum status: Good]
[Calculated Checksum: 0x0036]
Source: c-73-15-2-31.hsd1.ca.comcast.net (73.15.2.31)
Destination: 10.0.1.29 (10.0.1.29)
[Source GeoIP: Unknown]
[Destination GeoIP: Unknown]
User Datagram Protocol, Src Port: 55438, Dst Port: 33013
Source Port: 55438
Destination Port: 33013
Length: 980
Checksum: 0xd7b8 [correct]
[Calculated Checksum: 0xd7b8]
[Checksum Status: Good]
[Stream index: 3]
Data (972 bytes)
Data: f3f01e88e7604fb10032000100020002000003b8000003b4...
[Length: 972]
CHAT Protocol Data
SPI (zero for Authorization): 0xf3f01e88
Salt (zero for Authorization): 0xe7604fb1
Packet Type: 0x0032
Source: 0x0001
Tunnel Number: 0x0002
Tunnel Data Sequence: 0x0002
Tunnel Data Subsequence: 0x0000
Tunnel Data Length: 952
Payload Data:

| | |
|---|---|
| 000003B404145BE0 | (......[.) |
| 50973A3B4FB65EDC | (P.:;O.\hat{ }.) |
| 75ADC399CAEF0000 | (u.......) |
| 0096637572766532 | (..curve2) |
| 353531392D736861 | (5519-sha) |
| 323536406C696273 | (256@libs) |
| 73682E6F72672C65 | (sh.org,e) |

[snip]

| 00156E6F6E652C7A | | | | (..none,z) | | | | | | | | | | | | | |
|---|---|---|---|---|---|---|---|---|---|---|---|---|---|---|---|---|---|
| 6C6962406F70656E | | | | (lib@open) | | | | | | | | | | | | | |
| 7373682E636F6D00 | | | | (ssh.com.) | | | | | | | | | | | | | |
| 0000000000000000 | | | | (........) | | | | | | | | | | | | | |
| 0000000000000000 | | | | (........) | | | | | | | | | | | | | |
| 0000 | ff | ff | ff | ff | ff | ff | 2c | f0 | ee | 01 | 30 | b2 | 08 | 00 | 45 | 00 | ......,...0...E. |
| 0010 | 03 | e8 | 20 | 85 | 00 | 00 | 40 | 11 | 00 | 36 | 49 | Of | 02 | 1f | 0a | 00 | .. ...@..6I..... |
| 0020 | 01 | 1d | d8 | 8e | 80 | f5 | 03 | d4 | d7 | b8 | f3 | f0 | 1e | 88 | e7 | 60 | ............... |
| 0030 | 4f | b1 | 00 | 32 | 00 | 01 | 00 | 02 | 00 | 02 | 00 | 00 | 03 | b8 | 00 | 00 | O..2............ |
| 0040 | 03 | b4 | 04 | 14 | 5b | e0 | 50 | 97 | 3a | 3b | 4f | b6 | 5e | dc | 75 | ad | ....[.P.:;O.\hat{ }.u. |
| 0050 | c3 | 99 | ca | ef | 00 | 00 | 00 | 96 | 63 | 75 | 72 | 76 | 65 | 32 | 35 | 35 | ........curve255 |
| 0060 | 31 | 39 | 2d | 73 | 68 | 61 | 32 | 35 | 36 | 40 | 6c | 69 | 62 | 73 | 73 | 68 | 19-sha256@libssh |
| 0070 | 2e | 6f | 72 | 67 | 2c | 65 | 63 | 64 | 68 | 2d | 73 | 68 | 61 | 32 | 2d | 6e | .org,ecdh-sha2-n |

[snip]

| | | | | | | | | | | | | | | | | | |
|---|---|---|---|---|---|---|---|---|---|---|---|---|---|---|---|---|---|
| 03a0 | 2d | 73 | 68 | 61 | 32 | 2d | 35 | 31 | 32 | 2c | 68 | 6d | 61 | 63 | 2d | 73 | -sha2-512,hmac-s |
| 03b0 | 68 | 61 | 31 | 00 | 00 | 00 | 15 | 6e | 6f | 6e | 65 | 2c | 7a | 6c | 69 | 62 | ha1....none,zlib |
| 03c0 | 40 | 6f | 70 | 65 | 6e | 73 | 73 | 68 | 2e | 63 | 6f | 6d | 00 | 00 | 00 | 15 | @openssh.com.... |
| 03d0 | 6e | 6f | 6e | 65 | 2c | 7a | 6c | 69 | 62 | 40 | 6f | 70 | 65 | 6e | 73 | 73 | none,zlib@openss |
| 03e0 | 68 | 2e | 63 | 6f | 6d | 00 | 00 | 00 | 00 | 00 | 00 | 00 | 00 | 00 | 00 | 00 | h.com........... |
| 03f0 | 00 | 00 | 00 | 00 | 00 | 00 | | | | | | | | | | | ...... |

This Wireshark remot3.it CHAT protocol packet trace above is packet number 22 from the section “How remot3.it makes connections.” Packet 22 is a remot3.it P2P communications packet from the middle of an ssh connection session using remot3.it. This packet is part of the key exchange process. Packet 22 contains an ssh2 type 20 SSH_MSG_KEXINIT message. From our previous examination of the example remot3.it sever communications packet containing a REQUEST_AUTH_MESSAGE, we are now familiar with the Wireshark trace of a remot3.it packet. We already know what most of the remot3.it fields are. The remot3.it packet fields that we can concentrate on now, in packet 22 above, are the remot3.it payload data in lines 73 through 85:

TABLE 27

| 000003B404145BE0 | (......[.) |
|---|---|
| 50973A3B4FB65EDC | (P.:;O.\hat{ }.) |
| 75ADC399CAEF0000 | (u.......) |
| 0096637572766532 | (..curve2) |
| 353531392D736861 | (5519-sha) |
| 323536406C696273 | (256@libs) |
| 73682E6F72672C65 | (sh.org,e) |
| [snip] | |
| 00156E6F6E652C7A | (..none,z) |
| 6C6962406F70656E | (lib@open) |
| 7373682E636F6D00 | (ssh.com.) |
| 0000000000000000 | (........) |
| 0000000000000000 | (........) |

Notice we have snipped or omitted (as shown by [snip]) some of the remot3.it data payload (the complete payload is 972 bytes) in packet 22 in order to make it easier to see and understand the remot3.it packet format for remot3.it P2P communications. We especially want to see what the data would look like if we did not use remot3.it for an ssh connection. Let's next look at what the remot3.it payload data in packet 22 represents. We need to briefly take a step aside and understand just enough of the ssh2 type 20 SSH_MSG_KEXINIT message format to see what is in the remot3.it payload data above.

An ssh Packet carried by Remot3.it

The packet format of an ssh2 packet type 20 SSH_MSG_KEXINIT is shown in FIG. Y5-11. We have also shown the first part of the remot3.it CHAT protocol P2P communications protocol payload. We have taken the first 52 bytes of the payload from packet 22 from the above Wireshark trace. We have shown these first 52 bytes of the payload on the right of the diagram below. These remot3.it payload bytes start with 0x000003B4 (which is the 32-bit SSH2 packet length) and the end of the part we are interested in is at 0x72672C65. The bytes 0x72672C65 are part of the ssh2 name-list of KEX algorithms. Hexadecimal 0x72672C65 is the 4-byte string “rg,e” (in bold below) in the middle of the KEX algorithms name-list string:

TABLE 28
debug2: KEX algorithms: curve25519-sha256@libssh.org,ecdh-sha2-nistp256,ecdh-
sha2-nistp384,ecdh-sha2-nistp521,diffie-hellman-group-exchange-sha256,diffie-
hellman-group16-sha512,diffie-hellman-group18-sha512,diffie-hellman-group-
exchange-sha1,diffie-hellman-group14-sha256,diffie-hellman-group14-sha1,ext-info-
c

This KEX algorithms name-list string is the same as shown in line 40 of the ssh key exchange log shown in Appendix 2C (also refer to FIG. Y5-11 for packet format). We have now finished our detour through the details of the ssh2 payload being carried by the remot3.it. Now we can see clearly that there is no TCP information whatsoever in the remot3.it data payload despite the fact that remot3.it is tunneling a TCP connection (in this case ssh). We can clearly see that the remot3.it data payload starts immediately with the ssh2 packet length, there is no TCP header information present as there would be if ssh connection was made without remot3.it.

The fact that remot3.it only tunnels data is another very important feature. For example, if we use remot3.it to tunnel TCP, an attacker would have to break multiple layers of encryption in a remot3.it connection to get to data. If the encryption were to be somehow broken, the data that would be uncovered is not usable. The data is not usable since there is no TCP header and thus no end-point routing information. For example, let us compare our example ssh connection carried by TCP and carried by remot3.it.

The chart in Y5-12 shows what our packet 22 (ssh2 packet type 20 SSH_MSG_KEXINIT) would look like using TCP (on the left) and using remot3.it (on the right). Note the following important differences between using TCP and using remot3.it:
First note that when using TCP all the data in this packet, including all of the ssh key exchange data, is unencrypted. Anyone can find the key exchange algorithms supported by any such exposed device. Any device that leaves ssh port 22 open on the Internet exposes or leaks such information. An attacker could collect such information (using the same technology as www.shodan.io for example). As soon as a zero-day weakness in ssh algorithms are discovered the attacker can use such fingerprint information to attack.
Using remot3.it, the entire ssh connection payload is encrypted. We were only able to see the data in the above Wireshark traces because we used a special version of the remot3.it software.
Using TCP exposes the end-point source and destination IP addresses and other information in the TCP header.
Using remot3.it the worst that can happen is exposing a NAT gateway address, the device external address, which is normally protected. The device internal address is not exposed and is known only to remot3.it.
Using TCP, if other packets are deciphered, then replay attacks, man-in-the-middle attacks, spoofing etc. are possible.
Using remot3.it, there is no information to be used for any type of replay etc. attack. The only data that can be lost even if the encryption were to be broken is the data in the packet itself.
Using TCP requires a port to be open, for example port 22 for ssh.
Using remot3.it, all ports can be closed putting the device into a “cloaked” state invisible to scanners. Only UDP ports (behind a NAT gateway) need be open for outgoing connections using remot3.it traffic.

For packet format details, refer to FIG. Y5-12.

### Summary

In this section, we showed you an example use of the remot3.it CHAT protocol to establish a connection in a simple NAT situation. The remot3.it CHAT protocol is efficient but flexible. The CHAT protocol uses packet types that have a flexible structure using several data types. The protocol was designed to make the remot3.it device software small and easy to configure for use, for example, in small embedded systems with limited processing power and low memory footprint.

In this section, we showed a remot3.it connection that performed a simple NAT traversal, but remot3.it uses a flexible, programmable engine that is programmed to handle all known NAT types and can be programmed to handle special NAT situations, including the more complex CG-NAT configurations. What we have not covered in this section was the use of remot3.it CHAT protocol messages that can be sent from server to/from each device to help with NAT traversal in difficult situations. We also did not show the packet communications used in a fallback to a proxy connection in the rare case that a remot3.it P2P connection fails. In one embodiment, a fallback, escape, default, etc. mechanism, method, feature etc. may be used to enable connection, communications, etc. to be established, made, attempted, etc. by using one or more alternative meands (e.g. proxy, P2P, combinations of these and other similar mechanisms etc.).

In the Wireshark trace that we used for the remot3.it connection examples we showed the UDP datagrams and some of the TCP data and TCP connections details (flow control and so forth), but showed that we would not see any TCP header information. This means that even if multiple layers of encryption in a remot3.it connection were to be somehow broken, the TCP data that would be uncovered is not usable since there is no header and thus no end-point routing information.

In one embodiment, the remot3.it CHAT protocol is designed to have very low overhead and includes messages that allow data usage monitoring for example. We showed and explained some but not all the details and capabilities of the protocols, packet types and data types used for these and other additional remot3.it features.

In the Wireshark traces that we used as examples we focused on the packets. We did show as part of an example ssh connection that remot3.it connections appear to be a 127.0.0.1 or localhost connection. This is as a result of the remot3.it device software terminating the TCP connection carried inside the encrypted remot3.it P2P UDP tunnel. This is a very important feature as it allows the host device to close all ports in a cloaked fashion. Only 127.0.0.1 or other localhost connections need be allowed.

In the Wireshark traces that we used to explain the remot3.it protocols and packet structures, we explained some, but not all, of the subtle features of the remot3.it system. For example, experience in real-world deployment has shown us that sending multiple datagrams with duplicate messages improves speed and reliability, but only in certain cases. We were not able to show the details of all such remot3.it features in this section.

### Appendix 2A: the Remot3.it Chat Protocol Packet Types

In one embodiment, the remot3.it CHAT protocol packet types for an endpoint device are as follows (in C code format):

TABLE 29
//
// Packet Types
//

| | | |
|---|---|---|
| #define | REQ_AUTH_MSG | 0x0001 |

| | | |
|---|---|---|
| #define | AUTH_RESPONSE_MSG | 0x0002 |

| | | |
|---|---|---|
| #define | IDENTIFICATION_MSG | 0x0003 |

| | | |
|---|---|---|
| #define | ACK_MSG | 0x0004 |
| #define | PING_MSG | 0x0005 |

| | | |
|---|---|---|
| #define | INITIATE_P2P_MSG | 0x0006 |
| #define | REQ_P2P_MSG | 0x0007 |
| #define | REQ_UNCONFIG_DEV_MSG | 0x0008 |
| #define | WRITE_CONFIGURATION | 0x0009 |
| #define | READ_CONFIGURATION | 0x000A |
| #define | LOG_OFF_SERVER | 0x000B |
| #define | REQ_ASSOCIATION | 0x000C |

| | | |
|---|---|---|
| #define | RELOGIN | 0x000D |
| #define | P2P_HELLO_MSG | 0x0020 |
| #define | P2P_CONNECTED | 0x0021 |

| | | |
|---|---|---|
| #define | P2P_DISCONNECTED | 0x0022 |
| #define | P2P_BW_MSG | 0x0023 |
| #define | P2P_DISCONNECT | 0x0024 |

| | | |
|---|---|---|
| #define | TUNNEL_CREATE_MSG | 0x0030 |

| | | |
|---|---|---|
| #define | TUNNEL_DESTROY_MSG | 0x0031 |
| #define | TUNNEL_DATA_MSG | 0x0032 |
| #define | TUNNEL_ACK_MSG | 0x0033 |

| | | |
|---|---|---|
| #define | SHUTDOWN_MSG | 0x0040 |

| | | |
|---|---|---|
| #define | SERVER_REQ_TOKEN | 0x0040 |
| #define | SERVER_REP_TOKEN | 0x0041 |
| #define | SERVER_PKT_FORWARD | 0x0050 |
| #define | MAP_REQ_MSG | 0x0051 |
| #define | MAP_REQ_RESP_MSG | 0x0052 |

| | | |
|---|---|---|
| #define | MAP_PEER_MSG | 0x0053 |
| #define | RAW_DATA_MSG | 0x0060 |

### Appendix 2B: the Remot3.it TLV Data Types

In one embodiment, the remot3.it server communications remot3.it TLV protocol data types for an endpoint device are shown below (in C code format). These data types are used for (device to) server communications.

TABLE 30

| // | | |
|---|---|---|
| // Server Communications Data Types | | |
| // | | |
| #define | NULLTYPE | 0x00 |
| #define | CLIENTUID | 0x01 |
| #define | NONCE | 0x02 |
| #define | AUTHHASH | 0x03 |
| #define | REDIRECT | 0x04 |
| #define | STUNTYPE | 0x06 |
| #define | MAPPEDADDRESS | 0x07 |

| | | |
|---|---|---|
| #define | INTERNALADDRESS | 0x08 |

| | | |
|---|---|---|
| #define | ACK | 0x09 |

| | | |
|---|---|---|
| #define | PEERUID | 0x0A |
| #define | PEERALIAS | 0x0B |
| #define | SESSIONID | 0x0C |

| | | |
|---|---|---|
| #define | CLIENT_TYPE | 0x0D |
| #define | APPLICATION_LIST | 0x0E |
| #define | ENCRYPTION_TYPE | 0x0F |

| | | |
|---|---|---|
| #define | TARGETADDRESS | 0x10 |

| | | |
|---|---|---|
| #define | SECRET_FAIL | 0x11 |
| #define | SEQUENCE_NUMBER | 0x12 |

| | | |
|---|---|---|
| #define | YOICSID | 0x20 |
| #define | SALT | 0x21 |

| | | |
|---|---|---|
| #define | SERIAL_NUM | 0x22 |
| #define | PROJECT_ID | 0x23 |

| | | |
|---|---|---|
| #define | SOURCID | 0x30 |

| | | |
|---|---|---|
| #define | MAXSESSIONPACKET | 0x31 |
| #define | MAXOUTSTANDING | 0x32 |

| | | |
|---|---|---|
| #define | SHAREDSECRET | 0x40 |
| #define | WRITE_CONFIG | 0x41 |
| #define | RESTART | 0x44 |

| | | |
|---|---|---|
| #define | TOKEN_DATA | 0x45 |
| #define | SMALL_PACKET_FWD | 0x46 |
| #define | PREDICTED_PORT | 0x47 |
| #define | SERVER_RESERVED1 | 0x48 |

| | | |
|---|---|---|
| #define | BANDWIDTH | 0x50 |
| #define | ECHO_DATA | 0x52 |

| | | |
|---|---|---|
| #define | SIDE_DATA | 0x53 |
| #define | P2P_USE_RESTRICTIONS | 0x70 |
| #define | P2P_SESSION_DURATION | 0x71 |
| #define | P2P_CONCURRENT_COUNT | 0x72 |

### Appendix 2C: an Example SSH Session Log

This ssh session log is not to the same RaspberryPi device used in the remot3.it connection example. Since the RaspberryPi used in the connection example is a remote device (at the office), there is no way to connect to this device without using remot3.it. Instead we connected locally to another RaspberryPi device and captured the ssh exchange in verbose mode. The KEX exchange (with the KEX name-list shown in line 40) is the same for both RaspberryPi devices.

TABLE 31

| | |
|---|---|
| 1. | MacBook-Air:Downloads mike$ ssh -vvv pi@10.0.1.28 |
| 2. | OpenSSH_7.3p1, LibreSSL 2.4.1 |
| 3. | debug1: Reading configuration data /etc/ssh/ssh_config |
| 4. | debug1: /etc/ssh/ssh_config line 20: Applying options for * |
| 5. | debug1: /etc/ssh/ssh_config line 56: Applying options for * |
| 6. | debug2: resolving “10.0.1.28” port 22 |
| 7. | debug2: ssh_connect_direct: needpriv 0 |
| 8. | debug1: Connecting to 10.0.1.28 [10.0.1.28] port 22. |
| 9. | debug1: Connection established. |
| 10. | debug1: identity file /Users/mike/.ssh/id_rsa type 1 |
| 11. | debug1: key_load_public: No such file or directory |
| 12. | debug1: identity file /Users/mike/.ssh/id_rsa-cert type −1 |
| 13. | debug1: key_load_public: No such file or directory |
| 14. | debug1: identity file /Users/mike/.ssh/id_dsa type −1 |
| 15. | debug1: key_load_public: No such file or directory |
| 16. | debug1: identity file /Users/mike/.ssh/id_dsa-cert type −1 |
| 17. | debug1: key_load_public: No such file or directory |
| 18. | debug1: identity file /Users/mike/.ssh/id_ecdsa type −1 |
| 19. | debug1: key_load_public: No such file or directory |
| 20. | debug1: identity file /Users/mike/.ssh/id_ecdsa-cert type −1 |
| 21. | debug1: key_load_public: No such file or directory |
| 22. | debug1: identity file /Users/mike/.ssh/id_ed25519 type −1 |
| 23. | debug1: key_load_public: No such file or directory |
| 24. | debug1: identity file /Users/mike/.ssh/id_ed25519-cert type −1 |
| 25. | debug1: Enabling compatibility mode for protocol 2.0 |
| 26. | debug1: Local version string SSH-2.0-OpenSSH_7.3 |
| 27. | debug1: Remote protocol version 2.0, remote software version |
| | OpenSSH_6.7p1 Raspbian-5+deb8u2 |
| 28. | debug1: match: OpenSSH_6.7p1 Raspbian-5+deb8u2 pat OpenSSH* compat |
| | 0x04000000 |
| 29. | debug2: fd 3 setting O_NONBLOCK |
| 30. | debug1: Authenticating to 10.0.1.28:22 as ‘pi’ |
| 31. | debug3: hostkeys_foreach: reading file “/Users/mike/.ssh/known_hosts” |
| 32. | debug3: record_hostkey: found key type ECDSA in file |
| | /Users/mike/.ssh/known_hosts:476 |
| 33. | debug3: load_hostkeys: loaded 1 keys from 10.0.1.28 |
| 34. | debug3: order_hostkeyalgs: prefer hostkeyalgs: ecdsa-sha2-nistp256- |
| | cert-v01@openssh.com, ecdsa-sha2-nistp384-cert-v01@openssh.com,ecdsa- |
| | sha2-nistp521-cert-v01@openssh.com,ecdsa-sha2-nistp256,ecdsa-sha2- |
| | nistp384,ecdsa-sha2-nistp521 |
| 35. | debug3: send packet: type 20 |
| 36. | debug1: SSH2_MSG_KEXINIT sent |
| 37. | debug3: receive packet: type 20 |
| 38. | debug1: SSH2_MSG_KEXINIT received |
| 39. | debug2: local client KEXINIT proposal |
| 40. | debug2: KEX algorithms: curve25519-sha256@libssh.org,ecdh-sha2- |
| | nistp256,ecdh-sha2-nistp384,ecdh-sha2-nistp521,diffie-hellman-group- |
| | exchange-sha256,diffie-hellman-group16-sha512,diffie-hellman-group18- |
| | sha512,diffie-hellman-group-exchange-sha1,diffie-hellman-group14- |
| | sha256,diffie-hellman-group14-sha1,ext-info-c |
| 41. | debug2: host key algorithms: ecdsa-sha2-nistp256-cert- |
| | v01@openssh.com,ecdsa-sha2-nistp384-cert-v01@openssh.com,ecdsa-sha2- |
| | nistp521-cert-v01@openssh.com,ecdsa-sha2-nistp256,ecdsa-sha2- |
| | nistp384,ecdsa-sha2-nistp521,ssh-ed25519-cert-v01@openssh.com,ssh-rsa- |
| | cert-v01@openssh.com,ssh-ed25519,rsa-sha2-512,rsa-sha2-256,ssh-rsa |
| 42. | debug2: ciphers ctos: chacha20-poly1305@openssh.com,aes128-ctr,aes192- |
| | ctr,aes256-ctr,aes128-gcm@openssh.com,aes256-gcm@openssh.com,aes128- |
| | cbc,aes192-cbc,aes256-cbc,3des-cbc |
| 43. | debug2: ciphers stoc: chacha20-poly1305@openssh.com,aes128-ctr,aes192- |
| | ctr,aes256-ctr,aes128-gcm@openssh.com,aes256-gcm@openssh.com,aes128- |
| | cbc,aes192-cbc,aes256-cbc,3des-cbc |
| 44. | debug2: MACs ctos: umac-64-etm@openssh.com,umac-128- |
| | etm@openssh.com,hmac-sha2-256-etm@openssh.com,hmac-sha2-512- |
| | etm@openssh.com,hmac-sha1-etm@openssh.com,umac-64@openssh.com,umac- |
| | 128@openssh.com,hmac-sha2-256,hmac-sha2-512,hmac-sha1 |
| 45. | debug2: MACs stoc: umac-64-etm@openssh.com,umac-128- |
| | etm@openssh.com,hmac-sha2-256-etm@openssh.com,hmac-sha2-512- |
| | etm@openssh.com,hmac-sha1-etm@openssh.com,umac-64@openssh.com,umac- |
| | 128@openssh.com,hmac-sha2-256,hmac-sha2-512,hmac-sha1 |
| 46. | debug2: compression ctos: none,zlib@openssh.com,zlib |
| 47. | debug2: compression stoc: none,zlib@openssh.com,zlib |
| 48. | debug2: languages ctos: |
| 49. | debug2: languages stoc: |
| 50. | debug2: first_kex_follows 0 |
| 51. | debug2: reserved 0 |
| 52. | debug2: peer server KEXINIT proposal |

| | |
|---|---|
| 53. | [snip] |

Advanced Remot3.it—Inside the Server Channel

The remot3.it system allows any device to communicate with any other device on the Internet, no matter what the network looks like or where the devices may be located.

This section provides a view of how remot3.it provides Bulk Management (sometimes also called Fleet Management) capabilities using the remot3.it Server Channel. Bulk management allows the management of many devices at the same time using the same tools, scripts and commands. In the remot3.it system bulk management is not limited to the same type of device, the same platform (CPU, etc.), or the same OS.

Once you understand the basic remot3.it connection mechanism, the remot3.it protocols, and the packet flow for a connection describebd in previous sections, it is much easier to understand how the remot3.it Server Channel works.

### What is Server Channel?

In one embodiment, the remot3.it Server Channel is a part of the remot3.it system. In one embodiment, the remot3.it Server Channel is the part of remot3.it that enables remote control of your devices. Server Channel allows you to send commands to any number of your remot3.it devices. In one embodiment, the remot3.it Server Channel may use the same remot3.it protocol, remot3.it packet structures, and remot3.it connection mechanism described in other sections

FIG Y5-13 shows the remot3.it Manage Device page. The Manage Device page is the remot3.it web page that you will see when you login to the remot3.it website at https://www.remot3.it. This remot3.it web page will show all of your remot3.it devices that you have previously registered with the remot3.it system.

The remot3.it Manage Devices page shown in FIG Y5-13 may include, but is not limited to, one or more of the following features:
Account name. This is the remot3.it login name provided at login with account password.
Manage Devices. This is the first item and the default in the menu on the main remot3.it management page.
Storage. This menu item will allow you to manage scripts and files stored at the remot3.it website. Storage sub-items are “Files”, “Scripts”, and “Upload”.
Job Status. This menu item allows you to monitor bulk management commands and actions that are programmed by scripts. This menu item takes you to the “Bulk Jobs” page.
Register Devices. This menu item allows you to register and define properties (device name and so on) of your devices. This menu item will take you to the “Bulk Registration” page. Register Devices sub-items are “History” and “Upload”.
My Account. This menu item allows you to monitor and change your account properties, such as changing your remot3.it login password.
Support. This menu item allows you to get help and support for your remot3.it account. Support sub-items are “Forum”, “Get Started”, and “About”.
Devices. This heading field will change, for example, to “Bulk Jobs” if you select “Job Status” on the menu.
Group By. This text entry field allows you to group your devices by “Status”, “Hardware ID”, “Shared”, “External IP”, or any of the Status or Category columns.
Actions. This drop-down menu allows you to select one of a number of possible actions. Actions comprise: “Execute Script”, “Change Category”, “Clear Status”, “Add Sharing”, “Remove Sharing”, and “Delete Device”. An “Actions Help” button will take you to a new website page with detailed help on each of the remot3.it actions.
Select. The Select column allows you to select one or more or all of your devices. Status. The status column shows which of your devices are online (connected to remot3.it) and available to remot3.it.
Device Name. This column contains the device name given by you to each remot3.it device at registration (the device name can also be edited). The device name will often include some unique identifier (such as all or part of a MAC address) to allow you to identify your devices.
Share. This column indicates which of your devices are shared with other remot3.it accounts.
HWID. Hardware Identification. This column shows a unique identifier that you choose to associate with each of your remot3.it devices. This may be a MAC address or manufacturer serial number or any identifier that you choose during the remot3.it registration process.
Internal IP. This column lists the internal IP address of your device that may be a private IP address (such as 192.x.x.x or 10.x.x.x for example) behind a NAT.
External IP. This column lists the external IP address of your device. For example if your device is connected via a cell modem, this will be the IP address provided by your carrier.
Status A. This column provides feedback from your device as a result of executing scripts that can populate this field. There are five Status fields (Status A, Status B, Status C, Status D, Status E) and three Category fields (Category A, Category B, Category C). You could use one or more of the Category fields to further identify or otherwise categorize your devices. For example, you might include the address (town and state, for example) in one or more of the category fields.
Filter. This text entry box allows you to enter a search string or filter that is to be applied to the displayed fields in order to limit or restrict the devices displayed. For example, if you enter the text string “02:42”, the devices displayed will be limited to those that contain that string in the any of the displayed fields.
   Server Channel overview

The following sections describe the various parts of the remot3.it Server Channel (henceforth Server Channel):

The Server Channel processes.

The Server Channel daemon configuration file.

The remot3.it daemon configuration file for Server Channel.

Key remot3.it files used by Server Chanel

The ports and connections used by Server Channel

The Server Channel API

Server Channel messages and their format.

The Server Channel remot3.it daemon

Local Server Channel messages and their format.

A Server Channel processor

Server Channel commands and their format.

Server Channel feedback to the remot3.it system.

An example remot3.it Server Channel script

We will use a MacOS laptop (with hostname MacBook-Air) as the target device for our remot3.it Server Channel examples below. As described in other sections this will allow us to capture the remot3.it packets using Wireshark running on the target device and a special version of the remot3.it weavedConnectd daemon.

### Server Channel Processes

In one embodiment, the following remot3.it processes are running on the target device (the MacOS laptop, MacBook-Air):

TABLE 32
MacBook-Air:~ mike$ ps ax | grep weaved

| | |
|---|---|
| 478 ?? S | 5:40.85 /usr/local/bin/weavedConnectd -f |

/etc/weaved/services/Weavedweb80.conf -d /var/run/Weavedweb80.pid

| | |
|---|---|
| 34441 ?? S | 3:27.00 /usr/local/bin/weavedConnectd -f |

/etc/weaved/services/Weavedrmt365535.conf -d /var/run/Weavedrmt365535.pid

| | |
|---|---|
| 88095 ?? S | 0:01.12 /usr/local/bin/schannel -f /etc/weaved/schannel.conf - |

d /var/run/schannel.pid

| | |
|---|---|
| 95006 ?? S | 5:53.56 /usr/local/bin/weavedConnectd -f |

/etc/weaved/services/Weavedssh22.conf -d /var/run/Weavedssh22.pid

| | |
|---|---|
| 27182 s000 S+ | 0:00.01 grep weaved |

You have mail in /var/mail/mike
MacBook-Air:~ mike$

We can see that there are three copies of the Weaved daemon software, weavedConnectd (also sometimes called bcaster. There is one copy of the remot3.it Server Channel daemon, schannel. Each of the weavedConnectd daemons have their own configuration file. For example, the weavedConnectd configuration file for the remot3.it Server Channel service is Weavedrmt365535.conf. The single copy of the schannel daemon has its own configuration file, schannel.conf. The “−d” flag starts each process as a daemon. Each daemon has its own PID file.

Example Server Channel configuration file

Here is an example Server Channel configuration file. We will cover some of the options in this file, but not all, in this section:

TABLE 33
MacBook-Air:src mike$ cat /etc/weaved/schannel.conf
#
# Sample Server Channel Confguration File
# Note that command line will override settins set here.
#
#Uncomment to change the location of the task_notify.sh script, default
/usr/bin/task_notify.sh
Task_Notify_Script /usr/local/bin/task_notify.sh
#Uncomment and change to control the Listen Port for Server Channel Messages.
#Listen_Port 5970
#Uncomment to set bind IP, default 127.0.0.1, can be 0.0.0.0 for all or specific
IP. Settings other than 127.0.0.1 can be dangerous
#Bind_IP 0.0.0.0
# uncomment to set User to run as in daemon mode
#Run_As_User nobody
#uncomment if you want statistics written periodically to a file
#Stats_File /tmp/server_channel_stats.txt
# Interval in seconds to write the stats file, only valid if Stats_File is
defined. Minimum 15 seconds.
#Stats_Interval 15
#tags, tags are basically substitution strings, a short tag to an arbitrary
string
# the following would create a tag “noc” that would map to “-q --no-check-
certificate”
# server channel commands that contain <noc> would have that tag replaced with -q
--no-check-certificate
# you may specify any number of tags, if you specify multiple tags with same
name, only the last one will persist
# in the running environment. tag substitution strings cannot have leading
spaces. Spaces are not trimmed off the end.
#tag noc -q --no-check-certificate
MacBook-Air:src mike$

Note, for example, that for MacOS, the directory for remot3.it files is /usr/local/bin/ rather than /usr/bin/ (due to System Integrity Protection or SIP in MacOS).

Note also that as we will explain below this configuration file is an example and can be modified from the reference design. For example, this particular example and reference configuration was originally used for a device that did not have ssh and curl (due to system constraints). Thus, for example, in this example we use wget with a—no-check-certificate option. The configuration file gives us flexibility on options etc. that may be used.

### Remot3.it Configuration File

In one embodiment, the remot3.it weavedConnectd daemon for the Server Channel service uses the following configuration file:

TABLE 34
MacBook-Air:src mike$ cat /etc/weaved/services/Weavedrmt365535.conf
#begin <do not modify section> of weaved provisioning file.
DB0EC490-0D3E-64E0-590A-C379E3FE4FD3
1
7xCj54v4wU5CvAYjg2TUwTFkLPQ=
-----BEGIN CONFIG-----
FIPgUGfRor0MrVm+7K1eEYLpfXtXvivaXfycAemiT6ZAvgMcORi9HsrCJaglzcLP
tlFLSe/qwjuUn3Rd3sw3N3va/s7K/v0Fb2BEbpxJF7r8OTizSKBa5O+/CaW4siK0
vL+ILKXrOcBclJRgoMvORugXWxqCycC24tyLdVzjA7+V9Clg1OnBfZeAfZudhPCX
X6UF6sUIeI2oPZUxHE2heqhHLL9up8eJOgrRPhlvIXHxfxKke38uxuIgCeF+HWWa
4JSR8cP3FbTeElaumNGlV+XhxVtTxiD/bcYUu79+2k1KHhniKfb/JAvdPbbFO4xy
8Wr4klKQNJMSgJuBfUzJntR2TeX7fZaiV53ajknxY2+2xDYvVv/1ias7DOAEKeFV
ajjPtff6EIphlYA4PnDK/ZfnFGQsZ7s/jzeymCeTmiMF9203PBwtw3aq5wFEhktw
0TJ+NBgP0DcCSR5plPFYs1/PElzzzCd535lfvzwNTlk+gbv+tZh24e7UaWa1DRM8
pFr2LLOj1p2Bxej6N3MU
-----END CONFIG-----
#end <do not modify section> custom configurations after this line>
#note <you must remove all the lines below to copy this enablement to another
device>
# server retrieved UID
UID 80:00:00:05:46:02:C7:A2
# password - erase this line to unregister the device
password ADACF1F8503D BD21A63B53A891554AC70FAC73F9
MacBook-Air:src mike$

We have not added any options to this configuration file, but we could as part of the flexibility of the remot3.it system. For example, we can change the ports used by the remot3.it service, etc. We do not have space to include all the options that may be added to a configuration file in this section, but the ability to add options to the configuration files is a powerful feature of the remot3.it system. The example Server Channel configuration file above is similar to the configuration file for an ssh service as shown in [4]. Note that the Server Channel service is configured and runs in the same way as any other remot3.it service (e.g. ssh, VNC, etc.). The “server retrieved UID” and “password” are added during the registration process; both are unique to a device.

In one embodiment, the remot3.it system may use one or more configuration files. In one embodiment, the remot3.it system may use configuration options, configuration files, combinations of these and/or any other configuration means. In one embodiment, the remot3.it system may use one or more configuration options, means, etc. to change, modify or otherwise configure etc. options, settings, etc.

In one embodiment, the remot3.it system may use one or more configuration options etc. to change etc. one or more options etc. that may include one or more of the following, but not limited to the following: port settings, application ports, other port information, proxy device information, authorization, customer data, device data, customer settings, account data, account information, account settings, log information, connection lifetime setings, encryption settings, authentication settings, permissions, access controls, device address settings, proxy destination address, proxy destination port, proxy information, account keys, security settings, port information, application information, use settings, bandwidth settings, account expiration information, cloaking information, binding address information, combinations of these and/or other settings, options, flags, data, information and the like, etc.

For example, configuration may be used to adjust, control, modify, change, or otherwise configure customer data, customer permissions, customer service settings including which services are enabled and with what tpes of permissions, use, bandwidth limits and other features are enabled for certain accounts, users and so on. Configuration may be used to enable and configure proxy settings. For example, a device enabled with the remot3.it services, software and functions may be used as a proxy to relay, convey, broker, etc. connections from one device to another (e.g. the remot3.it device may act as a relay, proxy, jum p host, etc.). For example, configuration may be used to enable, configure certain software features, options, flags, functions, etc. that may be provided by one or more remot3.it daemons or other software, routines, virtual machines, containers, etc. that may be running, executing, etc. on a device.

### Key Remot3.it Files

In one embodiment, the key files for remot3.it Server Channel are located in /usr/local/bin as follows:

TABLE 35
MacBook-Air:src mike$ ls -alt /usr/local/bin
...

| | | | | | |
|---|---|---|---|---|---|
| -rwxr-xr-x | 1 root | admin | 2332 Mar 10 | 12:34 | weavedschannel |
| -rwxr-xr-x | 1 mike | admin | 2430 Mar 10 | 09:19 | notify_Weavedrmt365535.sh |
| -rwxr-xr-x | 1 root | admin | 9616 Mar 10 | 08:32 | task_notify.sh |
| -rwxr-xr-x | 1 root | admin | 31364 Mar 9 | 12:31 | schannel |
| -rwxr-xr-x | 1 mike | admin | 1713 Mar 9 | 12:17 | Weavedrmt365535.sh |
| -rwxr-xr-x | 1 mike | admin | 402 Mar 9 | 11:38 | weavedstart.sh |
| -rwxr-xr-x | 1 mike | admin | 8338 Mar 9 | 11:21 | weavednotify.sh |

...

These files are as follows:
weavedschannel: This is the start and stop script for the Server Channel daemon. This script is called by, for example, weavedstart.sh.
notify_Weavedrmt365535.sh: This is a Server Channel script for mobile notification (iOS and Android). This script calls, for example, weavednotify.sh.
task_notify.sh: This is the Server Channel script that sends information from the device back to the remot3.it system.
schannel: This is the Server Channel daemon binary.
Weavedrmt365535.sh: This is the start and stop script for the weavedConnectd daemon binary that handles the Server Channel service. This script is called by, for example, weavedstart.sh.
weavedstart.sh: This is the start and stop script for all remot3.it services on the device. This script calls, for example, Weavedrmt365535.sh and weavedschannel. weavednotify.sh: This is a Server Channel script for mobile notification (iOS and Android). This script is called, for example, by notify_Weavedrmt365535.sh
   Remot3.it Server Channel ports

In one embodiment, the remot3.it server communicates to the remot3.it Server Channel service daemon, weavedConnectd, running on the target device using the remot3.it protocol described in other sections

In one embodiment, the remot3.it Server Channel service daemon, weavedConnectd, running on the target device communicates to the Server Channel daemon, schannel, using a localhost connection. The details of this localhost connection are described in the following sections.

We can find the process ID (or PID) files for the remot3.it processes as follows (including all of the weavedConnectd daemons that may be running as well as the Serevr Channel schannel daemon):

TABLE 36
MacBook-Air:src mike$ ls -alt /var/run

| | |
|---|---|
| -rw-r--r-- 1 root daemon | 6 Mar 11 08:57 schannel.pid |
| ... | |
| -rw-rw-rw- 1 root daemon | 5 Mar 9 19:13 Weavedrmt365535.pid |
| ... | |
| -rw-rw-rw- 1 root daemon | 3 Mar 5 17:46 Weavedweb80.pid |
| -rw-rw-rw- 1 root daemon | 5 Mar 5 08:52 Weavedssh22.pid |

We can then find the process IDs (PIDs) for the two processes required for remot3.it Server Channel (the weavedConnectd daemon and schannel daemon) as follows:

TABLE 37

MacBook-Air:src mike$ cat /var/run/schannel.pid
67074
MacBook-Air:src mike$ cat /var/run/Weavedrmt365535.pid
34441
MacBook-Air:src mike$

We can then find the listening ports for each of the key remot3.it Server Channel processes (the weavedConnectd daemon and schannel daemon) as follows:

TABLE 38
MacBook-Air:src mike$ sudo lsof -Pan -p 67074 -i
Password:

| COMMAND | PID | USER | FD | TYPE DEVICE SIZE/OFF | NODE NAME |
|---|---|---|---|---|---|
| schannel | 67074 | root | 3u | IPv4 0xadf72bf5b573c977 0t0 | UDP 127.0.0.1:5980 |

MacBook-Air:src mike$ sudo lsof -Pan -p 34441 -i

| | | | | | |
|---|---|---|---|---|---|
| COMMAND | PID | USER | FD | TYPE DEVICE SIZE/OFF | NODE NAME |
| weavedCon | 34441 | root | 4u | IPv4 0xadf72bf5b6ab9117 0t0 | UDP *:60023 |
| weavedCon | 34441 | root | 5u | IPv4 0xadf72bf5b6abab37 0t0 | UDP *:65044 |

MacBook-Air:src mike$

Note that the Server Channel schannel daemon (with PID 67074) is listening on a localhost address: 127.0.0.1:5980 (the default UDP port for Server Channel). The remot3.it daemon for the Server Channel service, a copy of weavedConnectd (with PID 34441) is listening on two UDP ports (for the remot3.it server connections). Notice that this is an example of the standard interface to remot3.it connection software (in this case the weavedConnectd daemon for the Server Channel remot3.it service) which is a localhost connection.

In one embodiment, the remot3.it system may use one or more daemons. In one embodiment, the remot3.it system may use any daemon, foreground process, background process, or any program, process, routine, binary, compiled code, run-time executable, virtual machine, container, virtual environment, combinations of these and/or other similar executing process, executable, runtime environment, machine, virtual machine, and the like etc.

### Server Channel API

In one embodiment, the user starts a Bulk Management operation with login to the remot3.it website (using a remot3.it login and password or any other authentication means). We will assume in the following sections that a human user is performing remot3.it actions at the remot3.it website, but software using API calls can also be used.

In one embodiment, the remot3.it system may use one or more API calls to perform any of the functions, operations, checks, login functions, authorization, authentication, connection, connection initiation, connection attempt, connection failover, combinations of tehse functions and the like, etc.

In one embodiment, the user or a controlling program calls a remot3.it server API at /api/device/send. In one embodiment, this API is an authenticated call and requires a valid API key and an authentication token.

In one embodiment, the remot3.it system may use and authenticated API call. In one embodiment, the remot3.it system may use API key validation. In one embodiment, the remot3.it system may use one or more authentication tokens.

In one embodiment, the remot3.it API /api/device/send has two parameters, a target UID that corresponds to the target device and a message string containing the message to send to the target device.

In one embodiment, the remot3.it system may use one or more paramaters, fields, options, etc. in an API call that may include one or more of the following, but not limited to the following: target device, target UID, message, other target information, user information, authentication information, key information, token, combinations of one or more of tehse and other similar data, information, fields, options and the like, etc.

In one embodiment, if the remot3.it API accepts the message to be sent, then the message is forwarded to the correct chat server for the target device identified by the specified target UID. The chat server selected is the chat server that the target device is connected to. The chat server encrypts the message and forwards the message to the target device.

In one embodiment, the weavedConnectd daemon may be running on the target device and decrypt the message and forward the message as a UDP datagram to a specified Server Channel UDP port specified by weavedConnectd.conf configuration file (the default may be UDP port 5980).

In one embodiment, the schannel daemon that may be running on the target device may be listening for these Server Channel messages from the weavedConnectd daemon. In one embodiment, the schannel daemon may interpret these Server Channel messages and take an appropriate action.

In one embodiment, the API call format may be as follows:

TABLE 39
Post /api/device/send
Header: apikey & auth_token header value(s) required
URL Parameters: Device address, command (128 characters in Base64
format), client
IP (optional)
Body: JSON formatted
[‘deviceaddress’]
[‘command’]
[‘hostip’]
Return: JSON formatted responses
Success response (200):
Response[“status”] = ’true’ (no reason)
Error responses:
400, ′false′, ′send device failed′
401, ′false′, ′json body missing′
Example ret : {″status″:″true″}

{″status″:″false″,″reason″:″[0891] No device address was

specified or available″}
{″status″:″false″,″reason″:″ json body missing″}

The auth_token is received from a successful Weaved Server API login call.
The apikey is your developer API key for an app.
The deviceaddress is the device address associated with the device you wish to send the Server Channel message to.
The command field is a base64 encoded string of the message you wish to send to the target device.
The hostip field is optional and used for logging of the IP address that sent the command.

### CURL API Example

In one embodiment, the following is an example of a curl API call:

TABLE 40

curl -s -S -X POST -H content-type:application/json -H
‘apikey:WeavedDemoKey$2015’ -H token:<your login token>
https://api.weaved.com/api/device/send --data
‘{“deviceaddress”:“FF:FF:00:00:00:01:00:02”,
“command”:“base64(command)”}’

For example, if the command you wish to send to a target device is “reboot” you base64 encode “reboot” and send the encoded value (for example as “cmVib290”).

Server Channel messages

In one embodiment, the Server Channel message format uses the standard negotiated chat server to client mechanism and remot3.it protocol as described in other sections. In one embodiment, the Server Channel message is carried on the WRITE_CONFIGURATION remot3.it chat protocol packet type (packet type 0x0009).

In one embodiment, the data in the WRITE_CONFIGURATION packet determines the action of this packet. In one embodiment, for the Server Channel, the message is prefaced with the two-character string “*!”.In one embodiment, when the weavedConnectd daemon sees a WRITE_CONFIGUATION message that starts with the two-character string “*!” the weavedConnectd daemon handles the packet as a Server Channel message. The WRITE_CONFIGURATION messages have a maximum length, and thus Server Channel messages are limited to 230 characters or less.

In one embodiment, the Server Channel message has the following format:
*!<cmd>!<jobtaskid>! . . . ! . . . !<command>

In one embodiment, the two-character “*!” Server Channel message prefix signifies the start of a Server Channel message. The Server Channel message prefix is followed by a Command ID. For a Server Channel message, the Command ID is the three-character string “CMD”. The Command ID is followed by a Job Task ID. The Job Task ID is followed by zero, one or more expansion sections separated by the one-character string separator “!”. Finally, the command (or data for the command) is sent. The command is sent after the last “!”separator in the Server Channel message. Expansion sections are used to compress command data.

In one embodiment, each of the expansion sections between two “!” expansion separator characters can be expanded in the command with a $<field>, where the <cmd> is $0, <jobtaskid> is $1 and so on.

The <command> is the command to execute in the case of the <cmd>=CMD. In one embodiment, this command will be expanded and executed in a shell in the standard manner by the device OS.

Example Server Channel messages

In this section we cover examples of Server Channel messages. In one embodiment, when the Job Task ID <jobtaskid> of a Server Channel message is a GUID, the <jobtaskid> and <command> are passed to the Server Channel daemon.

In one embodiment, an example Server Channel message is as follows:
*!CMD!797ef1b2-6dd5-46a8-aef9-62777ea9aab7!reboot

In one embodiment, a more complex example that includes expansion is as follows:

*!CMD! 797ef1b2-6dd5-46a8-aef9-62777ea9aab7!https://dl.dropbox.com!cd /tmp;wget
$3/d/a9daaadssss;wget $3/a/diadiafdafdsoi

More advanced examples of Server Channel message formats will be explained below.

### Server Channel Message on the Wire

In one embodiment, the Server Channel messages between remot3.it server and the target device are encrypted. We can look at the Server Channel messages using a special version of the remot3.it weavedConnectd daemon described in other sections that use a custom Lua dissector.

We use the following Wireshark filter:
udp and !dns and !mdns and !db-lsp-disc and !browser and !nbns and !ip.src==10.0.1.8 and !icmp and !ssdp and !ntp and !quic

In one embodiment, an example of the encrypted and corresponding unencrypted Server Channel message follows:

TABLE 41

| | | | |
|---|---|---|---|
| 332 | 13.677335 209.235.201.53 10.0.1.29 | UDP | 266 5961 → 65044 Len=224 |
| 333 | 13.677501 10.0.1.29 255.255.255.255 | YOICS | 266 |
| | (WRITE_CONFIGURATION_MESSAGE) 9 | | |

Note the packet type is (WRITE_CONFIGURATION_MESSAGE).

In one embodiment, the payload of the unencrypted entire packet is as follows:

TABLE 42

| | | | | | | | | | | | | | | | | | |
|---|---|---|---|---|---|---|---|---|---|---|---|---|---|---|---|---|---|
| 0000 | ff | ff | ff | ff | ff | ff | 2c | f0 | ee | 01 | 30 | b2 | 08 | 00 | 45 | 00 | ......,...0...E. |
| 0010 | 00 | fc | f4 | a1 | 00 | 00 | 40 | 11 | 7a | 33 | 0a | 00 | 01 | 1d | ff | ff | ......@.z3...... |
| 0020 | ff | ff | ea | 77 | f6 | 18 | 00 | e8 | 23 | 10 | 44 | d5 | b6 | be | 8e | 2a | ...w....#.D....* |
| 0030 | 00 | 00 | 00 | 09 | 00 | 00 | 41 | d0 | 2a | 21 | 43 | 4d | 44 | 21 | 38 | 38 | ......A.*!CMD!88 |
| 0040 | 35 | 41 | 31 | 39 | 31 | 33 | 2d | 30 | 43 | 43 | 31 | 2d | 43 | 42 | 33 | 44 | 5A1913-0CC1-CB3D |
| 0050 | 2d | 31 | 38 | 34 | 33 | 2d | 37 | 34 | 38 | 38 | 46 | 32 | 39 | 34 | 43 | 31 | -1843-7488F294C1 |
| 0060 | 45 | 45 | 21 | 61 | 70 | 69 | 30 | 31 | 2e | 72 | 65 | 6d | 6f | 74 | 33 | 2e | EE!api01.remot3. |
| 0070 | 69 | 74 | 2f | 61 | 70 | 76 | 2f | 76 | 32 | 31 | 2e | 31 | 35 | 2f | 21 | 63 | it/apv/v21.15/!c |
| 0080 | 64 | 20 | 2f | 74 | 6d | 70 | 3b | 77 | 67 | 65 | 74 | 20 | 68 | 74 | 74 | 70 | d /tmp;wget http |
| 0090 | 3a | 2f | 2f | 24 | 33 | 2f | 74 | 69 | 6e | 79 | 2f | 54 | 57 | 76 | 61 | 6c | ://$3/tiny/TWval |
| 00a0 | 64 | 48 | 30 | 20 | 3c | 6e | 6f | 63 | 3e | 20 | 2d | 4f | 20 | 6d | 61 | 63 | dH0 <noc> -O mac |
| 00b0 | 6f | 73 | 78 | 5f | 72 | 65 | 6d | 6f | 74 | 33 | 69 | 74 | 2e | 73 | 68 | 3b | osx_remot3it.sh; |
| 00c0 | 63 | 68 | 6d | 6f | 64 | 20 | 2b | 78 | 20 | 2f | 74 | 6d | 70 | 2f | 6d | 61 | chmod +x /tmp/ma |
| 00d0 | 63 | 6f | 73 | 78 | 5f | 72 | 65 | 6d | 6f | 74 | 33 | 69 | 74 | 2e | 73 | 68 | cosx_remot3it.sh |
| 00e0 | 3b | 2f | 74 | 6d | 70 | 2f | 6d | 61 | 63 | 6f | 73 | 78 | 5f | 72 | 65 | 6d | ;/tmp/macosx_rem |
| 00f0 | 6f | 74 | 33 | 69 | 74 | 2e | 73 | 68 | 20 | 24 | 32 | 20 | 24 | 33 | 20 | 70 | ot3it.sh $2 $3 p |
| 0100 | 44 | 4b | 67 | 51 | 6a | 31 | 73 | 26 | 00 | 00 | | | | | | | DKgQj1s&.. |

In one embodiment, the payload of the unencrypted Server Channel message follows:

TABLE 43

| | | | | | | | | | | | | | | | | | |
|---|---|---|---|---|---|---|---|---|---|---|---|---|---|---|---|---|---|
| 0000 | 44 | d5 | b6 | be | 8e | 2a | 00 | 00 | 00 | 09 | 00 | 00 | 41 | d0 | 2a | 21 | D....*......A.*! |
| 0010 | 43 | 4d | 44 | 21 | 38 | 38 | 35 | 41 | 31 | 39 | 31 | 33 | 2d | 30 | 43 | 43 | CMD!885A1913-0CC |
| 0020 | 31 | 2d | 43 | 42 | 33 | 44 | 2d | 31 | 38 | 34 | 33 | 2d | 37 | 34 | 38 | 38 | 1-CB3D-1843-7488 |
| 0030 | 46 | 32 | 39 | 34 | 43 | 31 | 45 | 45 | 21 | 61 | 70 | 69 | 30 | 31 | 2e | 72 | F294C1EE!api01.r |
| 0040 | 65 | 6d | 6f | 74 | 33 | 2e | 69 | 74 | 2f | 61 | 70 | 76 | 2f | 76 | 32 | 31 | emot3.it/apv/v21 |
| 0050 | 2e | 31 | 35 | 2f | 21 | 63 | 64 | 20 | 2f | 74 | 6d | 70 | 3b | 77 | 67 | 65 | .15/!cd /tmp;wge |
| 0060 | 74 | 20 | 68 | 74 | 74 | 70 | 3a | 2f | 2f | 24 | 33 | 2f | 74 | 69 | 6e | 79 | t http://$3/tiny |
| 0070 | 2f | 54 | 57 | 76 | 61 | 6c | 64 | 48 | 30 | 20 | 3c | 6e | 6f | 63 | 3e | 20 | /TWvaldH0 <noc> |
| 0080 | 2d | 4f | 20 | 6d | 61 | 63 | 6f | 73 | 78 | 5f | 72 | 65 | 6d | 6f | 74 | 33 | -O macosx_remot3 |
| 0090 | 69 | 74 | 2e | 73 | 68 | 3b | 63 | 68 | 6d | 6f | 64 | 20 | 2b | 78 | 20 | 2f | it.sh;chmod +x / |
| 00a0 | 74 | 6d | 70 | 2f | 6d | 61 | 63 | 6f | 73 | 78 | 5f | 72 | 65 | 6d | 6f | 74 | tmp/macosx_remot |
| 00b0 | 33 | 69 | 74 | 2e | 73 | 68 | 3b | 2f | 74 | 6d | 70 | 2f | 6d | 61 | 63 | 6f | 3it.sh;/tmp/maco |
| 00c0 | 73 | 78 | 5f | 72 | 65 | 6d | 6f | 74 | 33 | 69 | 74 | 2e | 73 | 68 | 20 | 24 | sx_remot3it.sh $ |
| 00d0 | 32 | 20 | 24 | 33 | 20 | 70 | 44 | 4b | 67 | 51 | 6a | 31 | 73 | 26 | 00 | 00 | 2 $3 pDKgQj1s&.. |

In one embodiment, the Server Channel command in the format as described above. Note the following components of this command:

The <cmd>!<jobtaskid> portion:

885A1913-0CC1-CB3D-1843-7488F294C1EE

Expansion ! . . . ! section:

api01.remot3.it/apv/v21.15/

Command section:

cd /tmp; wget http://$3/tiny/TWvaldH0 <noc> -O
macosx_remot3it.sh;chmod
+x / tmp/macosx_remot3it.sh;/tmp/macosx_remot3it.sh $2 $3

In one embodiment, when expanded the command becomes:

wget http://api01.remot3.it/apv/v21.15//tiny/TWvaldH0 <noc> -O
macosx_remot3it.sh; chmod +x
/tmp/macosx_remot3it.sh;/tmp/macosx_remot3it.sh

### Server Channel Remot3.it Daemon

In one embodiment, the remot3.it Server Channel may use two daemons running on a target device. In one embodiment, the remot3.it Server Channel service daemon, weavedConnectd, running on the target device communicates to the Server Channel daemon, schannel, using a localhost connection.

In one embodiment, the weavedConnectd daemon terminates remot3.it protocol connections. In one embodiment, a copy of weavedConnectd is configured with a server_channel port specified in the configuration file (or by default it will use UDP port 5980). In one embodiment, this server_channel port will be used for local Server Channel messages sent over UDP by the weaveConnectd daemon. In one embodiment, the server_channel port can also be specified on the command line with an option switch. The Server Channel communication between weavedConnectd daemon and the schannel daemon will be described as the local Server Channel. In one embodiment, the local Server Channel consists of UDP datagrams with data described as local Server Channel messages.

In one embodiment, the local server channel UDP port is used to communicate between weavedConnectd and the Server Channel handler. In one embodiment, the local Server Channel messages are transported across this UDP port.

In one embodiment, the weavedConnectd daemon, when it receives the WRITE_CONFIGURATION messages of packet type Server Channel message creates a UDP datagram and sends it to localhost:[server_channel udp port] (which by default is 127.0.0.1:5980).

### Local Server Channel Messages

In one embodiment, the local Server Channel message content is similar (in fact almost the same) to the Server Channel message content. The difference is the addition of a SC header and a UID field. In one embodiment, the local Server Channel message format is as follows:
SC!<UID>!<chat server channel messages>

Assume the Server Channel message example from above:
*!CMD!797ef1b2-6dd5-46a8-aef9-62777ea9aab7!reboot

And assume a target device with UID 01:02:03:04:05:06:07:08, then the corresponding local Server Channel message would be:
SC!01:02:03:04:05:06:07:08!797ef1b2-6dd5-46a8-aef9-62777ea9aab7!reboot

### Local Server Channel Message on the Wire

We can capture the local Server Channel message on the localhost interface.

88 70.281694 localhost localhost UDP 264 57712 → 5980
Len=232 [UDP CHECKSUM INCORRECT]

The [UDP CHECKSUM INCORRECT] from Wireshark is due to checksum offload in the NIC. Wireshark captures UDP on the localhost interface before it is actually transmitted across the localhost interface. The UDP checksum as seen on the wire is correct.

Here is the payload of the local Server Channel message on the localhost interface:

TABLE 44

| | | | | | | | | | | | | | | | | | |
|---|---|---|---|---|---|---|---|---|---|---|---|---|---|---|---|---|---|
| 0000 | 02 | 00 | 00 | 00 | 45 | 00 | 01 | 04 | 84 | e4 | 00 | 00 | 40 | 11 | 00 | 00 | ....E.......@... |
| 0010 | 7f | 00 | 00 | 01 | 7f | 00 | 00 | 01 | e1 | 70 | 17 | 5c | 00 | f0 | ff | 03 | .........p.\.... |
| 0020 | 53 | 43 | 21 | 38 | 30 | 3a | 30 | 30 | 3a | 30 | 30 | 3a | 30 | 35 | 3a | 34 | SC!80:00:00:05:4 |
| 0030 | 36 | 3a | 30 | 32 | 3a | 63 | 37 | 3a | 61 | 32 | 21 | 43 | 4d | 44 | 21 | 35 | 6:02:c7:a2!CMD!5 |
| 0040 | 32 | 36 | 46 | 30 | 36 | 33 | 44 | 2d | 44 | 42 | 36 | 37 | 2d | 44 | 37 | 33 | 26F063D-DB67-D73 |
| 0050 | 42 | 2d | 30 | 41 | 42 | 32 | 2d | 41 | 37 | 38 | 31 | 34 | 45 | 33 | 35 | 43 | B-0AB2-A7814E35C |
| 0060 | 31 | 42 | 30 | 21 | 61 | 70 | 69 | 30 | 31 | 2e | 72 | 65 | 6d | 6f | 74 | 33 | 1B0!api01.remot3 |
| 0070 | 2e | 69 | 74 | 2f | 61 | 70 | 76 | 2f | 76 | 32 | 31 | 2e | 31 | 35 | 2f | 21 | .it/apv/v21.15/! |
| 0080 | 63 | 64 | 20 | 2f | 74 | 6d | 70 | 3b | 77 | 67 | 65 | 74 | 20 | 68 | 74 | 74 | cd /tmp;wget htt |
| 0090 | 70 | 3a | 2f | 2f | 24 | 33 | 2f | 74 | 69 | 6e | 79 | 2f | 62 | 6b | 70 | 32 | p://$3/tiny/bkp2 |
| 00a0 | 72 | 6c | 4a | 30 | 20 | 3c | 6e | 6f | 63 | 3e | 20 | 2d | 4f | 20 | 6d | 61 | rlJ0 <noc> -O ma |
| 00b0 | 63 | 6f | 73 | 78 | 5f | 72 | 65 | 6d | 6f | 74 | 33 | 69 | 74 | 2e | 73 | 68 | cosx_remot3it.sh |
| 00c0 | 3b | 63 | 68 | 6d | 6f | 64 | 20 | 2b | 78 | 20 | 2f | 74 | 6d | 70 | 2f | 6d | ;chmod +x /tmp/m |
| 00d0 | 61 | 63 | 6f | 73 | 78 | 5f | 72 | 65 | 6d | 6f | 74 | 33 | 69 | 74 | 2e | 73 | acosx_remot3it.s |
| 00e0 | 68 | 3b | 2f | 74 | 6d | 70 | 2f | 6d | 61 | 63 | 6f | 73 | 78 | 5f | 72 | 65 | h;/tmp/macosx_re |
| 00f0 | 6d | 6f | 74 | 33 | 69 | 74 | 2e | 73 | 68 | 20 | 24 | 32 | 20 | 24 | 33 | 20 | mot3it.sh $2 $3 |
| 0100 | 6e | 38 | 39 | 65 | 36 | 4f | 75 | 78 | | | | | | | | | n89e6Oux |

You can see the format of the local Server Channel message has added the “SC!” header and the target device UID, 80:00:00:05:46:02:c7:a2.

### Server Channel Processor

In one embodiment, the Server Channel processor is a separate piece of software from the remot3.it service daemon. In one embodiment, the remot3.it service daemon is weavedConnectd (also called bcaster) and typically runs as a daemon (though it need not). In one embodiment, the Server Channel processor is schannel and typically runs as a daemon (though it need not). Thus we may often call the Server Channel processor the Server Channel daemon, though the Server Channel processor need not always be a daemon. In one embodiment, the Server Channel processor job is to process local Server Channel messages, take action and provide feedback status to the remot3.it system.

Although the handling of the local Server Channel messages can be customized to suit specific needs and specific implementations, a reference use case is specified here and used to perform remot3.it Bulk Management (or remot3.it Fleet Management) in the remot3.it system.

### Remot3. it Bulk Management Server Channel Processor

In one embodiment, the remot3.it Bulk Management Server Channel Processor (BMSCP) is a Server Channel processor that expands on the above defined Server Channel messages and local Server Channel messages. In one embodiment, the BMSCP contains a default level of added commands and support a configuration file to expand or customize the remot3.it Bulk Management service functions according to the device platform.

Server Channel Commands and their Format

In one embodiment, the local server Channel messages received by the BMSCP are based on the expanded versions of the Server Channel messages. In one embodiment, the format the BMSCP processor expects is as follows:
SC!<uid>!<cmd>!<jobtaskid>!<apiServerCall>! . . . ! . . . !<command>

In one embodiment, the command is sent after the last “!” separator in the local Server Channel message. In one embodiment, the expansion sections are used to compress command data, each of the sections between two “!”separator characters can be expanded in the command with a $<field>, where the <uid> would be $0, <cmd> would be $1, <jobtaskid> would be $3, <apiserverCall> would be $4, <user defined 1> would be $5 and so on.

The <command> is the command to execute in the case of the <cmd>=CMD. In one embodiment, this command will be expanded and executed by the target device shell after it has been checked and expanded in the BMSCP.

In one embodiment, the <uid> is the UID of the sending device running the weavedConnectd daemon.

### Server Channel Feedback to Remot3.it System

In one embodiment, the feedback from the remot3.it BMSCP uses a REST API over HTTPS. In one embodiment, the remot3.it APIs are tied to a TASKID. In one embodiment, the remot3.it APIs are used to feedback task status and task data to the remot3.it service.

In one embodiment, three APIs are used to notify the remot3.it service of the Server Channel task completion, and two APIs are used to push custom data back to the service. Notification API's: Three task notification API's are defined for feedback to the remot3.it service. Custom Data API's: Two custom data API's are defined for feedback to the remot3.it service.

### Example Processor

An example BMSCP is located at:

https://github.com/weaved/Server-Channel

In one embodiment, this BMSCP is a reference design for remot3.it Bulk Management. In one embodiment, this BMSCP reference design can be operated as user runnable software or as a system daemon. In one embodiment, this BMSCP software will listen for local Server Channel messages on a UDP port. In one embodiment, this BMSCP software will process the local Server Channel messages and acknowledge the device status back to the remot3.it system.

### Server Channel Testing

In one embodiment, the reference code located at https://github.com/weaved/Server-Channel may be used to test the device side functions of Server Channel.

### A Remot3.it Server Channel Script

This remot3.it script is a simple example that will run on the MacOS platform and display OS name, system uptime, number of remot3.it services, and free memory at the remot3.it web page.

TABLE 45
/Users/mike/Downloads/macosx_remot3it.sh

| | |
|---|---|
| 1. | #!/bin/bash |
| 2. | # The above line should be for your system. Raspberry Pi supports bash shell |
| 3. | # |
| 4. | # remot3.it Bulk Management Script |
| 5. | # |
| 6. | # $1 parameter is the jobID used for completion status |
| 7. | # $2 is API server |
| 8. | # |
| 9. | # This example script first clears all the status columns (Status A-E) in the remot3.it portal. |
| 10. | # Next this script grabs the following Pi system values and returns them to the remot3.it portal. |
| 11. | # |
| 12. | #StatusA = os-release ID per /etc/os-release |
| 13. | #StatusB = Linux Kernel version |
| 14. | #StatusC = System uptime since last boot |
| 15. | #StatusD = counts and returns the number of TCP services on Pi that are available for remot3.it |
| | access |
| 16. | #StatusE = Free memory on the Pi |
| 17. | TOOL_DIR=″/usr/bin″ |
| 18. | machineType=″$(uname -m)″ |
| 19. | osName=″$(uname -s)″ |
| 20. | if [ ″$machineType″ = ″x86_64″ ] && [ ″$osName″ = ″Darwin″ ]; then |
| | TOOL_DIR=/usr/local/bin; fi |
| 21. | #if you need to update status in log running process use the following (not more than once |
| | every 30 seconds) |
| 22. | #task_notify.sh 1 $1 ″Job at stage x″ |
| 23. | # Clear all status columns A-E in remot3.it portal |
| 24. | ret=$(${TOOL_DIR}/task_notify.sh a $1 $2 ″″) |
| 25. | ret=$(${TOOL_DIR}/task_notify.sh b $1 $2 ″″) |
| 26. | ret=$(${TOOL_DIR}/task_notify.sh c $1 $2 ″″) |
| 27. | ret=$(${TOOL_DIR}/task_notify.sh d $1 $2 ″″) |
| 28. | ret=$(${TOOL_DIR}/task_notify.sh e $1 $2 ″″) |
| 29. | # Update status column A (Status A) in remot3.it portal |
| 30. | #------------------------------------------------- |
| 31. | # retrieve the os ID as reported by the command “cat /etc/os-release” |
| 32. | # os=$(cat /etc/os-release \| grep -w ID \| awk -F ″=″ ′{print $2 }′) |
| 33. | if [ ″$machineType″ = ″x86_64″ ] && [ ″$osName″ = ″Darwin″ ]; then os=″MacOS″; else |
| | os=$(cat /etc/os-release \| grep -w ID \| awk -F ″=″ ′{print $2 }′); fi |
| 34. | # send to status column a in remot3.it portal |
| 35. | ret=$(${TOOL_DIR}/task_notify.sh a $1 $2 $os) |
| 36. | #------------------------------------------------- |
| 37. | # Update status column B (StatusB) in remot3.it portal |
| 38. | #------------------------------------------------- |
| 39. | # retrieve the Linux kernel version |
| 40. | fwversion=$(uname -a \| awk ′{print $3 }′) |
| 41. | # send to status column b in remot3.it portal |
| 42. | ret=$(${TOOL_DIR}/task_notify.shb $1 $2 ″$fwversion″) |
| 43. | #------------------------------------------------- |
| 44. | # Update status column C (StatusC) in remot3.it portal |
| 45. | #------------------------------------------------- |
| 46. | # retrieve the system uptime |
| 47. | uptime=$(uptime \| sed ′s/\hat{ }.*up *//; s/, *[0-9]* user.*$/m/; s/day[\hat{ }0-9]*/d, |
| | /;s/\([hm]\).*m$/\1/;s/:/h, /;s/\hat{ }//′) |
| 48. | # send to status column c in remot3.it portal |
| 49. | ret=$(${TOOL_DIR}/task_notify.sh c $1 $2 ″$uptime″) |
| 50. | #------------------------------------------------- |
| 51. | # Update status column D (StatusD) in remot3.it portal |
| 52. | #------------------------------------------------- |
| 53. | # retrieve the number of services with an active remot3.it attachment |
| 54. | sys=$(ps ax \| grep weavedconnect \| grep -v grep \| wc -l) |
| 55. | # send to status d |
| 56. | ret=$(${TOOL_DIR}/task_notify.sh d $1 $2 ″$sys″) |
| 57. | #------------------------------------------------- |
| 58. | # Update status column E (StatusE) in remot3.it portal |
| 59. | #------------------------------------------------- |
| 60. | # use free command to retrieve free memory space value |
| 61. | # memfree=$(free \| grep Mem \| awk ′{print $4 }′) |
| 62. | if [ ″$machineType″ = ″x86_64″ ] && [ ″$osName″ = ″Darwin″ ]; then memfree=″$(( |
| | $(vm_stat \| awk ′/free/ {gsub(/\./, ″″, $3); print $3}′) * 4096 / 1048576)) MiB free″; else |
| | memfree=$(free \| grep Mem \| awk ′{print $4 }′); fi |
| 63. | # send to status e |
| 64. | ret=$(${TOOL_DIR}/task_notify.sh e $1 $2 ″$memfree″) |
| 65. | #------------------------------------------------- |
| 66. | #=================================================================== |
| | ==== |
| 67. | # ${TOOL_DIR}/task_notify.sh 1 $1 $2 ″Job at stage 3″ |
| 68. | #=================================================================== |
| | ==== |
| 69. | # Lastly finalize job, no updates allowed after this |
| 70. | ret=$(${TOOL_DIR}/task_notify.sh 1 $1 $2 ″Job complete″) |
| 71. | # Use this for error, and message |
| 72. | #${TOOL_DIR}/task_notify.sh 2 $1 $2 ″Job Failed″ |

### Summary

In this section, we have explained how the remot3.it Server Channel is used for Bulk Management using examples.

### Appendix 3A Task_Notify.SH

In one embodiment, this script is responsible for sending information from the device back to the remot3.it system using API calls.

Advanced Remot3.it—Programming Connections

The remot3.it system allows any device to communicate with any other device on the Internet, no matter what the network looks like or where the devices may be located. This section provides some examples of programming connections using remot3.it.

### Programming a Remot3.it ssh Connection

Appendix 4A shows an example of a simple bash script to make a remot3.it P2P connection and use that remot3.it connection for ssh. In one embodiment, the sshw script is launched like this to connect via ssh from, for example, the laptop (MacBook-Air) to a remote device (“Pi test custom ssh”):
Michaels-MacBook-Air:˜mike$ ./sshw.sh -v pi@‘RPi test custom ssh’

In one embodiment, the sshw script starts by logging into the remot3.it server to obtain a user login token. The login API call is documented at http://docs.weaved.com/docs/userlogin.

In one embodiment, the once the user is logged in with a remot3.it account and remot3.it password (or other authentication means), there is the option to store encrypted credentials in a key file so the user does not have to log into the remot3.it server each time they use the script to make a connection:

TABLE 47

MacBook-Air:~ mike$ more .weaved/auth
jsmith@weaved.com|1|
56CB6B391BA000B27689534D1B04F0EF53C09242
MacBook-Air:~ mike$

In one embodiment, the sshw script sends the user login token with a device list API call in order to retrieve the device list associated with the remot3.it account. The device list API call is documented at http://docs.weaved.com/docs/devicelistall.

In one embodiment, the sshw script then parses the JSON output of the device list in order to find the entry corresponding to the device name (for example, “RPi test custom ssh”). In one embodiment, the sshw script finds the UID (JSON [“deviceaddress”]) for the device name entry and uses UID in conjunction with the WeavedConnect daemon (weavedconnectd) in client mode to initiate a peer-to-peer connection.

In one embodiment, for example, the sshw script can launch the weavedConnectd daemon with the following template:

TABLE 48
/usr/bin/weavedconnectd -c <base64 of username> <base64 of password>
<UID>
T<portnum> <Encryption mode> <localhost address> <maxoutstanding>
-c = client mode
<base64 of username> = Weaved user name, base64 encoded
<base64 of password> = Weaved password, base64 encoded
<UID> = Weaved UID for this device connections
<portnum> = port to use on localhost address
<Encryption mode> = 1 or 2
<localhost address> = 127.0.0.1
<maxoutstanding> = 12

In one embodiment, an example command line would be as follows:

TABLE 49
/usr/bin/weavedconnectd -c ZmF1bHReaX5lMTk9OUB5YWhvby5jb20=
d5VhdmVkFjAxWg==
80:00:00:0F:96:00:01:D3 T33000 1 127.0.0.1 12

In one embodiment, the sshw launches the remot3.it daemon, weavedConnectd, to create a listener at 127.0.0.1:33000 that is a remot3.it connection to the remote device.

In one embodiment, the shw script then launches a command-line ssh client that will then request the ssh password for the remote device user account (for example “pi”) used in the sshw command-line. Until the port assignment values are cached, you may see SSH security warnings.

In one embodiment, an example of using the script sshw is shown below:

TABLE 50
Michaels-MacBook-Air:~ mike$ ./sshw.sh -v pi@‘RPi test custom ssh’
Weaved sshw.sh Version 0.0.7 Sept 16, 2015
Please enter your Weaved username (email address):
jsmith@weaved.com
Now, please enter your password:
Connecting...
Logged in - get device list
Saving Weaved credentials for jsmith@weaved.com
Device RPi test custom ssh address is 80:00:00:05:46:00:09:C9
Device is active
base64 username is bXNtaXRoQHdlYXZlZC5jb20=
Connection will be to 127.0.0.1:33001
Using connection log : /Users/mike/.weaved/log.46437.txt
......Connected to service, starting P2P tunnel
...P2P tunnel connected on port 33001
Running command>> ssh pi@127.0.0.1 -p33001
The authenticity of host ‘[127.0.0.1]:33001 ([127.0.0.1]:33001)’ can’t be
established.
ECDSA key fingerprint is SHA256:8u1uu3o+ouu1FoT3Oik5kkwLcTfNZIcwNzCbEK6xqNk.
Are you sure you want to continue connecting (yes/no)? yes
Warning: Permanently added ‘[127.0.0.1]:33001’ (ECDSA) to the list of known
hosts.
pi@127.0.0.1's password:
Linux raspberrypi 3.12.28+ #709 PREEMPT Mon Sep 8 15:28:00 BST 2014 armv61
The programs included with the Debian GNU/Linux system are free software;
the exact distribution terms for each program are described in the
individual files in /usr/share/doc/*/copyright.
Debian GNU/Linux comes with ABSOLUTELY NO WARRANTY, to the extent
permitted by applicable law.
Last login: Mon Aug 24 17:11:19 2015 from localhost
pi@raspberrypi ~ $ exit
logout
Connection to 127.0.0.1 closed.
Done
Removing connection log.
Kill connection pid 46633.
Remove active flag file /Users/mike/.weaved/33001.active.
Michaels-MacBook-Air:~ mike$

### The Remot3.it Daemon, WeavedConnectd

In one embodiment, the remot3.it daemon, called weavedConnectd, has a number of options that you can see with the “-h” parameter:

TABLE 51
MacBook-Air:~ mike$ /usr/local/bin/weavedConnectd -h
WeavedConnectd built Feb 11 2017 at 09:23:22 Now Starting Up

Version 3.7 - (c)2016 Weaved, Inc. All Rights Reserved
Built with BCASTER MALLOC_POOL RESOLVE BIGBUF NOTE pool=262144

usage: /usr/local/bin/weavedConnectd [-h] [-d] [pid file] [-f config_file]

-f specify a config file.
-d runs the program as a daemon with optional pid file.

-c and -p must be last switch on the list

-c run without config file, -c base64(yoicsid) base64(password)

UID_to_connect TPort_to_bind encryption bind_to_address maxoutstanding <optional
proxy-lifetime-min idle_limit both must be provided>

-p run without config file -p <Base64(username)>

<PlainText(passwordHash)> <peeruid> <proxyport> <encryptflag> <bindaddress>
<restrictedconnectip 0.0.0.0=any> <maxoutstanding> <proxylifetime-minutes 0=no-
limit> <idle-limit 0=no-limit>

-unixpid echo process id of unix application (this one that you’re

running).

-y server:port - server to connect to.
-s prints out !! status and info.
-i turn interactive processor off
-h print this message.
-u <http auth (base64)> for writing credentials in embedded
-a <auth string> This is the auth credentials 40 byte HEXASC string.

(with or without |A|)

-t <targetIP> Target IP works in conjunction with target port -x
-x <port list> IE T80 T442 (should be last)
-z <web port> (if not first in <port list> (default))
-life lifetime in seconds, negitive values cause program to exit before

login

-l <log port> <id> (must have both log port and ID)
-n network diagnostics, if this is set network diagnostics will be done,

results are printed and program exits

-uid <uid> Use this UID
-sn <sn> Use this Serial Number (0 to disable, default disabled)

-sch <port> server channel port.
-side <port> side channel port.
-note <type=1(RC4) =0(none)> <msg> [status>]
-notecl <uid> <secret> <type=1(RC4) =0(none)> <msg> [status]

<msg> is what is stored in alert <status> what is in push notification.
if <status> is not specified <msg> is used for both alert and push

notification.
MacBook-Air:~ mike$

In this section, we will focus on using the “c” and “p” options to create a P2P connection.

Programming a Remot3.it Connection with Proxy Failover

Appendix 4B shows an example of a simple Python script to program a remot3.it connection to a list of devices using P2P with failover to a proxy connection. In one embodiment, the remot3.it connection is then used to ssh to each device and execute a remote command.

In one embodiment, the script we want to execute on each remote device is in a file called “remotescript”. In the following example, we will execute a simple directory listing command “ls-al”. The remote devices we want to manage are in a file “devicelist”. Optionally, we can cache the remot3.it UIDs and port numbers for remot3.it connections for all of the remote devices in a remot3.it account in a file called “endpoints”.

TABLE 52
MacBook-Air:~ mike$ cat .weaved/remotescript
ls -al
MacBook-Air:~ mike$ cat .weaved/devicelist
dnabox1001-ssh-22
B2 RPi3 v1 ssh
MacBook-Air:~ mike$ cat .weaved/endpoints
TPORT33000|B2_netgear_rn102_ssh|80:00:00:05:46:00:7F:F0
TPORT33001|Smith_netgear_rn102_ssh|80:00:00:05:46:00:81:03
TPORT33002|remoteit_smith_1|80:00:00:05:46:00:7C:4E
TPORT33003|remoteit_smith_2|80:00:00:05:46:00:85:1E
TPORT33004|remoteit_att992_wired|80:00:00:05:46:00:7F:D1
TPORT33005|Smith_netgear_rn104_ssh|80:00:00:05:46:00:81:6D
TPORT33006|unknown|80:00:00:05:46:00:7B:AC
TPORT33007|unknown|80:00:00:05:46:00:9E:C6
TPORT33008|unknown|80:00:00:05:46:00:9E:E9
TPORT33009|remoteit_smith_1_custom_tcp_33333|
80:00:00:05:46:00:9C:29
TPORT33010|RPI2|80:00:00:05:46:01:FA:5A
TPORT33011|RPI2 ssh 7|80:00:00:05:46:01:FA:48
TPORT33012|dnabox1001-ssh-22|80:00:00:05:46:01:50:B4
TPORT33013|B2 RPi3 v1 ssh|80:00:00:05:46:02:15:21
TPORT33014|B2 RPi3 v1|80:00:00:05:46:02:15:31
TPORT33015|MacBook-Air_ssh|80:00:00:05:46:02:50:54
MacBook-Air:~ mike$

A complete example of using this Python script from Appendix 4B is shown below. We will explain the operation of the script and the details of the output in more detail in the next section. In the following example, we will use the Python script to make a proxy connection to two remote devices “dnabox1001-ssh-22” and “B2 RPi3 v1 ssh” (both are Raspberry Pi devices in this case, but they could be any devices, or any combination of devices running Linux or similar OS that understands the script):

TABLE 53

| | |
|---|---|
| 1. | MacBook-Air:~ mike$ time python /Users/mike/Downloads/Weaved-ssh-bulk-manage-demo- |
| | 2.py |
| 2. | Start time in milliseconds = 1490629204088 |
| 3. | Login to remot3.it |
| 4. | System time = 1490629204088 ms Delta = 0.0 s Elapsed = 0.0 s |
| 5. | Got response. |
| 6. | System time = 1490629206072 ms Delta = 1.984 s Elapsed = 1.984 s |
| 7. | Next line in deviceFile is dnabox1001-ssh-22 |
| 8. | Looking for device name dnabox1001-ssh-22 |
| 9. | Found this device at remot3.it: dnabox1001-ssh-22 |
| 10. | This device is active at remot3.it: dnabox1001-ssh-22 |
| 11. | Trying remot3.it proxy connection to dnabox1001-ssh-22. |
| 12. | Making remot3.it proxy connection. |
| 13. | System time = 1490629208059 ms Delta = 1.987 s Elapsed = 3.971 s |
| 14. | Got response from remot3.it proxy. |
| 15. | System time = 1490629218871 ms Delta = 10.812 s Elapsed = 14.783 s |
| 16. | Open ssh connection to proxy19.weaved.com:36311 |
| 17. | Made ssh connection to proxy19.weaved.com:36311 |
| 18. | System time = 1490629220731 ms Delta = 1.86 s Elapsed = 16.643 s |
| 19. | Executing script via remot3.it proxy connection. |
| 20. | Looking for script file at /Users/mike/.weaved/remotescript |
| 21. | Found script file at /Users/mike/.weaved/remotescript |
| 22. | Open script file. |
| 23. | Script file: |
| 24. | ls -al |
| 25. | Remote output: |
| 26. | The programs included with the Debian GNU/Linux system are free software; |
| 27. | the exact distribution terms for each program are described in the |
| 28. | individual files in /usr/share/doc/*/copyright. |
| 29. | Debian GNU/Linux comes with ABSOLUTELY NO WARRANTY, to the extent |
| 30. | permitted by applicable law. |
| 31. | Last login: Mon Mar 27 15:35:51 2017 from localhost |
| 32. | ls -al |
| 33. | pi@raspberrypi:~$ ls -al |
| 34. | total 20876 |
| 35. | drwxr-xr-x 20 pi pi 4096 Feb 3 17:14 . |
| 36. | drwxr-xr-x 3 root root 4096 May 27 2016 .. |
| 37. | -rw-r--r-- 1 pi pi 10485760 Jun 16 2016 10MB_sample_copy.txt |
| 38. | -rw-r--r-- 1 pi pi 10485760 Jun 16 2016 10MB_sample.txt |
| 39. | -rwxr-xr-x 1 pi pi 5229 Jun 20 2016 add_HWID_EKM.sh |
| 40. | drwx------ 3 pi pi 4096 Nov 27 01:55 .ansible |
| 41. | drwx------ 2 pi pi 4096 Oct 12 01:14 .aptitude |
| 42. | -rw-r--r-- 1 pi pi 69 Feb 3 17:14 .asoundrc |
| 43. | -rw------- 1 pi pi 5817 Mar 27 15:15 .bash_history |
| 44. | -rw-r--r-- 1 pi pi 220 May 27 2016 .bash_logout |
| 45. | -rw-r--r-- 1 pi pi 3512 May 27 2016 .bashrc |
| 46. | drwxr-xr-x 6 pi pi 4096 Jun 16 2016 .cache |
| 47. | drwxr-xr-x 9 pi pi 4096 Jun 16 2016 .config |
| 48. | drwx------ 3 pi pi 4096 Jun 16 2016 .dbus |
| 49. | drwxr-xr-x 2 pi pi 4096 May 27 2016 Desktop |
| 50. | drwxr-xr-x 5 pi pi 4096 May 27 2016 Documents |
| 51. | drwxr-xr-x 2 pi pi 4096 Jun 16 2016 Downloads |
| 52. | -rwx------ 1 pi pi 4096 Jun 20 2016 ._.DS_Store |
| 53. | -rwx------ 1 pi pi 8196 Aug 7 2016 .DS_Store |
| 54. | drwxr-xr-x 2 pi pi 4096 Jun 16 2016 .gstreamer-0.10 |
| 55. | -rw-r--r-- 1 pi pi 10942 Jun 20 2016 hwid.txt |
| 56. | drwxr-xr-x 3 pi pi 4096 May 27 2016 .local |
| 57. | drwxr-xr-x 2 pi pi 4096 Jun 16 2016 Music |
| 58. | drwxr-xr-x 2 pi pi 4096 Jun 16 2016 Pictures |
| 59. | -rw-r--r-- 1 pi pi 675 May 27 2016 .profile |
| 60. | drwxr-xr-x 2 pi pi 4096 Jun 16 2016 Public |
| 61. | drwxr-xr-x 2 pi pi 4096 May 27 2016 python_games |
| 62. | -rw-r--r-- 1 pi pi 9519 Oct 11 17:46 smb.conf.2016-10-11 |
| 63. | drwx------ 2 pi pi 4096 Jun 16 2016 .ssh |
| 64. | drwxr-xr-x 2 pi pi 4096 Jun 16 2016 Templates |
| 65. | drwxr-xr-x 3 pi pi 4096 May 27 2016 .themes |
| 66. | drwxr-xr-x 2 pi pi 4096 Jun 16 2016 Videos |
| 67. | -rw-r--r-- 1 pi pi 93882 Jun 15 2016 weavedconnectd-1.3-06-EKM.deb |
| 68. | -rwx------ 1 pi pi 97676 Aug 4 2016 weavedconnectd_1.3-07a.deb |
| 69. | -rwxr-xr-x 1 pi pi 37764 Jun 16 2016 weavedinstallerlib_hide |
| 70. | -rwxr-xr-x 1 pi pi 3319 Jun 16 2016 weavedinstaller_OEM_hide |
| 71. | -rw------- 1 pi pi 56 Feb 3 16:17 .Xauthority |
| 72. | -rw------- 1 pi pi 353 Feb 3 16:17 .xsession-errors |
| 73. | -rw------- 1 pi pi 353 Feb 3 15:17 .xsession-errors.old |
| 74. | pi@raspberrypi:~$ |
| 75. | Next line in deviceFile is B2 RPi3 v1 ssh |
| 76. | Looking for device name B2 RPi3 v1 ssh |
| 77. | Found this device at remot3.it: B2 RPi3 v1 ssh |
| 78. | This device is active at remot3.it: B2 RPi3 v1 ssh |
| 79. | Trying remot3.it proxy connection to B2 RPi3 v1 ssh. |
| 80. | Making remot3.it proxy connection. |
| 81. | System time = 1490629224734 ms Delta = 4.003 s Elapsed = 20.646 s |
| 82. | Got response from remot3.it proxy. |
| 83. | System time = 1490629229931 ms Delta = 5.197 s Elapsed = 25.843 s |
| 84. | Open ssh connection to proxy13.yoics.net:31308 |
| 85. | Made ssh connection to proxy13.yoics.net:31308 |
| 86. | System time = 1490629230605 ms Delta = 0.674 s Elapsed = 26.517 s |
| 87. | Executing script via remot3.it proxy connection. |
| 88. | Looking for script file at /Users/mike/.weaved/remotescript |
| 89. | Found script file at /Users/mike/.weaved/remotescript |
| 90. | Open script file. |
| 91. | Script file: |
| 92. | ls -al |
| 93. | Remote output: |
| 94. | The programs included with the Debian GNU/Linux system are free software; |
| 95. | the exact distribution terms for each program are described in the |
| 96. | individual files in /usr/share/doc/*/copyright. |
| 97. | Debian GNU/Linux comes with ABSOLUTELY NO WARRANTY, to the extent |
| 98. | permitted by applicable law. |
| 99. | Last login: Mon Mar 27 15:35:55 2017 from localhost |

| 100. | ls -al | |
|---|---|---|
| 101. | pi@raspberrypi:~$ ls -al | |
| 102. | total 296 | |
| 103. | drwxr-xr-x 20 pi pi 4096 Mar 7 18:52 . | |
| 104. | drwxr-xr-x 3 root root 4096 Sep 23 2016 .. | |
| 105. | drwx------ 3 pi pi 4096 Dec 3 01:24 .ansible | |
| 106. | -rw-r--r-- 1 pi pi 69 Nov 15 16:17 .asoundrc | |
| 107. | -rw------- 1 pi pi 3269 Mar 25 17:15 .bash_history | |
| 108. | -rw-r--r-- 1 pi pi 220 Sep 23 2016 .bash_logout | |
| 109. | -rw-r--r-- 1 pi pi 3512 Sep 23 2016 .bashrc | |
| 110. | drwxr-xr-x 5 pi pi 4096 Sep 23 2016 .cache | |
| 111. | drwxr-xr-x 10 pi pi 4096 Nov 15 20:28 .config | |
| 112. | drwx------ 3 pi pi 4096 Sep 23 2016 .dbus | |
| 113. | drwxr-xr-x 2 pi pi 4096 Sep 23 2016 Desktop | |
| 114. | drwxr-xr-x 5 pi pi 4096 Sep 23 2016 Documents | |
| 115. | drwxr-xr-x 2 pi pi 4096 Sep 23 2016 Downloads | |
| 116. | drwxr-xr-x 2 pi pi 4096 Sep 23 2016 .gstreamer-0.10 | |
| 117. | drwxr-xr-x 3 pi pi 4096 Sep 23 2016 .local | |
| 118. | drwxr-xr-x 2 pi pi 4096 Sep 23 2016 Music | |
| 119. | drwxr-xr-x 2 pi pi 4096 Sep 23 2016 Pictures | |
| 120. | -rw-r--r-- 1 pi pi 675 Sep 23 2016 .profile | |
| 121. | drwxr-xr-x 2 pi pi 4096 Sep 23 2016 Public | |
| 122. | drwxr-xr-x 2 pi pi 4096 Sep 23 2016 python_games | |
| 123. | drwxr-xr-x 2 pi pi 4096 Sep 23 2016 Templates | |
| 124. | drwxr-xr-x 3 pi pi 4096 Sep 23 2016 .themes | |
| 125. | drwx------ 4 pi pi 4096 Nov 15 20:28 .thumbnails | |
| 126. | drwxr-xr-x 2 pi pi 4096 Sep 23 2016 Videos | |
| 127. | drwx------ 3 pi pi 4096 Nov 15 20:22 .vnc | |
| 128. | -rw-r--r-- 1 pi pi 82530 Nov 15 17:37 weavedconnectd-1.3-02.deb | |
| 129. | -rw-r--r-- 1 pi pi 100572 Nov 15 17:43 weavedconnectd_1.3-07u_armhf.deb | |
| 130. | -rw------- 1 pi pi 56 Nov 17 19:17 .Xauthority | |
| 131. | -rw------- 1 pi pi 353 Nov 17 19:17 .xsession-errors | |
| 132. | -rw------- 1 pi pi 353 Nov 15 16:17 .xsession-errors.old | |
| 133. | pi@raspberrypi:~$ | |
| 134. | End program. | |
| 135. | End system time = 1490629233865 ms Delta = 3.26 s Elapsed = 29.777 s | |
| 136. | real | 0m30.273s |
| 137. | user | 0m0.633s |
| 138. | sys | 0m0.117s |

| | |
|---|---|
| 139. | MacBook-Air:~ mike$ |

In the above example, we have used the added debug and timing statements in the Python script in order to show each stage of the remot3.it proxy connection process.

Note that we also ran the Python script from Appendix 4B using “time” so that the system time statistics could be checked against the internal Python timing outputs.

### A Remot3.it P2P Remote Management Connection Example

In the following example, we will employ the same Python script from Appendix 4B used in the above example to make a P2P connection (rather than a proxy connection) to the same two remote devices, “dnabox1001-ssh-22” and “B2 RPi3 v1 ssh”:

TABLE 54

| | |
|---|---|
| 1. | MacBook-Air:~ mike$ time python /Users/mike/Downloads/Weaved-ssh-bulk-manage-demo- |
| | 2.py |
| 2. | Start time in milliseconds = 1490628945293 |
| 3. | Login to remot3.it |
| 4. | System time = 1490628945293 ms Delta = 0.0 s Elapsed = 0.0 s |
| 5. | Got response. |
| 6. | System time = 1490628947290 ms Delta = 1.997 s Elapsed = 1.997 s |
| 7. | Next line in deviceFile is dnabox1001-ssh-22 |
| 8. | Looking for device name dnabox1001-ssh-22 |
| 9. | Found this device at remot3.it: dnabox1001-ssh-22 |
| 10. | This device is active at remot3.it: dnabox1001-ssh-22 |
| 11. | Making remot3.it P2P connection. |
| 12. | Device: dnabox1001-ssh-22 |
| 13. | Launch remot3.it daemon. |
| 14. | WeavedConnectd built Feb 11 2017 at 09:23:22 Now Starting Up |
| 15. | Version 3.7 - (c)2016 Weaved, Inc. All Rights Reserved |
| 16. | Built with BCASTER MALLOC_POOL RESOLVE BIGBUF NOTE pool=262144 |
| 17. | Logging to UDP port=5000 id=hello |
| 18. | hello WeavedConnectd built Feb 11 2017 at 09:23:22 Now Starting Up |
| 19. | hello Version 3.7 - (c)2016 Weaved, Inc. All Rights Reserved |
| 20. | hello Built with |
| 21. | hello BCASTER |
| 22. | hello MALLOC_POOL |
| 23. | hello RESOLVE |
| 24. | hello BIGBUF |
| 25. | hello NOTE |
| 26. | hello pool=262144 |
| 27. | hello proxy local port is TCP = 33012 |
| 28. | hello setting web config port to dest_server_port 80 |
| 29. | hello primary local ip = 10.0.1.29 |
| 30. | hello alloc pool |
| 31. | hello Using server on port 5959 |
| 32. | hello Using device uid = |
| 33. | hello 00:00:00:00:00:00:00:00 |
| 34. | hello |
| 35. | hello Using Server Channel Port 5980 |
| 36. | hello User jsmith@weaved.com connecting to |
| 37. | hello 80:00:00:05:46:01:50:b4 |
| 38. | hello |
| 39. | hello primary local ip = 10.0.1.29 |
| 40. | hello local IP address found 10.0.1.29 |
| 41. | hello initialize proxy client target 127.0.0.1 port 80 |
| 42. | hello generate our own UID= |
| 43. | hello f2:93:af:40:f2:14:9d:c2 |
| 44. | hello |
| 45. | hello Command Processor now active. |
| 46. | hello 60754> req auth weavedid jsmith@weaved.com |
| 47. | hello 60754> Status redirect to 209.235.201.48:5963 |
| 48. | hello 60754> req auth weavedid jsmith@weaved.com |
| 49. | hello Starting Proxy on port 33012 on index 1. |
| 50. | hello Proxy started. |
| 51. | System time = 1490628949973 ms Delta = 2.683 s Elapsed = 4.68 s |
| 52. | Open ssh connection to 127.0.0.1:33012 |
| 53. | Made ssh connection to 127.0.0.1:33012 |
| 54. | System time = 1490628950886 ms Delta = 0.913 s Elapsed = 5.593 s |
| 55. | Executing script via remot3.it P2P connection. |
| 56. | Looking for script file at /Users/mike/.weaved/remotescript |
| 57. | Found script file at /Users/mike/.weaved/remotescript |
| 58. | Open script file. |
| 59. | Script file: |
| 60. | ls -al |
| 61. | Remote output: |
| 62. | The programs included with the Debian GNU/Linux system are free software; |
| 63. | the exact distribution terms for each program are described in the |
| 64. | individual files in /usr/share/doc/*/copyright. |
| 65. | Debian GNU/Linux comes with ABSOLUTELY NO WARRANTY, to the extent |
| 66. | permitted by applicable law. |
| 67. | Last login: Mon Mar 27 15:19:43 2017 from localhost |
| 68. | ls -al |
| 69. | pi@raspberrypi:~$ ls -al |
| 70. | total 20876 |
| 71. | drwxr-xr-x 20 pi pi 4096 Feb 3 17:14 . |
| 72. | drwxr-xr-x 3 root root 4096 May 27 2016 .. |
| 73. | -rw-r--r-- 1 pi pi 10485760 Jun 16 2016 10MB_sample_copy.txt |
| 74. | -rw-r--r-- 1 pi pi 10485760 Jun 16 2016 10MB_sample.txt |
| 75. | -rwxr-xr-x 1 pi pi 5229 Jun 20 2016 add_HWID_EKM.sh |
| 76. | drwx------ 3 pi pi 4096 Nov 27 01:55 .ansible |
| 77. | drwx------ 2 pi pi 4096 Oct 12 01:14 .aptitude |
| 78. | -rw-r--r-- 1 pi pi 69 Feb 3 17:14 .asoundrc |
| 79. | -rw------- 1 pi pi 5817 Mar 27 15:15 .bash_history |
| 80. | -rw-r--r-- 1 pi pi 220 May 27 2016 .bash_logout |
| 81. | -rw-r--r-- 1 pi pi 3512 May 27 2016 .bashrc |
| 82. | drwxr-xr-x 6 pi pi 4096 Jun 16 2016 .cache |
| 83. | drwxr-xr-x 9 pi pi 4096 Jun 16 2016 .config |
| 84. | drwx------ 3 pi pi 4096 Jun 16 2016 .dbus |
| 85. | drwxr-xr-x 2 pi pi 4096 May 27 2016 Desktop |
| 86. | drwxr-xr-x 5 pi pi 4096 May 27 2016 Documents |
| 87. | drwxr-xr-x 2 pi pi 4096 Jun 16 2016 Downloads |
| 88. | -rwx------ 1 pi pi 4096 Jun 20 2016 ._.DS_Store |
| 89. | -rwx------ 1 pi pi 8196 Aug 7 2016 .DS_Store |
| 90. | drwxr-xr-x 2 pi pi 4096 Jun 16 2016 .gstreamer-0.10 |
| 91. | -rw-r--r-- 1 pi pi 10942 Jun 20 2016 hwid.txt |
| 92. | drwxr-xr-x 3 pi pi 4096 May 27 2016 .local |
| 93. | drwxr-xr-x 2 pi pi 4096 Jun 16 2016 Music |
| 94. | drwxr-xr-x 2 pi pi 4096 Jun 16 2016 Pictures |
| 95. | -rw-r--r-- 1 pi pi 675 May 27 2016 .profile |
| 96. | drwxr-xr-x 2 pi pi 4096 Jun 16 2016 Public |
| 97. | drwxr-xr-x 2 pi pi 4096 May 27 2016 python_games |
| 98. | -rw-r--r-- 1 pi pi 9519 Oct 11 17:46 smb.conf.2016-10-11 |
| 99. | drwx------ 2 pi pi 4096 Jun 16 2016 .ssh |

| 100. | drwxr-xr-x 2 pi pi 4096 Jun 16 2016 Templates | |
|---|---|---|
| 101. | drwxr-xr-x 3 pi pi 4096 May 27 2016 .themes | |
| 102. | drwxr-xr-x 2 pi pi 4096 Jun 16 2016 Videos | |
| 103. | -rw-r--r-- 1 pi pi 93882 Jun 15 2016 weavedconnectd-1.3-06-EKM.deb | |
| 104. | -rwx------ 1 pi pi 97676 Aug 4 2016 weavedconnectd_1.3-07a.deb | |
| 105. | -rwxr-xr-x 1 pi pi 37764 Jun 16 2016 weavedinstallerlib_hide | |
| 106. | -rwxr-xr-x 1 pi pi 3319 Jun 16 2016 weavedinstaller_OEM_hide | |
| 107. | -rw------- 1 pi pi 56 Feb 3 16:17 .Xauthority | |
| 108. | -rw------- 1 pi pi 353 Feb 3 16:17 .xsession-errors | |
| 109. | -rw------- 1 pi pi 353 Feb 3 15:17 .xsession-errors.old | |
| 110. | pi@raspberrypi:~$ | |
| 111. | Script completed. | |
| 112. | System time = 1490628954118 ms Delta = 3.232 s Elapsed = 8.825 s | |
| 113. | Close ssh connection. | |
| 114. | Close remot3.it connection | |
| 115. | Next line in deviceFile is B2 RPi3 v1 ssh | |
| 116. | Looking for device name B2 RPi3 v1 ssh | |
| 117. | Found this device at remot3.it: B2 RPi3 v1 ssh | |
| 118. | This device is active at remot3.it: B2 RPi3 v1 ssh | |
| 119. | Making remot3.it P2P connection. | |
| 120. | Device: B2 RPi3 v1 ssh | |
| 121. | Launch remot3.it daemon. | |
| 122. | WeavedConnectd built Feb 11 2017 at 09:23:22 Now Starting Up | |
| 123. | Version 3.7 - (c)2016 Weaved, Inc. All Rights Reserved | |
| 124. | Built with BCASTER MALLOC_POOL RESOLVE BIGBUF NOTE pool=262144 | |
| 125. | Logging to UDP port=5000 id=hello | |
| 126. | hello WeavedConnectd built Feb 11 2017 at 09:23:22 Now Starting Up | |
| 127. | hello Version 3.7 - (c)2016 Weaved, Inc. All Rights Reserved | |
| 128. | hello Built with | |
| 129. | hello BCASTER | |
| 130. | hello MALLOC_POOL | |
| 131. | hello RESOLVE | |
| 132. | hello BIGBUF | |
| 133. | hello NOTE | |
| 134. | hello pool=262144 | |
| 135. | hello proxy local port is TCP = 33013 | |
| 136. | hello setting web config port to dest_server_port 80 | |
| 137. | hello primary local ip = 10.0.1.29 | |
| 138. | hello alloc pool | |
| 139. | hello Using server on port 5959 | |
| 140. | hello Using device uid = | |
| 141. | hello 00:00:00:00:00:00:00:00 | |
| 142. | hello | |
| 143. | hello Using Server Channel Port 5980 | |
| 144. | hello User jsmith@weaved.com connecting to | |
| 145. | hello 80:00:00:05:46:02:15:21 | |
| 146. | hello | |
| 147. | hello primary local ip = 10.0.1.29 | |
| 148. | hello local IP address found 10.0.1.29 | |
| 149. | hello initialize proxy client target 127.0.0.1 port 80 | |
| 150. | hello generate our own UID= | |
| 151. | hello f2:2b:0c:cc:f1:d6:a0:41 | |
| 152. | hello | |
| 153. | hello Command Processor now active. | |
| 154. | hello 60808> req auth weavedid jsmith@weaved.com | |
| 155. | hello 60808> Status redirect to 209.235.201.54:5962 | |
| 156. | hello 60808> req auth weavedid jsmith@weaved.com | |
| 157. | hello Starting Proxy on port 33013 on index 1. | |
| 158. | hello Proxy started. | |
| 159. | System time = 1490628955265 ms Delta = 1.147 s Elapsed = 9.972 s | |
| 160. | Open ssh connection to 127.0.0.1:33013 | |
| 161. | Made ssh connection to 127.0.0.1:33013 | |
| 162. | System time = 1490628955661 ms Delta = 0.396 s Elapsed = 10.368 s | |
| 163. | Executing script via remot3.it P2P connection. | |
| 164. | Looking for script file at /Users/mike/.weaved/remotescript | |
| 165. | Found script file at /Users/mike/.weaved/remotescript | |
| 166. | Open script file. | |
| 167. | Script file: | |
| 168. | ls -al | |
| 169. | Remote output: | |
| 170. | The programs included with the Debian GNU/Linux system are free software; | |
| 171. | the exact distribution terms for each program are described in the | |
| 172. | individual files in /usr/share/doc/*/copyright. | |
| 173. | Debian GNU/Linux comes with ABSOLUTELY NO WARRANTY, to the extent | |
| 174. | permitted by applicable law. | |
| 175. | Last login: Mon Mar 27 15:19:48 2017 from localhost | |
| 176. | ls -al | |
| 177. | pi@raspberrypi:~$ ls -al | |
| 178. | total 296 | |
| 179. | drwxr-xr-x 20 pi pi 4096 Mar 7 18:52 . | |
| 180. | drwxr-xr-x 3 root root 4096 Sep 23 2016 .. | |
| 181. | drwx------ 3 pi pi 4096 Dec 3 01:24 .ansible | |
| 182. | -rw-r--r-- 1 pi pi 69 Nov 15 16:17 .asoundrc | |
| 183. | -rw------- 1 pi pi 3269 Mar 25 17:15 .bash_history | |
| 184. | -rw-r--r-- 1 pi pi 220 Sep 23 2016 .bash_logout | |
| 185. | -rw-r--r-- 1 pi pi 3512 Sep 23 2016 .bashrc | |
| 186. | drwxr-xr-x 5 pi pi 4096 Sep 23 2016 .cache | |
| 187. | drwxr-xr-x 10 pi pi 4096 Nov 15 20:28 .config | |
| 188. | drwx------ 3 pi pi 4096 Sep 23 2016 .dbus | |
| 189. | drwxr-xr-x 2 pi pi 4096 Sep 23 2016 Desktop | |
| 190. | drwxr-xr-x 5 pi pi 4096 Sep 23 2016 Documents | |
| 191. | drwxr-xr-x 2 pi pi 4096 Sep 23 2016 Downloads | |
| 192. | drwxr-xr-x 2 pi pi 4096 Sep 23 2016 .gstreamer-0.10 | |
| 193. | drwxr-xr-x 3 pi pi 4096 Sep 23 2016 .local | |
| 194. | drwxr-xr-x 2 pi pi 4096 Sep 23 2016 Music | |
| 195. | drwxr-xr-x 2 pi pi 4096 Sep 23 2016 Pictures | |
| 196. | -rw-r--r-- 1 pi pi 675 Sep 23 2016 .profile | |
| 197. | drwxr-xr-x 2 pi pi 4096 Sep 23 2016 Public | |
| 198. | drwxr-xr-x 2 pi pi 4096 Sep 23 2016 python_games | |
| 199. | drwxr-xr-x 2 pi pi 4096 Sep 23 2016 Templates | |
| 200. | drwxr-xr-x 3 pi pi 4096 Sep 23 2016 .themes | |
| 201. | drwx------ 4 pi pi 4096 Nov 15 20:28 .thumbnails | |
| 202. | drwxr-xr-x 2 pi pi 4096 Sep 23 2016 Videos | |
| 203. | drwx------ 3 pi pi 4096 Nov 15 20:22 .vnc | |
| 204. | -rw-r--r-- 1 pi pi 82530 Nov 15 17:37 weavedconnectd-1.3-02.deb | |
| 205. | -rw-r--r-- 1 pi pi 100572 Nov 15 17:43 weavedconnectd_1.3-07u_armhf.deb | |
| 206. | -rw------- 1 pi pi 56 Nov 17 19:17 .Xauthority | |
| 207. | -rw------- 1 pi pi 353 Nov 17 19:17 .xsession-errors | |
| 208. | -rw------- 1 pi pi 353 Nov 15 16:17 .xsession-errors.old | |
| 209. | pi@raspberrypi:~$ | |
| 210. | Script completed. | |
| 211. | System time = 1490628958844 ms Delta = 3.183 s Elapsed = 13.551 s | |
| 212. | Close ssh connection. | |
| 213. | Close remot3.it connection | |
| 214. | End program. | |
| 215. | End system time = 1490628958864 ms Delta = 0.02 s Elapsed = 13.571 s | |
| 216. | real | 0m14.052s |
| 217. | user | 0m0.678s |
| 218. | sys | 0m0.177s |

| | |
|---|---|
| 219. | MacBook-Air:~ mike$ |

Again, in this example, we have included timing information so that you can compare the proxy and P2P connection timings.

In this example, we used the ability of the remot3.it daemon, weavedConnectd, to log output via UDP port 5000 and then printed the log information. In this example, the remot3.it daemon is prefixing its log information with the flag “hello”.

### Appendix 4A

A bash script to program a remot3.it ssh connection.

From https://github.com/weaved/misc_bins_and_scripts/blob/master/ssh_client/sshw.sh:

### Appendix 4B

A Python script to program a remot3.it ssh connection to multiple devices via P2P with failover to a proxy connection.

Based on https://github.com/weaved/misc_bins_and_scripts/blob/master/Python%20Bulk%20Management/Weaved-ssh-bulk-manage-demo.py:

### System Architecture Overview

### Additional System Architecture Examples

FIG. Y5-14A depicts a block diagram of an instance of a computer system Y5-1400 suitable for implementing certain embodiments or portions thereof of the present disclosure. Computer system Y5-1400 includes a bus Y5-1406 or other communication mechanism for communicating information, which interconnects subsystems and devices such as a data processor Y5-1407, a system memory (e.g., main memory Y5-1408, or an area of random access memory RAM), a static storage device (e.g., ROM Y5-1409), a storage device Y5-1413 (e.g., magnetic or optical), a data interface Y5-1433, a communications interface Y5-1414 (e.g., modem or Ethernet card), a display monitor Y5-1411 (e.g., CRT or LCD), input devices Y5-1412 (e.g., keyboard, cursor control), and an external data repository Y5-1431.

According to one embodiment of the disclosure, computer system Y5-1400 performs specific operations by data processor Y5-1407 executing one or more sequences of one or more instructions contained in system memory. Such instructions may be read into system memory from another computer readable/usable medium such as a static storage device or a disk drive. In alternative embodiments, hard-wired circuitry may be used in place of or in combination with software instructions to implement the disclosure. Thus, embodiments of the disclosure are not limited to any specific combination of hardware circuitry and/or software. In one embodiment, the term “logic” shall mean any combination of software or hardware that is used to implement all or part of the disclosure.

The term “computer readable medium” or “computer usable medium” as used herein refers to any medium that participates in providing instructions to data processor Y5-1407 for execution. Such a medium may take many forms including, but not limited to, non-volatile media and volatile media. Non-volatile media includes, for example, optical or magnetic disks such as disk drives or tape drives. Volatile media includes dynamic memory such as a RAM memory.

Common forms of computer readable media includes, for example, floppy disk, flexible disk, hard disk, magnetic tape, or any other magnetic medium; CD-ROM or any other optical medium; punch cards, paper tape, or any other physical medium with patterns of holes; RAM, PROM, EPROM, FLASH-EPROM, or any other memory chip or cartridge, or any other non-transitory medium from which a computer can read data.

In an embodiment of the disclosure, execution of the sequences of instructions to practice the disclosure is performed by a single instance of the computer system Y5-1400. According to certain embodiments of the disclosure, two or more instances of computer system Y5-1400 coupled by a communications link Y5-1415 (e.g., LAN, PTSN, or wireless network) may perform the sequence of instructions required to practice the disclosure in coordination with one another.

Computer system Y5-1400 may transmit and receive messages, data, and instructions including programs (e.g., application code), through communications link Y5-1415 and communications interface Y5-1414. Received program code may be executed by data processor Y5-1407 as it is received and/or stored in storage device Y5-1413 or any other non-volatile storage for later execution. Computer system Y5-1400 may communicate through a data interface Y5-1433 to a database Y5-1432 on an external data repository Y5-1431. Data items in database Y5-1432 can be accessed using a primary key (e.g., a relational database primary key). A module as used herein can be implemented using any mix of any portions of the system memory and any extent of hard-wired circuitry including hard-wired circuitry embodied as a data processor Y5-1407. Some embodiments include one or more special-purpose hardware components (e.g., power control, logic, sensors, etc.).

FIG. Y5-14B is a diagram Y5-14B00 illustrating a mobile terminal (see smart phone architecture Y5-14A00), in one embodiment. As shown, the smart phone Y5-1421 includes a housing, display screen, and interface device, which may include a button, microphone, and/or touch screen. In certain embodiments, a smart phone has a high resolution camera device, which can be used in various modes. An example of a smart phone can be an iPhone from Apple Inc. of Cupertino, California. Alternatively, a smart phone can be a Galaxy from Samsung, or others.

In a particular example, the smart phone may include one or more of the following features (which are found in an iPhone from Apple Inc., although there can be variations).
GSM model: UMTS/HSDPA/HSUPA (850, 900, 1900, 2100 MHz); ?GSM/EDGE (850, 900, 1800, 1900 MHz)
CDMA model: CDMA EV-DO Rev. A (800, 1900 MHz)
802.11b/g/n Wi-Fi (802.11n 2.4 GHz only)
Bluetooth 2.1+EDR wireless technology
Assisted GPS
Digital compass
Wi-Fi
Cellular
Retina display
3.5-inch (diagonal) widescreen multi-touch display
800:1 contrast ratio (typical)
500 cd/m2 max brightness (typical)
Fingerprint-resistant oleophobic coating on front and back
Support for display of multiple languages and characters simultaneously
5-megapixel iSight camera
Video recording, HD (720p) up to 30 frames per second with audio
VGA-quality photos and video at up to 30 frames per second with the front camera
Tap to focus video or still images
LED flash
Photo and video geotagging
Built-in rechargeable lithium-ion battery
Charging via USB to computer system or power adapter
Talk time: Up to 20 hours on 3G, up to 14 hours on 2G (GSM)
Standby time: Up to 300 hours
Internet use: Up to 6 hours on 3G, up to 10 hours on Wi-Fi
Video playback: Up to 10 hours
Audio playback: Up to 40 hours
Frequency response: 20 Hz to 22,000 Hz
User-configurable maximum volume limit
Three-axis gyro
Accelerometer
Proximity sensor
Ambient light sensor, etc.
Audio formats supported: AAC (8 to 320 Kbps), protected AAC (from iTunes Store), HE-AAC, MP3 (8 to 320 Kbps), MP3 VBR, audible (formats 2, 3, 4, audible enhanced audio, AAX, and AAX+), Apple lossless, AIFF, and WAV.
Video out support with Apple digital AV adapter or Apple VGA adapter; 576p and 480p with Apple component AV cable; 576i and 480i with Apple composite AV cable (cables sold separately).
Video formats supported: H.264 video up to 1080p, 30 frames per second, main profile Level 3.1 with AAC-LC audio up to 160 Kbps, 48 kHz, stereo audio in .m4v, .mp4, and .mov file formats; MPEG-4 video up to 2.5 Mbps, 640 by 480 pixels, 30 frames per second, simple profile with AAC-LC audio up to 160 Kbps per channel, 48 kHz, stereo audio in .m4v, .mp4, and .mov file formats; motion JPEG (M-JPEG) up to 35 Mbps, 1280 by 1020 pixels, 30 frames per second, audio in ulaw, PCM stereo audio in .avi file format.

Embodiments of the present disclosure may be used with other mobile terminals. Examples of suitable mobile terminals include a portable mobile terminal such as a media player, a cellular phone, a personal data organizer, or the like. In such embodiments, a portable mobile terminal may include a combination of the functionalities of such devices. In addition, a mobile terminal may allow a user to connect to and communicate through the Internet or through other networks such as local or wide area networks. For example, a portable mobile terminal may allow a user to access the internet and to communicate using email, text messaging, instant messaging, or using other forms of electronic communication. By way of example, the mobile terminal may be similar to an iPod having a display screen or an iPhone available from Apple, Inc.

In certain embodiments, a device may be powered by one or more rechargeable and/or replaceable batteries. Such embodiments may be highly portable, allowing a user to carry the mobile terminal while traveling, working, exercising, and so forth. In this manner, and depending on the functionalities provided by the mobile terminal, a user may listen to music, play games or video, record video or take pictures, place and receive telephone calls, communicate with others, control other devices (e.g., via remote control and/or Bluetooth functionality), and so forth while moving freely with the device. In addition, the device may be sized such that it fits relatively easily into a pocket or the hand of the user. While certain embodiments of the present disclosure are described with respect to portable mobile terminals, it should be noted that the presently disclosed techniques may be applicable to a wide array of other, less portable, mobile terminals and systems that are configured to render graphical data, such as a desktop computer.

The smart phone Y5-1421 is configured to communicate with a server Y5-1402 in electronic communication with any forms of handheld mobile terminals. Illustrative examples of such handheld mobile terminals can include functional components such as a processor Y5-1425, processor-accessible memory Y5-1410, graphics accelerator Y5-1427, accelerometer Y5-1426, communications interface Y5-1414 (possibly including an antenna Y5-1416), compass Y5-1418, GPS chip Y5-1420, display screen Y5-1422, and an input device Y5-1424. Each device is not limited to the illustrated components. The components may be hardware, software or a combination of both.

In some examples, instructions can be input to the handheld mobile terminal through an input device Y5-1424 that instructs the processor Y5-1425 to execute functions in an electronic imaging application. One potential instruction can be to generate an abstract of a captured image of a portion of a human user. In such a case the processor Y5-1425 instructs the communications interface Y5-1414 to communicate with the server Y5-1402 (e.g., possibly through or using a cloud Y5-1404) and transfer data (e.g., image data). The data is transferred by the communications interface Y5-1414 and either processed by the processor Y5-1425 immediately after image capture or stored in processor-accessible memory Y5-1410 for later use, or both. The processor Y5-1425 also receives information regarding the display screen's attributes, and can calculate the orientation of the device, e.g., using information from an accelerometer Y5-1426 and/or other external data such as compass headings from a compass Y5-1418, or GPS location from a GPS chip Y5-1420, and the processor then uses the information to determine an orientation in which to display the image depending upon the example.

The captured image can be rendered by the processor Y5-1425, by a graphics accelerator Y5-1427, or by a combination of the two. In some embodiments, the processor can be the graphics accelerator Y5-1427. The image can first be stored in processor-accessible memory Y5-1410 or, if available, the memory can be directly associated with the graphics accelerator Y5-1427. The methods described herein can be implemented by the processor Y5-1425, the graphics accelerator Y5-1427, or a combination of the two to create the image and related abstract. An image or abstract can be displayed on the display screen Y5-1422.

FIG. Y5-14C depicts an interconnection of components to form a mobile terminal Y5-14C00, in one embodiment. Examples of mobile terminals include an enclosure or housing, a display, user input structures, and input/output connectors in addition to the aforementioned interconnection of components. The enclosure may be formed from plastic, metal, composite materials, or other suitable materials, or any combination thereof. The enclosure may protect the interior components of the mobile terminal from physical damage, and may also shield the interior components from electromagnetic interference (EMI).

The display may be a liquid crystal display (LCD), a light emitting diode (LED) based display, an organic light emitting diode (OLED) based display, or some other suitable display. In accordance with certain embodiments of the present disclosure, the display may display a user interface and various other images such as logos, avatars, photos, album art, and the like. Additionally, in certain embodiments, a display may include a touch screen through which a user may interact with the user interface. The display may also include various functions and/or system indicators to provide feedback to a user such as power status, call status, memory status, or the like. These indicators may be incorporated into the user interface displayed on the display.

In certain embodiments, one or more of the user input structures can be configured to control the device such as by controlling a mode of operation, an output level, an output type, etc. For instance, the user input structures may include a button to turn the device on or off. Further, the user input structures may allow a user to interact with the user interface on the display. Embodiments of the portable mobile terminal may include any number of user input structures including buttons, switches, a control pad, a scroll wheel, or any other suitable input structures. The user input structures may work with the user interface displayed on the device to control functions of the device and/or any interfaces or devices connected to or used by the device. For example, the user input structures may allow a user to navigate a displayed user interface or to return such a displayed user interface to a default or home screen.

Certain devices may also include various input and output ports to allow connection of additional devices. For example, a port may be a headphone jack that provides for the connection of headphones. Additionally, a port may have both input and output capabilities to provide for the connection of a headset (e.g., a headphone and microphone combination). Embodiments of the present disclosure may include any number of input and/or output ports such as headphone and headset jacks, universal serial bus (USB) ports, IEEE-1394 ports, and AC and/or DC power connectors. Further, a device may use the input and output ports to connect to and send or receive data with any other device such as other portable mobile terminals, personal computers, printers, or the like. For example, in one embodiment, the device may connect to a personal computer via an IEEE-1394 connection to send and receive data files such as media files.

The depiction of mobile terminal Y5-14C00 illustrates computer hardware, software, and firmware that can be used to implement the disclosures above. The shown system includes a processor that is representative of any number of physically and/or logically distinct resources capable of executing software, firmware, and hardware configured to perform identified computations. A processor Y5-1425 communicates with a chipset Y5-1428 that can control input to and output from processor Y5-1425. In this example, chipset Y5-1428 outputs information to display screen Y5-1422 and can read and write information to non-volatile storage Y5-1444, which can include magnetic media and solid state media, and/or other non-transitory media, for example. Chipset Y5-1428 can also read data from and write data to RAM Y5-1446. A bridge Y5-1433 for interfacing with a variety of user interface components can be provided for interfacing with chipset Y5-1428. Such user interface components can include a keyboard Y5-1434, a microphone Y5-1436, touch-detection-and-processing circuitry Y5-1438, a pointing device Y5-1440 such as a mouse, and so on. In general, inputs to the system can come from any of a variety of machine-generated and/or human-generated sources.

Chipset Y5-1428 also can interface with one or more data network interfaces Y5-1430 that can have different physical interfaces. Such data network interfaces Y5-1430 can include interfaces for wired and wireless local area networks, for broadband wireless networks, as well as personal area networks. Some applications of the methods for generating, displaying and using the GUI disclosed herein can include receiving data over a physical interface Y5-1429 or be generated by the machine itself by a processor analyzing data stored in non-volatile storage Y5-1444 and/or in memory or RAM Y5-1446. Further, the machine can receive inputs from a user via devices such as a keyboard Y5-1434, microphone Y5-1436, touch-detection-and-processing circuitry Y5-1438, and pointing device Y5-1440 and execute appropriate functions such as browsing functions by interpreting these inputs using processor Y5-1425.

FIG. Y5-14D depicts a deployable device architecture Y5-14D00, in one embodiment. The deployable device architecture comprises an applications processor Y5-1450 which in turn can comprises a general-purpose processor Y5-1451, a special-purpose microprocessor Y5-1453, a block for common connectivity Y5-1452, and any number of accelerators Y5-1456, which may include one or more of a DSP core Y5-1457, a video accelerator Y5-1458, and a graphics engine Y5-1459, and/or any forms of special-purpose logic Y5-1486. Such a deployable device architecture may comprise multiple volatile and non-volatile memory segments such as NAND flash Y5-1482, RAM Y5-1483, one or more instances of a memory card Y5-1484, and/or one or more instances of a hard drive Y5-1476.

The architecture may further comprise various I/O modules such as a camera Y5-1481, a touch screen controls Y5-1477, a monitor Y5-1478, and other I/O such as may comprise analog transducers. Any one or more components within the deployable device architecture may be powered by a power supply Y5-1460 and/or a battery Y5-1480. Connectivity is supported for any standard or protocols as shown in block Y5-1454 and/or in block Y5-1455, and can further comprise one or more instances of a wired interface Y5-1488 and/or a wireless interface Y5-1489.

Some architectures include a power management unit Y5-1464, which in turn can manage power for submodules, such as any one or more of the shown audio/video codec Y5-1465, USB transceiver Y5-1467, keypad Y5-1468, and a battery charger Y5-1469. The power management unit might include a supervisor such as the shown power manager Y5-1466 that manages and/or prioritizes power regimes.

Network access is facilitated by any one or more networking interfaces, such as any of the shown wired interface Y5-1488 (e.g., powerline communications), a wireless interface Y5-1489, an Ethernet interface Y5-1490 and/or a PoE interface Y5-1491.

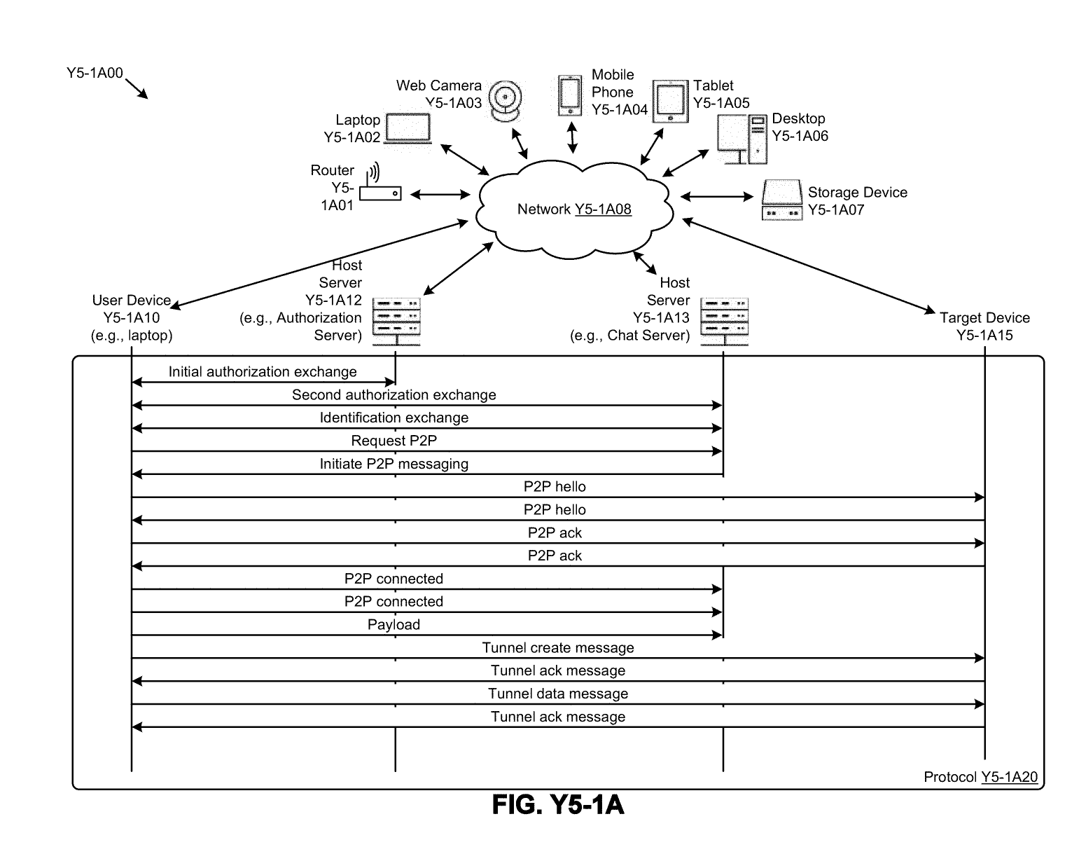

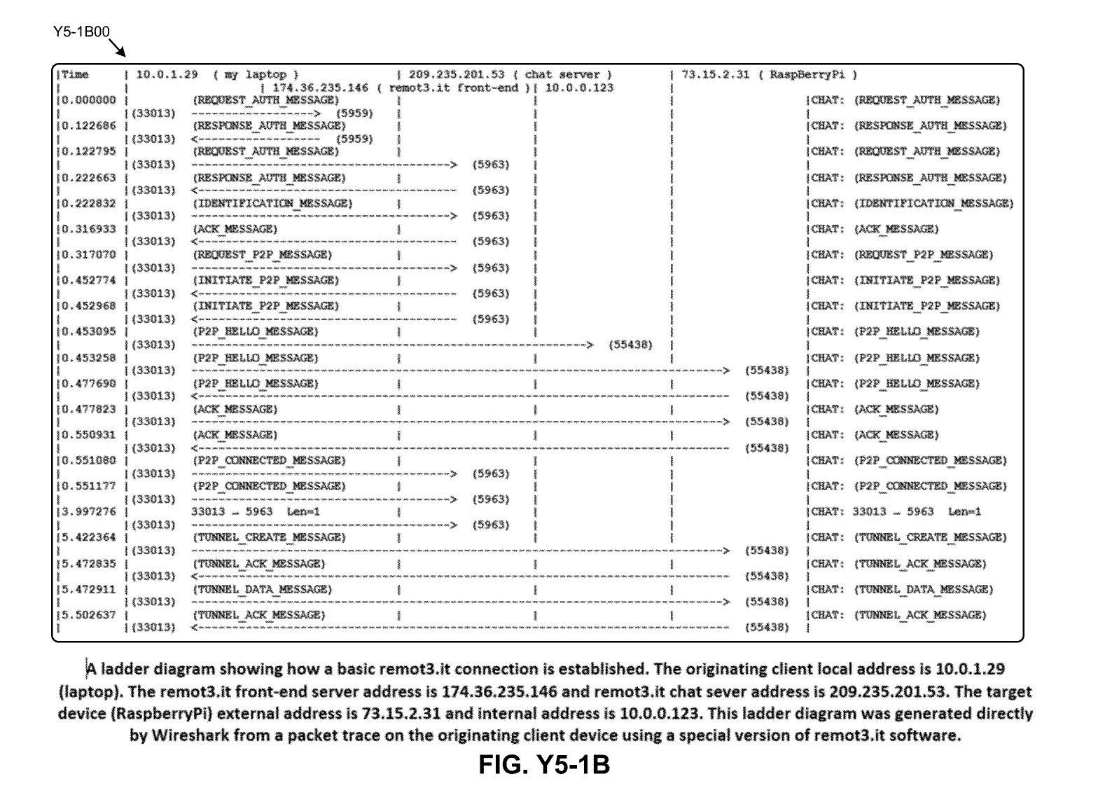

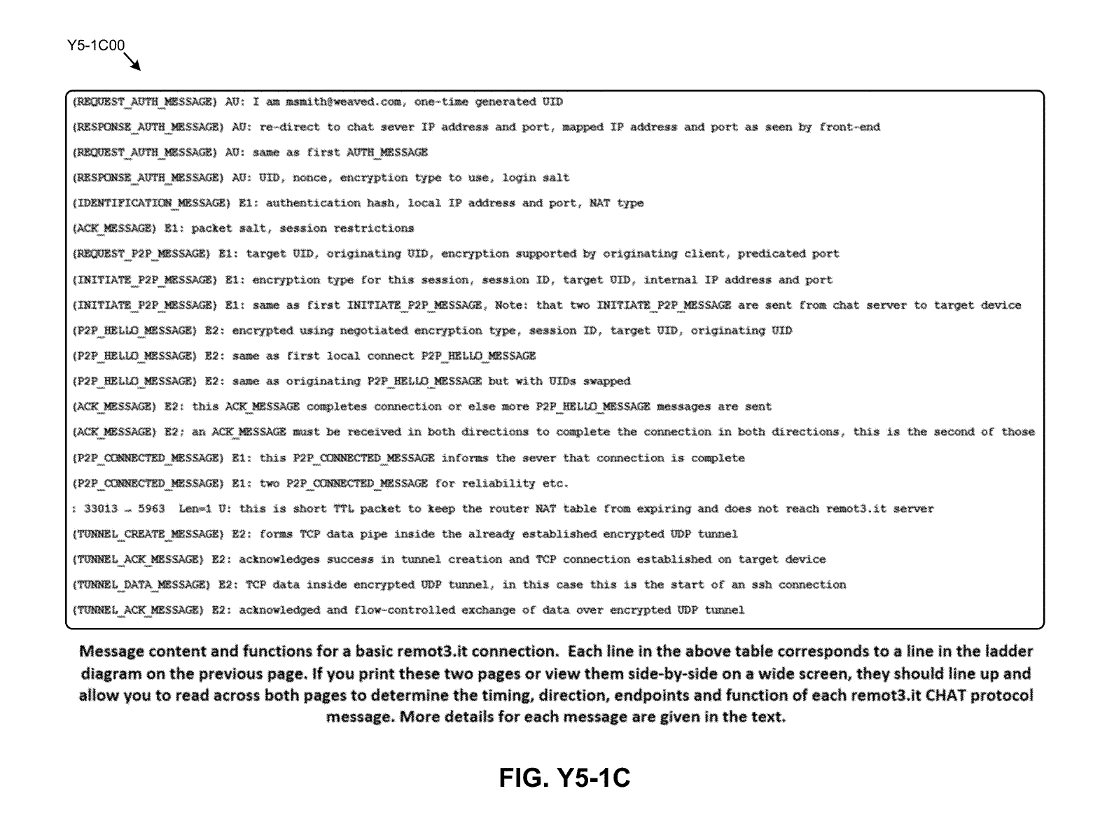

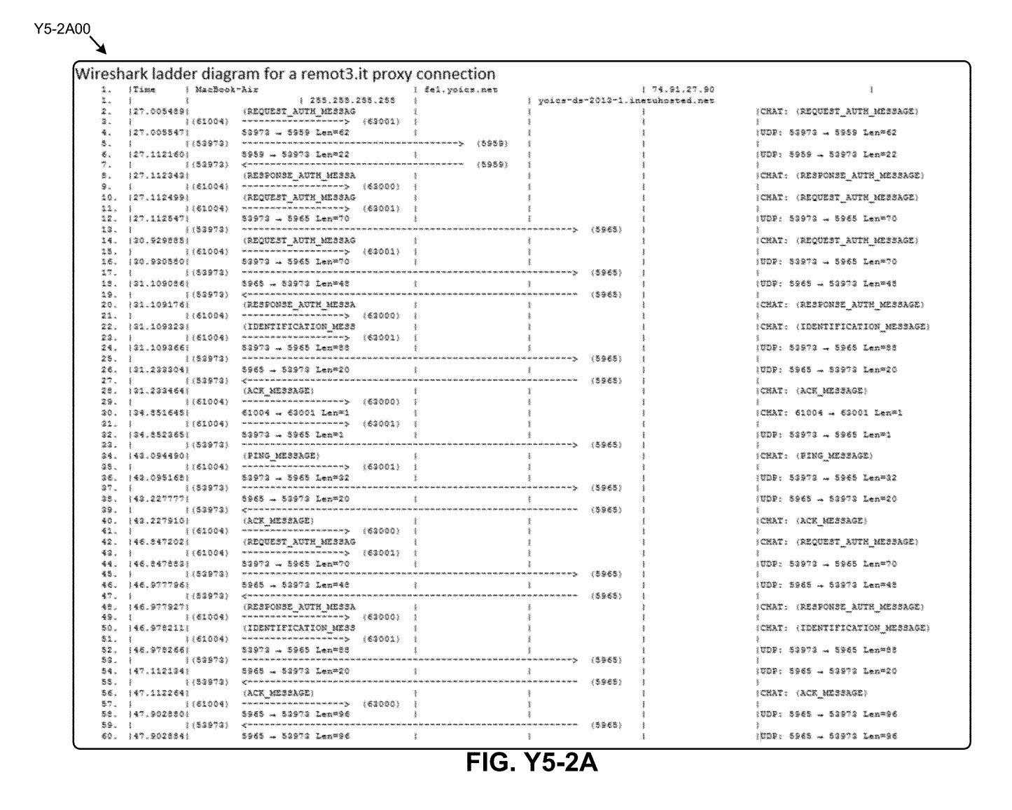

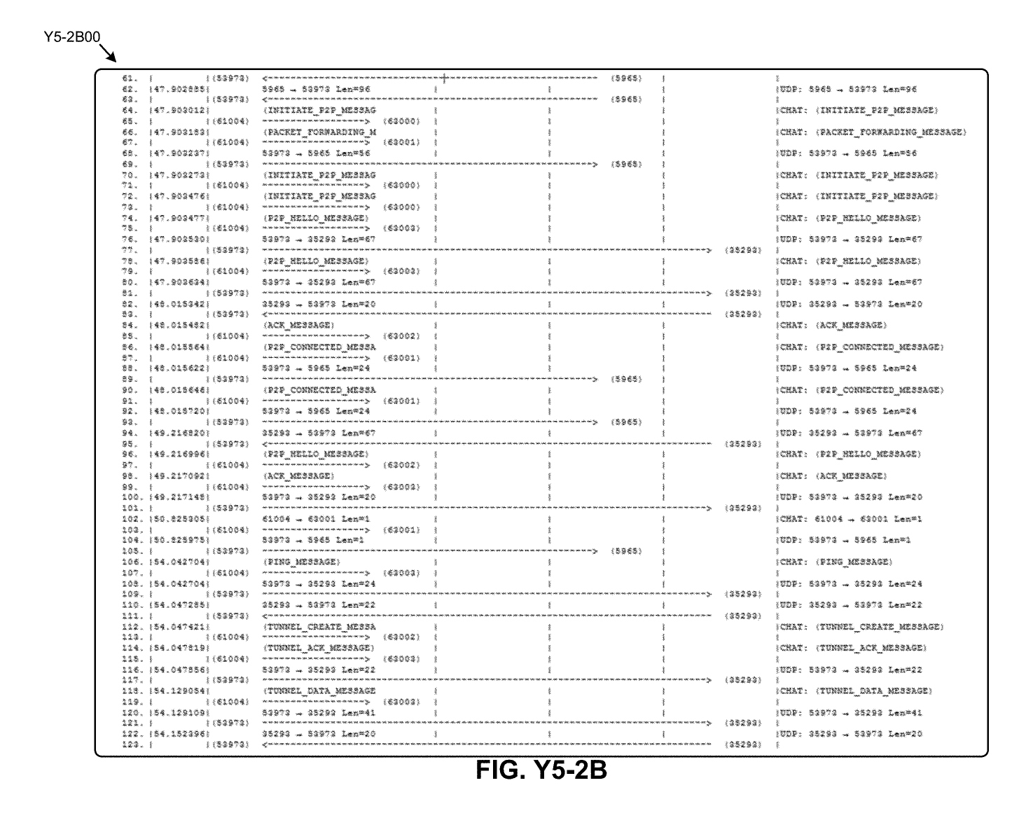

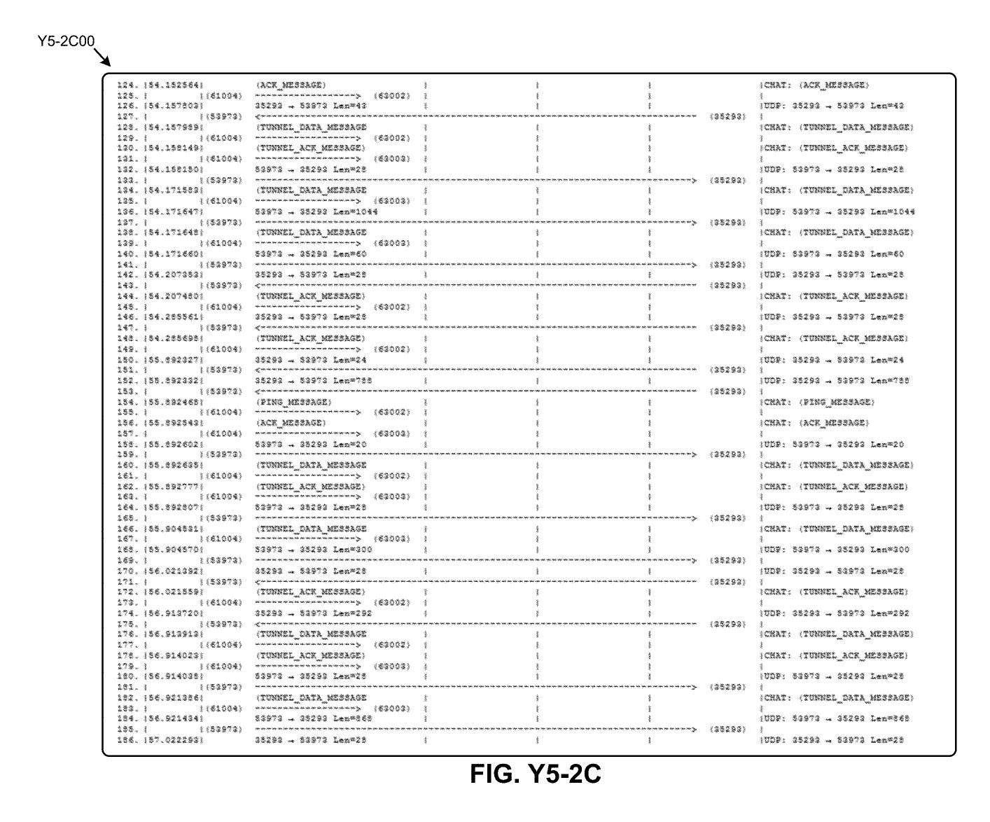

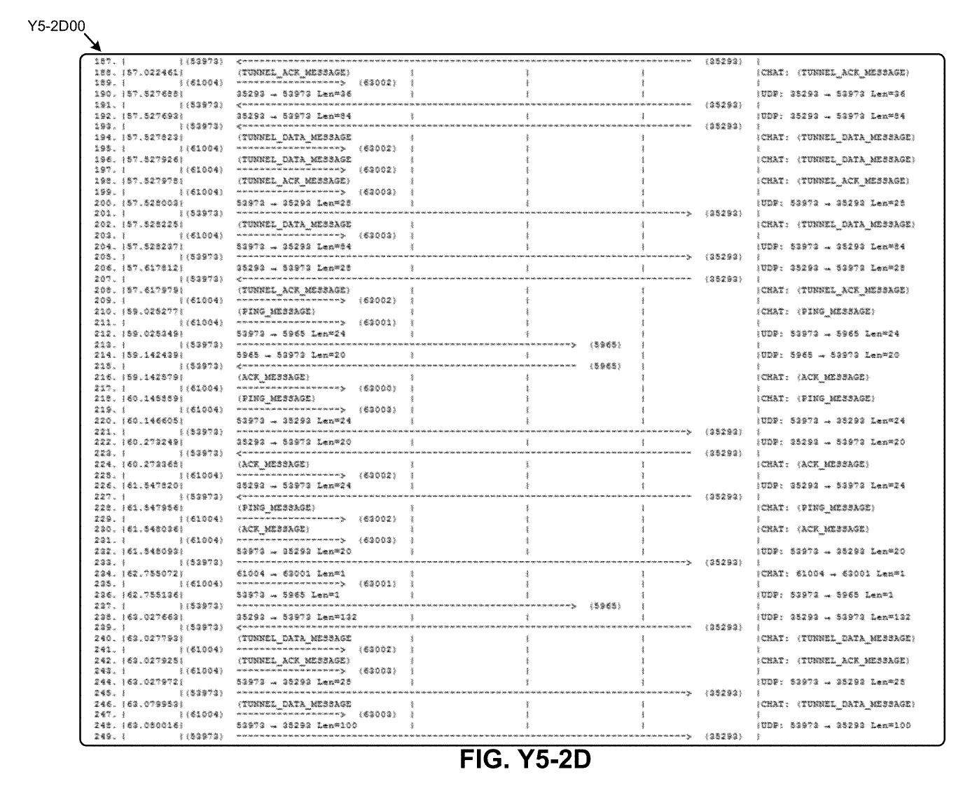

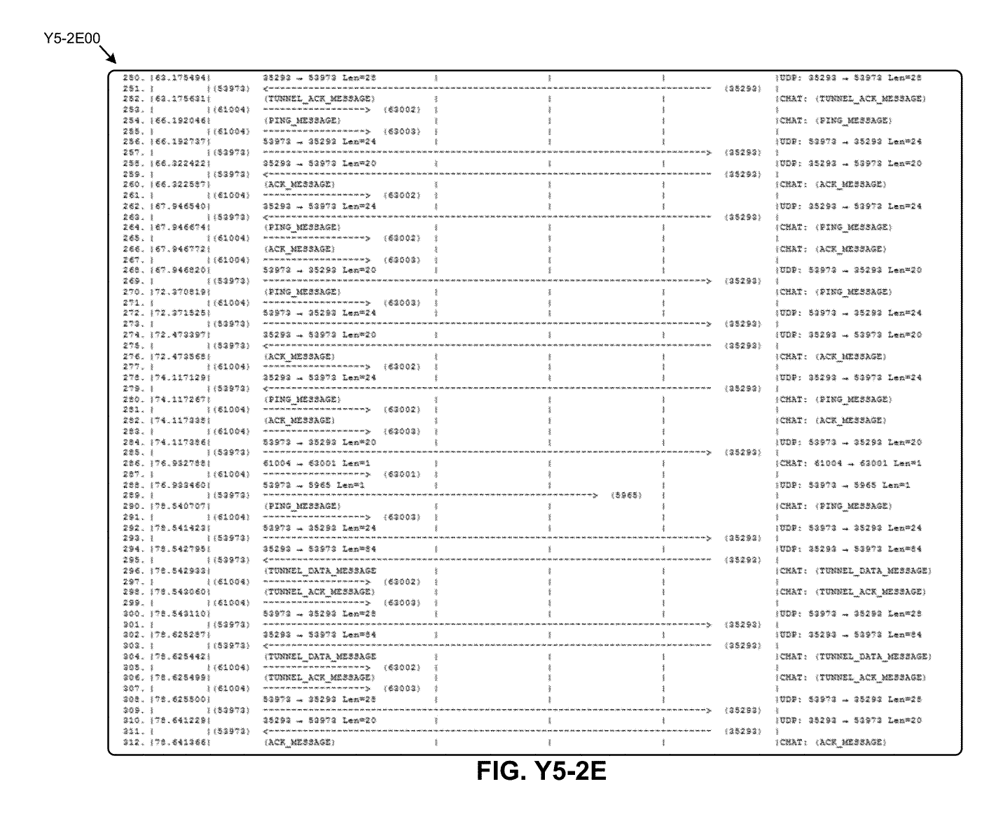

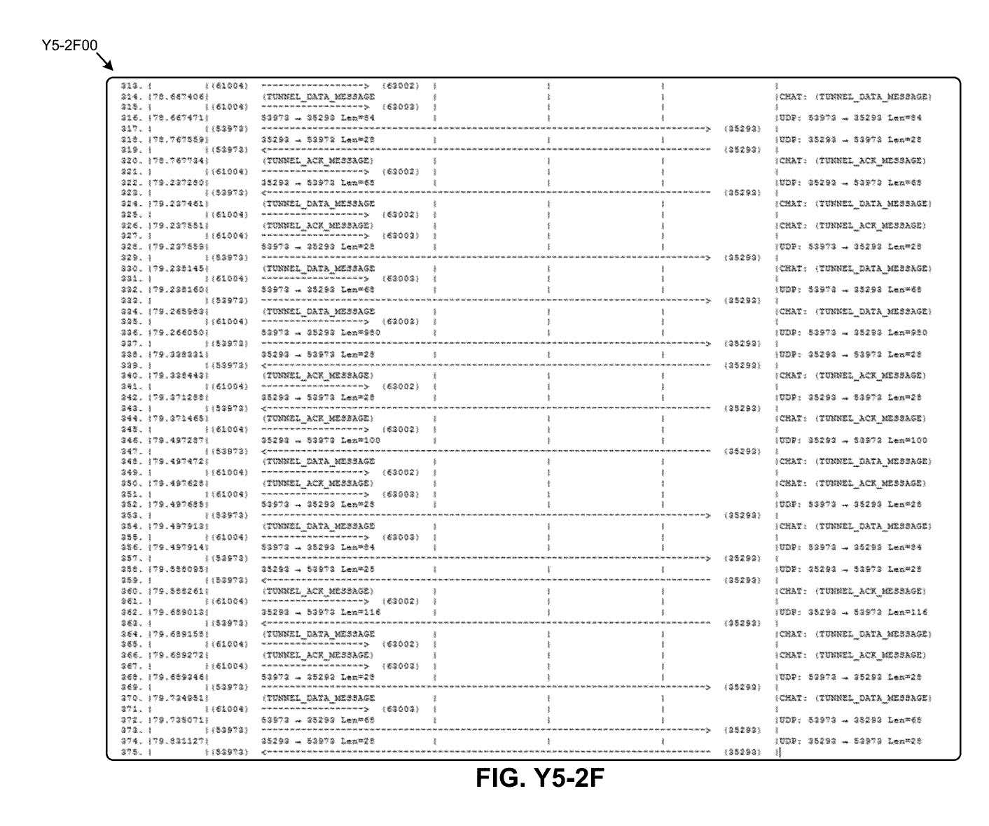

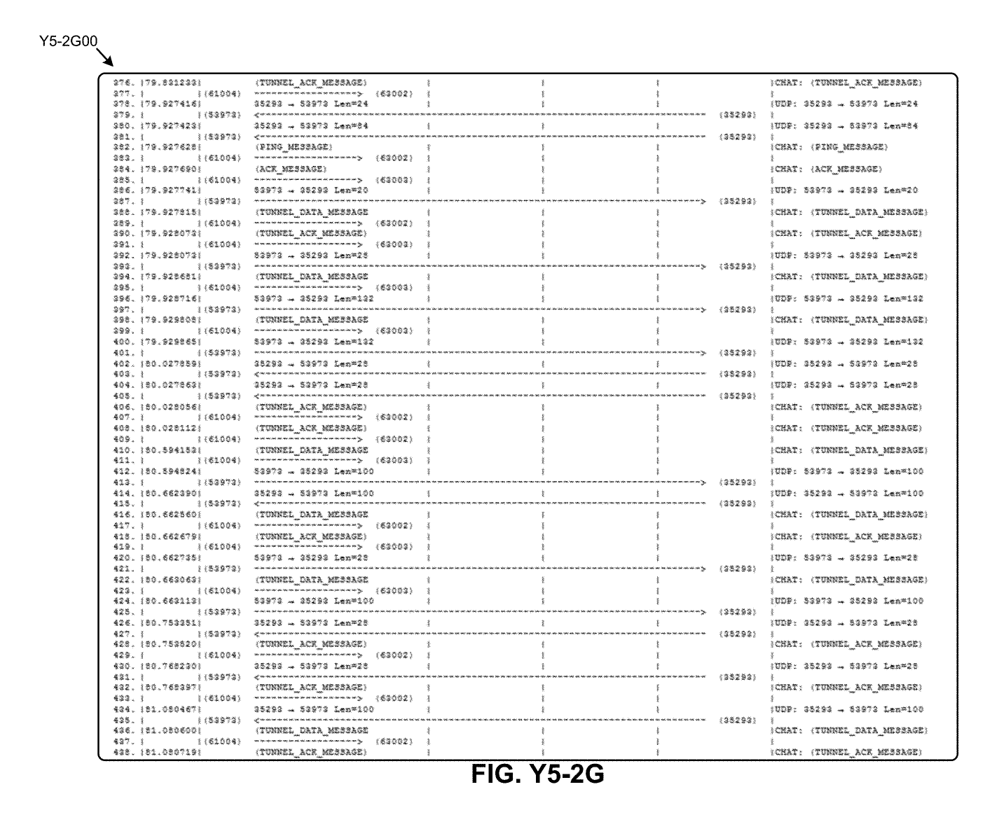

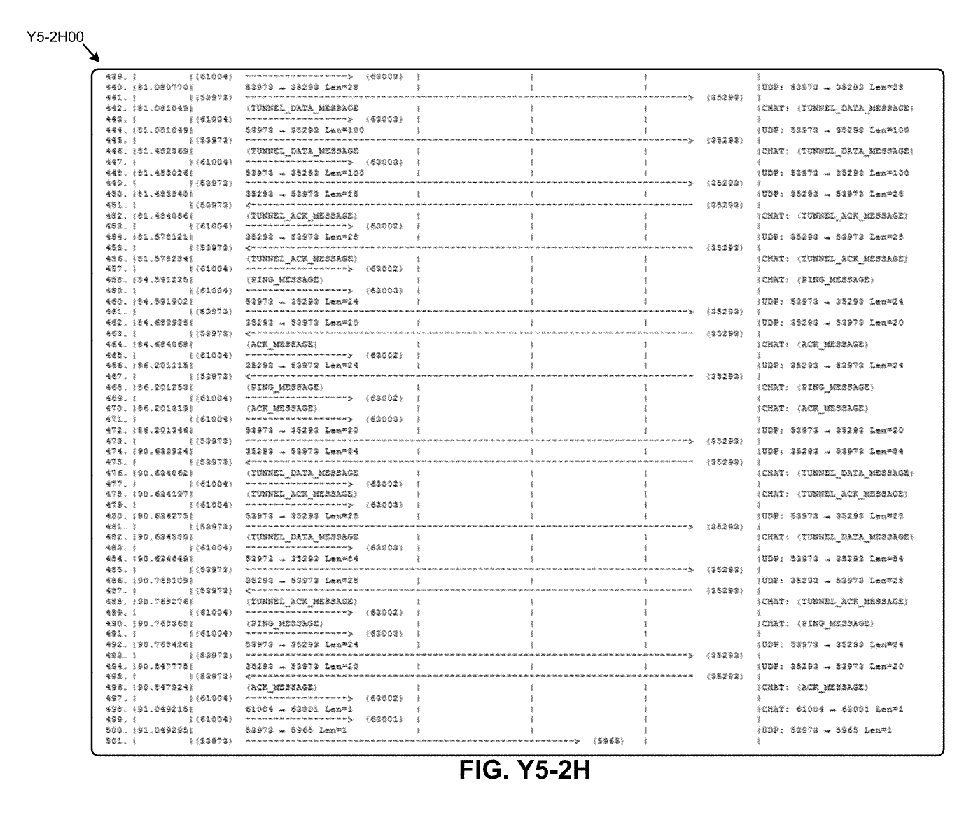

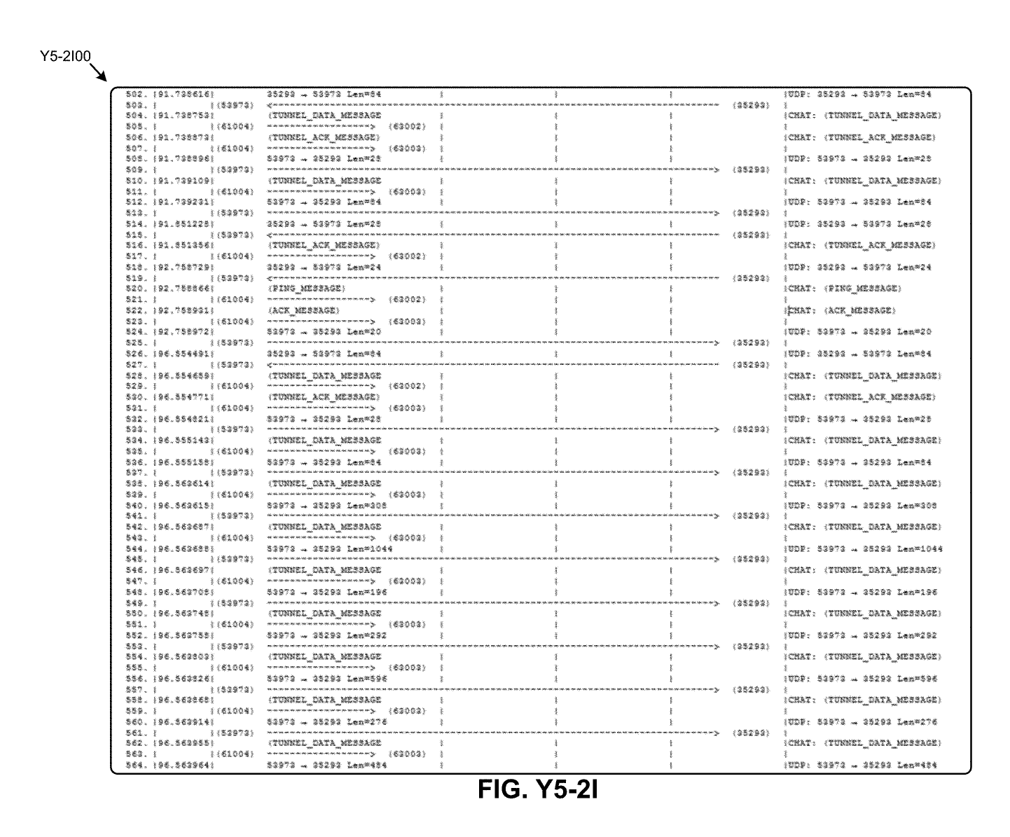

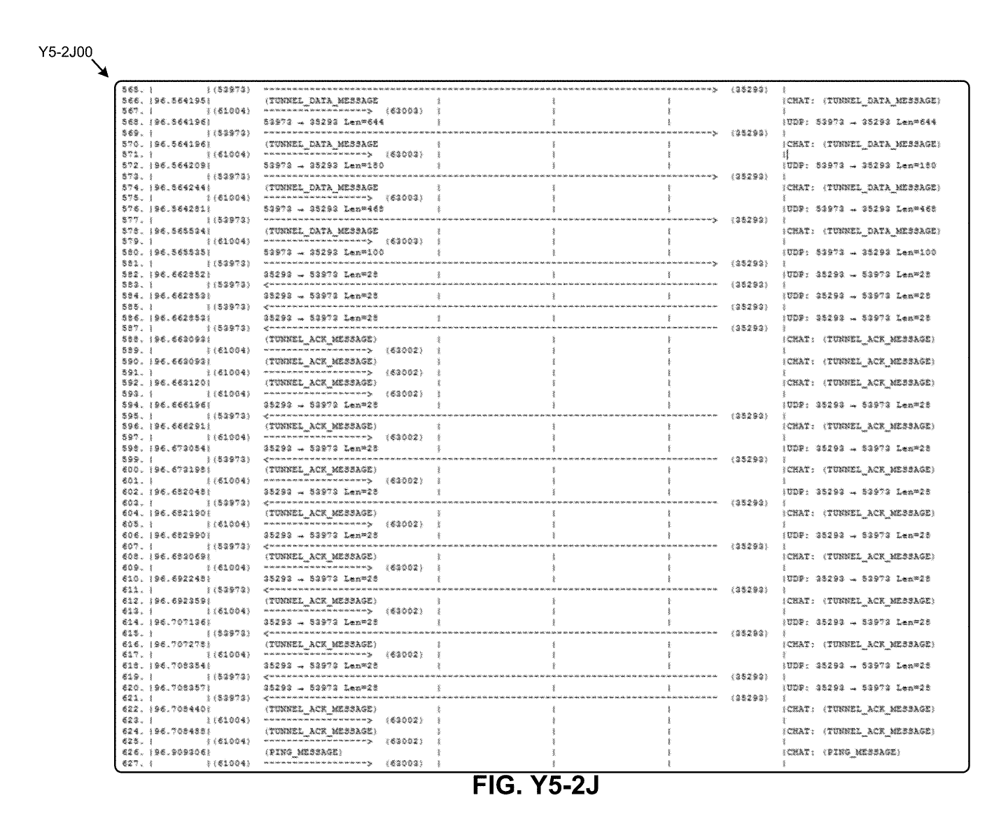

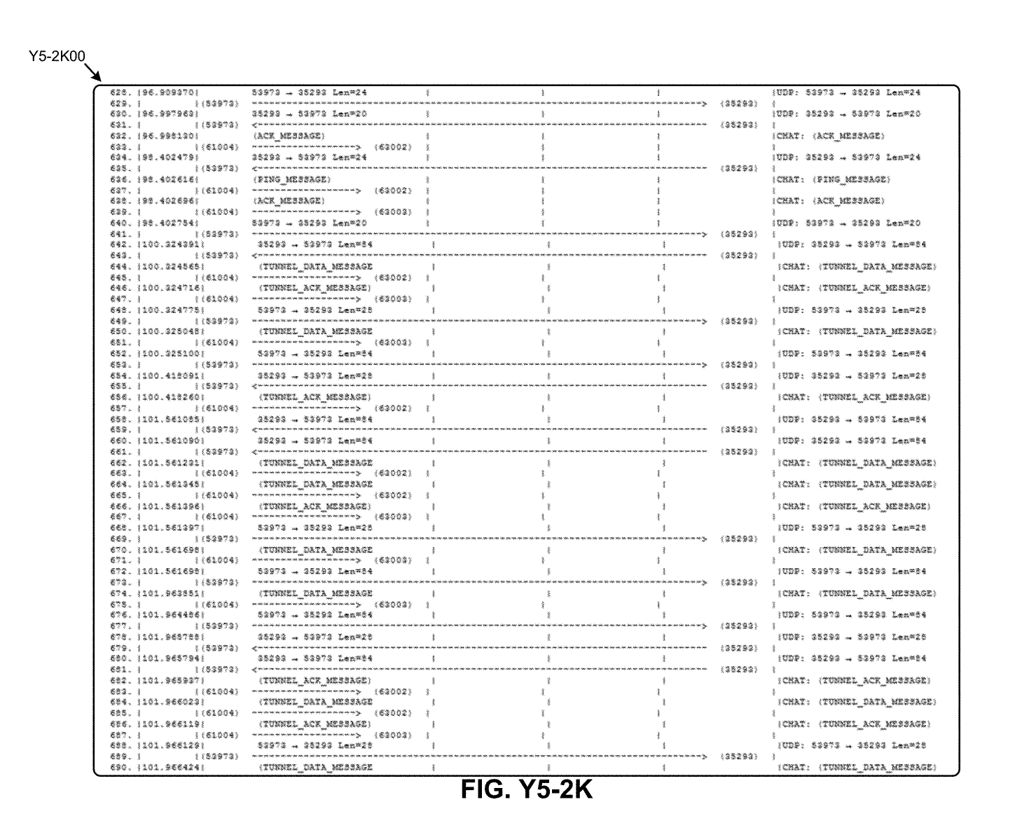

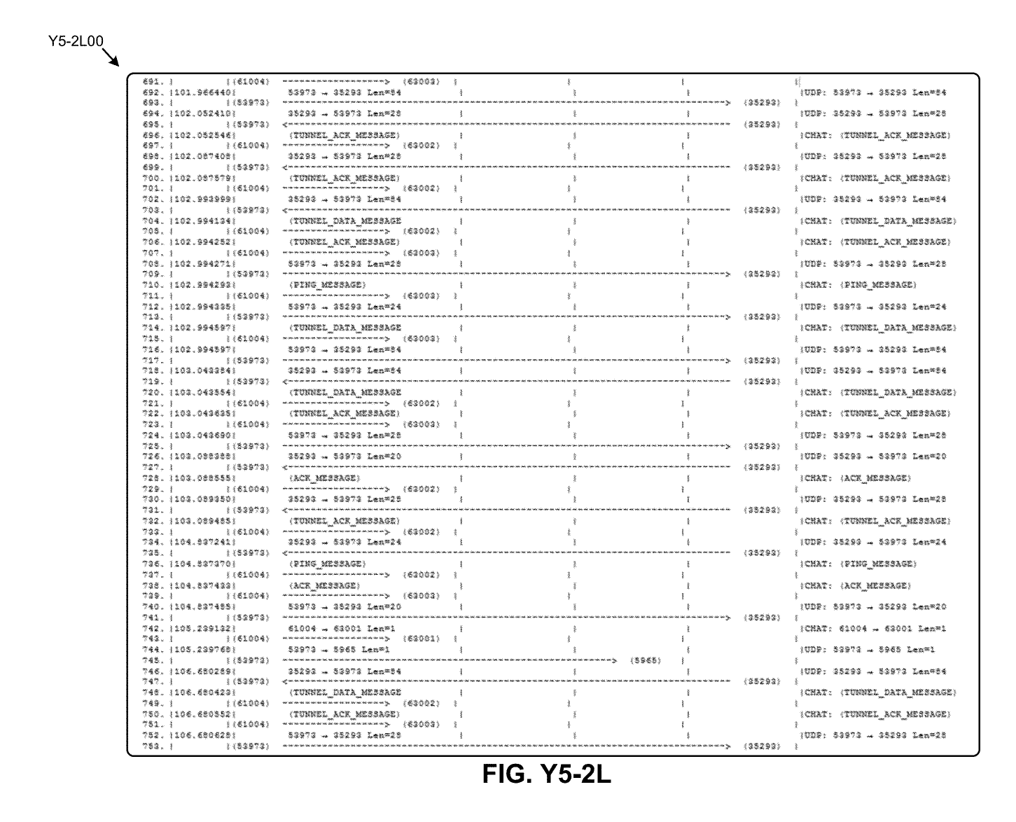

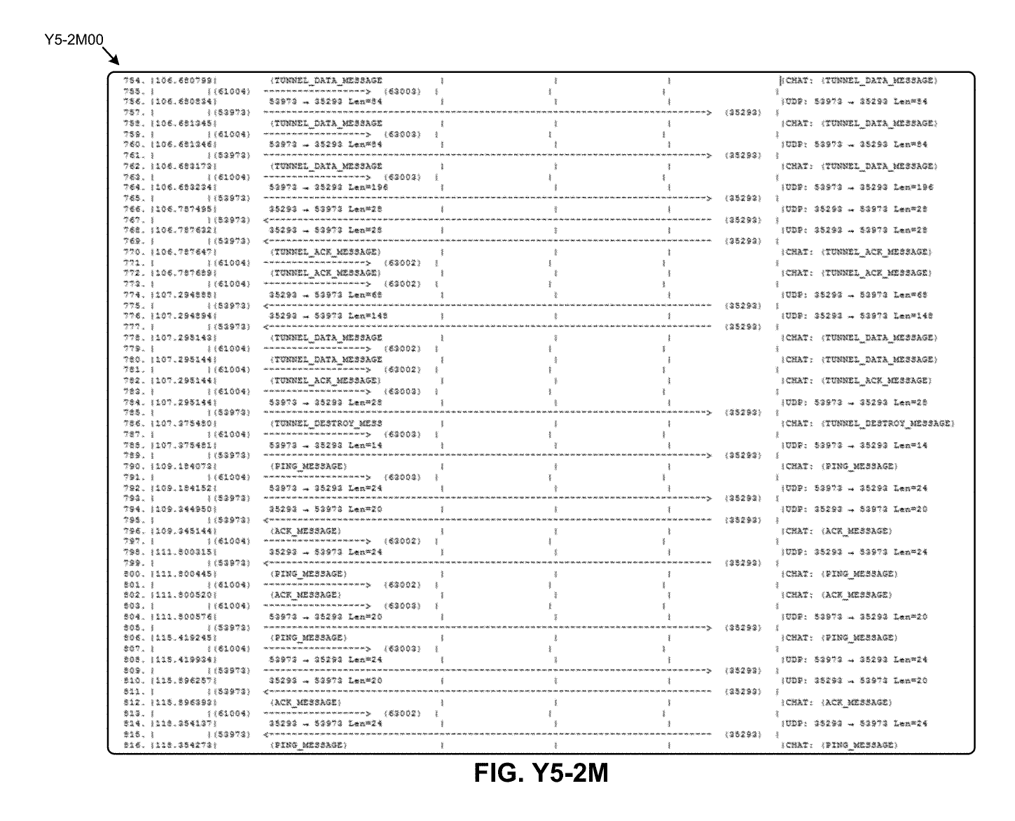

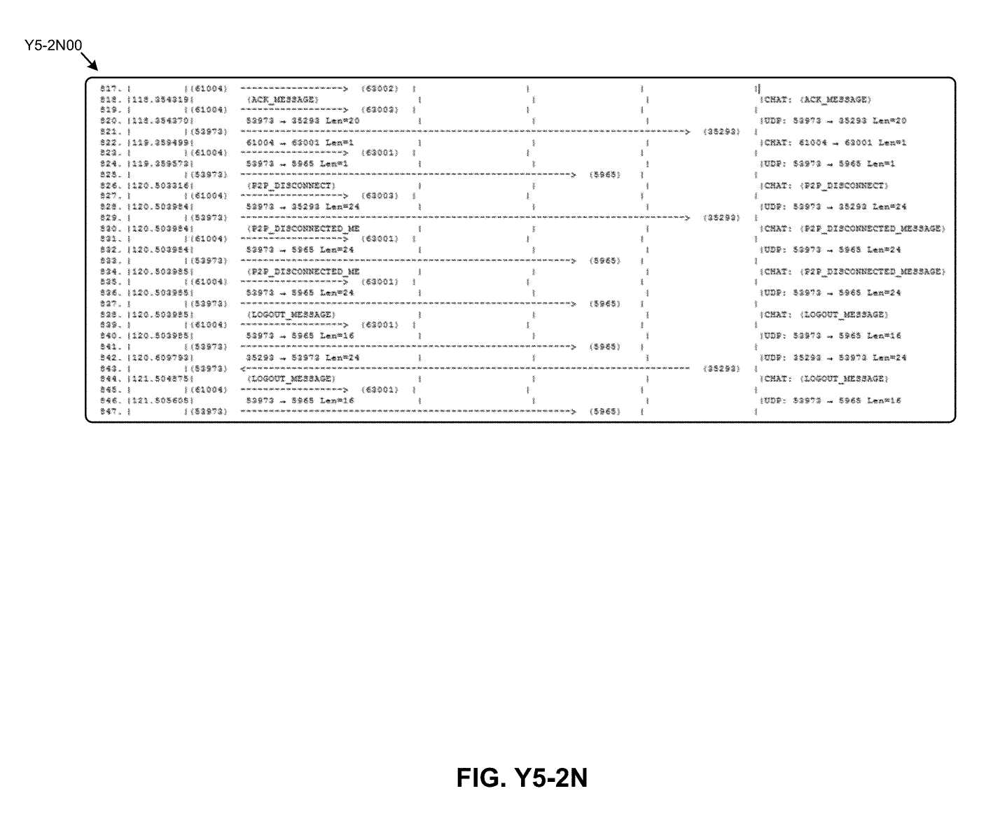

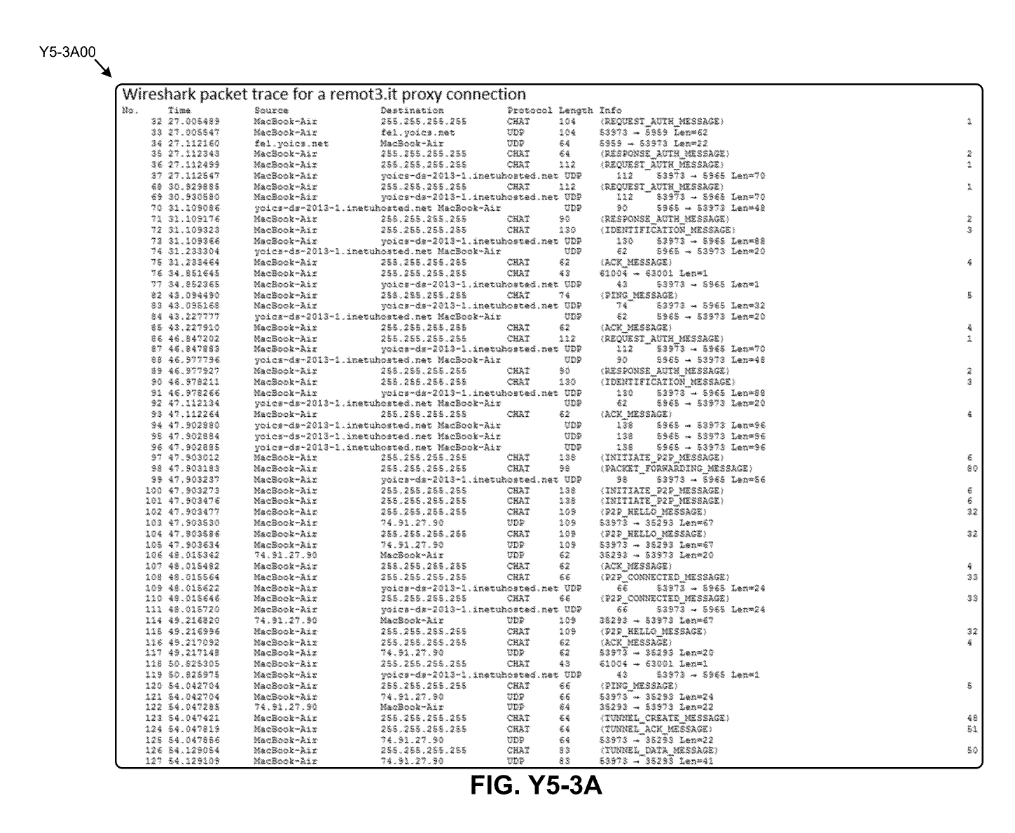

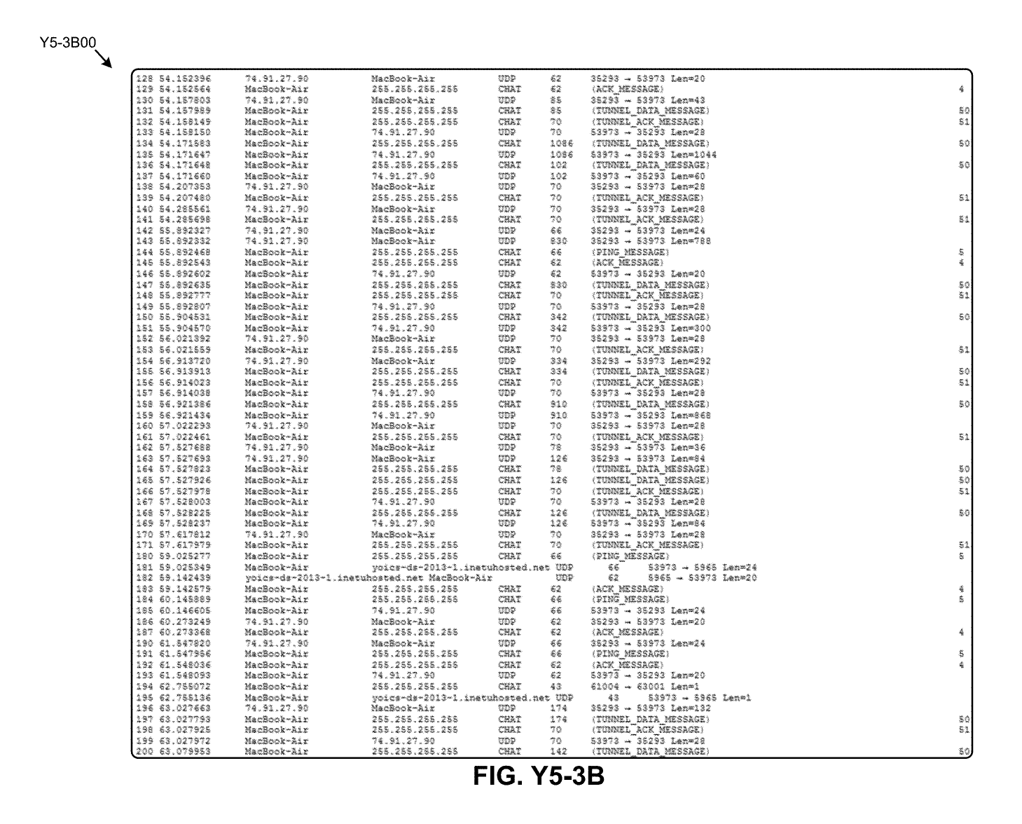

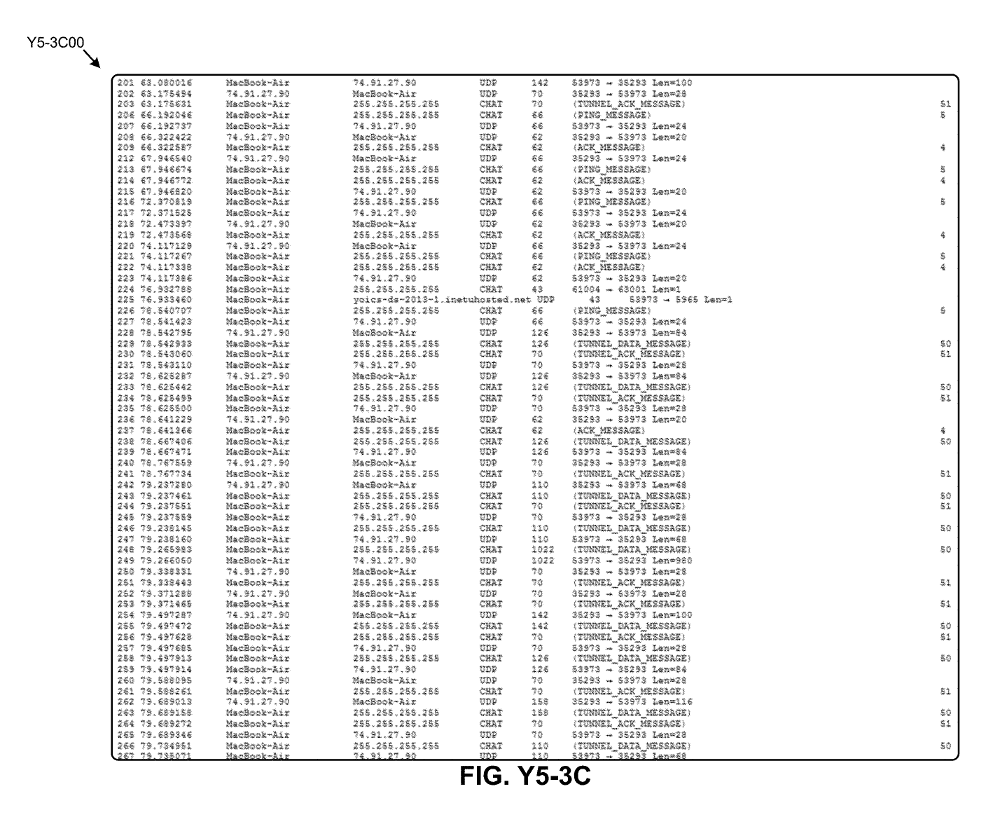

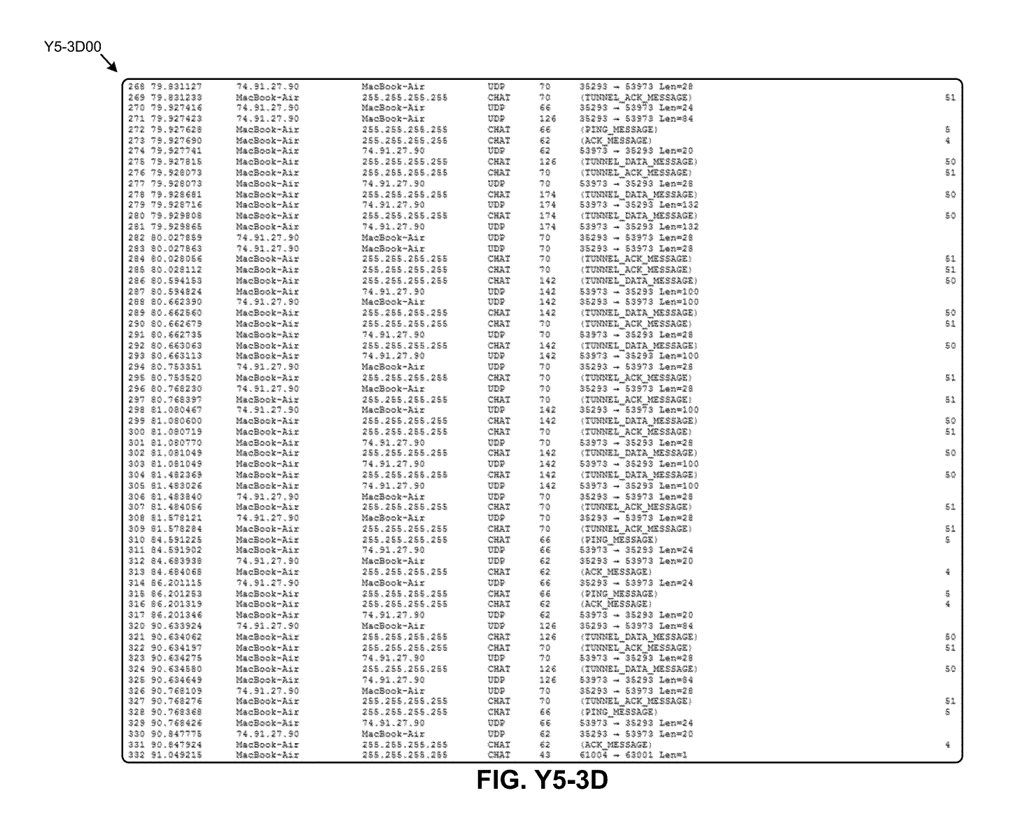

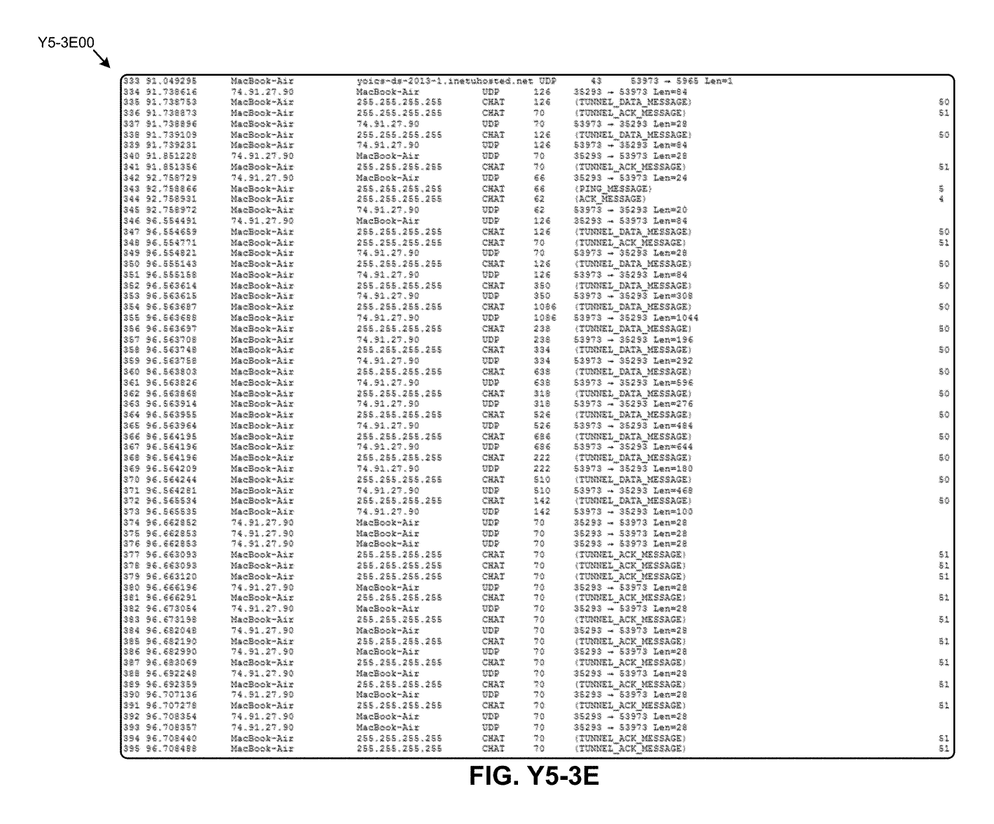

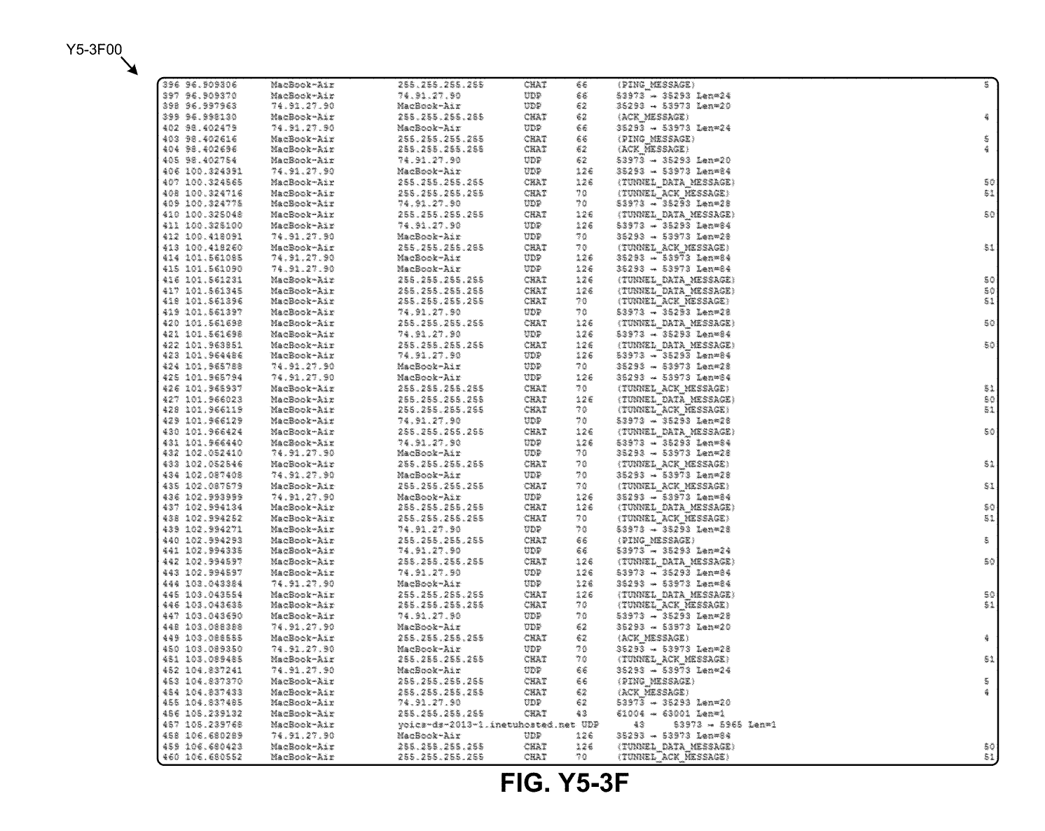

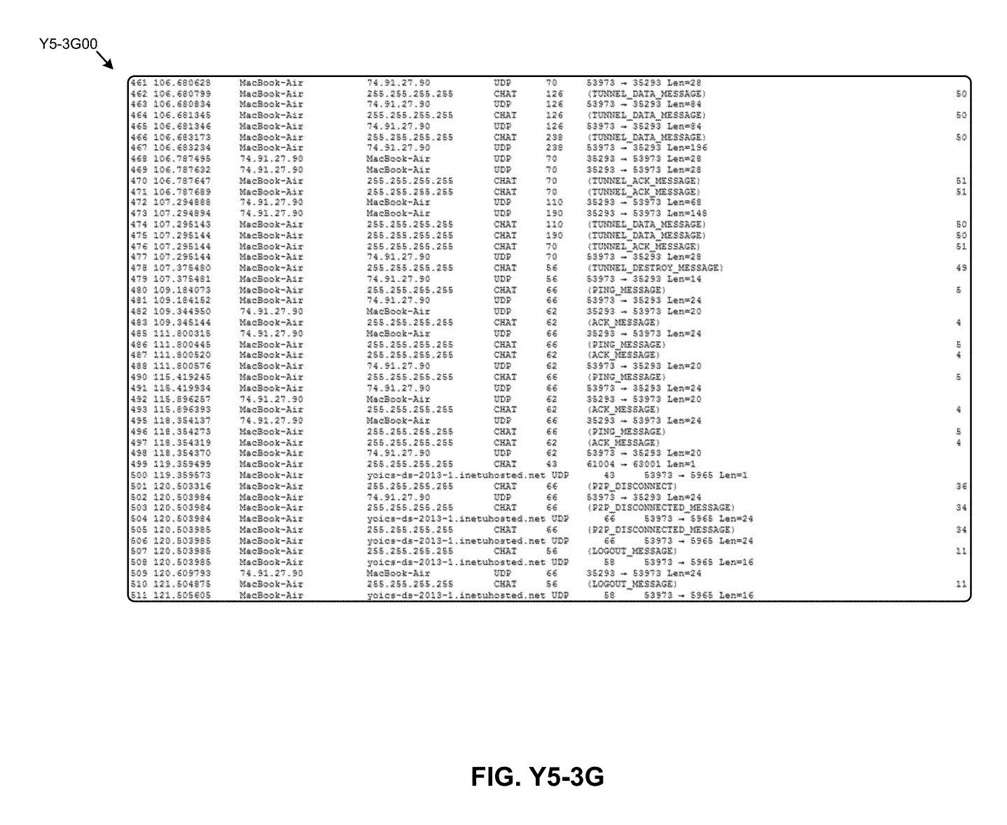

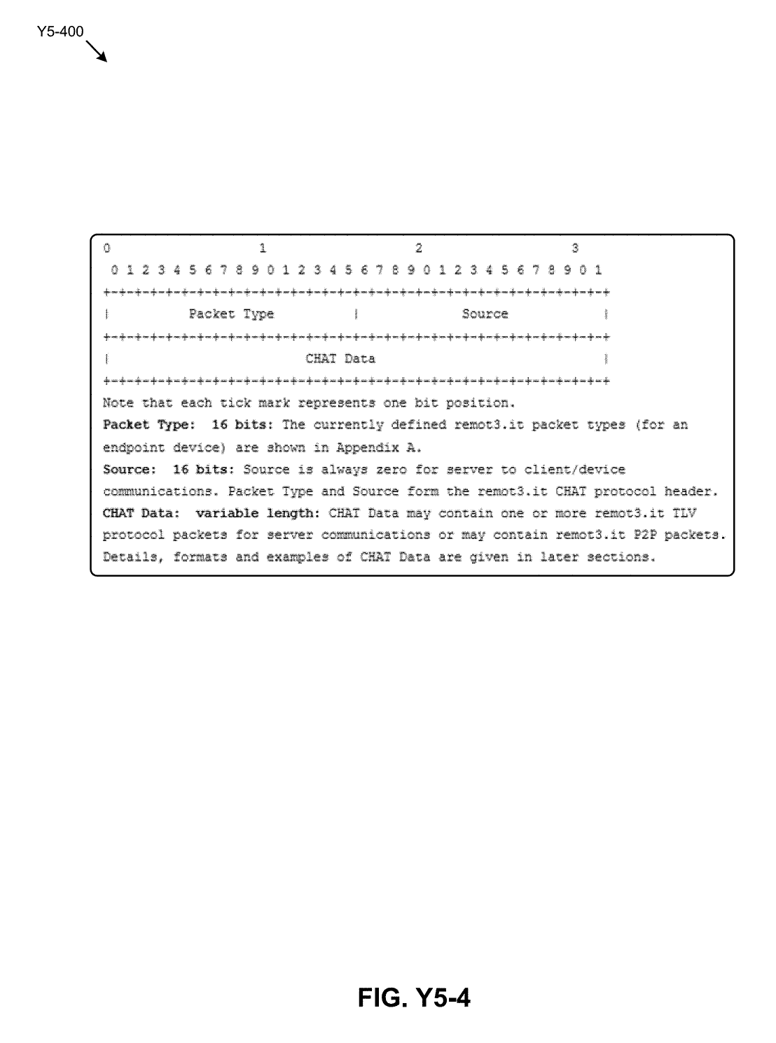

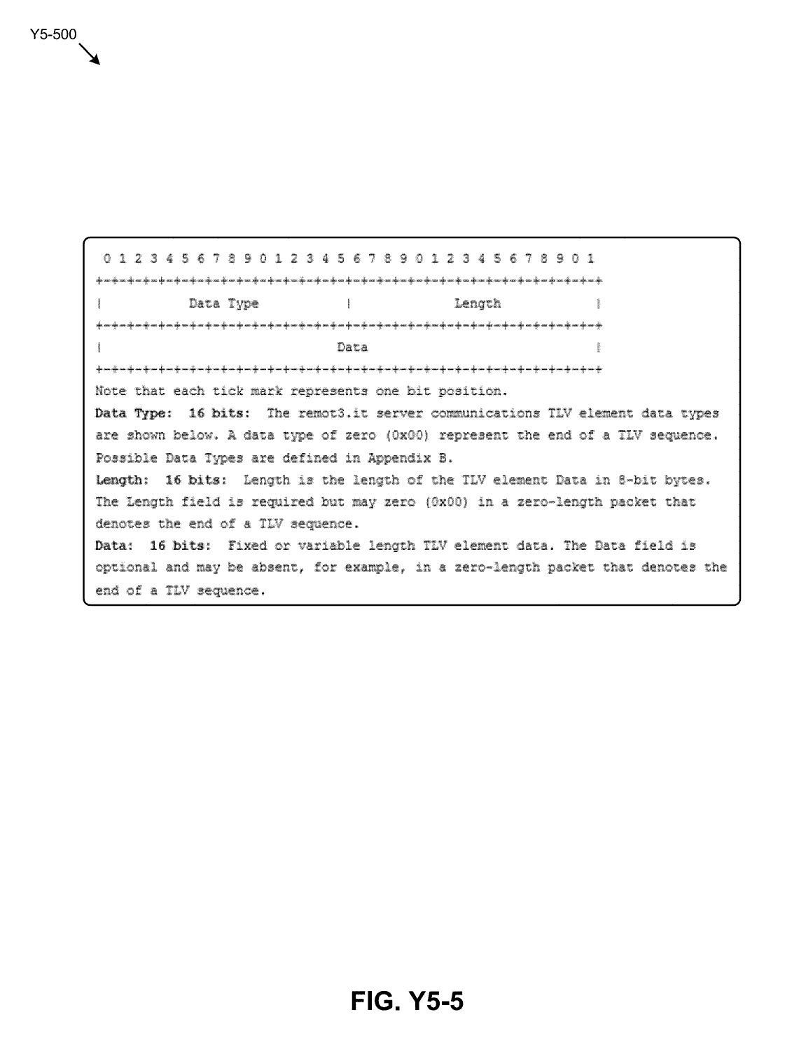

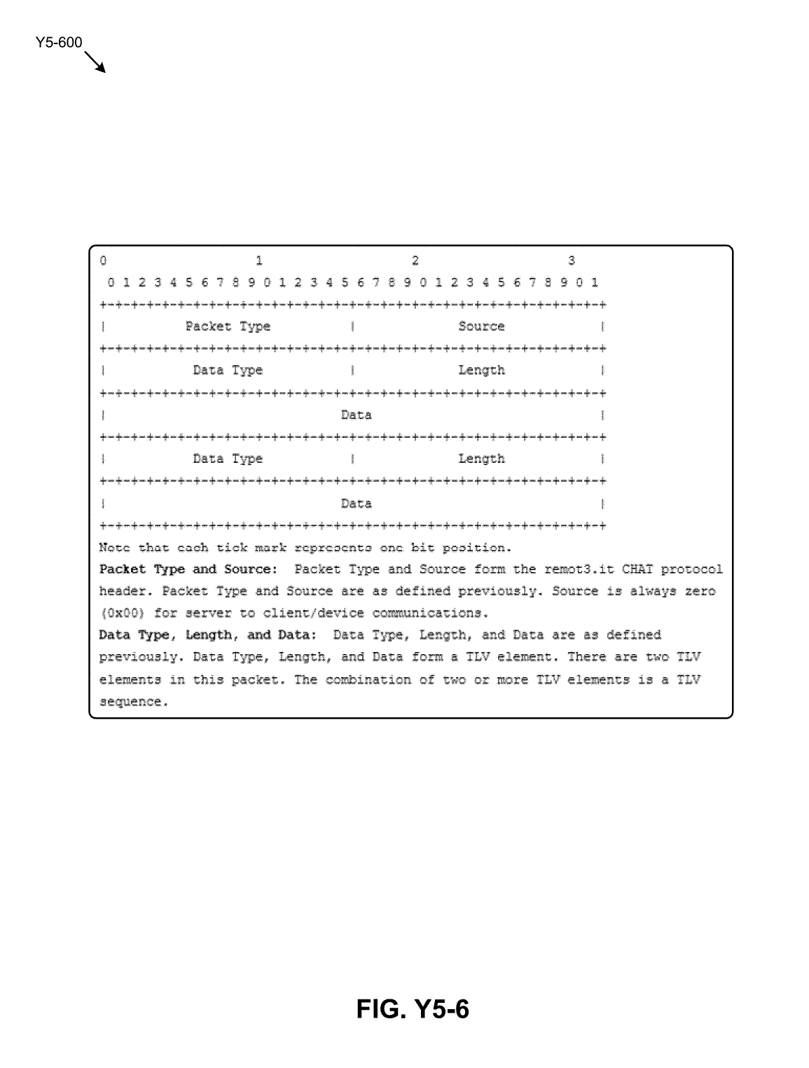

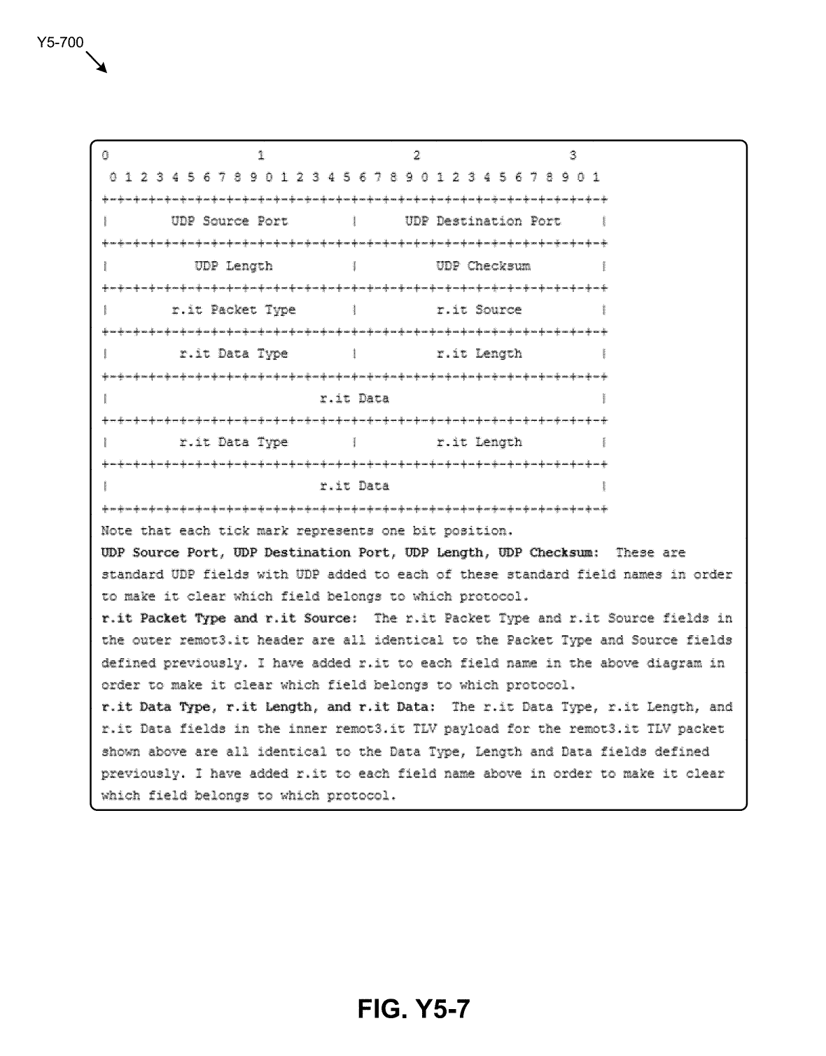

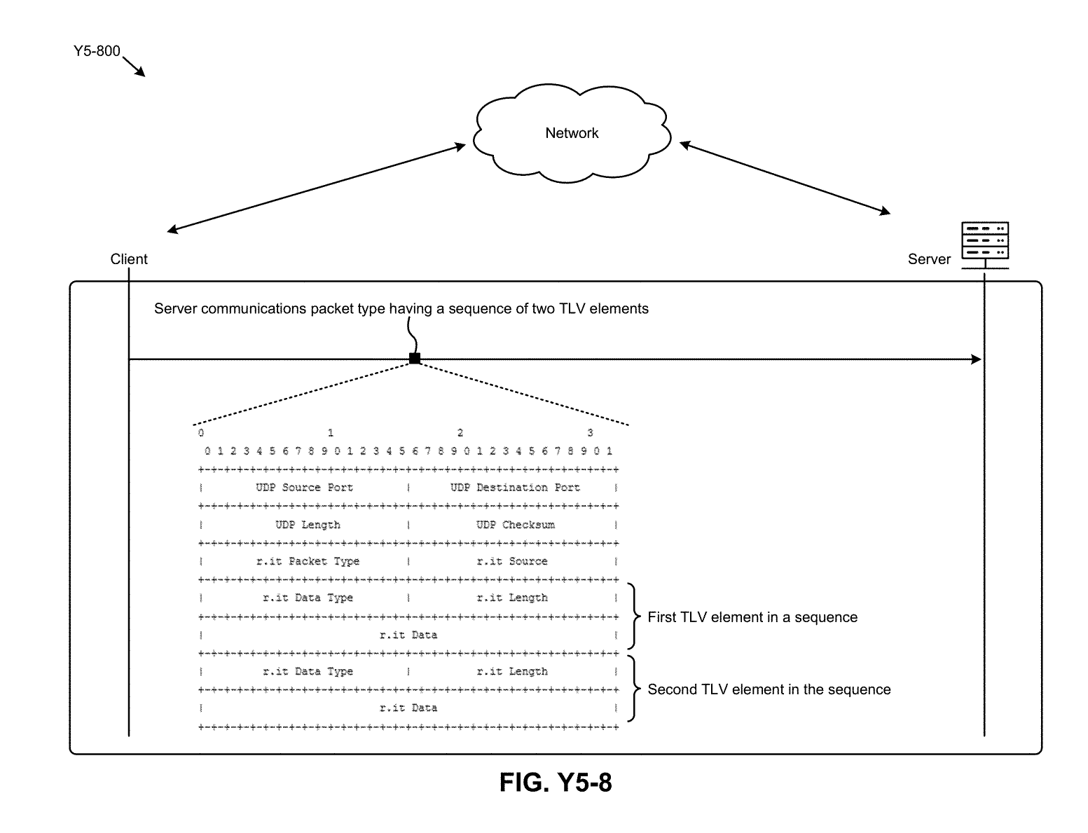

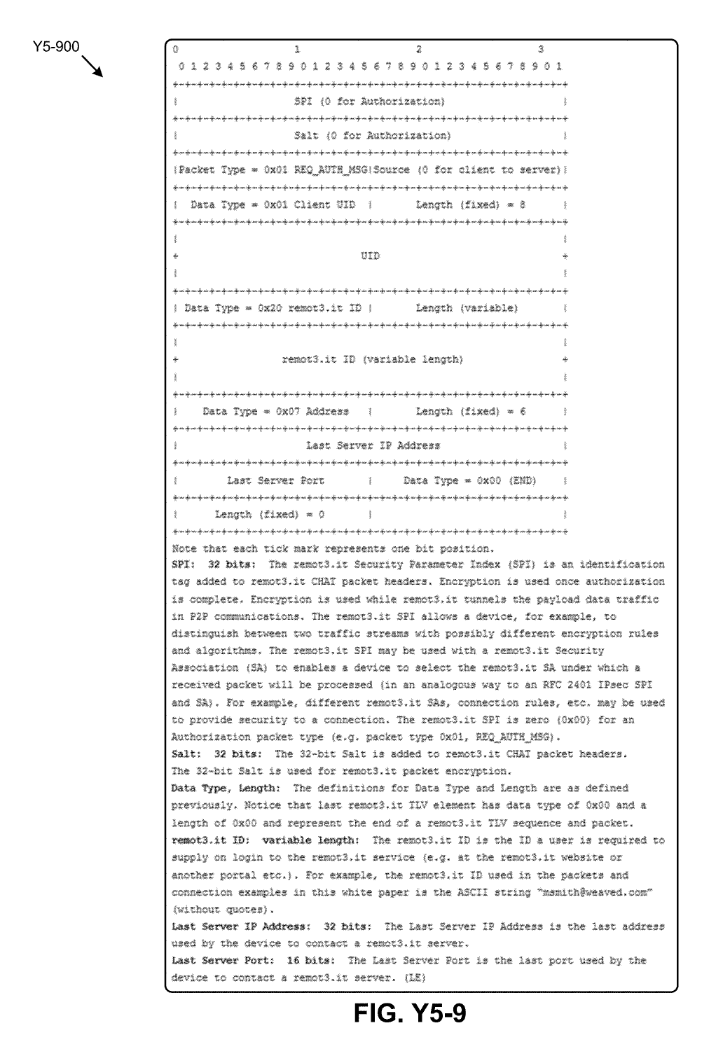

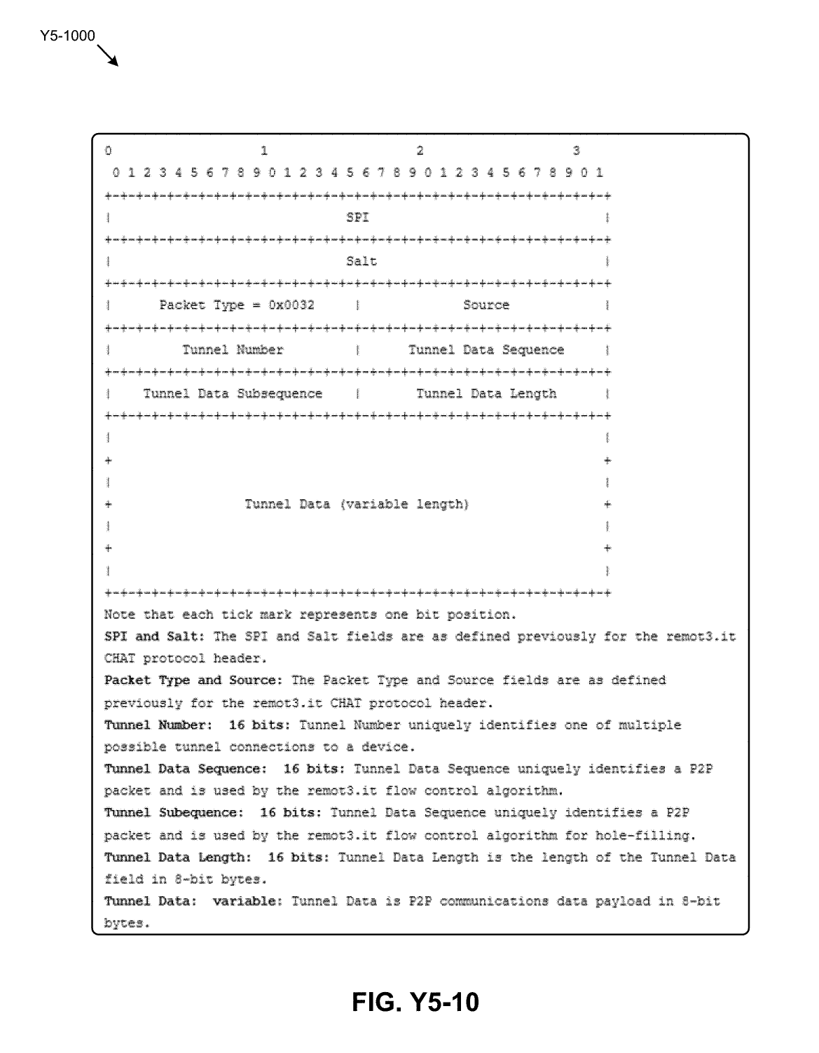

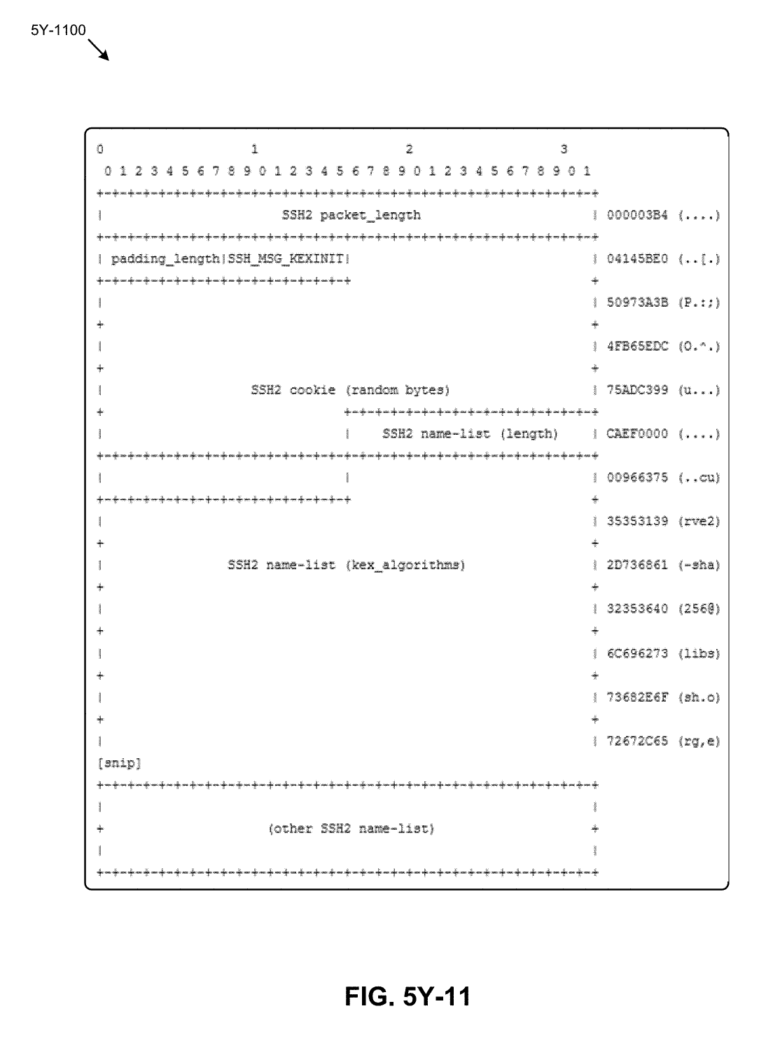

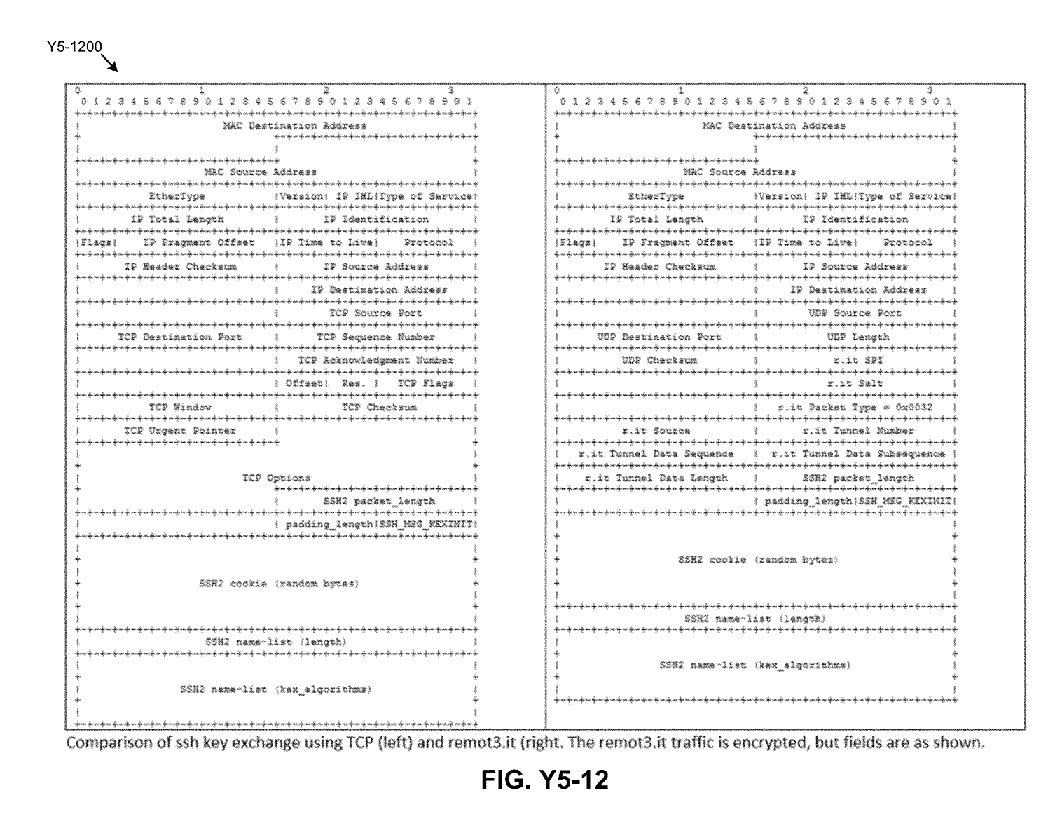

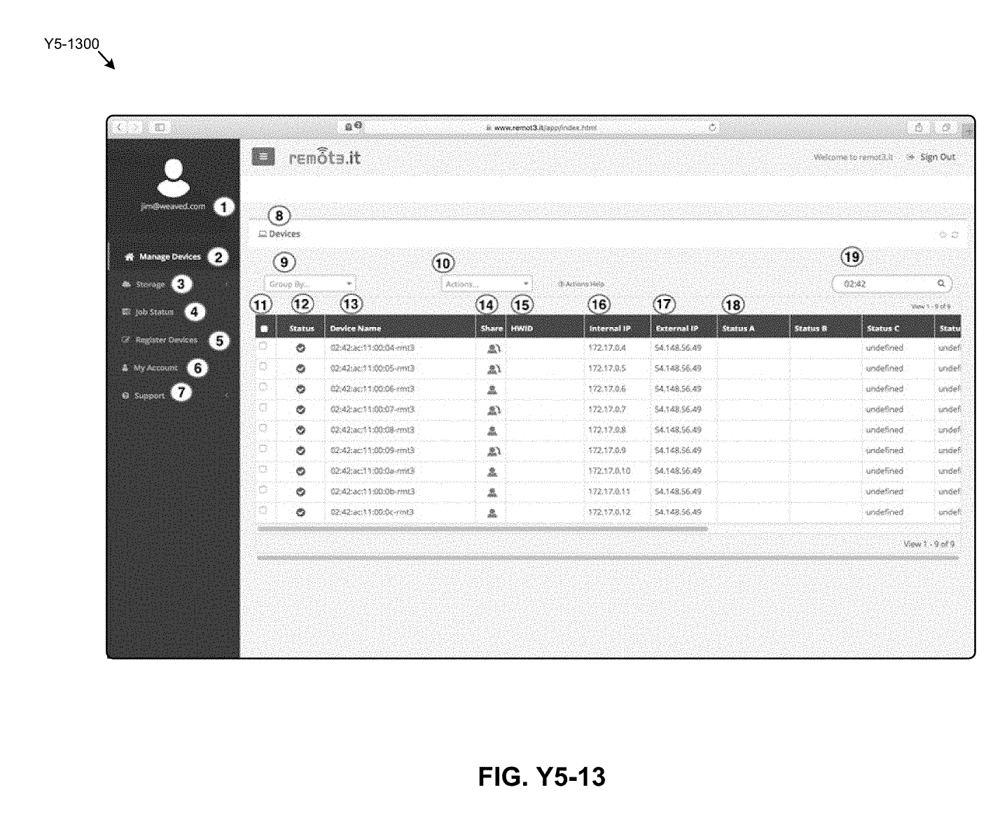

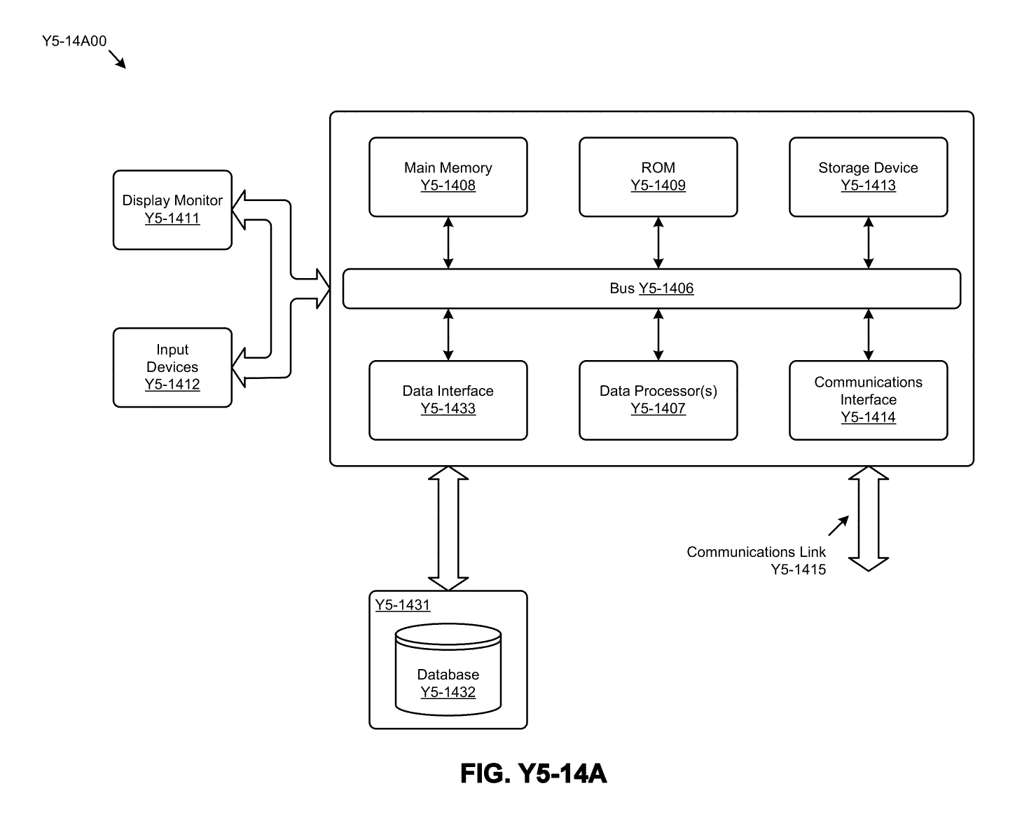

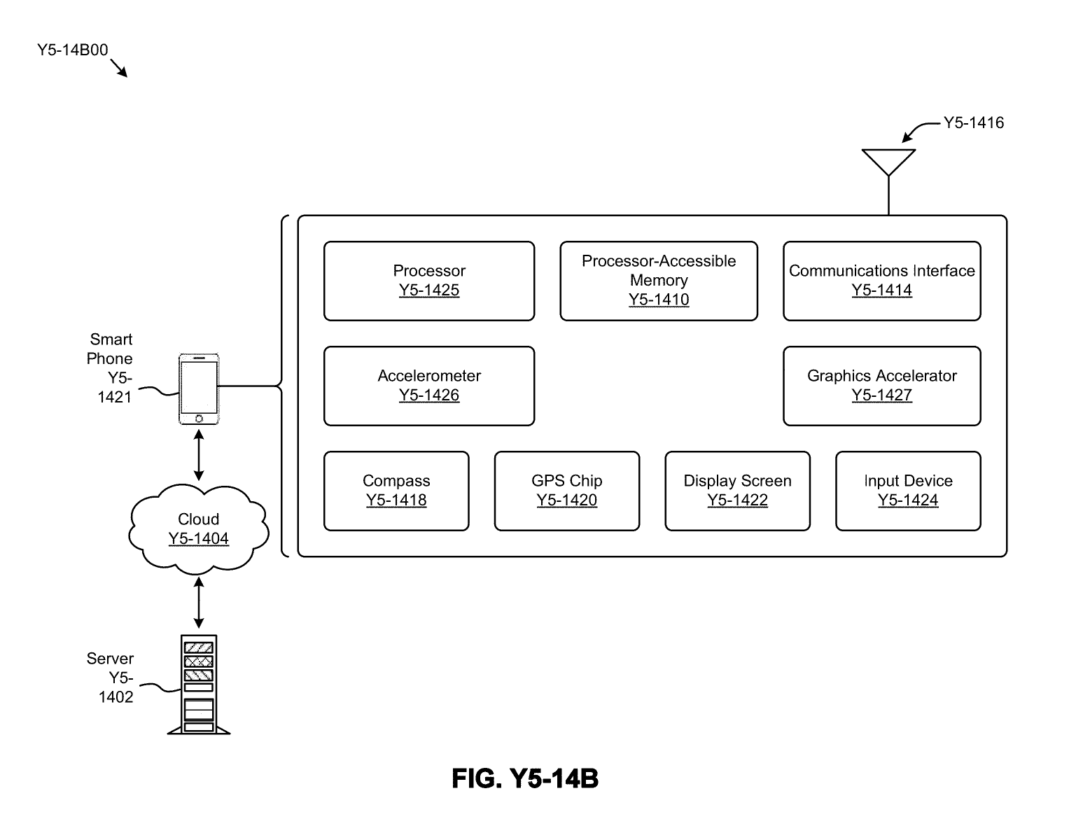

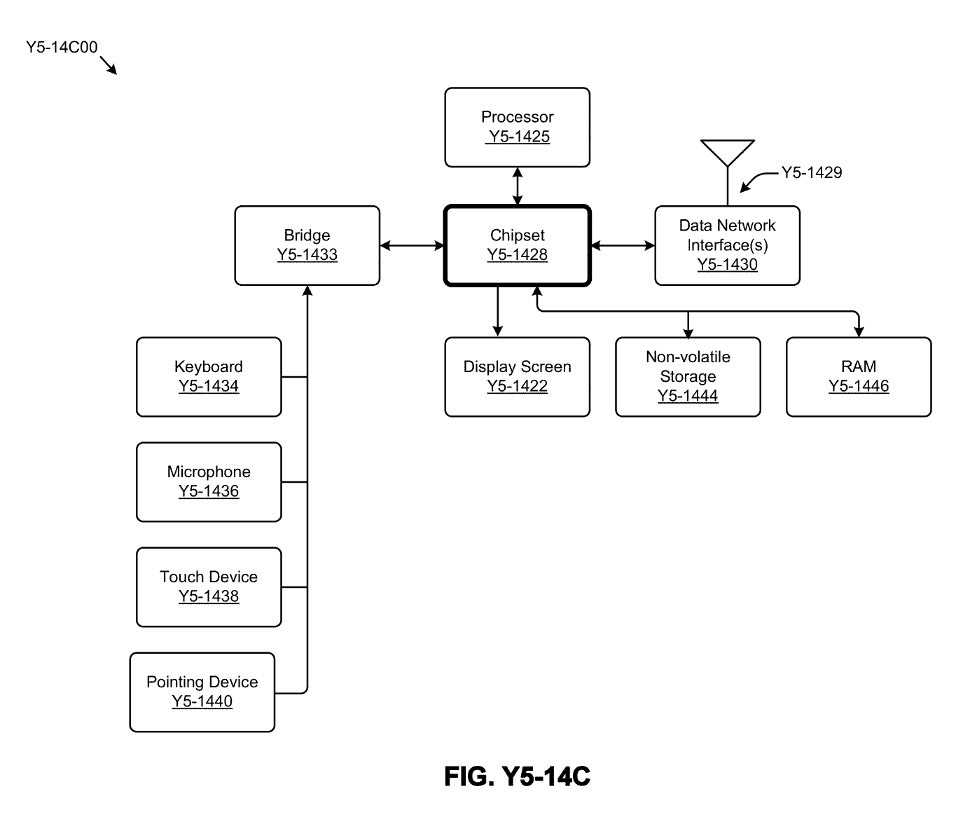

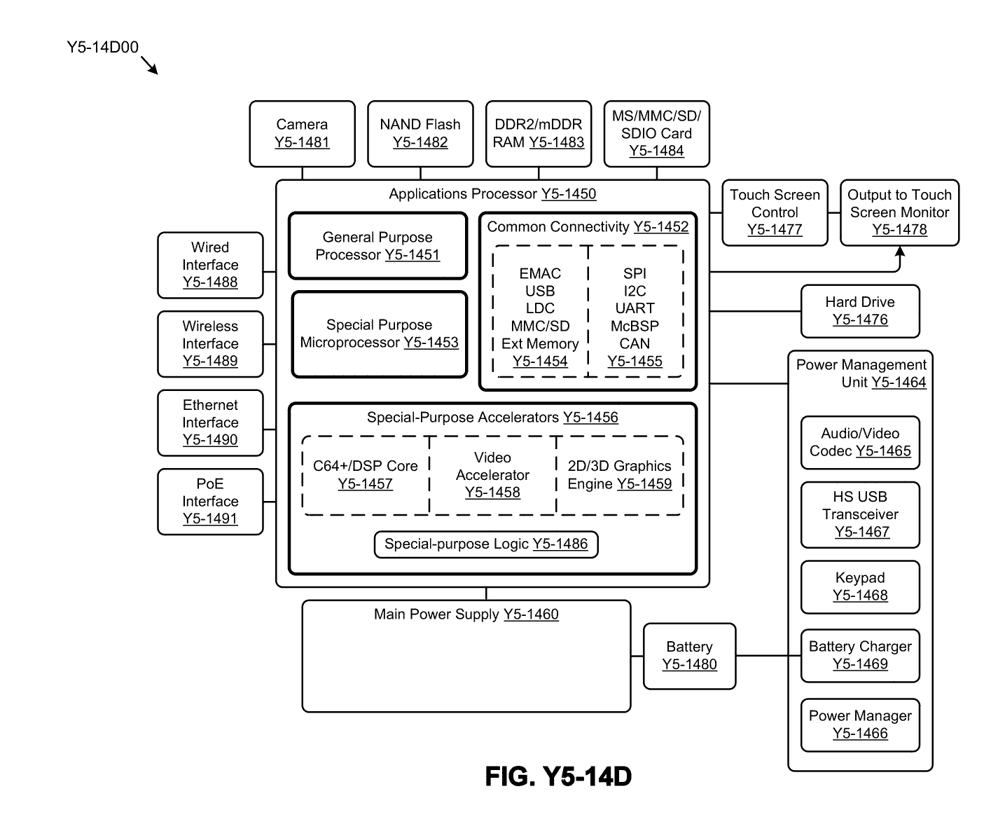

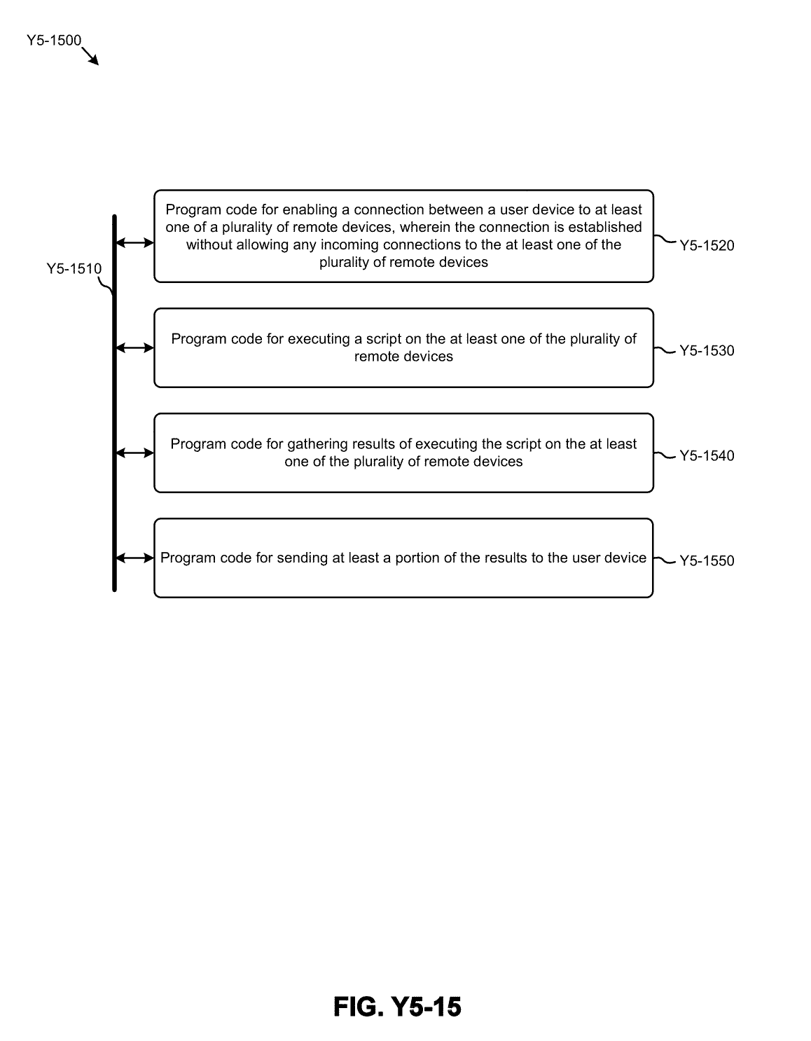

FIG. Y5-15 depicts a deployment scheme Y5-1500. FIG. 1012 depicts a block diagram of a system to perform certain functions of a computer system. As an option, the system Y5-1500 may be implemented in the context of the architecture and functionality of the embodiments described herein. Of course, however, the system Y5-1500 or any operation therein may be carried out in any desired environment. The system Y5-1500 comprises at least one processor and at least one memory, the memory serving to store program instructions corresponding to the operations of the system. An operation can be implemented in whole or in part using program instructions accessible by a module. The modules are connected to a communication path Y5-1510, and any operation can communicate with other operations over communication path Y5-1510. The modules of the system can, individually or in combination, perform method operations within system Y5-1500. Any operations performed within system Y5-1500 may be performed in any order unless as may be specified in the claims. The modules may be embedded in a device. The modules serve for accessing memory to hold program code instructions to perform: establishing a connection between a user device to at least one of a plurality of remote devices, wherein the connection is established without allowing any incoming connections to the at least one of the plurality of remote devices (module Y5-1520); executing a script on the at least one of the plurality of remote devices (module Y5-1530); gathering results of executing the script on the at least one of the plurality of remote devices (module Y5-1540); and sending at least a portion of the results to the user device (module Y5-1550).

It should be noted that, one or more aspects of the various embodiments of the present disclosure may be included in an article of manufacture (e.g., one or more computer program products) having, for instance, computer usable media. The media has embodied therein, for instance, computer readable program code for providing and facilitating the capabilities of the various embodiments of the present disclosure. The article of manufacture can be included as a part of a computer system or sold separately.

Additionally, one or more aspects of the various embodiments of the present disclosure may be designed using computer readable program code for providing and/or facilitating the capabilities of the various embodiments or configurations of embodiments of the present disclosure.

Additionally, one or more aspects of the various embodiments of the present disclosure may use computer readable program code embodied on a non-transitory computer readable medium for providing and facilitating the capabilities of the various embodiments or configurations of embodiments of the present disclosure and that may be included as a part of a computer system and/or memory system and/or sold separately.

Additionally, at least one program storage device readable by a machine, tangibly embodying at least one program of instructions executable by the machine to perform the capabilities of the various embodiments of the present disclosure can be provided.

The diagrams depicted herein are just examples. There may be many variations to these diagrams or the steps (or operations) described therein without departing from the spirit of the various embodiments of the disclosure. For instance, the steps may be performed in a differing order, or steps may be added, deleted or modified.

In various optional embodiments, the features, capabilities, techniques, and/or technology, etc. of the memory and/or storage devices, networks, mobile devices, peripherals, hardware, and/or software, etc. disclosed in the following applications may or may not be incorporated into any of the embodiments disclosed herein.

References in this specification and/or references in specifications incorporated by reference to “one embodiment” may mean that particular aspects, architectures, functions, features, structures, characteristics, etc. of an embodiment that may be described in connection with the embodiment may be included in at least one implementation. Thus references to “in one embodiment” may not necessarily refer to the same embodiment. The particular aspects, etc. may be included in forms other than the particular embodiment described and/or illustrated and all such forms may be encompassed within the scope and claims of the present application.

References in this specification and/or references in specifications incorporated by reference to “for example” may mean that particular aspects, architectures, functions, features, structures, characteristics, etc. described in connection with the embodiment or example may be included in at least one implementation. Thus references to an “example” may not necessarily refer to the same embodiment, example, etc. The particular aspects, etc. may be included in forms other than the particular embodiment or example described and/or illustrated and all such forms may be encompassed within the scope and claims of the present application.

This specification and/or specifications incorporated by reference may refer to a list of alternatives. For example, a first reference such as “A (e.g., B, C, D, E, etc.)” may refer to a list of alternatives to A including (but not limited to) B, C, D, E. A second reference to “A, etc.” may then be equivalent to the first reference to “A (e.g., B, C, D, E, etc.).” Thus, a reference to “A, etc.” may be interpreted to mean “A (e.g., B, C, D, E, etc.).”

It may thus be seen from the examples provided above that the improvements to devices (e.g., as shown in the contexts of the figures included in this specification, for example) may be used in various applications, contexts, environments, etc. The applications, uses, etc. of these improvements, etc. may not be limited to those described above, but may be used, for example, in combination. For example, one or more applications, etc. used in the contexts, for example, in one or more figures may be used in combination with one or more applications, etc. used in the contexts of, for example, one or more other figures and/or one or more applications, etc. described in any specifications incorporated by reference. Further, while various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method comprising:
establishing a connection between a user device and at least one of a plurality of remote devices, wherein the connection is established without allowing any incoming connections to the at least one of the plurality of remote devices;
executing a script on the at least one of the plurality of remote devices;
gathering results of executing the script on the at least one of the plurality of remote devices; and
sending at least a portion of the results to the user device.

2. A computer program, embodied in a non-transitory computer readable medium, the non-transitory computer readable medium having stored thereon a sequence of instructions which, when executed by one or more processors causes the one or more processors to perform a set of acts, the acts comprising:
establishing a connection between a user device and at least one of a plurality of remote devices, wherein the connection is established without allowing any incoming connections to the at least one of the plurality of remote devices;
executing a script on the at least one of the plurality of remote devices;
gathering results of executing the script on the at least one of the plurality of remote devices; and
sending at least a portion of the results to the user device.

3. A system comprising:
a storage medium having stored thereon a sequence of instructions; and
a processor or processors that execute the instructions to causes the processor or processors to perform a set of acts, the acts comprising,
establishing a connection between a user device and at least one of a plurality of remote devices, wherein the connection is established without allowing any incoming connections to the at least one of the plurality of remote devices;
executing a script on the at least one of the plurality of remote devices;
gathering results of executing the script on the at least one of the plurality of remote devices; and
sending at least a portion of the results to the user device.
